(19) United States
(12) Patent Application Publication
(10) Pub. No.: US 2007/0297694 A1
(43) Pub. Date: Dec. 27, 2007

(54) IMAGE-PROCESSING APPARATUS, IMAGE PROCESSING METHOD, IMAGE-PICKUP APPARATUS, AND IMAGE TAKING METHOD

(75) Inventor: Tohru Kurata, Saitama (JP)

Correspondence Address: BELL, BOYD & LLOYD, LLP, P. O. BOX 1135, CHICAGO, IL, 60690, US

(73) Assignee: Sony Corporation, Tokyo (JP)

(21) Appl. No.: 11/765,925

(22) Filed: Jun. 20, 2007

(30) Foreign Application Priority Data
Jun. 21, 2006 (JP) P2006-170947

(51) Int. Cl. G06K 9/36; G06K 9/32

(52) U.S. Cl. 382/284; 382/294

(57) ABSTRACT

An image-processing apparatus including computation means and rotation/parallel-shift addition means is provided. The computation means is configured to compute a parallel-shift quantity and a rotation angle of the observed screen. The rotation/parallel-shift addition means is configured to move the observed screen in a parallel shift according to the parallel-shift quantity computed by the computation means, rotate the observed screen by the rotation angle computed by the computation means, and superpose the shifted and rotated observed screen on the reference screen or a post-addition screen obtained as a result of superposing observed screens other than the observed screen on the reference screen in order to add the other observed screens to the reference screen.

### CROSS REFERENCES TO RELATED APPLICATIONS

The present application claims priority to Japanese Patent Application JP 2006-170947 filed in the Japan Patent Office on Jun. 21, 2006, the entire contents of which being incorporated herein by reference.

### BACKGROUND

The present disclosure relates to an image-processing apparatus, an image processing method, an image-pickup apparatus, an image taking method. The present invention is capable of compensating an image obtained as a result of an image taking process carried out by the image-pickup apparatus such as a digital still camera or a video camera for an effect of the so-called hand-trembling component included in the image so as to generate an image without the effect of the hand trembling component.

In general, in a photographing operation carried out by making use of an apparatus held by a hand such as a digital still camera or a video camera, vibration caused by hand trembling occurring during the photographing operation as vibration of the image-pickup apparatus appears as vibration on each screen unit of an image taken in the photographing operation carried out by making use of the image-pickup apparatus.

As a method for compensating an image of a picture taken in a photographing operation for an effect of vibration caused by such hand trembling, an optical hand-trembling compensation technique making use of a gyro sensor (or an angular-velocity sensor) is predominant. The price of a gyro sensor presently available in the market has been decreasing, the performance of the sensor has also been becoming better, and the size of the sensor has been becoming small as well.

In recent years, however, the very fast popularization of the digital camera and, at the same time, the very rapidly increasing number of pixels raise a new problem that, also in the case of a still image taken in a photographing operation carried out in a low-illumination environment necessary for a long exposure time, compensation of the picture for an effect caused by hand trembling is strongly demanded. However, the solution to the problem is a method making use of a sensor such as a gyro sensor, which raises other problems such as shortcomings of the gyro sensor itself. The shortcomings of the gyro sensor include mediocre detection precision.

In every process carried out by a consumer apparatus presently available in the market to compensate an image for effects caused by hand trembling, a hand-trembling vector is measured by making use of an omnipresent gyro sensor or an omnipresent acceleration sensor and the measured hand-trembling vector is fed back to a mechanism system in high-speed control to prevent an image projected on an image sensor such as a CCD (Charge Couple Device) imager or a CMOS (Complementary Metal Oxide Semiconductor) imager from causing an effect caused by hand trembling.

A proposed mechanism system employs a lens, a prism, and an imager (or a module integrated with the imager). The lens, the prism, and the imager are referred to as a lens shift, a prism shift, and an imager shift respectively.

With an image compensated for an effect caused by hand trembling by adoption of such a method, a prediction error and a control error of the mechanism system are generated in addition to the precision error caused by the aforementioned mediocre precision of the gyro sensor itself. The prediction error is an error caused by a delay of an operation to feed back a hand-trembling vector to the mechanism system or an error generated in a process to avoid a delay of an operation to feed back a hand-trembling vector to the mechanism system. Thus, it is difficult to compensate an image for an effect caused by hand trembling at pixel precision.

As described above, in spite of the fact that the compensation of an image for an effect caused by hand trembling has a big problem that, in principle, high precision is difficult to be pursued, image-processing apparatus and/or image-pickup apparatus are highly appreciated in the market because the apparatus are capable of reducing the effects caused by hand trembling, if not compensating an image for the effects caused by hand trembling.

With the number of pixels increasing more and more in the future, however, the pixel size decreases so that the gap between the compensation limit and the pixel precision increases inevitably. It is a problem of time that the market will be aware of the issue of the fact that the gap between the compensation limit and the pixel precision is increasing.

As another method to compensate an image for an effect caused by hand trembling, there is known a sensorless hand-trembling compensation technique whereby an image is compensated for an effect caused by hand trembling by computing a movement vector of a screen unit of a taken image and shifting the read position of data stored in an image memory as the data of the image on the basis of this movement vector.

As a method to detect a movement vector of a screen unit of a taken image from the taken-image information itself, there is known a block matching method for finding a correlation between 2 screens of a taken image. The sensorless hand-trembling compensation technique based on this block matching method is in principle implemented as a technique for detecting a hand-trembling vector at pixel precision including rotational components moving in a roll axis direction. In addition, since mechanical components such as the gyro sensor are not necessary, the sensorless hand-trembling compensation technique offers a merit that the image-pickup apparatus can be made compact and light.

FIGS. 78 and 79 are diagrams showing an outline of the block matching method cited above. FIG. 80 shows a typical processing flowchart of the block matching method.

In accordance with the block matching method, a movement vector of one screen unit is found by computing a correlation between a block on an original screen used as a target screen of a taken image generated by an image taking section and each block on an observed screen (or a referenced screen) of the taken image. The original screen (or the target screen) is a screen leading ahead of the observed screen by typically a time period corresponding to one screen. The block on the original screen (or the target screen) is a rectangular portion included in the target screen as a portion having a size determined in advance. By the same token, a block on the observed screen is a rectangular portion included in the observed screen as a portion having the same size as the predetermined size of the block on the target screen.

It is to be noted that a screen in this case is an image represented by image data of a frame or a field. In this specification, a screen is used to imply an image represented by image data of a frame in order to make the explanation simple. Thus, in the following description, the observed screen or is referred to as an observed frame (or a referenced frame) whereas the original screen or the target screen (also referred to as a reference screen) is referred to as an original frame (or a target frame).

Let us assume for example that the image taking section is generating a present frame at the present time. The image data of the observed frame is the image data of the present frame or the image data delayed by a time period corresponding to one frame from a time at which the present frame received from the image taking section is stored in a memory. The image data of the target frame (the original frame) is data stored at a time leading ahead of a time, at which the observed frame received from the image taking section was stored in the memory, by a time period corresponding to one frame.

As shown in FIG. 78, in accordance with the block matching method, a rectangular target block 103 having a size determined in advance is set at any arbitrary position on the target frame (or the original frame) 101. The target block 103 has a plurality of lines arranged in the vertical direction and each of the lines has a plurality of pixels arranged in the horizontal direction.

On the other hand, on the observed frame 102, a target-block projection image block 104 of the target block 103 is assumed at a position corresponding to the position of the target block 103 on the target frame 101. In FIG. 78, the target-block projection image block 104 is shown as a block enclosed by dashed lines. A search range 105 is set on the observed frame 102 at such a position that the center of the search range 105 coincides with the center of the target-block projection image block 104. In FIG. 39, the search range 105 is shown as a range enclosed by dotted dashed lines. In addition, an observed block 106 is set in the search range 105. Shown in the figure as a block enclosed by solid lines, the observed block 106 has the same size as the target block 103.

The observed block 106 is moved to every position in the search range 105 on the observed frame 102. At every position to which the observed block 106 is moved, the correlation between the image contents of the observed block 106 and the image contents of the target block 103 is found. Then, the position at which the observed block 106 has the strongest correlation with the target block 103 is determined. The determined position is a position to which the target block 103 on the target frame 101 has been moved over the observed frame 102 from the position of the target-block projection image block 104. Subsequently, the distance between the determined position, to which the target block 103 on the target frame 101 has been moved over the observed frame 102, and the position of the target-block projection image block 104 is found as a movement vector having a direction and a magnitude.

The observed block 106 is moved to every position in the search range 105 on the observed frame 102 in the vertical and horizontal directions by a distance corresponding to one pixel or a plurality of pixels at one time. By moving the observed block 106 in this way, it is possible to obtain the same effect as if a plurality of observed blocks had been set in the search range 105 on the observed frame 102.

The aforementioned correlation between the image contents of the observed block 106 and the image contents of the target block 103 is found by computing a SAD (Sum of Absolute Differences) value as follows. First of all, the absolute value of a difference in luminance value between every individual pixel in the target block 103 and a pixel included in the observed block 106 as a pixel corresponding to the individual pixel is computed. Then, the sum of the absolute values computed for all pixels in the target block 103 and the observed block 106 is found as the SAD value mentioned above. In the following description, the value of correlation between the image contents of the observed block 106 and the image contents of the target block 103 is referred to as a SAD value.

A SAD value is computed for every position included in the search range 105 as a position to which the observed block 106 is moved. Then, the position at which the observed block 106 has the smallest computed SAD value is determined. The smallest computed SAD value indicates the strongest correlation between the observed block 106 and the target block 103. The determined position is a position to which the target block 103 on the target frame 101 has been moved over the observed frame 102 from the position of the target-block projection image block 104. Subsequently, the distance between the determined position, to which the target block 103 on the target frame 101 has been moved over the observed frame 102, and the position of the target-block projection image block 104 is found as a movement vector having a direction and a magnitude.

An observation vector 107 shown in FIG. 78 is a vector representing the distance between any position, to which the observed block 106 is moved over the search range 105, and the position of the target-block projection image block 104. Notation RV is often used to denote an observation vector 107. Thus, there are as many observation vectors 107 as the positions to which the observed block 106 is moved over the search range 105. On the other hand, the movement vector cited above is the distance between the position having the smallest SAD value and the position of the target-block projection image block 104. The position having the smallest SAD value is a position, to which the target block 103 on the target frame 101 has been moved over the observed frame 102 from the position of the target-block projection image block 104. The block matching method in related art is thus a method by which a movement vector 110 is selected among the observation vectors 107. As described above, a vector representing a distance is a quantity representing the magnitude and direction of the distance.

In general, a SAD table 108 according to the block matching method is set as shown in FIG. 79. The SAD table 108 has SAD table elements 109, which are each a computed SAD value between the target block 103 and the observed block 106 at a position in the search range 105. As described above, instead of assuming that the observed block 106 is moved to a plurality of positions in the search range 105, a plurality of observed blocks 106 are set in advance at the positions in the search range 105. In this case, the SAD table 108 set for a search range 105 has as many SAD table elements 109 as the observed blocks 106 set in the search range 105 and the SAD table element 109 is a computed SAD value between the target block 103 and one of the observed blocks 106. In order to make the explanation simpler, in the following description, a SAD value between the target block 103 and an observed block 106 is referred to simply as a SAD value for an observed block 106. That is to say, the computed SAD values are stored in a memory as the SAD table 108. The positions of the SAD table elements 109 each for storing the SAD value for one of observed blocks 106 in the SAD table 108 correspond to the positions of the observed blocks 106 in the search range 105 on a one-to-one basis. An observation vector 107 pointing to the position of an observed block 106 in the search range 105 is thus a vector pointing to the position of a SAD table element 109 in the SAD table 108. The process to select a movement vector 110 for the target block 103 among observation vectors 107 is a process to identify the smallest SAD value for an observed block 106 among all the SAD table elements 109 of the SAD table 108 stored in the memory. An observation vector 107 pointing to the position of the SAD table element 109 having the identified smallest SAD value for the observed block 106 is taken as the movement vector 110 for the target block 103.

As described above, instead of assuming that the observed block 106 is moved to a plurality of positions in the search range 105, a plurality of observed blocks 106 are set in advance at positions in the search range 105 on the observed frame 102. In this case, the observation vectors 107 are associated with the positions in the search range 105 on the observed frame 102 a one-with-one basis. That is to say, since the positions of the observed blocks 106 in the search range 105 on the observed frame 102 correspond to the positions of SAD table elements 109 in the SAD table 108 on a one-to-one basis as described above, the observation vectors 107 are associated with the positions of SAD table elements 109 in the SAD table 108 shown in FIG. 79. As described earlier, the SAD table elements 109 are each a SAD value for one of the observation vectors 107. For this reason, the SAD table 108 is also referred to as a table of sums of absolute differences each computed for an observed block 106.

In the embodiment described above, the position of the target block 103 is an arbitrary specific position in the target frame 101, and the position of each observed block 106 is also an arbitrary specific position in the observed frame 102. It is to be noted, however, that the position of the target block 103 typically means the position of the center of the target block 103 whereas the position of each observed block 106 is typically the position of the center of the observed block 106. An observation vector 107 associated with the position of a SAD value for an observed block 106 is a vector representing the magnitude and direction of the distance between the observed block 106 and the target-block projection image block 104, which is a projection located in the observed frame 102 as a projection of the target block 103 located in the target frame 101. In the embodiment shown in FIGS. 78 and 79, the position of the target block 103 in the target frame 101 is the center of the target frame 101.

In addition, since an observation vector 107 represents the magnitude and direction of the distance between an observed block 106 and the target-block projection image block 104, which is a projection located in the observed frame 102 as a projection of the target block 103 located in the target frame 101, as described above, an observation vector 107 can be said to be a vector associated with an observed block 106. Thus, when the position of an observed block 106 in the search range 105 is identified, an observation vector 107 associated with the observed block 106 is also identified. That is to say, if the address of a SAD table element 109 in the SAD table 108 stored in the memory is identified, the position of an observed block 106 in the search range 105 is identified so that an observation vector 107 associated with the observed block 106 is also identified as well.

Processing carried out in accordance with the block matching method in related art described above is explained by referring to a flowchart shown in FIG. 80 as follows.

As shown in the figure, the flowchart begins with a step S1 at which an observed block Ii in the search range 105 is specified. The operation to specify an observed block Ii (denoted by reference numeral 106 in the above description) in the search range 105 is equivalent to an operation to specify an observation vector 107. Let us assume that notation (vx, vy) denote the coordinates of the position of an observed block 106 associated with an observation vector 107, and the position of the target block 103 in the target frame 101 or the position of the target-block projection image block 104 in the observed frame 102 is taken as a reference position indicated by coordinates (0, 0). In this case, the coordinate vx of an observation vector 107 is the horizontal-direction distance between the reference position and the position of an observed block 106 associated with the observation vector 107 whereas the coordinate vy of an observation vector 107 is the vertical-direction distance between the reference position and the position of an observed block 106 associated with the observation vector 107.

The coordinates (vx, vy) are each expressed in terms of pixels each used as the unit of distance. For example, a coordinate vx=+1 is the coordinate of a position separated in the horizontal direction to the right from the reference position (0, 0) by a distance of one pixel. On the other hand, a coordinate vx=−1 is the coordinate of a position separated in the horizontal direction to the left from the reference position (0, 0) by a distance of one pixel. By the same token, a coordinate vy=+1 is the coordinate of a position separated vertically in the upward direction from the reference position (0, 0) by a distance of one pixel. On the other hand, a coordinate vy=−1 is the coordinate of a position separated vertically in the downward direction from the reference position (0, 0) by a distance of one pixel.

As described above, the coordinates (vx, vy) are the coordinates of the position of an observed block 106 associated with the observation vector 107. In the following description, the position of an observed block 106 associated with the observation vector 107 is also referred to as a position pointed to by the observation vector 107 for the sake of simplicity. Thus, the coordinates (vx, vy) can be said to be coordinates associated with an observation vector 107. That is to say, the coordinates vx and vy, which are each typically an integer, are coordinates representing an observation vector 107. For this reason, in the following description, an observation vector 107 pointing to a position (vx, vy) is referred to as an observation vector (vx, vy).

As described above, the target block 103 in the target frame 101 is projected to the target-block projection image block 104 located at the center of the search range 105 on the observed frame 102, and the position of the target-block projection image block 104 or the center of the search range 105 is taken as the reference position (0, 0). Let us assume that the width of the search range 105 is horizontal dimensions of ±Rx whereas the height of the search range 105 is vertical dimensions of ±Ry. That is to say, the coordinates vx and vy satisfy the following relations:
−Rx≦vx≦+Rx and −Ry≦vy≦+Ry

Then, at the next step S2, a point (or a pixel) with coordinates (x, y) is specified as a point in the target block Io denoted by reference numeral 103 in FIG. 78. Let notation Io (x, y) denote a pixel value at the specified point (x, y) and notation Ii (x+vx, y+vy) denote a pixel value at a point (x+vx, y+vy) in the observed block Ii at the block position (vx, vy) set in the process carried out at the step S1. In the following description, the point (x+vx, y+vy) in the observed block Ii is said to be a point corresponding the point (x, y) in the target block Io. Then, at the next step S3, the absolute value α of the difference between the pixel value Io (x, y) and the pixel value Ii (x+vx, y+vy) is computed in accordance with Eq. (1) as follows:
α=|Io(x,y)−Ii(x+vx,y+vy)| (1)

The above difference absolute value α is to be computed for all points (x, y) in the target block Io and all their corresponding points (x+vx, y+vy) in the observed block Ii, and a SAD value representing the sum of the difference absolute values α computed for the target block Io and the observed block Ii is stored at a memory location (or an address) associated with an observation vector (vx, vy) pointing to the location of the current observed block Ii. In order to compute such a SAD value, at the next step S4, the difference absolute value α found in the process carried out at the step S3 is cumulatively added to a temporary SAD value already stored at the memory location or the address as a SAD value computed so far. The final SAD value denoted by notation SAD (vx, vy) is obtained as a result of a process to cumulatively sum up all difference absolute values α, which are computed for all points (x, y) in the target block Io and all their corresponding points (x+vx, y+vy) in the observed block Ii as described above. Thus, the final SAD value SAD (vx, vy) associated with the observation vector (x, y) can be expressed by Eq. (2) as follows:
SAD(vx,vy)=Σα32 Σ|Io(x,y)−Ii(x+vx,y+vy)| (2)

Then, the flow of the processing according to the block matching method in related art goes on to the next step S5 to produce a result of determination as to whether or not the processes of the steps S2 to S4 have been carried out for all pixels (x, y) in the target block Io and all their corresponding pixels (x+vx, y+vy) in the observed block Ii. If the result of the determination indicates that the processes of the steps S2 to S4 have not been carried out yet for all pixels (x, y) in the target block Io and all their corresponding pixels (x+vx, y+vy) in the observed block Ii, the flow of the processing according to the block matching method in related art goes back to the step S2 at which another pixel with coordinates (x, y) is specified as another pixel in the target block Io. Then, the processes of the steps S3 and S4 following the step S2 are repeated.

If the determination result produced in the process carried out at the step S5 indicates that the processes of the steps S2 to S4 have been carried out for all points (x, y) in the target block Io and all their corresponding points (x+vx, y+vy) in the observed block Ii, that is, if the final SAD value SAD (vx, vy) for the observation vector (vx, vy) set in the process carried out at the step S1 as a vector pointing to the observed block Ii has been found, on the other hand, the flow of the processing according to the block-matching method in related art goes on to a step S6 to produce a result of determination as to whether or not the processes of the steps S1 to S5 have been carried out for all observed block locations in the search range 105, that is, for all observation vectors (vx, vy).

If the determination result produced in the process carried out at the step S6 indicates that the processes of the steps S1 to S5 have not been carried out yet for all observed blocks Ii in the search range 105, that is, for all observation vectors (vx, vy) each pointing to an observed block Ii, the flow of the processing according to the block-matching method in related art goes back to the step S1 at which another observed block Ii pointed to by another observation vector (vx, vy) is set at another block position (vx, vy) in the search range 105. Then, the processes of the step S1 and the subsequent steps are repeated.

If the determination result produced in the process carried out at the step S6 indicates that the processes of the steps S1 to S5 have been carried out for all observed block positions in the search range 105 or for all observation vectors (vx, vy), that is, each element 109 of the SAD table 108 has been filled with a final SAD value (vx, vy), on the other hand, the flow of the processing according to the block-matching method in related art goes on to a step S7. The smallest value among all the final SAD values (vx, vy) stored in all the elements 109 of the SAD table 108 is identified as a minimum value representing the strongest correlation between the target block Io and the observed block Ii. Then, at the next step S8, an observation vector (vx, vy) pointing to the address of an element 109 included in the SAD table 108 as the element used for storing the smallest final SAD value (vx, vy) is recognized as the movement vector 110 described earlier. Let notation SAD (mx, my) denote the smallest final SAD value (vx, vy) whereas notation vector (mx, my) denote the observation vector (vx, vy) pointing to the address of an element 109 included in the SAD table 108 as the element 109 used for storing the SAD (mx, my) or denote the movement vector 110.

As described above, the processing according to the block-matching method in related art for a target block 103 is carried out to determine a movement vector (mx, my) for the target block 103.

In actuality, by merely determining a movement vector 110 for one target block 103 as described above, it is difficult to obtain a high-precision hand-trembling vector representing a movement caused by hand trembling as a movement made by an observed frame 102 from the target frame 101. In order to solve this problem, a plurality of target blocks 103 are set in the target frame 101 at positions spread all over the entire range of the target frame 101. With a plurality of target blocks 103 set in this way, there are also a plurality of target-block projection image blocks 104 each obtained as a projection of one of the target blocks 103, and a plurality of search ranges 105 are each set for each of the projection image blocks 104 as shown in FIG. 81. Then, a movement vector 110 is identified for each of the search ranges 104.

Finally, a hand-trembling vector is selected among the movement vectors 110. Also referred to as a global movement vector, the selected hand-trembling vector is a vector representing a movement caused by hand trembling as a movement made by an observed frame 102 from the target frame 101.

As a method for selecting a hand-trembling vector also referred to as a global movement vector from a plurality of movement vectors 110, a technique based on a majority of the movement vectors 110 has been proposed as a main method. In accordance with this majority-based technique, the movement vectors 110 are divided into groups each including movement vectors 110 having the same magnitude and the same direction. Then, the number of movement vectors 110 included in a group is counted for every group. Finally, a movement vector 110 included in a group having the largest number of movement-vectors among the movement-vector groups is selected as the hand-trembling vector or the global movement vector. In addition, there has also been proposed a combined method as a combination of the majority-based technique and reliability evaluation based on the magnitudes (and the frequency) of changes occurring along the time axis as changes in movement vector.

Japanese Patent Laid-open No. 2003-78807 discloses representative methods each based on the technology in related art as a method for compensating an image for an effect caused by hand trembling. As disclosed in the reference, a moving picture is taken as a target in most of the representative methods. In addition, sensorless methods each adopted for compensating an image for an effect caused by hand trembling are disclosed in some documents represented by Japanese Patent Laid-open No. Hei7-283999. In accordance with an algorithm adopted in a method described in patent document 2, first of all, some successive still images are taken consecutively in a photographing operation during such a short exposure period that no hand trembling occurs. Then, hand-trembling vectors between the still images are found and, while the images are being shifted in accordance with the hand-trembling vectors, the still images are added to each other to produce a final high-quality (or high-resolution) still image free of effects caused by hand trembling and noises caused by an environment with low illumination.

A realistic proposal that can be realized at a level of implementation is revealed in Japanese Patent Laid-open No. 2005-38396. In accordance with the proposal revealed in Japanese Patent Laid-open No. 2005-38396, an apparatus includes means configured to find a movement vector with an original image converted into an image having a reduced size and a unit configured to allow each SAD table element to be shared by a plurality of target blocks instead of providing a SAD table element for each target block. The conversion of an original image into an image having a reduced size and the sharing of a SAD table element by a plurality of target blocks are good techniques to reduce the size of the SAD table. This technique to reduce the size of the SAD table is adopted in other fields such as detection based on the MPEG (Moving Picture Experts Group) image compression as detection of a movement vector and detection of a scene change.

However, the algorithm disclosed in Japanese Patent Laid-open No. 2005-38396 has problems that that it takes long time to carry out a conversion process to contract an original image into an image having a reduced size and make an access to a DRAM (Dynamic RAM (Random Access Memory)) used as a memory necessary for the image conversion and that the memory is necessary for having a large size. In addition, since the algorithm is adopted in a technique to make accesses to the SAD table stored in the memory on a time-sharing basis among a plurality of target blocks, the algorithm raises another problem that the number of accesses made to the memory increases substantially so that it also undesirably takes time to carry out a process to make an access to the SAD table. In compensating a moving picture for an effect caused by hand trembling, both a real-time result and reduction of a system delay time are necessary. Thus, the long time it takes to carry out the process in accordance with the technique revealed in Japanese Patent Laid-open No. 2005-38396 is a problem that undesirably remains to be solved.

Prior to the conversion process to contract an original image into an image having a reduced size, pre-processing needs to be carried out by making use of a low-pass filter for getting rid of aliasing and low-illumination noises. In accordance with the magnitude of a contraction factor, however, the characteristics of the low-pass filter vary and, on the top of that, a number of line memories and much processing logic are necessary particularly in the case of a vertical-direction low-pass filter implemented as a multi-tap digital filter. Thus, this technique raises another problem of an increased scale of the circuit.

In a system for compensating an image for an effect caused by hand trembling, it is necessary to detect a rough hand trembling vector in a real time manner in vector detection placing emphasis on the processing time rather than precision. In most conditions, a satisfactory result can be obtained even if a sensorless hand-trembling compensation technique based on the technology in related art is adopted.

In the technology in related art adopted in a system for compensating a still image for an effect caused by hand trembling, on the other hand, there were a number of proposals made. In addition, the present pixel count of 10 million was not imagined in most applications of the technology in related art. For these reasons, the technology in related art has a lack of realistic consideration to take the contemporary mobile apparatus such as a digital still image camera as a target of application. To be more specific, for example, factors including the rotational component of a movement caused by hand trembling were not taken into consideration in the technology in related art and, even if considered, an extremely large amount of processing must be carried out.

As described before, however, in the case of an image-pickup apparatus such as a digital camera, it is expected that the number of pixels and, hence, the pixel density will increase and better performance will be necessary in the future. Under such a condition, implementation of a process to compensate a still image taken in a photographing operation for an effect caused by hand trembling without making use of a gyro sensor (or an angular-velocity sensor) or a sensorless compensation process is important.

In the hand-trembling compensation process, the processing to find a movement vector representing a movement caused by hand trembling in a sensorless way by adoption of the block matching method and the processing to compensate a still image taken in a photographing operation for an effect caused by the hand trembling by making use of the movement vector as described earlier are promising. Thus, a solution to the problems described above is important.

In this case, consideration of not only a parallel shift caused by hand trembling as a parallel shift of the whole image (or screen) but also a rotation made by the whole image (or screen) is of importance to the processing to obtain a more natural output image having a better picture quality as the still image.

### SUMMARY

effects caused by hand trembling as described above In an embodiment, an image processing method capable of solving the by consideration of not only a parallel shift caused by hand trembling as a parallel shift of an image, but also a rotation made by the image in order to obtain an output image having a better picture quality. In another embodiment, an image-processing apparatus for implementing the image processing method is provided.

An image-processing apparatus according to a first embodiment includes computation means and rotation/parallel-shift addition means. The computation means is configured to compute a parallel-shift quantity of a parallel shift between two screens of images received sequentially in screen units and compute a rotation angle as the angle of a rotation made by a specific one of the two screens from the other one of the two screens. The rotation/parallel-shift addition means is configured to move the specific screen in a parallel shift according to the parallel-shift quantity computed by the computation means and rotate the specific screen by the rotation angle computed by the computation means. Also, the rotation/parallel-shift addition means is configured to superpose the shifted and rotated specific screen on the other screen or a post-addition screen obtained as a result of superposing screens other than the specific screen on the other screen in order to add the screens other than the specific screen to the other screen. The rotation/parallel-shift addition means includes rotation/parallel-shift processing means, addition means, and control means. The rotation/parallel-shift processing means is configured to read out the specific screen stored in a first memory from the first memory by controlling an address to read out the specific screen from the first memory. The specific screen being read out from the first memory moves in a parallel shift according to the parallel-shift quantity computed by the computation means and the specific screen being read out from the first memory rotates by the rotation angle computed by the computation means. The addition means is configured to read out the other screen or the post-addition screen from a second memory and superpose the specific screen received from the rotation/parallel-shift processing means as a screen completing the parallel-shift and rotation processes on the other screen or the post-addition screen in order to add the specific screen to the other screen or the post-addition screen. The control means is configured to execute control to write back a new post-addition screen produced by the addition means as a result of the superposition process into the second memory.

As described above, the image-processing apparatus according to the first embodiment computes a parallel-shift quantity of a parallel shift between two screens of images received sequentially in screen units and computes a rotation angle as the angle of a rotation made by a specific one of the two screens from the other one of the two screens. Then, the computed parallel-shift quantities and the computed rotation angles are used in a process to sequentially superpose a plurality of screens on each other. In the case of an image taken in a photographing operation, for example, an image obtained as a result of the superposition process is a high-quality image free of effects caused by hand trembling.

In this case, the specific screen is read out from the first memory in a state of being moved in a parallel shift according to the parallel-shift quantity and rotated by the rotation angle to be superposed on the other screen or the post-addition screen in order to add the specific screen to the reference screen or the post-addition screen.

According to an image-processing apparatus according to a second embodiment, in a rotation matrix including a trigonometric functions cos γ and sin γ as matrix elements employed in the first embodiment for computing a rotation quantity according to the rotation angle where notation γ denotes the rotation angle, the trigonometric functions cos γ and sin γ are approximated as cos γ=1 and sin γ=γ.

In order to find rotation and parallel-shift quantities from the rotation angle γ, it is necessary to make use of a rotation matrix including the trigonometric functions cos γ and sin γ for the rotation angle γ as matrix elements. The values of the trigonometric functions cos γ and sin γ for any specific rotation angle γ can be found from a table but the cost of the table is high. A coordinate transformation process based on the rotation matrix also includes a small contraction process. Thus, the true implementation of the rotation matrix will serve as a hurdle against cost reductions.

In order to solve this problem, in the image-processing apparatus according to the second embodiment, the trigonometric functions cos γ and sin γ used as elements of the rotation matrix are approximated as cos γ=1 and sin γ=γ. Thus, the table showing the values of the trigonometric functions cos γ and sin γ for any specific rotation angle γ is not necessary, allowing the reduction of the cost to be implemented.

An image-processing apparatus according to a sixth embodiment is obtained by providing the computation means employed in the image-processing apparatus according to the first embodiment. The computation means includes every-block movement vector computation means, parallel-shift quantity computation means, and rotation-angle computation means. The every-block movement vector computation means is configured to compute every-block movement vectors representing a movement made by an observed screen included in images received sequentially in screen units as the specific screen of the two screens from an original screen included in the images as the other screen of the two screens, which leads ahead of the specific screen. Target blocks each having a size determined in advance and including a plurality of target pixels are set at a plurality of positions in the original screen. A plurality of search ranges are set at positions corresponding to the positions of the target blocks in the observed screen. A plurality of observed blocks each having the same size as the target blocks and including the same number of observed pixels as the target pixels included are set in the target block in each of the search ranges. A block matching method is determined on each individual one of the target blocks and all the observed blocks set in one of the search ranges, which is set at a position corresponding to the position of the individual target block, in order to find the every-block movement vector for the individual target block. The parallel-shift quantity computation means is configured to compute a parallel-shift quantity representing a movement made by the observed screen from the original screen on the basis of the every-block movement vectors each computed by the every-block movement vector computation means for one of the target blocks. The rotation-angle computation means is configured to compute a rotation angle, by which the observed screen is rotated from the original screen, on the basis of the every-block movement vectors each computed by the every-block movement vector computation means for one of the target blocks.

As described above, the image-processing apparatus according to the sixth embodiment computes a parallel-shift quantity of a parallel shift between the observed screen and the original screen from the every-block movement vectors each computed by the every-block movement vector computation means for one of the target blocks, and computes a rotation angle, by which the observed screen is rotated from the original screen, also from the every-block movement vectors. Then, the image-processing apparatus makes use of the computed parallel-shift quantity and the computed angle of rotation in process to sequentially superpose a plurality of screens on each other. In the case of an image taken in a photographing operation, for example, an image obtained as a result of the screen superposition process is a high-quality image free of effects caused by hand trembling.

An image-processing apparatus according to a seventh embodiment is obtained by providing the image-processing apparatus according to the sixth embodiment. The image-processing apparatus includes global movement vector computation means and vector evaluation means. The global movement vector computation means is configured to compute a global movement vector representing a movement made by the entire observed screen from the original screen. The vector evaluation means is configured to make use of the global movement vector in order to evaluate each of the every-block movement vectors computed by the every-block movement vector computation means for the target blocks set in the target screen and the observed screen. If the number of aforementioned every-block movement vectors each receiving a high evaluation value from the vector evaluation means is smaller than a threshold value determined in advance, the rotation/parallel-shifting/addition means excludes the observed screen from the process to superpose the observed screen on the reference screen or the post-addition screen.

In accordance with the seventh embodiment, the global movement vector computation means computes a global movement vector representing a movement made by the entire observed screen from the original screen. The vector evaluation means makes use of the global movement vector in order to evaluate each of the every-block movement vectors computed by the every-block movement vector computation means for the target blocks set in the target screen and the observed screen. If the number of aforementioned every-block movement vectors each having a high evaluation value is smaller than the threshold value determined in advance, the rotation/parallel-shifting/addition means excludes the hardly reliable observed screen from the process to superpose the observed screen on the reference screen or the post-addition screen.

Thus, a very reliable observed screen is subjected to the screen superposition process carried out by the rotation/parallel-shifting/addition means. As a result, it can be expected that a high-quality image free of effects caused by hand trembling results.

An image-processing apparatus according to an eighth embodiment is obtained by providing the image-processing apparatus according to the sixth embodiment. The image-processing apparatus includes global movement vector generation means and vector evaluation means. The global movement vector generation means is configured to generate a global movement vector representing a movement made by the entire observed screen from the original screen. The vector evaluation means is configured to make use of the global movement vector in order to evaluate each of the every-block movement vectors computed by the every-block movement vector computation means for the target blocks set in the target screen and the observed screen. The parallel-shift quantity computation means and the rotation angle computation means compute a parallel-shift quantity and a rotation angle respectively from the every-block movement vectors each receiving a high evaluation value from the vector evaluation means.

In accordance with the eighth embodiment, the global movement vector generation means generates a global movement vector representing a movement made by the entire observed screen from the original screen. The vector evaluation means makes use of the global movement vector in order to evaluate each of the every-block movement vectors computed by the every-block movement vector computation means for the target blocks set in the target screen and the observed screen. The parallel-shift quantity computation means and the rotation angle computation means compute a parallel-shift quantity and a rotation angle respectively from the every-block movement vectors each receiving a high evaluation value from the vector evaluation means.

Thus, the parallel-shift quantity computation means and the rotation angle computation means are capable of computing a parallel-shift quantity and a rotation angle respectively with a high degree of precision.

As a result, since the rotation/parallel-shifting/addition means superposes the shifted and rotated observed screen on the reference screen or a post-addition screen by making use of a parallel-shift quantity and a rotation angle, which have been computed with a high degree of precision, it can be expected that a high-quality image free of effects caused by hand trembling results.

An image-processing apparatus according to a ninth embodiment is obtained by providing the every-block movement vector computation means employed in the image-processing apparatus according to the seventh or eighth embodiments. The every-block movement vector computation means includes difference absolute-value sum computation means, difference absolute-value sum table generation means, and movement-vector computation means. The difference absolute-value sum computation means is configured to compute a difference absolute-value sum for each individual one of the observed blocks set in a specific search range corresponding to a specific one of the target blocks. The difference absolute-value sum is a sum of the absolute values of differences in pixel value between target pixels in the specific target block and observed pixels located at positions corresponding to the positions of the target pixels in the individual observed block. The difference absolute-value sum table generation means is configured to generate a difference absolute-value sum table for each individual one of the target blocks as a table with sum table elements thereof each used for storing a difference absolute-value sum computed by the difference absolute-value sum computation means for one of the observed blocks set in a search range corresponding to the individual target block. The movement-vector computation means is configured to compute a plurality of every-block movement vectors each associated with one of the target blocks from the difference absolute-value sum tables each generated by the difference absolute-value sum table generation means for one of the target blocks. The global movement vector generation means has difference absolute-value sum total table generation means and global movement vector detection means. The difference absolute-value sum total table generation means is configured to generate a difference absolute-value sum total table, each individual one of total table elements of which is used for storing a total of the difference absolute-value sums each stored in a sum table element included in one of the difference absolute-value sum tables as a sum table element corresponding to the individual total table element. The global movement vector detection means is configured to detect the global movement vector from the difference absolute-value sum total table generated by the difference absolute-value sum total table generation means.

In the every-block movement vector computation means:

difference absolute-value sum computation means computes a difference absolute-value sum (or a SAD value) for each of the observed blocks set in a search range corresponding to one of the target blocks and finds such difference absolute-value sums each computed for one of the observed blocks for each of the target blocks;

difference absolute-value sum table generation means generates a difference absolute-value sum table for each of the target blocks as a table with sum table elements thereof each used for storing a difference absolute-value sum; and

movement-vector computation means computes a plurality of every-block movement vectors each associated with one of the target blocks from the difference absolute-value sum tables.

In the case of the image-processing apparatus according to the ninth embodiment of the present invention, however, in the global movement vector generation means,

the difference absolute-value sum total table generation means generates a difference absolute-value sum total table (or a SAD total table), each individual one of total table elements of which is used for storing a total of the difference absolute-value sums each stored in a sum table element included in one of the difference absolute-value sum tables generated by the difference absolute-value sum table generation means as a sum table element (that is, a table element for storing a SAD value) corresponding to the individual total table element (that is, a specific table element for storing a total of the difference absolute-value sums); and

the global movement vector detection means detects the global movement vector from the difference absolute-value sum total table (or the SAD total table) generated by the difference absolute-value sum total table generation means as a vector representing a movement of the observed screen from the original screen.

In the case of the image-processing apparatus in related art, a movement vector is found for each of a plurality of target blocks set in the original screen. (Such a movement vector is referred to as a movement vector for a target block). Then, a global movement vector is selected from the movement vectors on a majority-determination basis. The image-processing apparatus according to the present embodiment is different from the image-processing apparatus in related art in that the global movement vector detection means employed in the image-processing apparatus according to the present embodiment detects the global movement vector from the SAD total table with each of total table elements thereof used for storing a total of SAD values as a vector representing a movement of the entire observed screen from the original screen in a technique equivalent to the block matching method.

Thus, a global movement vector found from a SAD total table has a higher degree of precision than a global movement vector found by the image-processing apparatus in related art.

An image-processing apparatus according to a tenth embodiment is obtained by providing the every-block movement vector computation means employed in the image-processing apparatus according to the sixth embodiment:

difference absolute-value sum computation means configured to compute a difference absolute-value sum for each individual one of the observed blocks set in a specific search range corresponding to a specific one of the target blocks as a sum of the absolute values of differences in pixel value between target pixels in the specific target block and observed pixels located at positions corresponding to the positions of the target pixels in the individual observed block and find such difference absolute-value sums each computed for one of the observed blocks for each of the target blocks;

contracted observation vector acquisition means configured to take an observation vector for each observed block set in the observed frame as a vector having a magnitude and a direction respectively representing the distance of a shift from the position of a target block on the target screen to the position of the observed block and the direction of the shift and acquire an contracted observation vector obtained by contracting the observation vector at a contraction factor determined in advance;

contracted difference absolute-value sum table generation means configured to generate a contracted difference absolute-value sum table for each individual one of the search ranges as a table having fewer table elements than observed blocks set in the individual search range by a difference depending on the contraction factor determined in advance and make use of each of the table elements for storing a fraction of the difference absolute-value sum computed by the difference absolute-value sum computation means for an observed block included in the individual search range as an observed block associated with the observation vector taken by the contracted observation vector acquisition means; and

movement-vector computation means configured to compute an every-block movement vector for each of the contracted difference absolute-value sum tables each generated by the contracted difference absolute-value sum table generation means for a target block corresponding to the individual search range. The contracted difference absolute-value sum table generation means employs:

neighbor observation vector detection means configured to find a plurality of neighbor observation vectors each having a vector quantity close to the vector quantity of the contracted observation vector acquired by the contracted observation vector acquisition means;

distributed difference absolute value sum computation means configured to split the difference absolute-value sum computed by the difference absolute-value sum computation means for each of the observed blocks into the fractions each used as a component difference absolute value sum associated with one of the neighbor observation vectors found by the neighbor observation vector detection means; and

component difference absolute-value sum addition means configured to cumulatively add the component difference absolute value sums each computed by the component difference absolute value sum computation means as a sum associated with one of the neighbor observation vectors for each of the neighbor observation vectors.

As described above, in the image-processing apparatus provided by the tenth embodiment as an apparatus based on the image-processing apparatus according to the sixth embodiment, a SAD (difference absolute-value sum) computation means computes a difference absolute-value sum (or a SAD value) for each observed block set in every search range corresponding to a target block much like the image-processing apparatus in related art.

In the case of the image-processing apparatus according to the tenth embodiment, however, the SAD value found for an observed block is not stored in a table element pointed to by an observation vector associated with the observed block. Instead, the shrunk SAD (difference absolute-value sum) table generation means is provided for generating a shrunk SAD table with each of the table elements thereof used for storing a fraction of the SAD value computed by the SAD computation means. Table elements each used for storing a fraction of the SAD value are associated with a contracted observation vector obtained as a result of contracting an observation vector associated with an observed block for which the SAD value is computed.

However, the number of table elements of the shrunk SAD table generated for a search range is smaller than the number of observed blocks set in the search range or smaller than the number of contracted observation vectors each obtained as a result of contracting an observation vector. Thus, the number of table elements of the shrunk SAD table generated for a search range is smaller than the number of SAD values each computed for an observed block included in the search range. In order to solve this problem, the shrunk SAD table generation means is provided with the neighbor observation vector detection means for finding a plurality of neighbor observation vectors each having a vector quantity close to the vector quantity of a contracted observation vector. In addition, the shrunk SAD table generation means is also provided with the SAD (component difference absolute-value sum) computation means for splitting a SAD value computed by the SAD computation means into fractions each used as a component SAD value associated with one of the neighbor observation vectors found by the neighbor observation vector detection means.

On the top of that, the shrunk SAD table generation means is also provided with the component SAD addition means for cumulatively adding the component SAD values each computed by the component SAD computation means as a sum associated with one of the neighbor observation vectors for each of the neighbor observation vectors.

Thus, each table element of the shrunk SAD table is used for storing a cumulative sum of component SAD values each obtained as a result of splitting a SAD value into fractions each associated with a neighbor observation vector having a quantity close to the quantity of an contracted observation vector resulting from contraction of an observation vector for which the SAD value has been computed. The number of table elements is smaller than the number of contracted observation vectors each obtained as a result of contracting an observation vector by a difference depending on the contraction factor.

In other words, the shrunk SAD (difference absolute-value sum) table is a SAD table for a contracted frame image, which is obtained as if the frame image were contracted at a contraction factor. In this case, however, the target and observed blocks used in the process to compute a SAD value are not contracted and the number of observed blocks used in the process is not reduced either. The size of the shrunk SAD table is smaller than the size of the SAD table so that the number of table elements in the shrunk SAD table is smaller than the number of contracted observation vectors each obtained as a result of contracting an observation vector associated with an observed block by a difference depending on the contraction factor.

In the image-processing apparatus according to the tenth embodiment of the present invention, such a shrunk SAD (difference absolute-value sum) table is generated for each of a plurality of target blocks set in the target screen. Then, an every-block movement vector is identified from each of a plurality of shrunk SAD (difference absolute-value sum) tables, which are each generated for a target block.

As described above, in the case of the image-processing apparatus according to the tenth embodiment, the size of the shrunk SAD table is smaller than the size of the SAD table used in the block matching method in related art. Thus, the implementation of the shrunk SAD table is realistic.

In this present embodiment, quantities of a parallel shift and angle of rotation of observed screen from a target screed serving as reference screen are computed and the observed screen is read out from a memory in a state of being moved in a parallel shift by the computed quantities and rotated by the computed rotation angle in order to compensate the screen for an effect caused by hand trembling. Then, a plurality of compensated screens are superposed sequentially on each other. In the case of an image taken in a photographing operation, for example, an image obtained as a result of the screen superposition process is a high-quality image free of effects caused by hand trembling. That is to say, the high-quality image is obtained as a result of carrying out not only a parallel shifting process but also a rotation process on an observed screen.

Additional features and advantages are described herein, and will be apparent from, the following Detailed Description and the figures.

### BRIEF DESCRIPTION OF THE FIGURES

FIG. 1 is a block diagram showing a typical configuration of an image-processing apparatus according to a first embodiment;

FIG. 2 is an explanatory diagram of an outline of an image processing method according to an embodiment;

FIG. 3 is an explanatory diagram of an outline of an image processing method according to an embodiment;

FIG. 4 is an explanatory diagram of an outline of an image processing method according to an embodiment;

FIG. 5 is an explanatory diagram of a process to compute parallel-shift components of hand trembling applied to a frame in an image processing method according to an embodiment;

FIG. 6 is an explanatory diagram of a process to compute parallel-shift components of hand trembling applied to a frame in an image processing method according to an embodiment;

FIGS. 7A to 7D are each an explanatory diagram of a process to compute a rotation component of hand trembling applied to a frame in an image processing method according to an embodiment;

FIGS. 8A to 8E are each an explanatory diagram of a process to compute a rotation component of hand trembling applied to a frame in an image processing method according to an embodiment;

FIGS. 9A to 9C are each an explanatory diagram of a process to compute a rotation component of hand trembling applied to a frame in an image processing method according to an embodiment;

FIGS. 10A and 10B are each an explanatory diagram of a process to compute a rotation component of hand trembling applied to a frame in an image processing method according to an embodiment;

FIG. 11 is an explanatory diagram of a process to compute a rotation component of hand trembling applied to a frame in an image processing method according to an embodiment;

FIGS. 12A and 12B are each an explanatory diagram of an outline of an image processing method according to an embodiment;

FIG. 13 is an explanatory diagram of an outline of an image processing method according to an embodiment;

FIG. 14 shows a flowchart explaining an outline of an image processing method according to an embodiment;

FIGS. 15A and 15B are each an explanatory diagram of a typical process to compute an every-block movement vector at a plurality of stages in accordance with an image processing method according to an embodiment;

FIG. 16 is an explanatory diagram of a typical process to compute an every-block movement vector in accordance with an image processing method according to an embodiment;

FIGS. 17A and 17B are each an explanatory diagram of a typical process to compute an every-block movement vector in accordance with an image processing method according to an embodiment;

FIG. 18 is an explanatory diagram of a typical process to compute an every-block movement vector in accordance with an image processing method according to an embodiment;

FIGS. 19A and 19B are each an explanatory diagram of a typical process to compute an every-block movement vector in accordance with an image processing method according to an embodiment;

FIG. 20 is an explanatory diagram of a typical process to compute an every-block movement vector in accordance with an image processing method according to an embodiment;

FIG. 21 is an explanatory diagram of a typical process to compute an every-block movement vector in accordance with an image processing method according to an embodiment;

FIG. 22 is an explanatory diagram of a typical process to compute an every-block movement vector in accordance with an image processing method according to an embodiment;

FIGS. 23A and 23B are each an explanatory diagram of a typical process to compute an every-block movement vector in accordance with an image processing method according to an embodiment;

FIG. 24 is an explanatory diagram of a typical process to compute an every-block movement vector in accordance with an image processing method according to an embodiment;

FIG. 25 is an explanatory diagram of a typical process to compute an every-block movement vector in accordance with an image processing method according to an embodiment;

FIGS. 26A and 26B are each an explanatory diagram of a typical process to compute an every-block movement vector in accordance with an image processing method according to an embodiment;

FIGS. 27A to 27D are each an explanatory diagram to be referred to in description of a typical process to compute an every-block movement vector in accordance with an image processing method according to an embodiment of the present invention;

FIG. 28 is an explanatory diagram of a typical process to compute an every-block movement vector in accordance with an image processing method according to an embodiment;

FIG. 29 is an explanatory diagram of a typical process to compute an every-block movement vector in accordance with an image processing method according to an embodiment;

FIGS. 30A and 30B are each an explanatory diagram of a typical process to compute an every-block movement vector in accordance with an image processing method according to an embodiment;

FIG. 31 is an explanatory diagram of a typical process to compute an every-block movement vector in accordance with an image processing method according to an embodiment;

FIG. 32 is an explanatory diagram of a typical process to compute an every-block movement vector in accordance with an image processing method according to an embodiment;

FIGS. 33A to 33D are each an explanatory diagram of a typical process to compute an every-block movement vector in accordance with an image processing method according to an embodiment;

FIG. 34 is an explanatory diagram of the processing performance of a typical process to compute an every-block movement vector in accordance with an image processing method according to an embodiment;

FIG. 35 is an explanatory diagram of an outline of an image processing method according to an embodiment;

FIG. 36 is an explanatory diagram comparing the characteristic of the image processing method according to the embodiment with that of the method in a related art;

FIG. 37 is an explanatory diagram comparing the characteristic of the image processing method according to the embodiment with that of the method in a related art;

FIG. 38 is an explanatory diagram comparing the characteristic of the image processing method according to the embodiment with that of the method in a related art;

FIG. 39 shows a flowchart of a first typical implementation of processing to compute parallel-shift and rotation components of hand trembling in the image-processing apparatus according to the first embodiment;

FIG. 40 shows a flowchart of the first typical implementation of processing to compute parallel-shift and rotation components of hand trembling in the image-processing apparatus according to the first embodiment;

FIG. 41 shows a flowchart of the first typical implementation of processing to compute parallel-shift and rotation components of hand trembling in the image-processing apparatus according to the first embodiment;

FIG. 42 shows a flowchart of the first typical implementation of processing to compute parallel-shift and rotation components of hand trembling in the image-processing apparatus according to the first embodiment;

FIG. 43 shows a flowchart of a second typical implementation of processing to compute parallel-shift and rotation components of hand trembling in the image-processing apparatus according to the first embodiment;

FIG. 44 shows a flowchart of the second typical implementation of processing to compute parallel-shift and rotation components of hand trembling in the image-processing apparatus according to the first embodiment;

FIG. 45 shows a flowchart of the second typical implementation of processing to compute parallel-shift and rotation components of hand trembling in the image-processing apparatus according to the first embodiment;

FIG. 46 is an explanatory diagram of the second typical implementation of processing to compute parallel-shift and rotation components of hand trembling in the image-processing apparatus according to the first embodiment;

FIG. 47 shows a flowchart to be referred of a first typical routine for detecting an every-block movement vector in the image-processing apparatus according to the first embodiment;

FIG. 48 shows a flowchart of the first typical routine for detecting an every-block movement vector in the image-processing apparatus according to the first embodiment;

FIG. 49 shows a flowchart of a second typical routine for detecting an every-block movement vector in the image-processing apparatus according to the first embodiment;

FIG. 50 shows a flowchart of the second typical routine for detecting an every-block movement vector in the image-processing apparatus according to the first embodiment;

FIG. 51 shows a flowchart of a third typical routine for detecting an every-block movement vector in the image-processing apparatus according to the first embodiment;

FIG. 52 shows a flowchart of the third typical routine for detecting an every-block movement vector in the image-processing apparatus according to the first embodiment;

FIG. 53 shows a flowchart of the third typical routine for detecting an every-block movement vector in the image-processing apparatus according to the first embodiment;

FIG. 54 shows a flowchart of the third typical routine for detecting an every-block movement vector in the image-processing apparatus according to the first embodiment;

FIG. 55 is an explanatory diagram of processing executed in the third typical routine for detecting an every-block movement vector in the image-processing apparatus according to the first embodiment;

FIG. 56 is a block diagram showing a typical configuration of a rotation/parallel-shift addition unit employed in the image-processing apparatus according to the first embodiment;

FIG. 57 is a diagram to be referred to in explanation of simple frame addition processing carried out by the rotation/parallel-shift addition unit shown in FIG. 56 as a rotation/parallel-shift addition unit employed in the image-processing apparatus according to the first embodiment;

FIG. 58 is a diagram of an access made to a frame memory to read out image data from the memory in a rotation/parallel-shift addition process carried out by the image-processing apparatus according to the first embodiment;

FIG. 59 is a diagram of an access made to a frame memory to read out image data from the memory in a rotation/parallel-shift addition process carried out by the image-processing apparatus according to the first embodiment;

FIG. 60 is a diagram of an access made to a frame memory to read out image data from the memory in a rotation/parallel-shift addition process carried out by the image-processing apparatus according to the first embodiment;

FIG. 61 is a diagram of an access made to a frame memory to read out image data from the memory in a rotation/parallel-shift addition process carried out by the image-processing apparatus according to the first embodiment;

FIG. 62 shows a flowchart of the simple frame addition processing carried out by the rotation/parallel-shift addition unit shown in FIG. 56 as a rotation/parallel-shift addition unit employed in the image-processing apparatus according to the first embodiment;

FIG. 63 is a block diagram showing another typical configuration of a rotation/parallel-shift addition unit employed in the image-processing apparatus according to the first embodiment;

FIG. 64 is a diagram to be referred to in explanation of averaging frame addition processing carried out by the rotation/parallel-shift addition unit shown in FIG. 63 as a rotation/parallel-shift addition unit employed in the image-processing apparatus according to the first embodiment;

FIG. 65 shows a flowchart to be referred to in explanation of the averaging frame addition processing carried out by the rotation/parallel-shift addition unit shown in FIG. 63 as a rotation/parallel-shift addition unit employed in the image-processing apparatus according to the first embodiment;

FIG. 66 is a block diagram showing a further typical configuration of a rotation/parallel-shift addition unit employed in the image-processing apparatus according to the first embodiment;

FIG. 67 is a diagram to be referred to in explanation of 3 stages of tournament frame addition processing carried out by the rotation/parallel-shift addition unit shown in FIG. 66 as a rotation/parallel-shift addition unit employed in the image-processing apparatus according to the first embodiment;

FIG. 68 is a diagram to be referred to in explanation of the tournament frame addition processing carried out by the rotation/parallel-shift addition unit shown in FIG. 66 as a rotation/parallel-shift addition unit employed in the image-processing apparatus according to the first embodiment;

FIG. 69 shows a flowchart to be referred to in explanation of the tournament frame addition processing carried out by the rotation/parallel-shift addition unit shown in FIG. 66 as a rotation/parallel-shift addition unit employed in the image-processing apparatus according to the first embodiment;

FIG. 70 shows a flowchart to be referred to in explanation of the tournament frame addition processing carried out by the rotation/parallel-shift addition unit shown in FIG. 66 as a rotation/parallel-shift addition unit employed in the image-processing apparatus according to the first embodiment;

FIG. 71 is a block diagram showing a typical configuration of an image-processing apparatus according to a second embodiment;

FIG. 72 is an explanatory diagram to be referred to in description of processing to detect an every-block movement vector in the image-processing apparatus according to the second embodiment;

FIG. 73 is an explanatory diagram to be referred to in description of the processing to detect an every-block movement vector in the image-processing apparatus according to the second embodiment;

FIG. 74 shows a flowchart to be referred to in explanation of the processing to detect an every-block movement vector in the image-processing apparatus according to the second embodiment;

FIG. 75 shows a flowchart to be referred to in explanation of the processing to detect an every-block movement vector in the image-processing apparatus according to the second embodiment;

FIG. 76 is a block diagram showing a typical configuration of an image-processing apparatus according to a third embodiment;

FIG. 77 is an explanatory diagram to be referred to in description of another typical image processing method according to the embodiment;

FIG. 78 is an explanatory diagram of the processing to detect an every-block movement vector in by adoption of a block matching method;

FIG. 79 is an explanatory diagram of the processing to detect an every-block movement vector in by adoption of the block matching method;

FIG. 80 shows a flowchart of the processing to detect an every-block movement vector in by adoption of the block matching method; and

FIG. 81 is an explanatory diagram of the processing to detect an every-block movement vector in by adoption of the block matching method.

### DETAILED DESCRIPTION

With reference to the drawings, the following description explains embodiments each implementing an image processing method and/or an image-processing apparatus.

[Outline of an Embodiment Implementing an Image Processing Method]

Embodiments described below each implement an image processing method adopted mainly in a system for compensating a still image in accordance with the embodiment.

In this embodiment, an input image frame is taken as an observed frame whereas an original frame leading ahead of the input image frame is taken as a target frame. For example, the observed frame lags behind the original frame by a delay time corresponding to one frame. Then, a movement vector representing a movement of the observed frame from the original frame is detected. In accordance with a method implemented by this embodiment as a method for compensating a still image for an effect caused by hand trembling, a plurality of successive images taken consecutively in a photographing operation at a typical rate of 3 fps are superposed on each other while the images are each being compensated for an effect caused by hand trembling.

As described above, in accordance with this embodiment, a still image taken in a photographing operation is compensated for an effect caused by hand trembling by superposing a plurality of successive images taken consecutively in the photographing operation on each other while compensating each of the images for an effect caused by hand trembling. Thus, precision close to the pixel-level precision is demanded. In this embodiment, both a movement vector representing a movement caused by hand trembling as a parallel-shift movement of an observed frame from an original frame and a rotation component indicating a rotation of the observed frame from the original frame are detected at the same time. The movement vector has a horizontal-direction parallel-shift component and a vertical-direction parallel-shift component. Thus, a plurality of successive frames taken consecutively in the photographing operation are superposed on each other while each of the frames is being subjected to a parallel-shift operation and a rotation simultaneously.

It is to be noted that applications of the embodiment to be described below are by no means limited to a still image, but the embodiment can also be applied virtually to a moving picture. In the case of a moving picture, however, the finally produced image is output in a real-time manner. Thus, the number of frames that can be superposed on each other is smaller than an upper limit due to real-time necessity as described later. If the technique according to this embodiment is applied for every frame, however, the technique can also be applied to a system for generating a moving picture exhibiting a noise reduction effect by making use of exactly the same means.

Also in the case of the embodiment described below, in a process to compute a movement vector indicating a movement of an observed frame from a leading ahead of original frame serving as a target frame, as explained earlier, a plurality of target blocks are set on the target frame and the block matching method is applied to each of the target blocks.

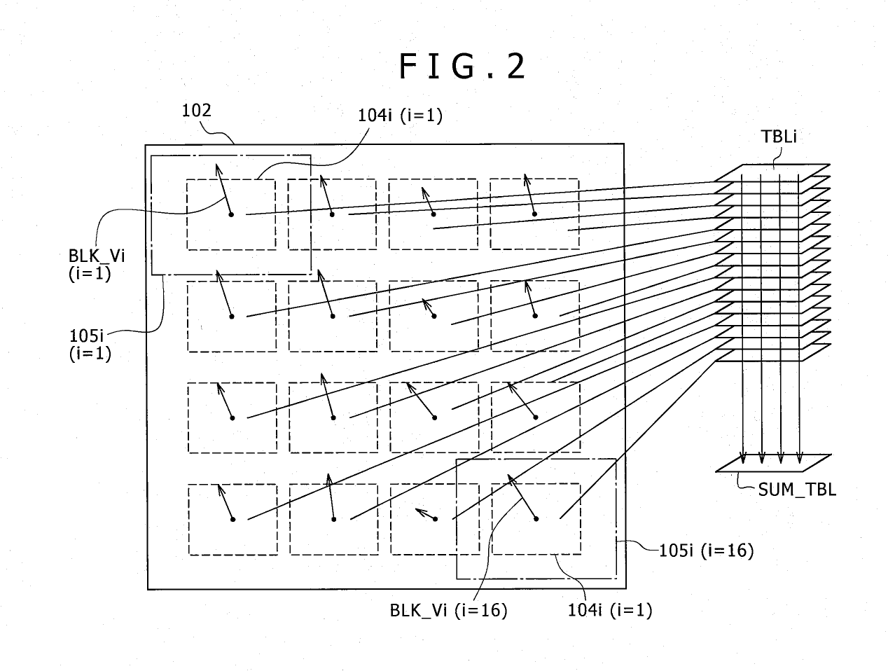

In the embodiment described below, for example, 16 target blocks TGi denoted by reference numerals 1031, where i=0, 1, 2, . . . , 15, are set on the original frame serving as the target frame 101. On the other hand, as many target-block projection image blocks 104i, where i=0, 1, 2, . . . , 15, as the target blocks TGi are set on the observed frame 102 as shown in FIG. 2. The target-block projection image blocks 104i correspond to the target blocks TGi respectively. In addition, as many search ranges 105i, where i=0, 1, 2, . . . , 15, as the target-block projection image blocks 104i are set on the observed frame 102. The search ranges 105i are associated with the target-block projection image blocks 104i respectively. For the target blocks TGi, SAD tables TBLi, where i=0, 1, 2, 15, are generated respectively as tables associated with the search ranges 105i respectively.

Then, in this embodiment, for each SAD table TBLi generated for a target block TGi, a movement vector 110 is identified for the target block TGi. The movement vector 110 identified for the target block TGi is also referred to as an every-block movement vector BLK_Vi.

Then, on the basis of a plurality of every-block movement vectors BLK_Vi, basically, a parallel-shift components and rotation angle of the movement of the observed frame from the original frame used as the target frame are found. Subsequently, the parallel-shift components and the rotation angle are used in a process to superpose the observed frame on the original frame. If the frame superposition process is to be carried out for every frame by superposing the next frame on a previously resulting frame, the processing to find parallel-shift components and a rotation angle as well as the frame superposition process are repeated. In this way, an observed frame is superposed on a frame obtained as a result of the immediately leading ahead of frame superposition process. Thus, it is possible to obtain a high-quality image free of effects caused by hand trembling.

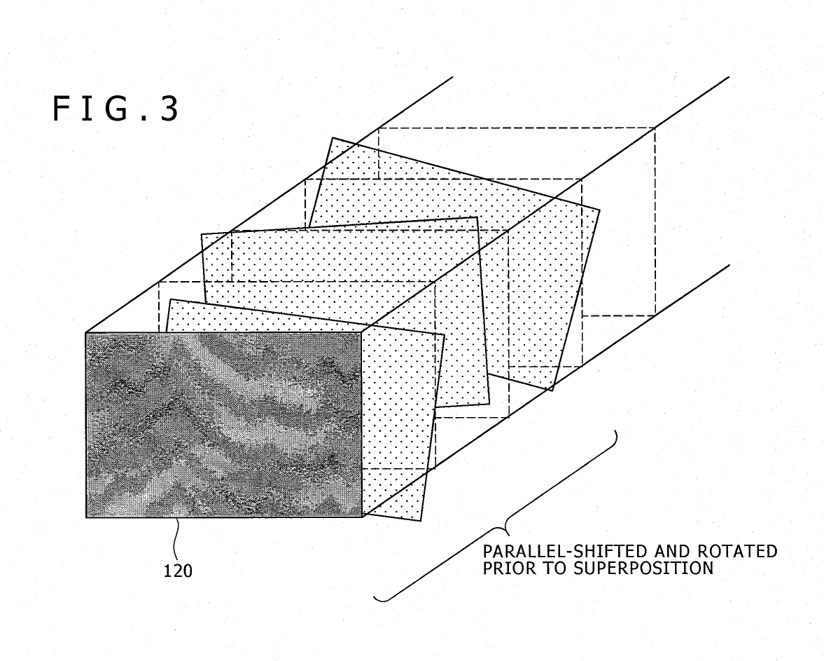

In this case, in a process to superpose two or more screens (or frames) on each other, in actuality, a frame is used as a reference screen and subsequent screens are superposed on the reference screen as shown in FIG. 3. Thus, for the second and subsequent frames, the parallel-shift quantities and rotation angle of a frame to be superposed on an immediately leading ahead of frame are cumulatively added to their respective previous cumulative sums sequentially. The respective previous cumulative sums are sums of previously computed parallel-shift quantities and a sum of previously computed rotation angles for frames observed so far as frames superposed on the first frame serving as the reference frame.

[First Typical Method to Compute Parallel-Shift Quantities and a Rotation Angle]

In accordance with one of methods to find parallel-shift quantities and rotation angle of an observed frame from an original frame by adoption of the block matching technique, the parallel-shift quantities and the rotation angle are found from a global movement vector representing a movement of the entire observed frame from the original frame. Since the global movement vector represents a movement of the entire observed frame from the original frame, the global movement vector can be used as it is as the parallel-shift quantities. In this specification, the technical term “block matching” is also referred to as detection.

That is to say, the horizontal-direction (x-direction) component of the global movement vector is the horizontal-direction parallel-shift quantity whereas the vertical-direction (y-direction) component of the global movement vector is the vertical-direction parallel-shift quantity.

A rotation angle formed by a global movement vector found for a previous frame (or an original frame) and a global movement vector found for the present frame, which is the observed frame, is a relative rotation angle by which the observed frame has been rotated with respect to the original frame.

The method adopted by this embodiment as a method to find a global movement vector is the same as the block matching method in related art. That is to say, in accordance with the method adopted by this embodiment, a global movement vector is selected from the 16 every-block movement vectors BLK_Vi each detected for a target block on a majority-determination basis. In accordance with this majority-based method, the magnitude and direction of every-block movement vectors BLK_Vi serving as the majority are taken as the magnitude and direction of the global movement vector. To put it in detail, the every-block movement vectors BLK_Vi are divided into groups each including every-block movement vectors BLK_Vi having the same or similar magnitude and the same or similar direction. Then, the number of every-block movement vector BLK_Vi included in a group is counted for every group. Finally, an every-block movement vector BLK_Vi included in a group having the largest movement-vector count among the movement-vector groups is selected as the global movement vector.

If a global movement vector is selected from the every-block movement vectors BLK_Vi each detected for a target block on a majority-determination basis, however, in many cases, an incorrect global movement vector also referred to as a hand-trembling vector is detected undesirably, raising a problem. For example, a picture of a photographing object is taken to result in a moving picture and the moving photographing object being photographed is in a visual scene where a water surface with a fine wavefront, trees, or grasses are fluttering in the wind. In the case of most of digital cameras developed recently, objects of photographing include not only still images, but also moving pictures. Thus, it is practically undesirable to adopt the method for selecting a global movement vector from every-block movement vectors BLK_Vi each detected a target block on a majority-determination basis.

In order to solve the problem described above, in this embodiment, a global movement vector is found from a SAD total table for storing SAD totals.

In this embodiment, a SAD total table SUM_TBL shown in FIG. 2 is found as follows. The 16 SAD tables TBLi each created for a target block TGi as described before are superposed on each other in the vertical direction. Every table element of each of the SAD tables TBLi is used for storing a SAD value each found for an observed block set at a position included in a search range associated with the SAD table TBLi as a position corresponding to the table element. The SAD values each found for an observed block set at a position included in a search range associated with a SAD table TBLi as a position corresponding to a table element of the SAD table TBLi are summed up to result in a SAD total, which is then stored in the corresponding table element in the SAD total table SUM_TBL. The process to sum up such SAD values to result in a SAD total and store the SAD total in the corresponding table element in the SAD total table SUM_TBL is carried out for every table element of the SAD table TBLi.

Let us assume that notation SUM_TBL (x, y) denotes a SAD total stored in a table element located at a position represented by table internal coordinates (x, y) inside the SAD total table SUM_TBL, whereas notation TBLi (x, y) denotes a SAD value stored in a table element located at a position represented by table internal coordinates (x, y) inside a SAD table TBLi. In this case, a SAD total can be expressed by the following equation:

$$\begin{matrix}SUM\_TBL ( x , y ) = TBL 1 ( x , y ) + TBL 2 ( x , y ) + … + \\ TBL 16 ( x , y ) \\ = Σ TBLi ( x , y )\end{matrix}$$

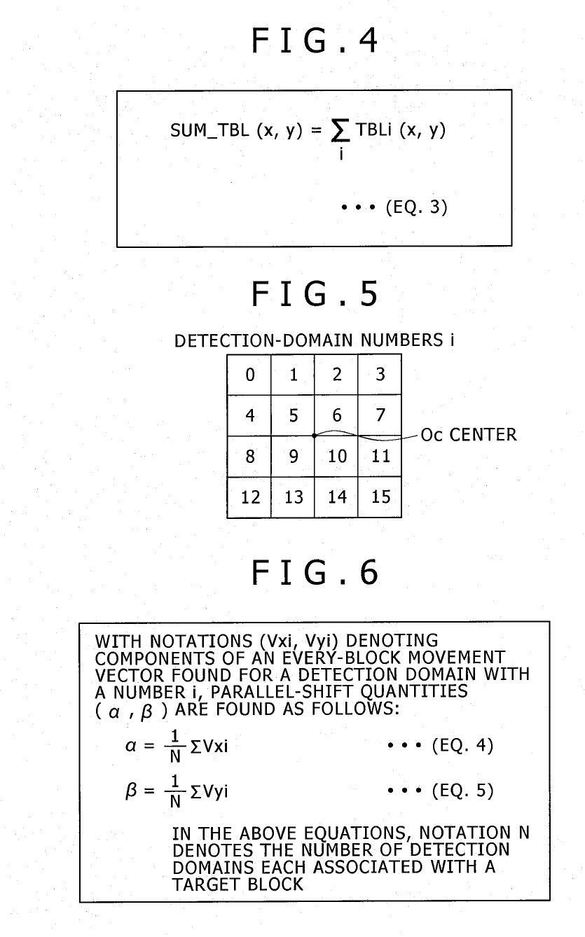

The above equation is Eq. (3) shown in FIG. 4.

Then, in this embodiment, a movement vector representing a movement of an observed screen from an original screen is found from the SAD total table SUM_TBL. The movement vector representing a movement of an observed screen from an original screen is referred to as a global movement vector or a hand-trembling vector of the image-pickup apparatus.

As a method to find a global movement vector from the SAD total table SUM_TBL, it is possible to adopt the technique in related art by which the position of the smallest SAD total among all SAD totals in the SAD total table SUM_TBL is determined and an observation vector pointing to the position of the smallest SAD total is taken as a global movement vector.

However, by adopting the method based on the smallest SAD total, a global movement vector at the pixel-level precision is difficult to obtain. In order to solve this problem, this embodiment carries out an approximation curved-face polarization process by making use of the smallest SAD total among all the SAD totals and a plurality of neighbor SAD totals each stored in a table element in close proximity to the table element for storing the smallest SAD total in order to find a global movement vector. To put it in detail, an approximation curved face is created on the basis of the smallest SAD total among all the SAD totals as well as a plurality of neighbor SAD totals each stored in a table element in close proximity to the table element for storing the smallest SAD total, and a point existing on the approximation curved face as a point corresponding to the smallest SAD total is determined. In this way, a global movement vector can be found at decimal-point precision equivalent to or even better than the pixel granularity. The approximation curved-face polarization process is described in detail later.

Since the SAD total table is a table of SAD totals found for the entire frame, the global movement vector found from the SAD total table is equivalent to a result of the block matching method applied to the entire frame. Thus, even in the case of a moving-picture photographing object for which the majority-determination method is undesirable, it is possible to obtain a global movement vector including a small error.

Then, from the global movement vector found on the basis of the SAD total table, it is possible to compute the parallel-shift quantities representing a movement of the observed frame from the original frame as well as the angle of a rotation made by the observed frame from the original frame.

It should be appreciated that a global movement vector used in the computation of the parallel-shift quantities and the rotation angle is not limited to the global movement vector found from the SAD total table. For example, the global movement vector used in the computation of the parallel-shift quantities and the rotation angle can be a global movement vector found by adoption of the majority-based method by which an every-block movement vector included in a group having the largest movement-vector count among the movement-vector groups is selected as the global movement vector. For the reasons described above, however, a global movement vector found from a SAD total table is desirable.

[Second Typical Method to Compute Parallel-Shift Quantities and a Rotation Angle]

In accordance with another method to find parallel-shift quantities representing a movement of the observed frame from the original frame as well as the angle of a rotation made by the observed frame from the original frame from a computed global movement vector, the parallel-shift quantities and rotation angle for the observed frame are found directly from a plurality of every-block movement vectors computed for the observed frame.

In accordance with this other method, in principle, the parallel-shift quantity of the observed frame is found as the average of parallel-shift quantities found from the horizontal-direction components of the 16 every-block movement vectors each corresponding to one of the 16 target blocks and the average of parallel-shift quantities found from the vertical-direction components of the 16 every-block movement vectors. Let every search range centered at a projection image block corresponding to one of the target blocks be referred to as a detection domain. In this case, detection-domain numbers i, where i=0, 1, 2, . . . , 15, can each be assigned to one of the detection domains set in the observed frame as shown in FIG. 5.

Then, let us have notation Vxi denote the horizontal-direction component of an every-block movement vector for a detection domain having the detection-domain number i whereas notation Vyi denotes the vertical-direction component of the every-block movement vector for the same detection domain. In this case, the every-block movement vector can be expressed by notation (Vxi, Vyi). The average horizontal-direction (x-direction) parallel-shift quantity α and the average vertical-direction (y-direction) parallel-shift quantity β can be found in accordance with Eqs. (4) and (5) respectively as shown in FIG. 6. As shown in the figure, the average horizontal-direction (x-direction) parallel-shift quantity α and the average vertical-direction (y-direction) parallel-shift quantity β are respectively averages of the horizontal-direction components and the vertical-direction components of the 16 every-block movement vectors.

In addition, in principle, the rotation angle γ can be found from the 16 block moving vectors as follows.

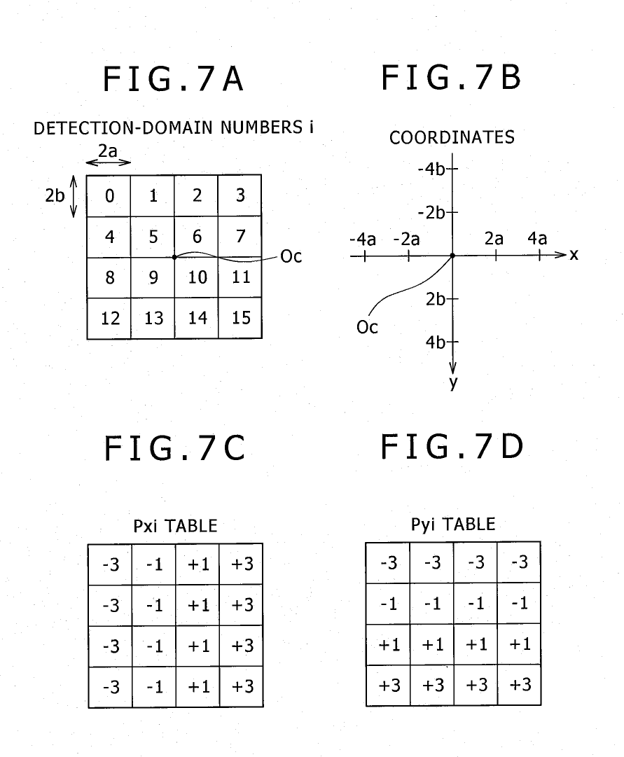

First of all, much like the assignment shown in FIG. 5, the assignment of detection-domain numbers i, where i=0, 1, 2, . . . , 15, to detection domains is defined in the observed frame as shown in FIG. 7A. As shown in FIG. 7A, the width (horizontal-direction dimension) and height (vertical-direction dimension) of the detection domain are 2a and 2b respectively. In this case, the following equations hold true:
a=horizontal pixel count of one observed block+horizontal distance to adjacent observed block (expressed in terms of pixels)
b=vertical pixel count of one observed block+vertical distance to adjacent observed block (expressed in terms of pixels).

Then, a coordinate system shown in FIG. 7B is set with its origin coinciding with the center Oc of all the detection domains having the detection-domain numbers of 0 to 15. Subsequently, values Pxi and Pyi for the detection-domain numbers i are defined as shown in FIGS. 7C and 7D. To be more specific, the value Pxi defined for a detection-domain number i is the horizontal-direction (x-direction) distance from the center Oc of all the detection domains to the center of a detection domain having the detection-domain number i as shown in FIG. 7C. By the same token, the value Pyi defined for a detection-domain number i is the vertical-direction (y-direction) distance from the center Oc of all the detection domains to the center of a detection domain having the detection-domain number i as shown in FIG. 7D.

The coordinates of the center of a detection domain having the detection-domain number i can be expressed as (Pxi·a, Pyi·b) where notations a, b, Pxi, and Pyi denote the values defined above.

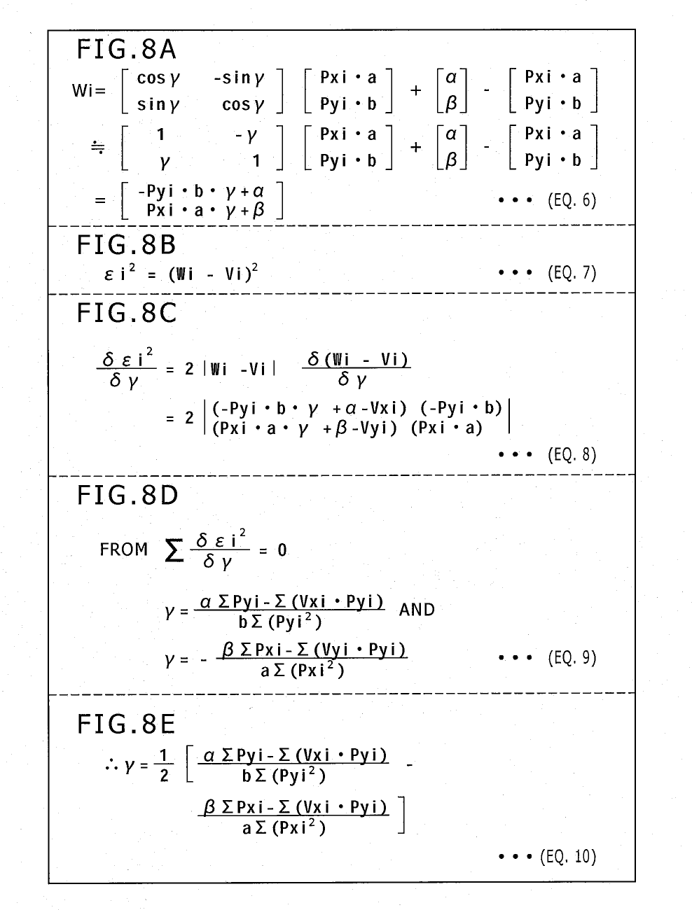

As described above, the parallel-shift quantities of an observed frame are (α, β) and the rotation angle of the frame is γ. In this case, the theoretical every-block movement vector Wi for a detection domain having a detection-domain number i can thus be expressed by Eq. (6) shown in FIG. 8A.

Let us have notation Vi denote an every-block movement vector BLK_Vi actually detected for a detection domain having a detection-domain number i whereas notation εi² denote an error between the every-block movement vector BLK_Vi actually detected for a detection domain having a detection-domain number i and the theoretical every-block movement vector Wi for the same detection domain. In this case, the errorεi² can be expressed by Eq. (7) shown in FIG. 8B. Partially differentiating the errorεi² with respect to the rotation angle γ results in Eq. (8) shown in FIG. 8C.

It is to be noted that notation δF(γ)/δγ used in FIGS. 8A to 8E denotes the partial differentiation of a function F(γ) with respect to the rotation angle γ.

If the every-block movement vector Vi actually detected for an observed frame can be assumed to correctly include the actual rotation angle γ, partial differentiation of the error sum Σεi² computed for all the every-block movement vectors Vi found for the observed frame with respect to the rotation angle γ should give a result of zero. Thus, the rotation angle γ can be expressed by Eq. (9) shown in FIG. 8D.

Therefore, the rotation angle γ to be found for the observed frame can be expressed by Eq. (10) shown in FIG. 8E.

It is to be noted that the first term of the top expression in Eq. (6) is a 2-row×2-column matrix having trigonometric functions as its elements. This matrix is a rotation matrix for rotating the observed frame by the rotation angle γ. For a reason to be described below, the 2-row×2-column matrix having trigonometric functions as its elements is approximated by the first term of the second expression from the top in Eq. (6).

Rotation angles caused by hand trembling were measured for a plurality of photographers serving as photographing experimental objects making use of some video and/or digital cameras. In the case of a plurality of successive images taken consecutively in a photographing operation at a typical rate of 3 fps, for example, the results of the photographing experiments indicate that the maximum rotation angle γ_max of rotation angles γ caused by hand trembling of a plurality of photographing experimental objects is known to have a value expressed by Eq. (11) as follows.
γ_max[rad]≈arctan( 1/64)=0.0156237 (11)

Thus, by assuming that rotation angles γ caused by hand trembling don't exceed the maximum rotation angle γ_max, we can think that the following relations hold true.
cos γ≈1 and sin γ≈γ

Thus, the 2-row×2-column rotation matrix having trigonometric functions as its elements can be expressed by the second expression from the top in Eq. (6).

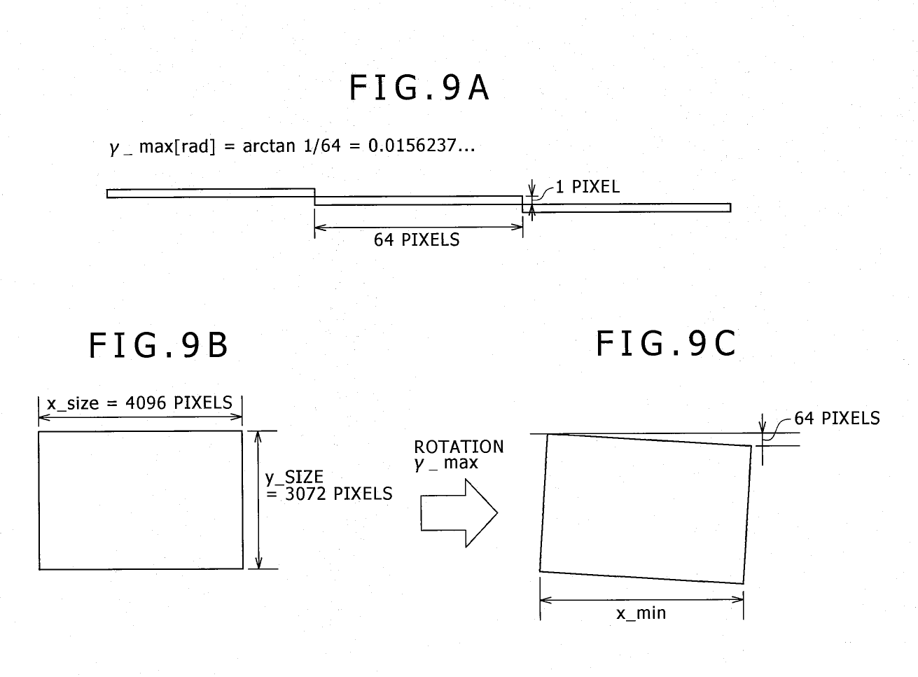

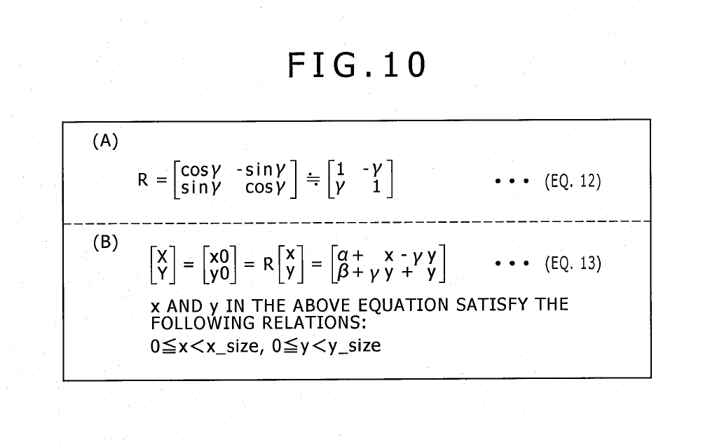

Let us assume that the aspect ratio of the pixel is 1:1 and 64 pixels are in the horizontal direction of the screen as shown in FIG. 9A. The aspect ratio is defined as the ratio of the vertical dimension (or the height) to the horizontal dimension (or the weight). In this case, the upper limit of rotation angles caused by ordinary hand trembling is known to be a gradient caused by a vertical movement distance of one pixel.

Let us assume that the upper limit of the number of pixels in an imager employed in a conceivable contemporary digital camera is about 12 million pixels, which are arranged in the imager having a typical horizontal size (x_size) of 4096 pixels and a typical vertical size (y_size) of 3072 pixels as shown in FIG. 9B. In this case, when the screen of an image is rotated by the maximum rotation angle γ_max, the horizontal size (x_size) of the post-rotation screen is slightly reduced from 4096 pixels to 4095.5 pixels as shown in FIG. 9B. The horizontal size (x_size) of the post-rotation screen is referred to as the minimum horizontal size (or the minimum width) x_min since the image has been rotated by the maximum rotation angle γ_max.

The minimum horizontal size (or the minimum width) x_min is found as follows:

$$\begin{matrix}x\_min = 4096 \times cos γ\_max \\ = 4096 \times cos ( 1 / 64 ) \\ = 4095.5000 … \\ \approx 4096\end{matrix}$$

Thus, by assuming that rotation angles γ caused by hand trembling don't exceed the maximum rotation angle γ_max, we may think that the rotation angles γ are very small as shown in Eq. (11) and, hence, the following relations hold true.
cos γ≈1 and sin γ≈γ

As a result, the rotation matrix R can be expressed by Eq. (12) shown in FIG. 10A.

In a rotation assuming that rotation angles γ caused by hand trembling don't exceed the maximum rotation angle γ_max as described above by referring to FIGS. 9A to 9C, the trigonometric functions can be used accurately in the rotation matrix R or the accurate values of the functions can be replaced by approximation values as shown in FIG. 10A. In this case, an error caused by the use of the approximation values does not exceed 0.5 pixels.

Trigonometric functions are used in the rotation matrix R and, in order to find rotation and shift quantities from the rotation angle γ, it is necessary to provide a table showing the values of the trigonometric functions in advance. However, the table showing such information costs much. On the top of that, since coordinate transformation based on the rotation matrix R includes a small contraction process, an effort to truly implement the table will serve as a hindrance to the cost reduction.

In the case of the embodiment, on the other hand, the rotation matrix R based on the approximations of cos γ≈=1 and sin γ≈γ is used as described above. Thus, the table of the values of the trigonometric functions cos and sin is not necessary so that the cost reduction can be implemented.

As described above, the observed frame is subjected to a parallel shift at parallel-shift quantities of (α, β) and a rotation at a rotation angle γ. Let us assume that the coordinates of the reference point of the shifted observed screen are (x0, y0). The reference point of the screen is a point at the left upper position of the screen. In this case, the position (X, Y) of a pixel obtained as a result of addition carried out on the pixel located at the position (x, y) on the observed frame can be found in accordance with Eq. (13) shown in FIG. 10B. The position (X, Y) is a position on a reference frame, which is the original frame or the target frame. That is to say, when the observed frame is subjected to a parallel shift at parallel-shift quantities of (α, β) and a rotation at a rotation angle γ, being superposed on the original frame in order to add the observed frame to the original frame, the pixel located at the position (x, y) on the observed frame is moved to the position (X, Y) shown in Eq. (13) of a pixel on a frame obtained as a result of the addition of the observed frame to the original frame.

Eq. (13) can be changed to a reversed-form equation used for finding a pixel position (x, y) on the observed frame from the pixel position (X, Y) on a frame, which is the reference frame or a frame obtained as a result of the frame addition. The process to find every pixel position (x, y) on the observed frame is equivalent to a process to read out the image of the observed frame from a memory in a state of being moved by the parallel shift quantities in a parallel shift and rotated by the rotation angle to be superposed on the reference screen in order to add the observed screen to the reference screen.

As described above, the image of the observed screen is read out from the memory in a state of being moved in a parallel shift by the parallel shift quantities of (α, β) and rotated by the rotation angle γ to be superposed on the reference screen or a post-addition screen in order to add the observed screen to the reference screen or the post-addition screen. The post-addition screen is a screen obtained as a result of a process to superpose observed screens other than the current observed screen to the reference screen in order to cumulatively add the other observed screens to the reference screen.

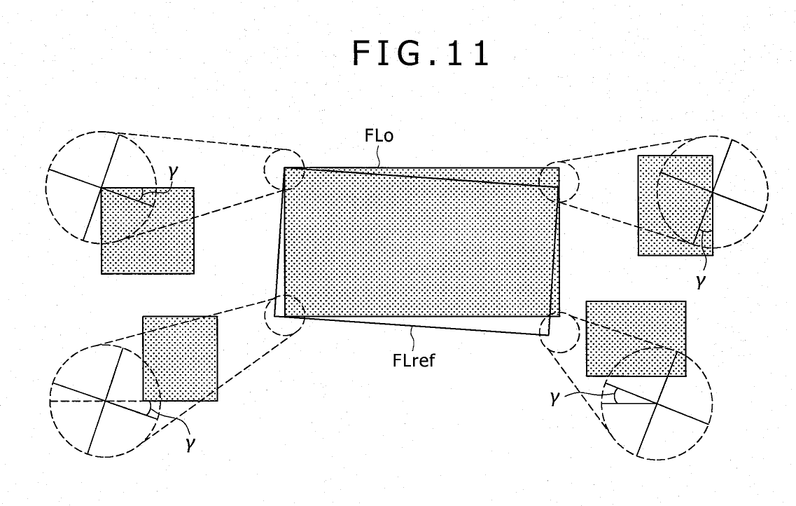

FIG. 11 is a diagram showing an observed image FLref read out from a memory in a state of being rotated by the rotation angle γ to be superposed on the original image FLo serving as a reference image. Since the coefficients of the coordinates x and y of the pixel position (x, y) on the observed image (or observed frame) in the computation formula shown in FIG. 10B are each 1, it is obvious that the rotation in this embodiment is not accompanied by enlargement and contraction. As described earlier, FIG. 10B shows an equation for computing a pixel position (X, Y) on an image obtained as a result of frame addition.

As shown in FIG. 11, the embodiment allows rotation processing to be implemented as a shape change to a parallelogram rather than implementation of rotation of an image. Thus, an access to a memory can be made in order to read out data from the memory inexpensively and efficiently.

[Typical Method to Compute Parallel-Shift Quantities and a Rotation Angle with a Higher Degree of Precision]

In the case of a still image, it is feared that the precision of the parallel-shift quantities and the rotation angle is not sufficient even if the parallel-shift quantities and the rotation angle are found from a global movement vector or a plurality of every-block movement vectors.

Thus, addressing this precision problem, the embodiment is designed by considering computation of parallel-shift quantities and a rotation angle with a higher degree of precision and use of the higher-precision parallel-shift quantities and the higher-precision rotation angle to superpose the image of an observed frame onto the image of a reference frame.

Also as described earlier, in the case of a moving photographing object or the like, even if all every-block movement vectors found for an observed frame are used, a hand-trembling vector also referred to as a global movement vector is difficult to be determined with a sufficiently high degree of efficiency.

In order to solve this problem, in this embodiment, from a plurality of every-block movement vectors found for an observed frame, those considered to be reliable are selected. Then, the every-block movement vectors considered to be reliable are used for computing parallel-shift quantities and a rotation angle. In this way, parallel-shift quantities and a rotation angle can be computed with a higher degree of reliability.

That is to say, in this embodiment, as many unnecessary every-block movement vector components as possible are eliminated from the computation of parallel-shift quantities and a rotation angle. The eliminated unnecessary every-block movement vector components are components which are not movement vectors representing a movement caused by hand trembling as a movement of the entire observed screen. By eliminating such unnecessary every-block movement vector components, parallel-shift quantities and a rotation angle can be computed with a higher degree of reliability.

In this embodiment, high-reliability every-block movement vectors are selected as follows. First of all, a global movement vector is determined for an observed frame. In the case of the embodiment, a global movement vector is determined from a SAD total table. In the following description, a global movement vector determined from a SAD total table is referred to as a total movement vector SUM_V. Then, the total movement vector SUM_V is compared with every-block movement vectors BLK_Vi each determined from a SAD table TBLi found for a target block TGi where i=0, 1, 2, . . . , 15. Finally, every-block movement vectors BLK_Vi each having a vector quantity close or equal to the vector quantity of the total movement vector SUM_V are each identified as a high-reliability every-block movement vector.

If the number of identified high-reliability every-block movement vectors is small, being smaller than a threshold value set in advance, this embodiment determines that the observed frame for which the high-reliability every-block movement vectors have been found is not used as a frame to be superposed on the inference frame. That is to say, in this embodiment, the still-image processing for the observed frame is skipped and the processing is continued to the next observed frame.

If the number of identified high-reliability every-block movement vectors is at least equal to the threshold value, on the other hand, for each individual one of the identified high-reliability every-block movement vectors, a high-reliability every-block movement vector with precision better than a granularity of one pixel is computed from the SAD table set for a target block for which the individual identified high-reliability every-block movement vector has been found. Then, the parallel-shift quantities and the rotation angle, which are mentioned above, are found by making use of the computed high-reliability every-block movement vectors each having precision better than a granularity of one pixel. The high-reliability every-block movement vector with precision better than a granularity of one pixel will be described later.

In the process to compute the parallel-shift quantities, the first or second typical method described earlier can be adopted.

In the case of the second typical method described earlier, for example, high-reliability detection domains each having a detection-domain number of i are selected from the 16 detection domains shown in FIG. 5 and parallel-shift quantities are found by making use of high-reliability every-block movement vectors each found for one of the selected high-reliability detection domains. This embodiment excludes the every-block movement vector found for any detection domain with a detection-domain number of q from the process to compute the parallel-shift quantities because the every-block movement vector found for the detection domain with a detection-domain number of q is regarded as a low-reliability every-block movement vector. This embodiment also excludes the every-block movement vector found for a detection domain with a detection-domain number of (15-q). The detection domain with a detection-domain number of (15-q) is a detection domain located at a position seen from the position of the detection domain with a detection-domain number of q as a position symmetrical with respect to the center Oc of all the detection domains.

This is because this embodiment takes the rotation of the observed frame into consideration. Thus, if the every-block movement vector found for a specific detection domain is excluded from the process to compute the parallel-shift quantities because the vector is regarded as a low-reliability, an error will be undesirably generated in the resulting parallel-shift quantities without excluding the every-block movement vector located at a position symmetrical with respect to the center Oc.

On the other hand, the embodiment excludes the every-block movement vector found for any specific detection domain from the process to compute the rotation angle because the vector found for the specific detection domain is regarded as a low-reliability every, but not the vector found for a detection domain located at a position symmetrical with respect to the center Oc.

As described above, by making use of high-reliability detection domains in the process to compute parallel-shift quantities and a rotation angle, it is expected that high-precision parallel-shift quantities and a high-precision rotation angle can be found.

The following description explains how to carry out the aforementioned process to produce a result of determination as to whether or not an observed frame is reliable or whether or not the every-block movement vector inside the observed frame are reliable.

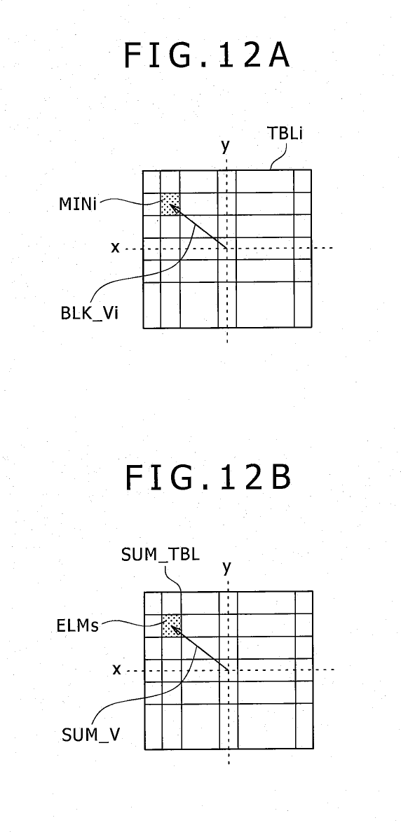

First of all, a SAD table TBLi is computed for every target block TGi. In this embodiment, there are 16 target blocks TGi where i=0, 1, 2, . . . , 15. Then, for each individual one of the SAD tables TBLi, an every-block movement vector BLK_Vi is detected as a vector pointing to the coordinate position of the minimum SAD value MINi of the individual SAD table TBLi as shown in FIG. 12A. Subsequently, a SAD total table SUM_TBL is computed from the 16 SAD tables TBLi in accordance with Eq. (3). Then, a total movement vector SUM_V is detected as a vector pointing to the coordinate position of the minimum SAD total value MINs of the SAD total table SUM_TBL as shown in FIG. 12B.

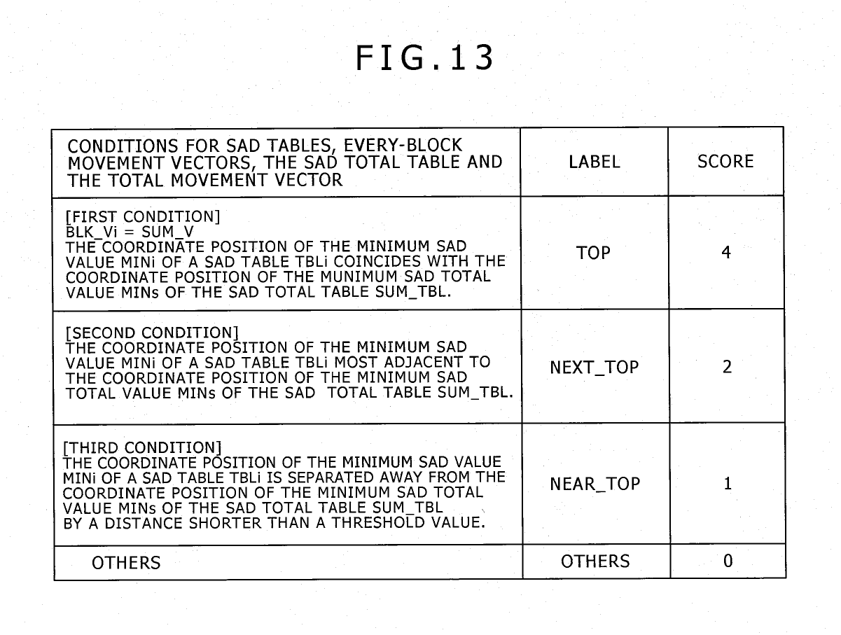

Subsequently, in this embodiment, the total movement vector SUM_V or the coordinate position of the minimum SAD total value MINs of the SAD total table SUM_TBL, the minimum SAD total value MINs, the 16 every-block movement vectors BLK_Vi each associated with a target block or the coordinate position of the minimum SAD value MINi of each SAD table TBLi, and each minimum SAD value MINi are examined. The determination is produced as to whether or not the total movement vector SUM_V, the every-block movement vector BLK_Vi, and the minimum SAD value MINi satisfy conditions shown on the leftmost column of FIG. 13. A score (or an evaluation point) is given to every-block movement vectors BLK_Vi in accordance with the results of the determination as shown on the rightmost column of FIG. 13.

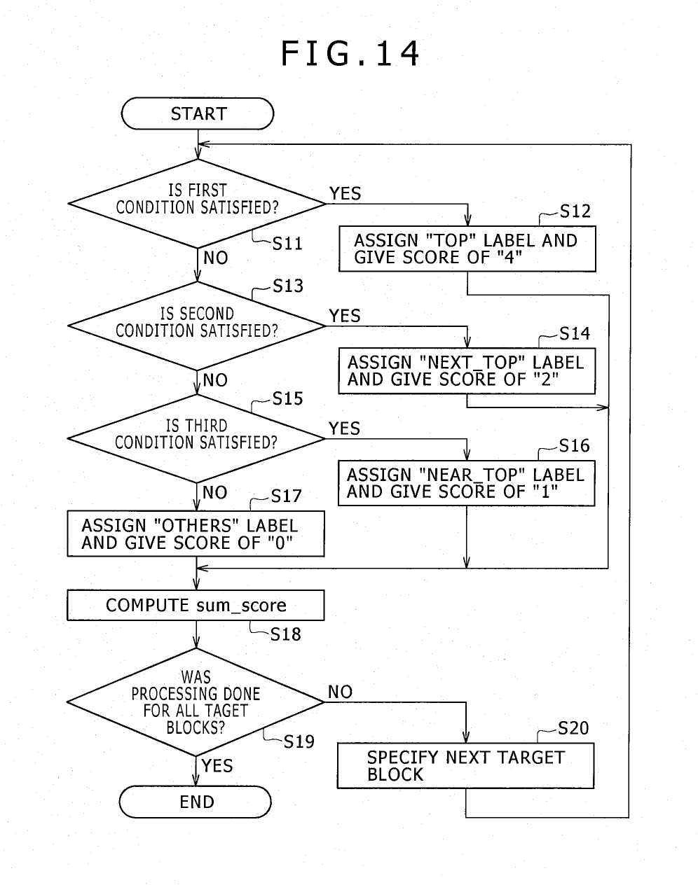

FIG. 14 shows a flowchart referred to in explanation of typical processing to assign a label and give a score to each every-block movement vector. The processing represented by the flowchart shown in FIG. 14 is processing carried out on one observed frame. Thus, the processing represented by the flowchart shown in FIG. 14 is carried out repeatedly for a plurality of observed frames.

As shown in the figure, the flowchart begins with a step S11 to produce a result of determination as to whether or not a first condition is satisfied. The first condition is a condition stating that an every-block movement vector BLK_Vi found for a target block being subjected to the processing to assign a label and give a score to a target block associated with the every-block movement vector BLK_Vi shall be equal to the total movement vector SUM_V. To put it in detail, the first condition is equivalent to a condition stating that the coordinate position of the minimum SAD value MINi in a SAD table TBLi associated with the every-block movement vector BLK_Vi shall coincide with the coordinate position of the minimum SAD total value MINs associated with the total movement vector SUM_V in the SAD total table SUM_TBL projected on the SAD table TBLi.

If the result of the determination indicates that the first condition is satisfied for the target block being processed, the flow of the processing goes on to a step S12 at which a TOP label is assigned to the target block. In addition, in the case of this embodiment, the highest score of four is given to the target block.

If the result of the determination indicates that the first condition is not satisfied for the target block being processed, on the other hand, the flow of the processing goes on to a step S13 to produce a result of determination as to whether or not a second condition is satisfied. Knowing that the every-block movement vector BLK_Vi is known to be unequal to the total movement vector SUM_V, the second condition states that the every-block movement vector BLK_Vi in the SAD table TBLi shall be most adjacent to the total movement vector SUM_V in the SAD total table SUM_TBL projected on the SAD table TBLi. To put it concretely, the coordinate position of the minimum SAD value MINi in a SAD table TBLi associated with the every-block movement vector BLK_Vi shall be separated away in the vertical, horizontal, or inclined direction by a distance equal to one coordinate unit from the coordinate position of the minimum SAD total value MINs associated with the total movement vector SUM_V in the SAD total table SUM_TBL projected on the SAD table TBLi.

If the result of the determination indicates that the second condition is satisfied for the target block being processed, the flow of the processing goes on to a step S14 at which a NEXT_TOP label is assigned to the target block. In addition, in the case of this embodiment, a mediocre score of two is given to the target block.

If the result of the determination indicates that the second condition is not satisfied for the target block being processed, on the other hand, the flow of the processing goes on to a step S15 to produce a result of determination as to whether or not a third condition is satisfied. The third condition states that the coordinate position of the minimum SAD value MINi in a SAD table TBLi associated with the every-block movement vector BLK_Vi shall be separated away from the coordinate position of the minimum SAD total value MINs associated with the total movement vector SUM_V by a distance shorter than a predetermined threshold value, which is desirably a value expressed in terms of pixels. This is because, in the case of the embodiment, it is assumed that an image is compensated for an effect caused by hand trembling at precision equivalent to a granularity of one pixel.

If the result of the determination indicates that the third condition is satisfied for the target block being processed, the flow of the processing goes on to a step S16 at which a NEAR_TOP label is assigned to the target block. In addition, in the case of this embodiment, a low score of one is given to the target block.

If the result of the determination indicates that the third condition is not satisfied for the target block being processed, on the other hand, the flow of the processing goes on to a step S17 at which an OTHERS label is assigned to the target block. In addition, in the case of this embodiment, the lowest score of zero is given to the target block.

After a label is assigned and a score is given in a process carried out at the step S12, S14, S16, or S17, the flow of the processing goes on to a step S18 at which sum_score representing the sum of the given scores is found.

Then, the flow of the processing goes on to a step S19 to produce a result of determination as to whether or not the processing has been done for all the 16 target blocks set in the target frame. If the result of the determination indicates that the processing has not been done for all the 16 target blocks set in the target frame, the flow of the processing goes on to a step S20 at which a target block to be processed next is specified. Then, the flow of the processing goes back to the step S11.

If the result of the determination indicates that the processing has been done for all the 16 target blocks in the target frame, on the other hand, the processing to assign a label and give a score to each target block is ended. Thus, the score sum sum_score computed in the process carried out at the step S18 is a sum of scores given to all the 16 target blocks for an observed frame.

As described above, the flowchart shown in FIG. 14 represents typical processing. It is possible to change the order to produce results of determination as to whether or not the first, second, and third conditions are satisfied. That is to say, it is possible to carry out first any of the processes to produce a result of determination as to whether or not any of the first, second, and third conditions respectively is satisfied.

After the processing to assign a label and give a score to each of the 16 target blocks is ended, the score sum sum_score computed in the process carried out at the step S18 is compared with a threshold value set in advance for evaluating reliability of the observed frame for which the processing has been carried out. If the result of the comparison indicates that the score sum sum_score is smaller than the threshold value, the every-block movement vectors found for the observed frame are determined to be movement vectors having low reliability for determination of a global movement vector.

Instead of comparing the score sum sum_score with the threshold value, it is also possible to count the number of target blocks (or every-block movement vectors) to which the TOP and NEXT_TOP labels each representing high reliability have been assigned to respectively indicate that the first and second conditions are satisfied. Then, the counted number of target blocks is compared with another threshold value. If the result of the comparison indicates that the counted number of target blocks is smaller than the other threshold value, the every-block movement vectors found for the observed frame are determined to be movement vectors having low reliability for determination of a global movement vector.

If the score sum sum_score is at least equal to the threshold value or indicates that the counted number of target blocks to which the TOP and NEXT_TOP labels have been assigned is at least equal to the other threshold value, on the other hand, the every-block movement vectors found for the observed frame are determined to be used for determination of a global movement vector with a sufficiently high degree of reliability.

Thus, if the score sum sum_score is at least equal to the threshold value or indicates that the counted number of target blocks to which the TOP and NEXT_TOP labels have been assigned to respectively is at least equal to the other threshold value, a new SAD total table is created on the basis of SAD values of SAD tables associated with target blocks (or every-block movement vectors). The TOP and NEXT_TOP labels each representing high reliability have been assigned to the vectors to respectively indicate that the first and second conditions are satisfied. Then, on the basis of the newly created SAD total table, a total movement vector to serve as a global movement vector is recomputed. Finally, the parallel-shift quantities and rotation angle of the observed frame are found from the total movement vector.

In this case, the global movement vector does not have to be the total movement vector found from the SAD total table. For example, a global movement vector can also be selected from high-reliability every-block movement vectors on a majority-determination basis.

In addition, instead of finding the parallel-shift quantities and rotation angle of the observed frame from the global movement vector as described above, the parallel-shift quantities (α, β) and rotation angle γ of the observed frame can also be computed by making use of every-block movement vectors, to which the TOP and NEXT_TOP labels each representing high reliability have been assigned, on the basis of Eqs. (4) to (10) explained earlier by referring to FIGS. 6 to 8E.

As described above, the embodiment adopts a method to compute the parallel-shift quantities (α, β) and rotation angle γ of the observed frame by making use of every-block movement vectors, to which the TOP and NEXT_TOP labels each representing high reliability have been assigned.

In order to provide even higher reliability, however, the embodiment further carries out the following processing.

In this embodiment, while the block matching processing is being carried out at a plurality of stages, the area of a search range set for each target block is gradually made smaller from stage to stage. In the following description, the block matching processing carried out on the entire observed frame at a specific stage is referred to as a detection process of the specific stage. As an example, the block matching processing (or the detection process) is carried out at two stages as first and second detection processes.

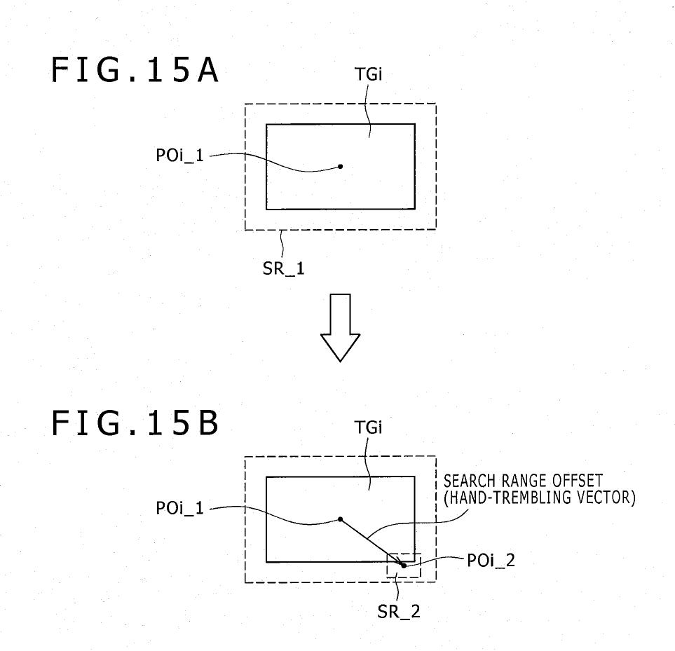

As shown in FIG. 15A, a first-detection search area SR_1 set in a first detection process for every target block TGi is made as large as possible and, for each first-detection search area SR_1, an every-block movement vector BLK_Vi is found. Then, when a plurality of every-block movement vectors BLK_Vi have been found at the end of the first detection process, the every-block movement vectors BLK_Vi are evaluated and every-block movement vectors BLK_Vi each receiving a high evaluation point are searched for. Subsequently, parallel-shift quantities (α, β) for the first detection process are found by making use of every-block movement vectors BLK_Vi each receiving a high evaluation point in accordance with Eqs. (4) and (5). Then, a second-detection search area SR_2 is determined as a search area to be used in a second detection process for every target block TGi from the parallel-shift quantities (α, β) found in the first detection process as shown in FIG. 15B.

As an alternative, a global movement vector to serve as a hand-trembling vector is found from every-block movement vectors BLK_Vi each receiving a high evaluation point, and parallel-shift quantities (α, β) for the first detection process are found from the global movement vector. Then, a second-detection search area SR_2 is determined as a search area to be used in a second detection process for every target block TGi from the parallel-shift quantities (α, β) found in the first detection process as shown in FIG. 15B.

As seen from the above description, for each first-detection search area SR_1 set in the first detection process for a target block TGi as shown in FIG. 15A, an every-block movement vector BLK_Vi is computed. Then, parallel-shift quantities (α, β) are found from a plurality of every-block movement vectors BLK_Vi. As an alternative, parallel-shift quantities (α, β) are found from a global movement vector, which is computed from a plurality of every-block movement vectors BLK_Vi. Thus, a block range having a correlation between the observed frame and the original frame can be roughly detected from the computed parallel-shift quantities (α, β).

As shown in FIG. 15B, a second-detection search area SR_2 set in the second detection process is an area having a size smaller than the first-detection search area SR_1 set in the first detection process and having its center coinciding with the aforementioned block range having a correlation between the observed frame and the original frame. In this case, as shown in FIG. 15B, the center position POi_1 of the first-detection search area SR_1 set for the first detection process and the center position POi_2 of the second-detection search area SR_2 set for the second detection process are separated away from each other by a search-range offset. The offset corresponds to the parallel-shift quantities (α, β) found in the first detection process or an offset represented by the global movement vector.

In this way, by carrying out a second detection process based on a more focused second-detection search range SR_2 set for every target block, a higher-precision block matching result can be obtained from the second detection process.

Then, in this embodiment, parallel-shift quantities and rotation angle of the observed frame are found from a plurality of high-reliability every-block movement vectors BLK_Vi selected from every-block movement vectors BLK_Vi computed in the second detection process as described above. As a result, it is possible to obtain high-precision parallel-shift quantities and a high-precision rotation angle.

The SAD total table used in this embodiment is not a SAD table created for every target block. Instead, the SAD total table is a table created for the entire target frame (and the entire observed frame) as a table all but equivalent to a result of a block matching process carried out on the entire target frame. In the case of an ordinary photographing object, a movement vector selected on a majority-determination basis as explained earlier in the description of the technology in related art is the same as a total movement vector found from the SAD total table. In processing to superpose a plurality of frames on each other, however, a result obtained on a majority-determination basis is a vector having low reliability or a vector close to a random vector particularly in the case of a blinking whole frame caused by flashes spread by another person or in the case of a water-surface wavefront serving as a photographing object. On the other hand, it is quite within the bounds of possibility that a total movement vector found from a SAD total table leads to a result comparatively close to a correct solution.

Thus, by comparing a result of a total movement vector found from a SAD total table with a result of a global movement vector identified on a majority-determination basis, it is possible to quantitatively evaluate the reliability of at least a result obtained for the current observed frame. The central aim of the proposals made in the past is determination as to whether or not each every-block movement vector is reliable. However, a policy is set to place emphasis on the reliability of the entire observed frame and, hence, exclude a doubtful observed frame from the frame superposition process so as to implement a stable system for compensating an image for effects caused by hand trembling yet introducing a small sense of incompatibility.

Taking the above characteristic into consideration, a method according to the embodiment is adopted as a method whereby, much like the matching method in related art, a global movement vector is selected from 16 every-block movement vectors BLK_Vi each computed for a target block on the basis of a majority-determination basis as a movement vector pertaining to a majority top, which is a largest group of every-block movement vectors having equal or close magnitudes and equal or close directions.

Then, the selected movement vector pertaining to the majority top is taken as an observation vector serving as a substitute for the total movement vector SUM_V in the descriptions of the conditions shown in FIG. 13. Subsequently, labels and scores are given to 16 every-block movement vectors BLK_Vi each detected for a target block on the basis of minimum SAD values associated with the observation vector and the every-block movement vectors BLK_Vi in accordance with the conditions shown in FIG. 13.

Thus, the above operation to give labels and scores to target blocks or every-block movement vectors is equivalent to a process to take the selected movement vector pertaining to the majority top as an observation vector serving as a substitute for the total movement vector SUM_V in the descriptions of the conditions shown in FIG. 13.

That is to say, in this case, the first condition is implemented as a condition stating that an every-block movement vector BLK_Vi found for a target block being subjected to the processing to assign a label and give a score to a target block associated with the every-block movement vector BLK_Vi shall be equal to the selected movement vector pertaining to the majority top. To put it in detail, the first condition is implemented as a condition equivalent to a condition stating that the coordinate position of the minimum SAD value MINi in a SAD table TBLi associated with the every-block movement vector BLK_Vi shall coincide with the coordinate position of the minimum SAD value associated with the selected movement vector pertaining to the majority top.

In addition, knowing that the every-block movement vector BLK_Vi in the SAD table TBLi is not equal to the selected movement vector pertaining to the majority top, the second condition is implemented as a condition stating that the every-block movement vector BLK_Vi in the SAD table TBLi shall be most adjacent to the selected movement vector pertaining to the majority top. To put it concretely, the second condition is implemented as a condition that the coordinate position of the minimum SAD value MINi in a SAD table TBLi associated with the every-block movement vector BLK_Vi shall be separated away from the coordinate position of the minimum SAD value associated with the selected movement vector pertaining to the majority top in the vertical, horizontal, or inclined direction by a distance equal to one coordinate unit.

On the top of that, the coordinate position of the minimum SAD value MINi in a SAD table TBLi associated with the every-block movement vector BLK_Vi is separated away from the coordinate position of the minimum SAD value associated with the selected movement vector pertaining to the majority top in the vertical, horizontal, or inclined direction by a distance longer than one coordinate unit. The third condition is implemented as a condition stating that the coordinate position of the minimum SAD value MINi in a SAD table TBLi associated with the every-block movement vector BLK_Vi shall be separated away from the coordinate position of the minimum SAD value associated with the selected movement vector pertaining to the majority top by a distance shorter than a threshold value determined in advance.

As described above, a movement vector pertaining to the majority top is selected from 16 every-block movement vectors each found for a target block as a vector in an observed frame and taken as a reference in a process to give a label and a score to each target block (or each of the every-block movement vectors). Then, a score total many_score based on such a reference is found as a sum of scores given to all target blocks (or all the every-block movement vectors) on the basis of the movement vector pertaining to the majority top.

In this embodiment, if the coordinate position of the minimum SAD total value MINs associated with the total movement vector SUM_V is separated away from the coordinate position of the minimum SAD value MINi associated with the selected movement vector pertaining to the majority top by a distance not exceeding a distance equivalent to the most adjacency, the vector found for the observed frame is regarded as a high-reliability movement vector. For example, the score sum sum_score is at least equal to a threshold value determined in advance and the score total many_score is not smaller than another threshold value determined in advance.

Conversely, the high-reliability hand-trembling vector is difficult to be detected, and the observed frame is determined to be excluded from the process to superpose a plurality of frames on each other in the case as follows. The coordinate position of the minimum SAD total value MINs associated with the total movement vector SUM_V is separated away from the coordinate position of the SAD value MINi associated with the movement vector pertaining to the majority top by a distance exceeding a predetermined distance such as a distance equivalent to the most adjacency.

In addition, also if the score sum sum_score is smaller than the threshold value or the score total many_score is smaller than the other threshold value, the observed frame is determined to be a frame, from which a high-reliability hand-trembling vector is difficult to be detected and, hence, excluded from the process to superpose a plurality of frames on each other.

Then, in this embodiment, if a movement vector found for the observed frame can be regarded as a high-reliability movement vector as described above, a recreated SAD total table RSUM_TBL is generated on the basis of SAD values of SAD tables each associated with a target block, to which the TOP or NEXT_TOP label has been assigned by taking the total movement vector as a reference.

Subsequently, a total movement vector to serve as a global movement vector can be computed by application of an interpolation technique based on a curved surface approximating the minimum SAD value of the recreated SAD total table RSUM_TBL and neighbor SAD values each stored in a table element located in the vicinity of the table element for storing the minimum SAD value. Then, the computed total movement vector is used in determination of a search range for a second detection process or computation of parallel-shift quantities and a rotation angle.

As an alternative, by making use of every-block movement vectors each computed for a target block, to which the TOP or NEXT_TOP label has been assigned, parallel-shift quantities are found in accordance with Eqs. (4) and (5), and a search range to be used in a second detection process is determined. As another alternative, processing based on Eqs. (4) to (10) is carried out in order to compute parallel-shift quantities and a rotation angle.

It is to be noted that, a technique in related art for predicting a global movement vector from the frequency of changes occurring along the time axis as changes in movement vector can also be adopted in conjunction with the technique according to the embodiment in order to further improve the reliability and the precision.

As described above, in accordance with the method according to this embodiment, a SAD table is generated for each of a plurality of target blocks in the target frame and an every-block movement vector is computed for each of the SAD tables. In this case, if the method is applied to an image-pickup apparatus employing the contemporary image-pickup device having at least 5 million pixels, the size of a memory for storing the SAD tables increases in proportion to the number of pixels in one screen. Thus, the method according to this embodiment has a problem that the method is difficult to be implemented by making use of a circuit having a practical size.

As described earlier, a realistic proposal that can be realized at a level of implementation is revealed in Japanese Patent Laid-open No. 2005-38396. In accordance with the proposal revealed in Japanese Patent Laid-open No. 2005-38396, an apparatus employs a unit configured to find a movement vector with the image contracted to a smaller size and a unit configured to share a SAD table among a plurality of target blocks instead of providing a SAD table element for each target block. The conversion of an original image into an image having a reduced size and the sharing of a SAD table element by a plurality of target blocks are a very good technique to reduce the size of the SAD table. This technique to reduce the size of the SAD table is adopted in other fields such as detection based on the MPEG (Moving Picture Experts Group) image compression as detection of a movement vector and detection of a scene change.

However, the algorithm disclosed in Japanese Patent Laid-open No. 2005-38396 has problems that that it takes long time to carry out a conversion process to contract an original image into an image having a reduced size and make an access to a DRAM (Dynamic RAM (Random Access Memory)) used as a memory necessary for the image conversion and that the memory is necessary for having a large size. In addition, since the algorithm is adopted in a technique to make accesses to the SAD table stored in the memory on a time-sharing basis among a plurality of target blocks, the algorithm raises another problem that the number of accesses made to the memory increases substantially so that it also undesirably takes time to carry out a process to make an access to the SAD table. In compensating a moving picture for an effect caused by hand trembling, both a real-time result and reduction of a system delay time are necessary. Thus, the long time it takes to carry out the process in accordance with the technique revealed in patent document 3 is a problem that undesirably remains to be solved.

A result of evaluation given by a number of users each taking pictures at a typical rate of 3 fps (frames per second) in a photographing operation obviously indicates that, on the assumption that the entire area of a frame is 100, the size of the hand-trembling search area is about ±10%. In the case of a high-performance image-pickup apparatus, the number of pixels composing the image is already assumed to be 12 million and, with the presently proposed technology adopted as it is, the size of the necessary SAD table is estimated to be about 80 megabits. In addition, if an attempt is made to satisfy a realistic processing speed, an SRAM (Static RAM (Random Access Memory)) is necessary as a memory used for storing the SAD table. In spite of the fact that the semiconductor process rule is said to be making progress, this size of about 80 megabits is far away from a realistic level, being greater than a realistic value by about three digits.

Prior to the conversion process to contract an original image into an image having a reduced size, pre-processing needs to be carried out by making use of a low-pass filter for getting rid of aliasing and low-illumination noises. In accordance with the magnitude of a contraction factor, however, the characteristics of the low-pass filter vary and, on the top of that, a number of line memories and much processing logic are necessary particularly in the case of a vertical-direction low-pass filter implemented as a multi-tap digital filter. Thus, this technique raises another problem of an increased scale of the circuit.

Addressing the problems described above, in an embodiment, an image-processing method allowing the size of a SAD table used in a process to identify a movement vector between two frames by adoption of the block-matching technique to be substantially reduced, and an image-processing apparatus adopting the image-processing method are provided.

In addition, the technique revealed in Japanese Patent Laid-open No. 2005-38396 as a technique to reduce the size of the SAD table by contracting the image raises two problems. One of the problems is that that it takes long time to carry out a conversion process to contract an original image into an image having a reduced size and that the memory is necessary for having a large size. The other problem is that the size of the circuit increases due to implementation of a proper low-pass filter for getting rid of aliasing accompanying the conversion process to contract an original image into an image having a reduced size. However, the embodiment is capable of solving these problems as follows.

In this embodiment, instead of storing a SAD value representing differences in luminance value between pixels in a target block and corresponding pixels in an observed block pertaining to a search range associated with the target block in a SAD table element pointed to by an observation vector associated with the observed block, the observation vector is contracted. The SAD table in related art is shrunk into a shrunk SAD table having table elements fewer than those of the SAD table in related art, and a plurality of neighbor observation vectors each pointing to a SAD table element in the vicinity of a position pointed to by the contracted observation vector are determined. Subsequently, the SAD value is split into as many component SAD values as the neighbor observation vectors. Then, each individual one of the component SAD values is stored in a SAD table element pointed to by a neighbor observation vector corresponding to the individual component SAD value by cumulatively adding the individual component SAD value to a component SAD value already stored in the SAD table element.

Thus, the shrunk SAD table has a much smaller size in comparison with the SAD table in related art. In addition, the embodiment is capable of solving the two problems. As described above, one of the problems is that that it takes long time to carry out a conversion process to contract an original image into an image having a reduced size and that the memory is necessary for having a large size. The other problem is that the size of the circuit increases due to implementation of a proper low-pass filter for getting rid of aliasing accompanying the conversion process to contract an original image into an image having a reduced size.

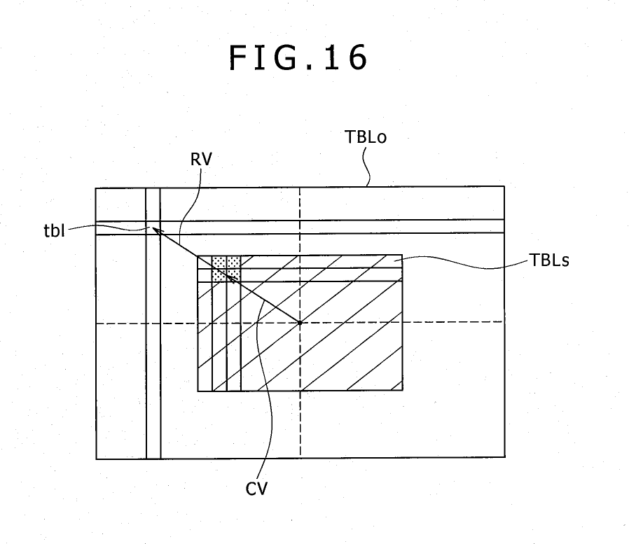

FIGS. 16 to 18 are each a diagram referred to in explanation of an outline of the new block matching method adopted in the embodiment. To be more specific, FIG. 16 is a diagram showing a relation between the SAD table TBLo in related art and a shrunk SAD table TBLs generated in accordance with an image processing method adopted by the embodiment.

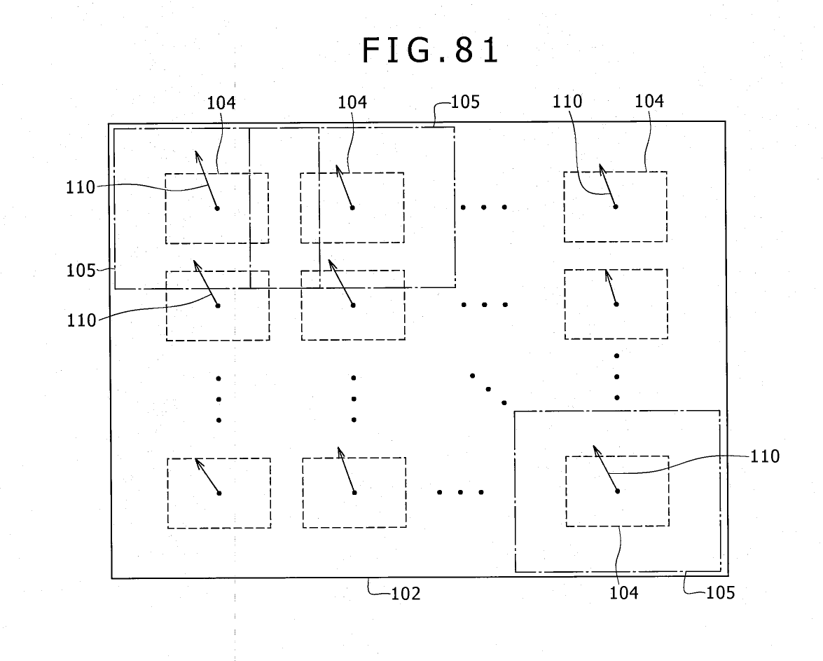

Also in the case of this embodiment, much like the method in related art explained earlier by referring to FIG. 81, a plurality of search ranges are each set on the observed frame with the center of the search range coinciding with a position corresponding to the center of a target block set on the original frame. In this embodiment, 16 search ranges are each set for one of 16 target blocks. Then, in each of the search ranges, a plurality of observed blocks described before are set, and a SAD value representing differences in luminance value between pixels in each of the observed blocks set in any individual one of the search ranges and corresponding pixels in a target block associated with the individual search range is computed as follows. First of all, the absolute value of a difference in luminance value between every individual pixel in the target block and a pixel included in the observed block as a pixel corresponding to the individual pixel is computed. Then, the sum of the absolute values computed for all pixels in the target block and the observed block is found as the SAD value mentioned above.

In the image processing apparatus in related art, a computed SAD value is stored in a SAD table TBLo as a table element tbl located at an address corresponding to an observation vector RV pointing to an observed block being processed as shown in FIG. 16.

Thus, in the case of the block-matching technique, an observation vector RV representing the magnitude of a shift from a target block to an observed block over an observed frame is associated with a SAD value stored as a table element for the observed block in the SAD table TBLo on a one-with-one basis. That is to say, the number of table elements composing the SAD table TBLo in related art is equal to the number of observed blocks (or observation vectors RV) that can be set in the search range.

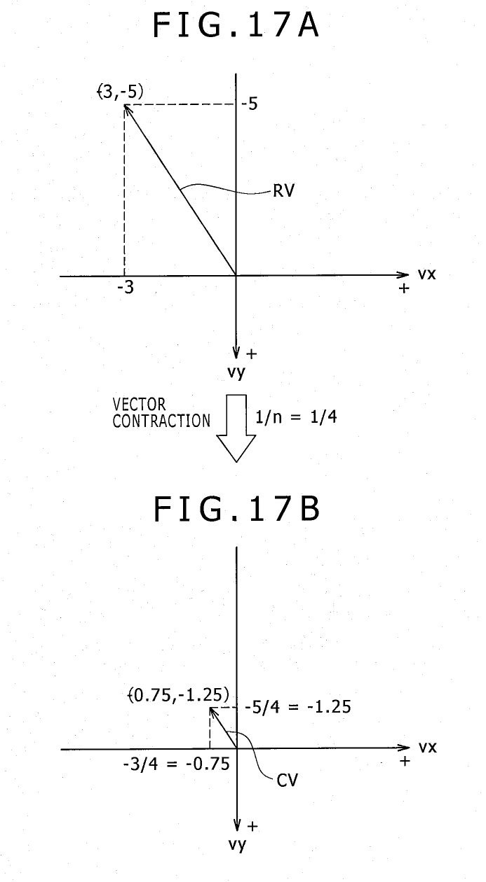

In the case of the block-matching technique according to this embodiment, on the other hand, as shown in FIGS. 16, 17A, and 17B, each observation vector RV pointing to an observed block being processed is contracted at a contraction factor of 1/n, where notation n denotes an integer, into a contracted observation vector CV.

In the following description, in order to make the explanation easy to understand, the horizontal-direction contraction factor is assumed to be equal to the vertical-direction contraction factor. However, the horizontal-direction contraction factor and the vertical-direction contraction factor can also be set independently of each other at values different from each other. In addition, as will be described later, the horizontal-direction contraction factor and the vertical-direction contraction factor are set independently of each other at any arbitrary fractions (such as 1/m and 1/n, where notations m and n each denote an integer) in order to provide a higher degree of flexibility as well as a higher degree of convenience.

Also in the case of this embodiment, much like the image-processing method in related art, the position of the target block is taken as a reference position (0, 0) at the center of the search range. The horizontal-direction and vertical-direction components (vx, vy) of an observation vector RV are each an integer representing horizontal-direction and vertical-direction magnitudes measured from the reference position (0, 0). In the following description, an observation vector RV having horizontal-direction and vertical-direction components (vx, vy) is referred to as an observation vector RV (vx, vy).

An observation vector RV (vx, vy) is contracted at a contraction factor of 1/n into a contracted observation vector CV (vx/n, vy/n). Thus, even though the horizontal-direction and vertical-direction components (vx, vy) of the pre-contraction original observation vector RV CV (vx, vy) are each an integer, the horizontal-direction and vertical-direction components (vx/n, vy/n) of the contracted observation vector CV (vx/n, vy/n) are not necessarily integers. That is to say, they may each be a value including a fraction part in some cases. Thus, if a SAD value computed for a pre-contraction original observation vector RV is merely stored as an element included in the shrunk SAD table as an element associated with a contracted observation vector having integer vx/n and vy/n values closest to the non-integer vx/n and vy/n values of the contracted observation vector CV in this embodiment, an error will be undesirably generated. In addition, while the number of elements in the shrunk SAD table is smaller than the number of elements in the pre-contraction original SAD table, the number of contracted observation vectors CVs is equal to the number of pre-contraction original observation vector RVs RVs. Thus, contracted observation vectors CVs are not associated with elements in the shrunk SAD table on a one-with-one basis.

A neighbor observation vector NV (vx/n, vy/n) is defined as a contracted observation vector having an integer vx/n value closest to the non-integer vx/n value of the contracted observation vector RV (vx/n, vy/n) and/or an integer vy/n value closest to the non-integer vy/n value of the contracted observation vector RV (vx/n, vy/n). A plurality of neighbor observation vectors NVs exist in the neighborhood of every contracted observation vector RV. Since contracted observation vectors CVs are not associated with elements in the shrunk SAD table on a one-with-one basis as described above, in this embodiment, a SAD value computed for the pre-contraction original observation vector RV of a contracted observation vector CV is not stored in an element of the shrunk SAD table as it is. Instead, the SAD value computed for the pre-contraction original observation vector RV of a contracted observation vector CV is split by adoption of a linear weighted distribution technique into as many component SAD values as neighbor observation vectors NVs located in the neighborhood of the contracted observation vector CV.

A contracted observation vector CV (vx/n, vy/n) having non-integer vx/n and vy/n values is not associated with a table element tbl of the shrunk SAD table. However, neighbor observation vectors NV (vx/n, vy/n) each having integer vx/n and vy/n values are associated with table elements tbl of the shrunk SAD table on a one-with-one basis. Thus, in this embodiment, a SAD value computed by the linear weighted distribution technique is stored in the table element tbl in a cumulative addition process in the same way as the process to store a SAD value computed for a pre-contraction original observation vector RV in an element included in the SAD table as an element associated with the corresponding observation vector RV. The linear weighted distribution technique is a method based on the distances between a position pointed to by a contracted observation vector CV and positions pointed to by neighbor observation vectors NV located in the neighborhood of the contracted observation vector CV.

To be more specific, weights used to find component SAD values for neighbor observation vectors NV by the linear weighted distribution technique are determined on the basis of the distances between a position pointed to by a contracted observation vector CV and positions pointed to by neighbor observation vectors NV located in the neighborhood of the contracted observation vector CV as described above. Then, a final component SAD value for each of the neighbor observation vectors NV is found by cumulatively adding a currently calculated value to a temporary sum stored previously.

It is to be noted that, if the values (vx/n, vy/n) of a contracted observation vector CV (vx/n, vy/n) are each an integer, the contracted observation vector CV (vx/n, vy/n) itself is associated with an element of the shrunk SAD table on a one-with-one basis. Thus, in the table element associated with the contracted observation vector CV (vx/n, vy/n), the SAD value corresponding to the observation vector RV (vx, vy) itself can be stored. In addition, in the case of such a contracted observation vector CV (vx/n, vy/n), it is not necessary to determine a plurality of neighbor observation vectors NVs for the contracted observation vector CV (vx/n, vy/n).

Next, the processing described above is explained through the example below. As described before, the target block is placed at the reference position (0, 0). In this case, let us assume that an observation vector RV (−3, −5) shown in FIG. 17A is contracted in both the horizontal and vertical directions at a contraction factor of 1/n (=¼) to result in a contracted observation vector CV (−0.75, −1.25) shown in FIG. 17B.

As described above, the values of the resulting contracted observation vector CV each include a fraction par. It is necessary to determine a plurality of neighbor observation vectors NVs each pointing to a table element tbl in the shrunk SAD table for the contracted observation vector CV because the resulting contracted observation vector CV does not point to a table element tbl in the shrunk SAD table.

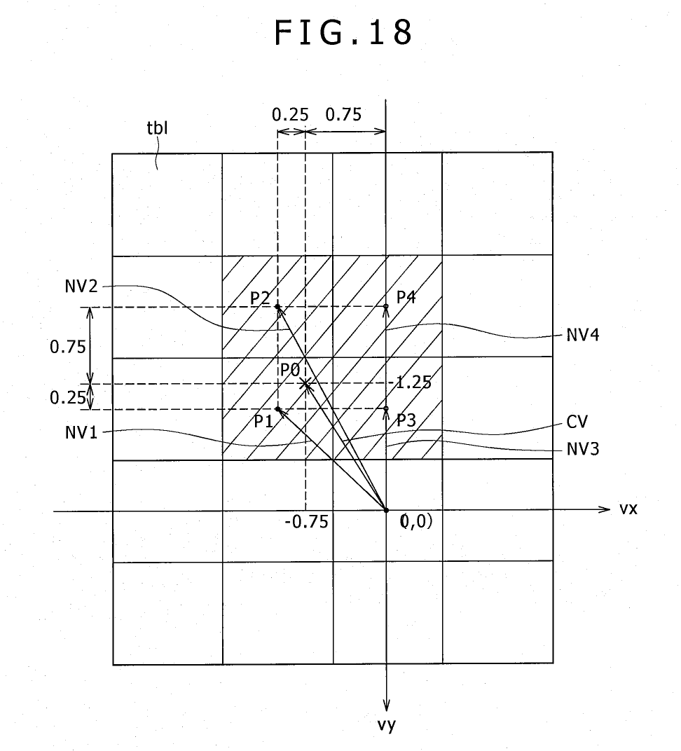

In an example shown in FIG. 18, four neighbor observation vectors NV1 (−1, −1), NV2 (−1, −2), NV3 (0, −1), and NV4 (0, −2) are determined for the contracted observation vector CV (−0.75, −1.25). As is obvious from the example shown in FIG. 18, a plurality of such neighbor observation vectors are selected that the values of each of the neighbor observation vectors are integers closest to the values of the contracted observation vector.

In the example shown in FIG. 18, the four neighbor observation vectors NV1, NV2, NV3, and NV4 are vectors pointing from the reference position (0, 0) to positions P1, P2, P3, and P4 respectively, which are each shown as a circle. On the other hand, the contracted observation vector CV is a vector pointing from the reference position (0, 0) to a point P0 shown as notation X.

Then, in the case of this embodiment, a component SAD value for each of the four neighbor observation vectors NV1, NV2, NV3, and NV4 of a contracted observation vector is computed by adoption of the linear weighted distribution technique applied to a SAD value found for an observed block associated with a pre-contraction original observation vector RV serving as the origin of the contracted observation vector as described above, and a final component SAD value for each neighbor observation vectors NV is found by cumulatively adding a currently calculated value to a temporary sum stored previously.

Next, weights to be used in a process to find the component SAD values for the neighbor observation vectors NV1, NV2, NV3, and NV4 shown in the example of FIG. 18 are determined as follows. As described above, the contracted observation vector CV points to the point P0 (−0.75, −1.25) whereas the neighbor observation vectors NV1, NV2, NV3, and NV4 point to the positions P1 (−1, −1), P2 (−1, −2), P3 (0, −1), and P4 (0, −2) respectively. Thus, (the distance between the positions P0 and P1): (the distance between the positions P0 and P2): (the distance between the positions P0 and P3): (the distance between the positions P0 and P4)=1:3:3:9. Since weights are inversely proportional to distances, typical weights of 9/16, 3/16, 3/16, and 1/16 are assigned to the four neighbor observation vectors NV1, NV2, NV3, and NV4 respectively.

Let us assume that the SAD value computed for the pre-contraction original observation vector RV serving as the origin of the contracted observation vector CV is Sα. In this case, component SAD values SADp1, SADp2, SADp3, SADp4 for the neighbor observation vectors NV1, NV2, NV3, and NV4 pointing to the positions P1, P2, P3, and P4 respectively are found as follows:
SADp1=Sα× 9/16
SADp2=Sα× 3/16
SADp3=Sα× 3/16
SADp4=Sα× 1/16

Final component SAD values of the component SAD values SADp1, SADp2, SADp3, and SADp4 for the four neighbor observation vectors NV1, NV2, NV3, and NV4 are computed by cumulatively adding currently calculated values to temporary sums computed earlier and stored in table elements included in the shrunk SAD table as elements provided for the four neighbor observation vectors NV1, NV2, NV3, and NV4 pointing to the positions P0, P1, P2, P3, and P4 respectively.

In this embodiment, the process to contract an observation vector into a contracted observation vector and the process to compute a component SAD for an element included the shrunk SAD table as an element associated with a neighbor observation vector are carried out for all observation vectors each pointing to an observed block set in the search range.

As is obvious from the descriptions given so far, in this embodiment, the process to contract each observation vector RV into a contracted observation vector CV is carried out at a contraction factor of 1/n to accompany a process of contracting the SAD table TBLo at the same contraction factor of 1/n in both the horizontal and vertical directions in order to generate a shrunk SAD table TBLs with a shrunk size. The SAD table TBLo has the original size and includes elements associated with observation vectors RVs on a one-with-one basis. Then, a component SAD value is computed for each element of the shrunk SAD table TBLs by splitting a SAD value computed for an observed block pointed to by an observation vector RV serving as the origin of a contracted observation vector CV associated with the element. For more information, the reader is suggested to refer to FIG. 16.

Thus, in the case of this embodiment, the number of elements composing the shrunk SAD table TBLs is (1/n²) times the number of elements composing the pre-contraction original SAD table TBLo. That is to say, the size of the SAD table can be reduced substantially.

In accordance with the above description of the embodiment, for each element of the shrunk SAD table TBLs, four neighbor observation vectors NVs in the neighborhood of a contracted observation vector CV are selected. Then, as many component SAD values as the selected neighbor observation vectors NVs are found from a SAD value computed for a processed observed block pointed to by an observation vector RV serving as the origin of the contracted observation vector CV. A component SAD value for a neighbor observation vector NV located in the neighborhood of a contracted observation vector CV is found in a process based on the so-called linear weighted distribution technique to split a SAD value computed for the an observed block pointed to by the observation vector RV serving as the origin of the contracted observation vector CV. It is to be noted, however, that the method of selecting neighbor observation vectors NV in the neighborhood of a contracted observation vector CV and the linear weighted distribution technique of finding a component SAD value for every element of the shrunk SAD table TBLs are by no means limited to those adopted by the embodiment.

For example, as an alternative, for each element of the shrunk SAD table TBLs, 9 or 16 neighbor observation vectors NVs in the neighborhood of a contracted observation vector CV are selected. Then, as many component SAD values as the selected neighbor observation vectors NVs are found from a SAD value computed for a processed observed block pointed to by an observation vector RV serving as the origin of the contracted observation vector CV. In this case, however, a component SAD value for a neighbor observation vector NV located in the neighborhood of a contracted observation vector CV is found in a process based on the so-called cubic interpolation technique to split a SAD value computed for an observed block pointed to by the observation vector RV serving as the origin of the contracted observation vector CV. By carrying out these processes, the precision of the component SAD value is improved. If a stronger emphasis is to be laid upon a real-time necessity and reduction of the processing-circuit count, however, the process of finding component SAD values of four neighbor observation vectors NV is more effective.

Also in the case of this embodiment, a component SAD value is stored as an element of the shrunk SAD table, which is a shrunk SAD table, in a cumulative addition process carried out in the same way as the block-matching technique in related art. Thus, a SAD value is stored as an element of the original SAD table for each of spread omnipresent locations included in the search range as locations to which the observed block is to be moved.

However, in the case of the block-matching technique in related art, observation vectors are associated with the addresses of the elements composing the SAD table on a one-with-one basis so that a SAD value is computed for each observed block corresponding to an observation vector and merely stored in the SAD table as an element associated with the observation vector. In the case of the technique according to this embodiment, on the other hand, observation vectors are associated with the addresses of the elements composing the shrunk SAD table not on a one-with-one basis. Thus, a SAD value computed for an observed block is spilt into a plurality of component SAD values, which are each then stored in the shrunk SAD table as an element corresponding to one of neighbor observation vectors associated with the component SAD values. Much like every element of the SAD table, the memory locations each used for storing a computed component reference value are each also initialized to zero at an initial time.

In the case of the block-matching technique in related art, the SAD table created as described above is searched for a table element used for storing a minimum SAD value indicating a strongest correlation between the target block on the target frame and an observed block on the observed frame. Then, an observation vector pointing to the address of the table element used for storing the minimum SAD value is taken as a movement vector representing a movement from the position of the target frame to the position of the observed frame.

In the case of the embodiment, on the other hand, a SAD value stored in the shrunk SAD table according to the embodiment as an element of the shrunk SAD table is a component SAD value, which is also a SAD value. Then, the shrunk SAD table is searched for a table element used for storing a minimum SAD value indicating a strongest correlation between the target block on the target frame and a plurality of observed blocks included in the observed frame as blocks pointed to by their respective neighbor observation vectors. A movement vector is identified from the vectors because each of the neighbor observation vectors may not necessarily be an accurate movement vector.

As a most reasonable technique to identify a movement vector from neighbor observation vectors associated with such a table element of the shrunk SAD table, the shrunk SAD table is restored to the original SAD table by multiplying the size of the shrunk SAD table by an integer n (which is the reciprocal of the contraction factor of 1/n). Then, an element included in the pre-contraction original SAD table as an element corresponding to the detected element of the shrunk SAD table is identified. Finally, a movement vector pointing to the selected element of the original SAD table is determined. However, this technique can be adopted for an image processing apparatus tolerating errors to a certain degree.

In order to detect a movement vector with a higher degree of accuracy, however, it is necessary to carry out one of typical interpolation processes described below on element values stored in the shrunk SAD table. By carrying out one of the typical interpolation processes, an accurate movement vector can be detected with the original degree of precision.

In the prevon described above, a SAD table is created for each of a plurality of target blocks by adoption of the block matching technique in related art based on observation vectors and making use of no contracted observation vectors. Then, a SAD total table is created by computing every SAD total value as a sum of SAD values at in corresponding table elements of a plurality of aforementioned SAD tables. Finally, an interpolation process based on an approximation curve is carried out on the SAD total table in order to find a global movement vector. It is to be noted, however, that interpolation processed to be described below can each be carried out as the based on an approximation curve.

[First Typical Interpolation Process to Detect a Movement Vector with a Higher Degree of Accuracy]

A first typical interpolation process to detect a movement vector with a higher degree of accuracy adopts a technique by which a plurality of SAD values stored in elements of the shrunk SAD table are approximated by using a quadratic surface.

In this embodiment, since a SAD value is used as a correlation value, the smaller the SAD value, the stronger the correlation indicated by the SAD value. Thus, in this embodiment, the shrunk SAD table is searched for a specific table element used for storing a minimum SAD value indicating a strongest correlation between the target block on the target frame and a plurality of observed blocks included in the observed frame as blocks pointed to by their respective neighbor observed vectors. A table element of the shrunk SAD table can be searched for at table-address precision, which is the precision of the integer level. In addition, a plurality of neighbor table elements in a table area centered at the specific table element already detected at the precision of the integer level as an area in the shrunk SAD table are also each identified also at the precision of the integer level. Then, by adoption of the method of least squares, a quadratic surface is found as a surface representing the SAD values stored in the shrunk SAD table as the specific table element and the neighbor table elements detected in the table area. Subsequently, the minimum value of the quadratic surface representing the SAD values is determined and the position of the SAD value determined as the minimum value is identified as a position shifted from a reference position (0, 0). The identified position of a SAD value determined as the minimum value corresponds to a location included in the search area on the observed frame as the location of an observed block exhibiting the strongest correlation with the target block. The identified position is a position included in the contracted SAD table as a position at an address having precision of the fraction level. Finally, a contracted observed vector pointing to the identified position is detected as a vector pointing to the position identified at the precision of the fraction level. In the following description, the contracted observed vector pointing to the identified position of an observed block exhibiting the strongest correlation with the target block is also referred to as a minimum-value vector.

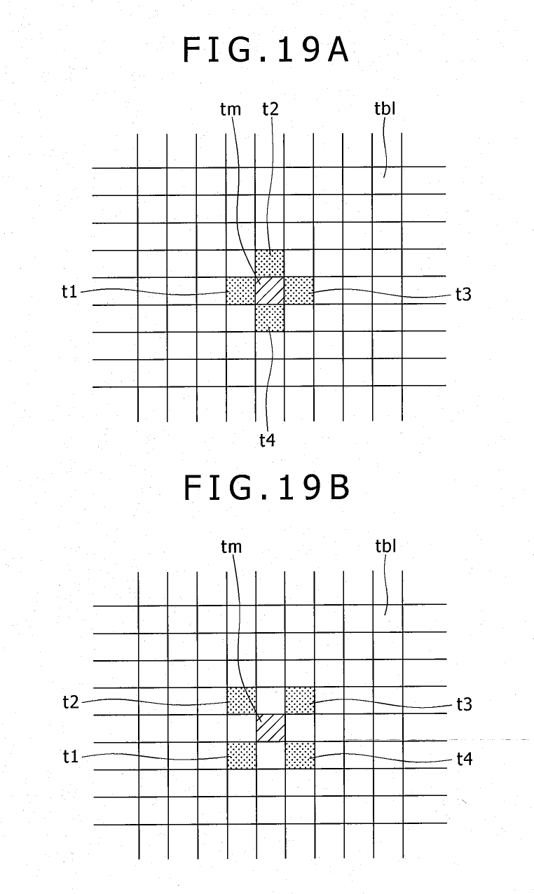

An example of the process to set a quadratic surface is shown in FIG. 19A or 19B. In either of the examples, notation tm denotes the specific table element identified at the precision of the integer level as a table element representing the minimum SAD value. On the other hand, notations t1, t2, t3, and t4 each denote a table element also identified at the precision of the integer level in the table area centered at the specific table element tm. At least four table elements sandwiching the specific table element tm in two directions are necessary.

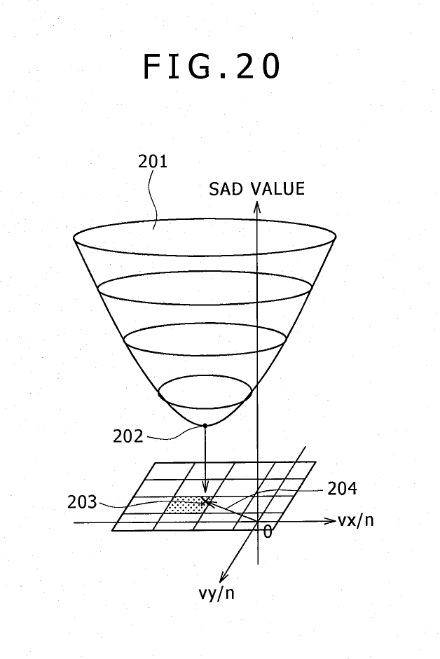

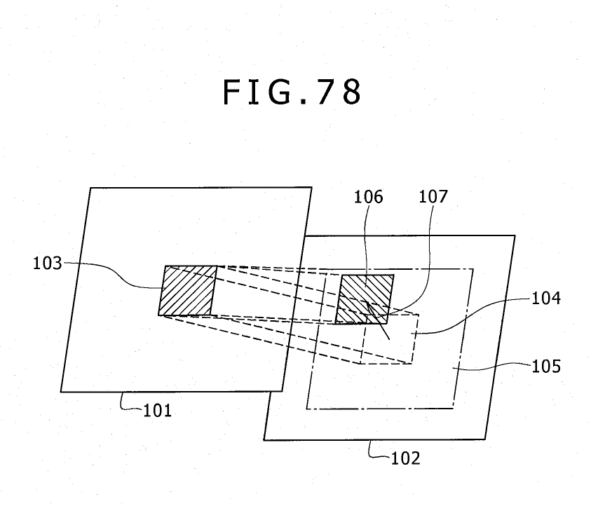

Then, as shown in FIG. 20, a coordinate space is assumed in the range of contracted observed vectors (or the range of the shrunk SAD table). The range of contracted observed vectors corresponds to the search range of the observed frame. The position of the target frame (or, strictly speaking, the position of the target-block projected image block 104 shown in FIG. 78 explained earlier) is taken as the aforementioned reference position (0, 0) of the X-Y plane in the coordinate space. The vertical Z axis (or the SAD value axis) is taken as an axis representing the SAD value, which decreases inversely proportional to the correlation between the observed and target blocks. The horizontal X axis (or a vx/n axis) is taken as an axis representing the shift of the observed block from the target block in the X direction or an axis representing the value vx/n of the contracted observed vector. By the same token, the horizontal Y axis (or a vy/n axis) is taken as an axis representing the shift of the observed block from the target block in the Y direction perpendicular to the X direction or an axis representing the value vy/n of the contracted observed vector.

Then, from the SAD value of the minimum-value table element tm identified at the precision of the integer level as well as the SAD values of the two table elements t1 and t3 identified also at the precision of the integer level as table elements sandwiching the minimum-value table element tm in a specific direction, a quadratic curve is created in the coordinate space shown in FIG. 20. By the same token, from the SAD value of the minimum-value table element tm as well as the SAD values of the two table elements t2 and t4 identified also at the precision of the integer level as table elements sandwiching the minimum-value table element tm in another direction perpendicular to the specific direction, another quadratic curve is created in the coordinate space. Then, an approximation quadratic surface 201 including these two quadratic curves is found in the coordinate space shown in FIG. 20 by adopting the method of least squares.

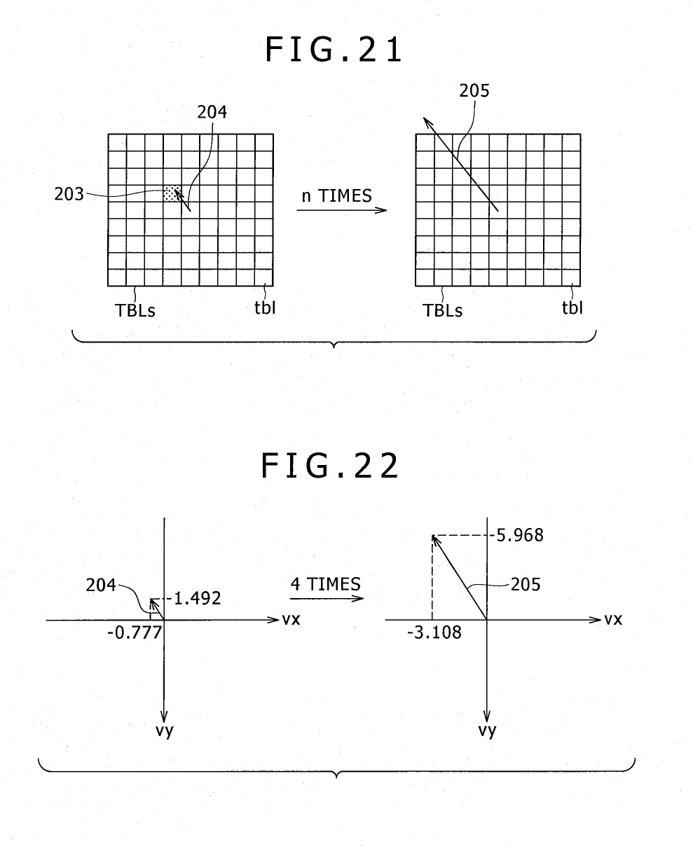

Subsequently, a minimum-value point 202 of the approximation quadratic surface 201 is detected at a position 203 existing on the X-Y plane as a position with coordinates of (vx/n, vy/n) as shown in FIG. 20. The position (vx/n, vy/n) is a position identified at the precision of the fraction level as the position of a table element (or a table-element address) with the smallest SAD value in the shrunk SAD table. Finally, a minimum-value vector 204 pointing to the position (vx/n, vy/n) identified at the precision of the fraction level is determined, and the movement vector 205 with the original magnitude and the original direction is computed by multiplying the minimum-value vector 204 by the reciprocal value n of the contraction factor as shown in FIG. 21.

For example, a shrunk SAD table TBLs shown in FIG. 22 is obtained by shrinking the original SAD table to accompany a process of contracting observed vectors at a contraction factor of ¼ and a movement vector 204 (−0.777, −1.492) is found from the address of the minimum-value table element identified at the precision of the fraction level. In this case, the minimum-value vector 204 is multiplied by four to obtain the original movement vector 205 (−3.108, −5.968). The movement vector 205 is a movement vector at the original scale of the image.

In accordance with the embodiment of the present invention described above, the shrunk SAD table is searched for a specific table element tm used for storing a minimum SAD value indicating a strongest correlation and four neighbor table elements in a table area centered at the specific table element tm. In order to set an approximation quadratic surface of SAD values, however, it is better to find a larger number of neighbor table elements in such a table area. For this reason, in general, neighbor table elements in a rectangular table area centered at the specific table element tm detected at the precision of the integer level as an area including m×m table elements (where notation m denotes an integer at least equal to three) in the horizontal and vertical directions are found.

However, a larger number of neighbor table elements is not necessarily better. This is because neighbor table elements in such a large table area leads to an increased amount of processing. In addition, if the number of neighbor table elements is increased, it will be more likely within the bounds of possibility that a false local minimum value dependent on the image pattern is inevitably detected. Thus, table elements in a rectangular table area including a proper number of neighbor table elements are selected.

The following description explains two examples of the rectangular table area included in the shrunk SAD table as an area containing a proper number of neighbor table elements. One of the examples according to this embodiment is a rectangular table area centered at the minimum-value table element tm found at the precision of the integer level as an area containing 3×3 neighbor table elements surrounding the minimum-value table element tm in the horizontal and vertical directions. The other example according to this embodiment is a rectangular table area centered at the minimum-value table element tm found at the precision of the integer level as an area containing 4×4 neighbor table elements surrounding the minimum-value table element tm in the horizontal and vertical directions.

[Rectangular Table Area Including 3×3 Table Elements]

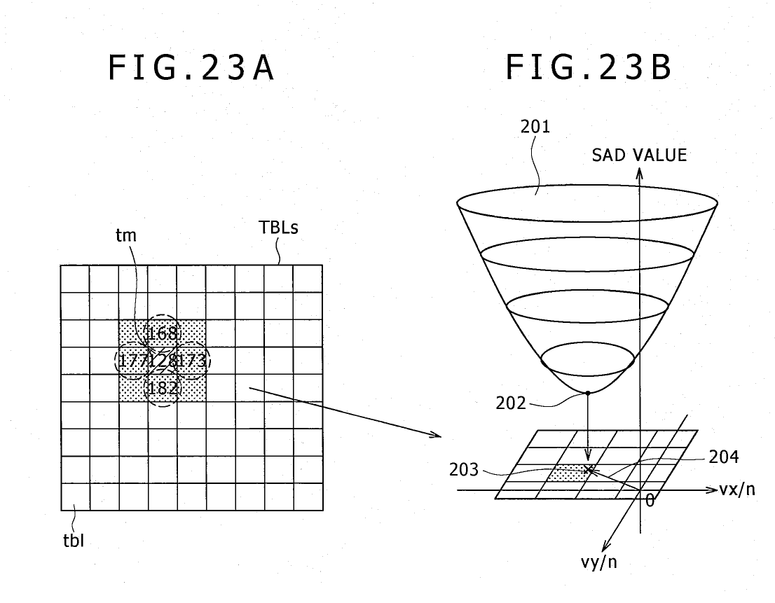

FIGS. 23A and 23B is a diagram showing a technique to find a movement vector by using a rectangular table area centered at the minimum-value table element tm found at the precision of the integer level as an area including 3×3 neighbor table elements surrounding the minimum-value table element tm in the horizontal and vertical directions. In FIGS. 23A and 23B, the table area is shown as a gray block.

In accordance with the technique shown in FIGS. 23A and 23B, an approximation quadratic surface 201 shown in FIG. 23B is set by adopting the method of least squares on the basis of SAD values of the minimum-value table element tm found at the precision of the integer level and eight neighbor table elements surrounding the minimum-value table element tm as shown in FIG. 23A.

Subsequently, a minimum-value point 202 of the approximation quadratic surface 201 is detected at a position 203 existing on the X-Y plane as a position with coordinates of (vx/n, vy/n) as shown in FIG. 23B. The position (vx/n, vy/n) is a position identified at the precision of the fraction level as the position corresponding to a table element (or a table-element address) with the smallest SAD value in the shrunk SAD table.

Finally, a minimum-value vector 204 pointing to the position 203 identified at the precision of the fraction level as a position of the table element is determined, and the movement vector 205 (or the minimum-value vector) with the original magnitude and the original direction is computed by multiplying the minimum-value vector 204 by the reciprocal value n of the contraction factor as shown in FIG. 21.

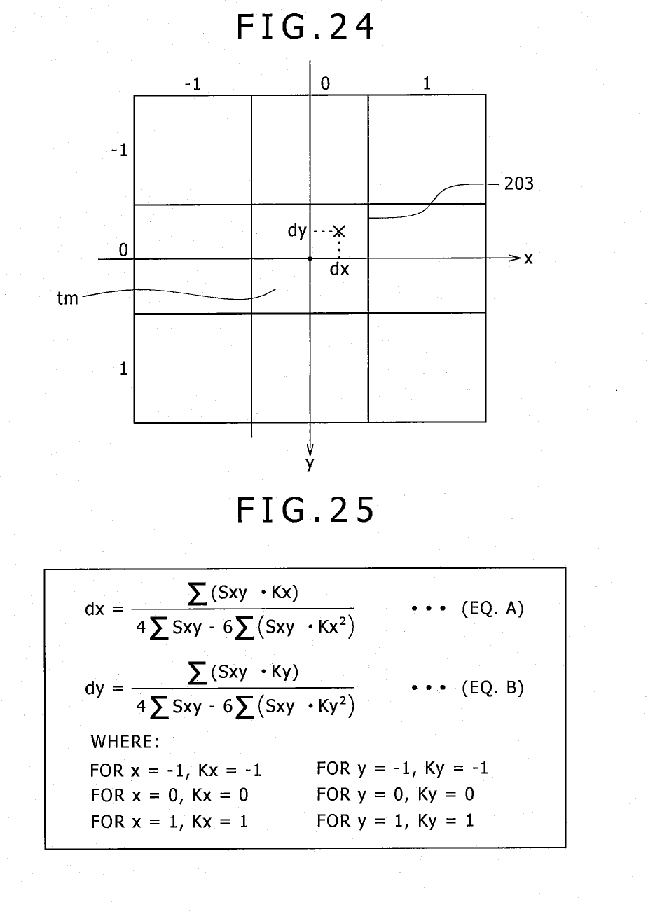

A process to find the position 203 corresponding to the minimum-value point 202 on the approximation quadratic surface 201 is carried out by adoption of a method described as follows. As shown in FIG. 24, a coordinate (x, y) system is devised as a system in which the position of the center of the minimum-value table element tm found at the precision of the integer level is taken as the origin point (0, 0). In this case, eight neighbor table elements surrounding the minimum-value table element tm found at the precision of the integer level are located at positions with x-axis coordinates represented by x=−1, x=0, and x=+1 in the horizontal direction and y-axis coordinates represented by y=−1, y=0, and y=+1 in the vertical direction except the position at a coordinate of (x=0 and y=0). That is to say, the eight neighbor table elements surrounding the minimum-value table element tm found at the precision of the integer level are located at coordinates of (−1, −1), (0, −1), (1, −1), (−1, 0), (0, 1), (−1, 1), (0, 1), and (1, 1).

Let us have notation Sxy denote the SAD value of a table element in the coordinate system shown in FIG. 24. For example, the SAD value of the minimum-value table element tm found at the origin point (0, 0) at the precision of the integer level is denoted by symbol S₀₀ whereas the SAD value of the neighbor table element at the position (1, 1) on the right side of the minimum-value table element tm and below the minimum-value table element tm is denoted by symbol S₁₁.

Thus, the coordinates (dx, dy) of a position observed in the (x, y) coordinate system at the precision of the fraction level with the minimum-value table element tm found at the origin point (0, 0) of the (x, y) coordinate system at the precision of the integer level can be found in accordance with Eqs. (A) and (B) shown in FIG. 25.

In Eqs. (A) and (B) shown in FIG. 25, the values of Kx and Ky are given as follows:

For x=−1, Kx=−1;

for x=0, Kx=0;

for x=1, Kx=1;

for y=−1, Ky=−1;

for y=0, Ky=0; and

for y=1, Ky=1.

The coordinates of (dx, dy) are the coordinates of a position at the precision of the fraction level with the minimum-value table element tm found at the origin point (0, 0) at the precision of the integer level, from the position (dx, dy) at the precision of the fraction level and the position of the minimum-value table element tm found at the origin point (0, 0) at the precision of the integer level. Thus, the position 203 can be detected as a position separated away from the center of the identified minimum-value table element tm.

[Rectangular Table Area Including 4×4 Table Elements]

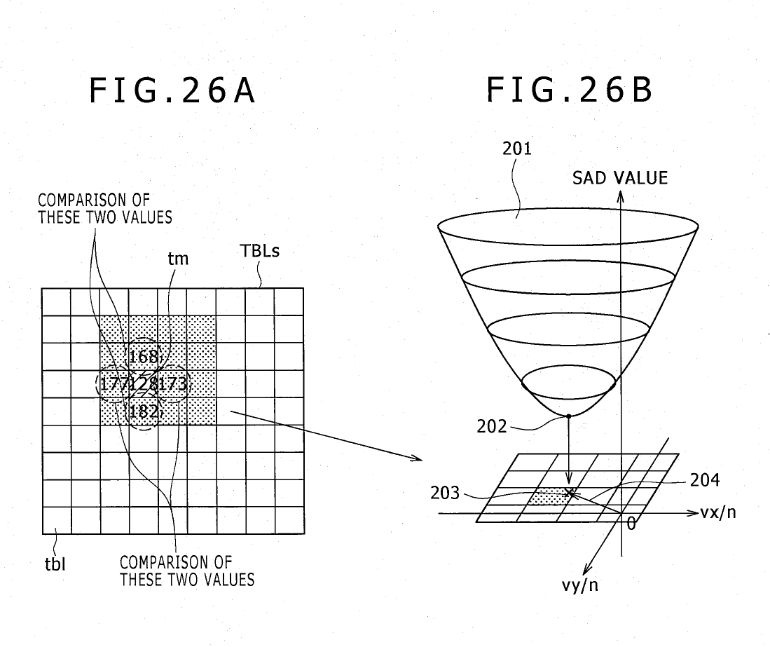

FIGS. 26A and 26B are diagrams showing a technique to find a movement vector by using a rectangular table area centered at the minimum-value table element tm found at the precision of the integer level as an area including 4×4 neighbor table elements surrounding the minimum-value table element tm in the horizontal and vertical directions. In FIGS. 26A and 26B, the table area is shown as a gray block.

In the case of an m×m table area (including m×m table elements where m is an odd integer), the minimum-value table element tm found at the precision of the integer level is usually located as the center table element of the neighbor table elements. For example, the table area covering a total of 9 (=3×3) table elements includes the minimum-value table element tm found at the precision of the integer level and its eight neighbor table elements. The table area covering a total of 25 (=5×5) table elements includes the minimum-value table element tm and its 24 neighbor table elements. Thus, the rectangular table area used for determining a movement vector can be set with ease.

In the case of an m×m table area (including m×m neighbor table elements where m is an even integer) such as a table area including table elements 4×4 table elements including the minimum-value table element tm found at the precision of the integer level and the 15 neighbor table elements, on the other hand, the minimum-value table element tm is located not as the center table element of the neighbor table elements. Thus, the rectangular table area used for determining a movement vector is difficult to be set with ease so that some devised endeavors described below are made.

In this case, the SAD values (which are each a final component SAD value in this embodiment) of neighbor table elements including the minimum-value table element tm found at the precision of the integer level on the same row of the shrunk SAD table as the minimum-value table element tm are compared with each other. As a result of the comparison, such a rectangular table area is set that the minimum-value table element tm serves as the second table element of the row while the table element having the smallest SAD value among four adjacent neighbor table elements including the minimum-value table element tm serves as the fourth neighbor table element of the row. By the same token, the SAD values of neighbor table elements including the minimum-value table element tm found at the precision of the integer level on the same column of the shrunk SAD table as the minimum-value table element tm are compared with each other. As a result of the comparison, such a rectangular table area is set that the minimum-value table element tm serves as the second table element of the column while and the table element having the smallest SAD value among four adjacent neighbor table elements including the minimum-value table element tm serves as the fourth neighbor table element of the column.

In the example shown in FIGS. 26A and 26B, the minimum-value table element tm found at the precision of the integer level is sandwiched by two adjacent neighbor table elements having SAD values of 177 and 173 respectively on the same row. In this case, the minimum-value table element tm is taken as the second table element of the row while a neighbor table element on the right side of the neighbor table element having the smaller SAD value of 173 is taken as the fourth neighbor table element of the row. By the same token, the minimum-value table element tm found at the precision of the integer level is sandwiched by the two adjacent neighbor table elements having SAD values of 168 and 182 respectively on the same column. In this case, the minimum-value table element tm is taken as the second table element of the column while a neighbor table element above the neighbor table element having the smaller SAD value of 168 is taken as the fourth neighbor table element of the column.

Then, in the example shown in FIGS. 26A and 26B, an approximation quadratic surface 201 shown in FIG. 26B is set by adopting the method of least squares on the basis of SAD values of the minimum-value table element tm found at the precision of the integer level and 15 neighbor table elements surrounding the minimum-value table element tm as shown in FIG. 26A.

Subsequently, a minimum-value point 202 of the approximation quadratic surface 201 is detected at a position 203 existing on the X-Y plane as a position with coordinates of (vx/n, vy/n) as shown in FIG. 26B. The position (vx/n, vy/n) is a position identified at the precision of the fraction level as the position corresponding to a table element (or a table-element address) with the smallest SAD value in the shrunk SAD table.

Finally, a minimum-value vector 204 pointing to the position 203 identified at the precision of the fraction level as a position of the table element is determined, and the movement vector 205 (or the minimum-value vector) with the original magnitude and the original direction is computed by multiplying the minimum-value vector 204 by the reciprocal value n of the contraction factor as shown in FIG. 21.

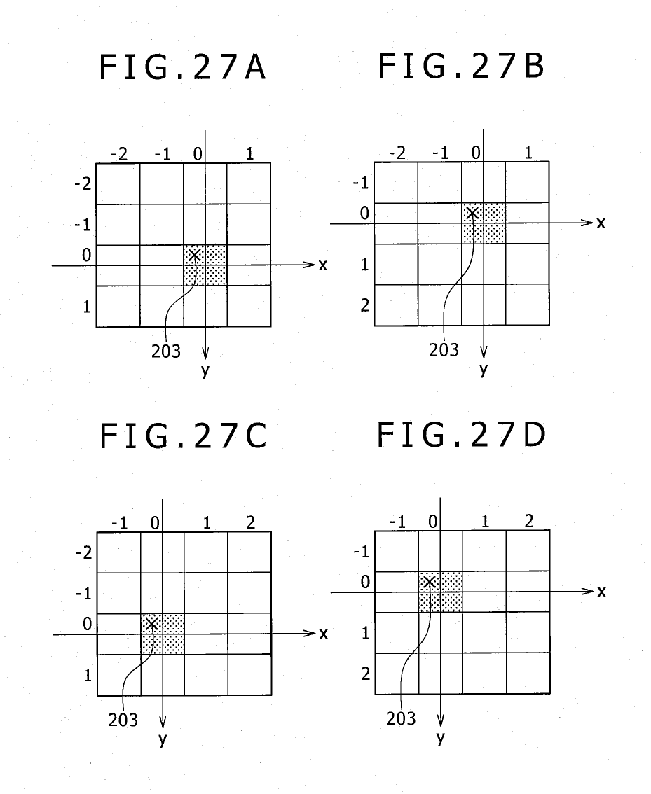

A process to find the position 203 corresponding to the minimum-value point 202 on the approximation quadratic surface 201 is carried out by adoption of a method described as follows. As shown in FIGS. 27A to 27D, a coordinate (x, y) system is devised as a system in which the position of the center of the minimum-value table element tm found at the precision of the integer level is taken as the origin point (0, 0).

In the case of the example shown in FIGS. 26A and 26B, as shown in FIGS. 27A to 27D, there are four rectangular table areas including the 16 table elements laid out in different ways resulting in different positions of the minimum-value table element tm found at the precision of the integer level.

In this case, as is obvious from FIGS. 27A to 27D, the position the minimum-value table element tm found at the precision of the integer level is fixed at the origin point (0, 0) in the coordinate system. The positions of the 15 neighbor table elements located in the neighborhood of the minimum-value table element tm have x-axis coordinates represented by x=−2 or x=−1, x=0, and x=+1 or x=+2 in the horizontal direction and y-axis coordinates represented by y=−2 or y=−1, y=0 and y=+1 or y=+2 in the vertical direction.

Let us have notation Sxy denote the SAD value of a table element in the coordinate system shown in FIGS. 27A to 27D. For example, the SAD value of the minimum-value table element tm found at the origin point (0, 0) at the precision of the integer level is denoted by symbol S₀₀ whereas the SAD value of the table element at the position (1, 1) on the right side of the minimum-value table element tm and below the minimum-value table element tm is denoted by symbol S11.

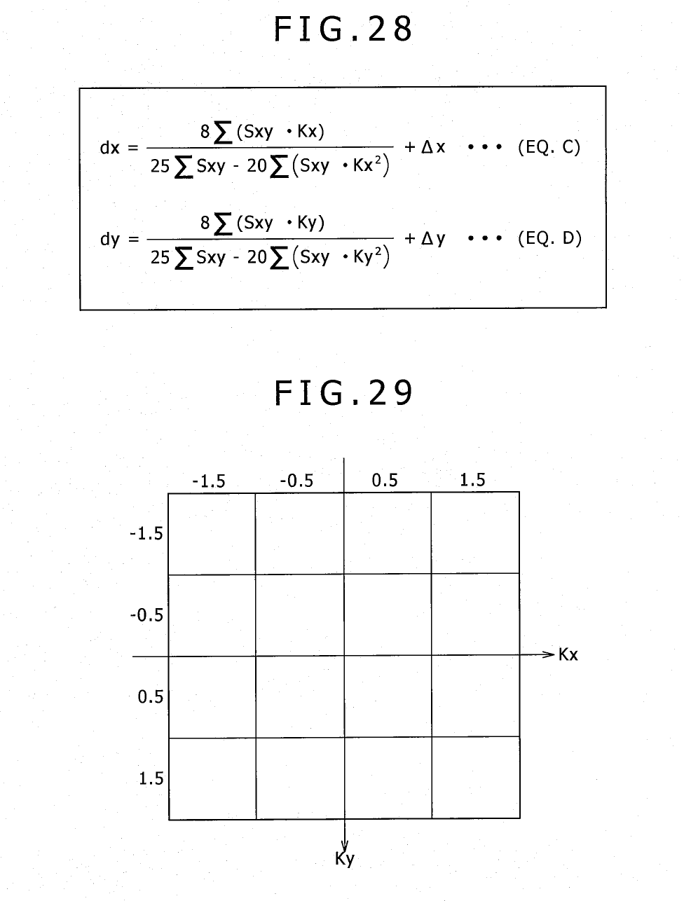

Thus, the coordinates (dx, dy) of a position observed in the (x, y) coordinate system at the precision of the fraction level with the minimum-value table element tm found at the origin point (0, 0) of the (x, y) coordinate system at the precision of the integer level can be found in accordance with Eqs. (C) and (D) shown in FIG. 28. The origin point (0, 0) of the (x, y) coordinate system coincides with the center of a rectangular area covering 16 table elements including the minimum-value table element tm found at the origin point (0, 0) of the (x, y) coordinate system at the precision of the integer level.

In Eqs. (C) and (D) shown in FIG. 28, the values of Kx and Ky are the values represented by respectively the axes of a (Kx, Ky) of coordinate system shown in FIG. 29 as a coordinate system placed over a rectangular table area. The table area includes the minimum-value table element tm found at the precision of the integer level and the 15 neighbor table elements located in the neighborhood of the minimum-value table element tm. In such a way, the center of the rectangular area coincides with the origin point (0, 0) of the (Kx, Ky) coordinate system. The values of Kx and Ky are values dependent on four different layouts shown in FIGS. 27A to 27D as layouts of the table elements.

TIn detail, in the case of the coordinate system shown in FIG. 27A, the coordinates Kx and Ky of the (Kx, Ky) coordinate system shown in FIG. 29 have the following values:

For x=−2, Kx=−1.5;

for x=−1, Kx=−0.5;

for x=0, Kx=0.5;

for x=1, Kx=1.5;

for y=−2, Ky=−1.5;

for y=−1, Ky=−0.5;

for y=0, Ky=0.5; and

for y=1, Ky=1.5.

In the case of the coordinate system shown in FIG. 27B, the coordinates Kx and Ky of the (Kx, Ky) coordinate system shown in FIG. 29 have the following values:

For x=−2, Kx=−1.5;

for x=−1, Kx=−0.5;

for x=0, Kx=0.5;

for x=1, Kx=1.5;

for y=−1, Ky=−1.5;

for y=0, Ky=−0.5;

for y=1, Ky=0.5; and

for y=2, Ky=1.5.

In the case of the coordinate system shown in FIG. 27C, the coordinates Kx and Ky of the (Kx, Ky) coordinate system shown in FIG. 29 have the following values:

For x=−1, Kx=−1.5;

for x=0, Kx=−0.5;

for x=1, Kx=0.5;

for x=2, Kx=1.5;

for y=−2, Ky=−1.5;

for y=−1, Ky=−0.5;

for y=0, Ky=0.5; and

for y=1, Ky=1.5.

In the case of the coordinate system shown in FIG. 27D, the coordinates Kx and Ky of the (Kx, Ky) coordinate system shown in FIG. 29 have the following values:

For x=−1, Kx=−1.5;

for x=0, Kx=−0.5;

for x=1, Kx=0.5;

for x=2, Kx=1.5;

for y=−1, Ky=−1.5;

for y=0, Ky=−0.5;

for y=1, Ky=0.5; and

for y=2, Ky=1.5.

Notation Δx used in Eqs. (C) shown in FIG. 28 is a shift of the coordinate x of the position of a table element in the (x, y) coordinate system shown in FIG. 27A to 27D for the coordinate Kx in the (Kx, Ky) coordinate system shown in FIG. 29. By the same token, notation Δy used in Eqs. (D) shown in FIG. 28 is a shift of the coordinate y of the position of a table element in the (x, y) coordinate system shown in FIG. 27A to 27D for the coordinate Ky in the (Kx, Ky) coordinate system shown in FIG. 29. The shifts Δx and Δy have the following values:

In the case of FIG. 27A, Δx=−0.5 and Δy=−0.5;

in the case of FIG. 27B, Δx=−0.5 and Δy=0.5;

in the case of FIG. 27C, Δx=0.5 and Δy=−0.5; and

in the case of FIG. 27D, Δx=0.5 and Δy=0.5.

The coordinates (dx, dy) are the coordinates of a position at the precision of the fraction level with the minimum-value table element tm found at the origin point (0, 0) at the precision of the integer level, from the position (dx, dy) at the precision of the fraction level and the position of the minimum-value table element tm found at the origin point (0, 0) at the precision of the integer level. The position 203 can be detected as a position separated away from the center of the identified minimum-value table element tm.

[Second Typical Interpolation Process to Detect a Movement Vector with a Higher Degree of Accuracy]

A second typical interpolation process to detect a movement vector with a higher degree of accuracy adopts a technique whereby a plurality of SAD values stored in elements arranged in the horizontal direction on a row including the minimum-value table element tm found at the precision of the integer level in the shrunk SAD table are used to create a cubic curve laid on a plane oriented in the horizontal direction. A plurality of SAD values stored in elements arranged in the vertical direction on a column including the minimum-value table element tm in the shrunk SAD table are used to create a cubic curve laid on a plane oriented in the vertical direction. Then, a position (vx, vy) of the minimum values of the cubic curves is detected and taken as a minimum-value address having the precision of the fraction level.

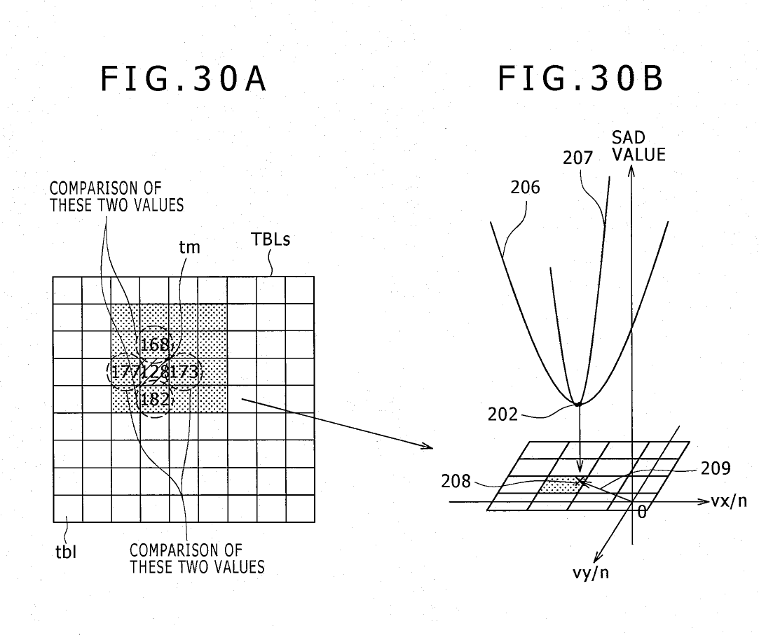

FIGS. 30A and 30B are explanatory diagrams referred to in the following description of the second typical interpolation process to detect a movement vector with a higher degree of accuracy. Much like the first typical interpolation process, the second typical interpolation process is carried out to find a movement vector by using a rectangular table area centered at the minimum-value table element tm found at the precision of the integer level as an area including neighbor table elements surrounding the minimum-value table element tm in the horizontal and vertical directions. In the example shown in FIGS. 30A and 30B, the number of neighbor table elements is set at 16 (=4×4). In FIGS. 30A and 30B, the table area is shown as a gray block.

Next, much like the first typical interpolation process to detect a movement vector with a higher degree of accuracy, as shown in FIG. 30B, a coordinate space is assumed in the range of contracted observed vectors (or the range of the shrunk SAD table). The range of contracted observed vectors corresponds to the search range of the observed frame. The position of the target frame (or, strictly speaking, the position of the target-block projected image block 104 shown in FIG. 78) is taken as the reference position (0, 0) of the X-Y plane in the coordinate space. The vertical Z axis (or the SAD value axis) is taken as an axis representing the SAD value, which decreases inversely proportional to the correlation between the reference and target blocks. In this embodiment, the SAD value is a final component SAD value. The horizontal X axis (or a vx/n axis) is taken as an axis representing the shift of the observed block from the target block in the X direction or an axis representing the value vx/n of the contracted observed vector. By the same token, the horizontal Y axis (or a vy/n axis) is taken as an axis representing the shift of the observed block from the target block in the Y direction perpendicular to the X direction or an axis representing the value vy/n of the contracted observed vector.

Then, four table elements on a horizontal-direction row including the minimum-value table element tm found at the precision of the integer level are selected among the 16 table elements in the neighborhood of the table minimum-value element tm. Subsequently, the SAD values (which are each a final component SAD value) of the four selected table elements are used to create a horizontal cubic curve 206 laid on a plane oriented in the horizontal direction in the coordinate system. Then, the horizontal-direction position vx/n of the minimum value on the horizontal cubic curve 206 is selected in the area of a table element at the precision of the fraction level.

By the same token, four table elements on a vertical-direction column including the minimum-value table element tm found at the precision of the integer level are selected among the 16 table elements in the neighborhood of the table minimum-value element tm. Subsequently, the SAD values (which are each a final component SAD value) of the four selected table elements are used to create a vertical cubic curve 207 laid on a plane oriented in the vertical direction in the coordinate system. Then, the vertical-direction position vy/n of the minimum value on the vertical cubic curve 207 is selected in the area of a table element at the precision of the fraction level.

From the horizontal-direction position vx/n selected at the precision of the fraction level and the vertical-direction position vy/n selected at the precision of the fraction level, a minimum-value table address 208 is then found at the precision of the fraction level. The fraction-precision minimum-value table address 208 is a table-element address corresponding to the minimum value on the horizontal cubic curve 206 and the vertical cubic curve 207. Finally, a minimum-value vector 209 pointing to the fraction-precision minimum-value table address 208 identified at the precision of the fraction level as a position in the table element is determined. The movement vector (or the minimum-value vector) with the original magnitude and the original direction is computed by multiplying the minimum-value vector 209 by the reciprocal value n of the contraction factor as shown in FIG. 21.

That is to say, the second typical interpolation process adopts a technique whereby four table elements are selected in each of a row oriented in the horizontal direction and a column oriented in the vertical direction by adoption of the same technique as the first typical interpolation process. Then, a cubic curve laid on a plane oriented in the horizontal direction is created on the basis of the four table elements selected on the row whereas a cubic curve laid on a plane oriented in the vertical direction is created on the basis of the four table elements selected on the column as shown in FIG. 30B.

A process to find the fraction-precision minimum-value table address 208 corresponding to the minimum-value point 202 on the horizontal cubic curve 206 and the vertical cubic curve 207 is carried out by adoption of a method described as follows. Let us have notations S₀, S₁, S₂, and S₃ denote SAD values of the four table elements selected on a row oriented in the horizontal direction or a column oriented in the vertical direction. As described above, in this embodiment, a SAD value is a final component SAD value. The SAD values S₀, S₁, S₂, and S₃ correspond to four adjacent points laid out consecutively along the horizontal cubic curve 206 in the horizontal direction or the vertical cubic curve 207 in the vertical direction. As shown in FIG. 31, notations Ra, Rb, and Rc respectively denote a segment representing the axis-direction distance between the points S₀ and S₁, a segment representing the axis-direction distance between the points S₁ and S₂, and a segment representing the axis-direction distance between the points S₂ and S₃. A segment portion u is a fraction part included the coordinate value of the position of the minimum SAD value. The segment portion u is found in accordance with an equation dependent on which of the three segments Ra, Rb, and Rc shown in FIG. 31 includes the segment portion u serving as the fraction part included in the coordinate value of the position of the minimum SAD value.

As described above, the segment Ra is a segment between the position corresponding to the SAD value (or SAD value) S₀ and the position corresponding to the SAD value S1, the segment Rb is a segment between the position corresponding to the SAD value S1 and the position corresponding to the SAD value S2. The segment Rc is a segment between the position corresponding to the SAD value S₂ and the position corresponding to the SAD value S3. As described above, in this embodiment, a SAD value is a final component SAD value.

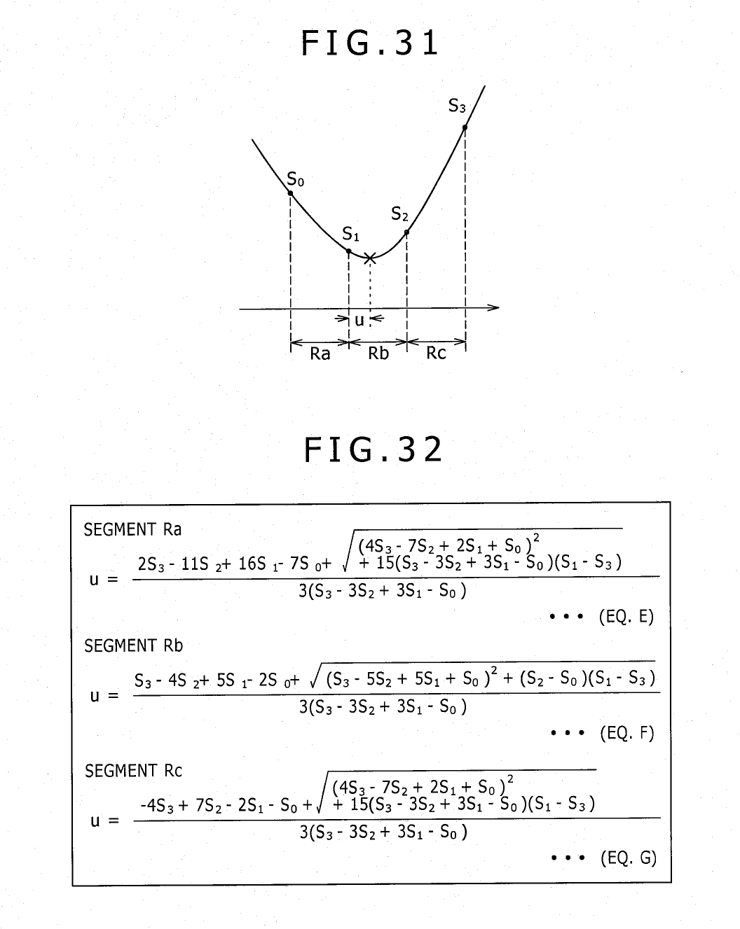

If the fraction-precision position of the minimum SAD value exists in the segment Ra shown in FIG. 31, the segment portion u representing the distance from the beginning of the segment Ra to the position is found as a fraction by using Eq. (E) shown in FIG. 32.

By the same token, if the fraction-precision position of the minimum SAD value exists in the segment Rb shown in FIG. 31, the segment portion u representing the distance from the beginning of the segment Rb to the position is found as a fraction by using Eq. (F) shown in FIG. 32.

In the same way, if the fraction-precision position of the minimum SAD value exists in the segment Rc shown in FIG. 31, the segment portion u representing the distance from the beginning of the segment Rc to the position is found as a fraction by using Eq. (G) shown in FIG. 32.

The following description explains a technique to determine which of the three segments Ra, Rb, and Rc shown in FIG. 31 includes the fraction part u.

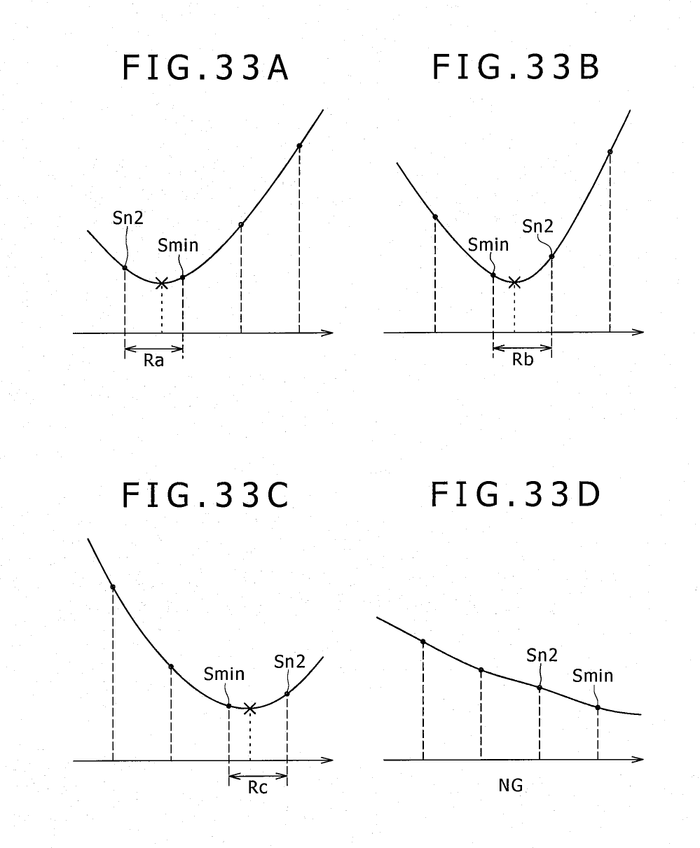

FIGS. 33A to 33D is an explanatory diagram referred to in description of the technique to determine which of the three segments Ra, Rb, and Rc shown in FIG. 31 includes the fraction part u. First of all, notation 5 min denotes the minimum SAD value at a position detected at the precision of the integer level. Notation Sn2 denotes a SAD value located at an integer-precision position as a SAD value having a smallest difference from the minimum SAD value 5 min among the SAD values at the integer-precision positions of all the four table elements. The true minimum SAD value denoted by symbol x in FIGS. 33A to 33C exists at a position detected at the precision of the fraction level as a position between the position of the minimum SAD value 5 min and the position of the SAD value Sn2. Then, by recognizing which of the SAD values S₀, S₁, S₂, and S₃ shown in FIG. 31 serve as the minimum SAD value 5 min and the SAD value Sn2, it is possible to determine which of the three segments Ra, Rb, and Rc includes the fraction part u.

It is to be noted that there is also a case in which the integer-precision position of the minimum SAD value 5 min is an edge of a range including the positions of the SAD values of the four table elements as shown in FIG. 33D. In this case, the position of the true minimum SAD value x is difficult to determine, and the embodiment does not find the position of the true minimum SAD value x, handling this case as an error. Nevertheless, the position of the true minimum SAD value x can also be found even in the case like the one shown in FIG. 33D.

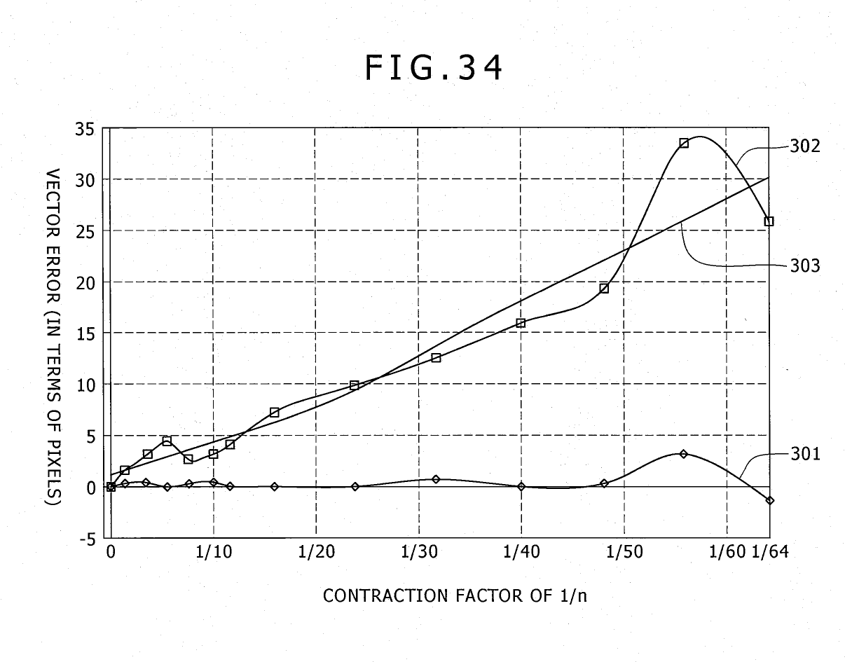

As described above, in accordance with the embodiments described above, by using a shrunk SAD table with a size scaled down by a down-sizing factor of 1/n², the movement vector at the original image scale can be detected. FIG. 34 is a diagram showing the fact that all but the same vector detection results as the image-processing apparatus in related art can be obtained in spite of the use of a shrunk SAD table with a size scaled down by a down-sizing factor of 1/n².

The horizontal axis of FIG. 34 represents the one-dimensional contraction factor of 1/n used in contracting the SAD table in the horizontal or vertical direction. On the other hand, the vertical axis represents the vector error, which is an error of a detected movement vector. The value of the vector error shown in FIG. 34 is expressed in terms of pixels.

In FIG. 34, a curve 301 represents the average value of vector errors detected for different contraction factors. A curve 302 represents the three-time value (3a (99.7%) value) of the variance σ of the vector errors detected for different contraction factors. A curve 303 is an approximation curve of the curve 302.

The curves shown in FIG. 34 represent the vector error detected at different one-dimensional contraction factors 1/n. Since the SAD table is a two-dimensional table, however, the size of the table (that is, the number of elements composing the SAD table) is reduced at a rate equal to the square of the one-dimensional contraction factor of 1/n used in FIG. 34. Nevertheless, the usefulness of the technique according to the embodiments is obvious from the curves indicating that the average of vector errors does not change and the variance of the vector errors increases linearly with changes in contraction factor.

In addition, even for n=64 (or a contraction factor of 1/64), the average of vector errors is small, proving that there is not a failure caused by detection of an incorrect movement vector. Thus, we can say that the size of the SAD table can be reduced by a down-sizing factor of 1/4096.

On the top of that, as described earlier, in a process to compensate a moving picture for effects caused by hand trembling, a real-time response and reduction of the time delay are strongly necessary. However, errors of the detected movement vector can be tolerated to a certain degree as long as the error is not a failure caused by detection of an incompletely incorrect movement vector. Thus, the size of the SAD table can be reduced substantially without causing a failure. As a result, the embodiments are very useful.

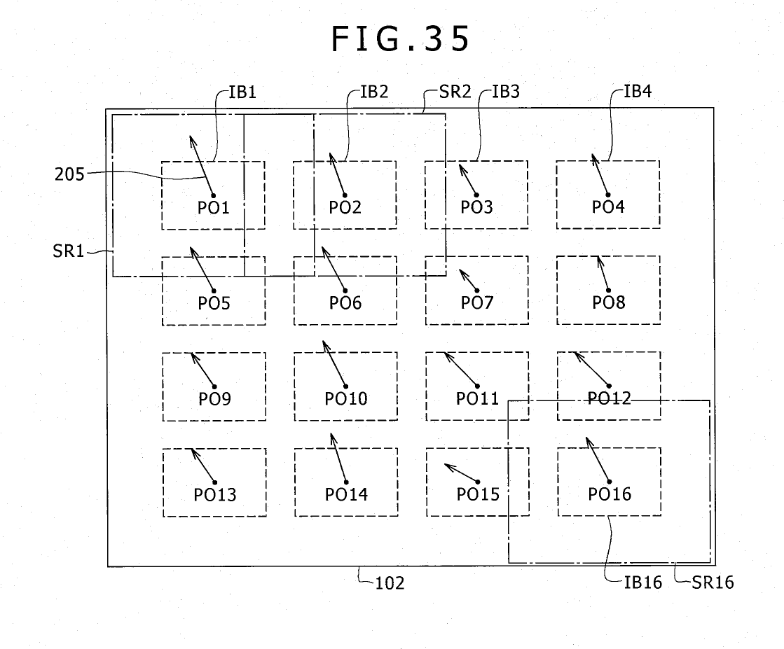

In the actual system for compensating an image for effects caused by hand trembling, an observed frame 102 is divided into a plurality of partial areas and, for each of the partial areas, a movement vector 205 is detected. This is because it is quite within the bounds of possibility that a moving object of photographing is included in the observed frame 102. For example, in one observed frame 102, 16 movement vectors 205 are detected as shown in FIG. 35. Then, while considering transitions each indicated by one of the movement vectors 205 from a past image, a statistical process is carried out in order to determine a global vector for the observed frame 102, that is, a hand-trembling movement vector of the observed frame 102.

In this case, as shown in FIG. 35, 16 search ranges SR1, SR2, . . . , and SR16 centered at the origin points PO1, PO2, . . . , and PO16 of respectively the 16 movement vectors 205 to be detected are set in advance. Target-block projected image blocks IB1, IB2, . . . , and IB16 are assumed to exist at the centers of the search ranges SR1, SR2, and SR19 respectively.

Then, in each of the search ranges SR1, SR2, . . . , and SR16, an observed block having the same size as each of the target-block projected image blocks IB1, IB2, . . . , and IB16 is set as a block to be moved from position to position over the search range SR1, SR2, . . . , or SR16 respectively. A shrunk SAD table is then generated for finding the movement vector 205 in each of the search ranges SR1, SR2, . . . , and SR16 in the same way as the technique provided by the present embodiment as described earlier.

Then, in this embodiment, the SAD values in the 16 shrunk SAD tables TBLi created respectively for the 16 target blocks associated with 16 search ranges respectively are used to compute SAD total values to be included in a SAD total table SUM_TBL as table elements corresponding to the table elements of their respective SAD values in the 16 shrunk SAD tables TBLi as shown in FIG. 2. Each of the computed SAD total values is the sum of SAD values each computed for a plurality of neighbor observed blocks in a search range. Thus, in this embodiment, the SAD total table SUM_TBL including the computed SAD total values has the same configuration as the shrunk SAD tables TBLi.

Then, in this embodiment, processing explained earlier by referring to FIGS. 13 and 14 as processing to evaluate reliability of each every-block movement vector 205 is typically carried out on the basis of the shrunk SAD tables TBLi, every-block movement vectors 205 each computed for one of the shrunk SAD tables TBLi by carrying out an approximation interpolation process like the one described earlier, and the SAD total table SUM_TBL. Subsequently, a recreated SAD total table RSUM_TBL is generated for target blocks, for each of which a high-reliability every-block movement vector 205 has been detected. Finally, a curve approximation interpolation process making use of the minimum SAD total value of the recreated SAD total table RSUM_TBL and a plurality of neighbor SAD total values each stored in a table element in the vicinity of the table element for storing the minimum SAD total value is carried out to find a high-precision global movement vector.

In comparison with the method in related art disclosed in Japanese Patent Laid-open No. 2005-38396 as a method for detecting a movement vector for an image with a reduced size, the image processing method according to the embodiments described above has the following two characteristics different from those of the method in related art.

In the first place, unlike the method in related art disclosed in Japanese Patent Laid-open No. 2005-38396, the image processing method according to the embodiments does not need a process to contract an image at all. This is because, in accordance with the image processing method provided by the embodiments, in a process to store a component SAD value computed for an observed block in a shrunk SAD table as an element of the table, a process to translate the address of the element is carried out at the same time. As described above, the SAD value computed for an observed block is actually a final component SAD value computed for the observed block.

Thus, in comparison with the method in related art disclosed in Japanese Patent Laid-open No. 2005-38396, the image processing method according to the embodiments offers merits such as elimination of logic to contract an image, the time it takes to store a contracted image in a memory, the bandwidth of a process to store a contracted image in the memory, and the memory for storing a contracted image.

In the second place, the method in related art disclosed in Japanese Patent Laid-open No. 2005-38396 raises another serious problem that, as described earlier, the method needs a low-pass filter for getting rid of aliasing and low-illumination noises generated in the process to shrink an image. That is to say, in the process to shrink an image, image data are supplied to a proper low-pass filter before being re-sampled. Otherwise, aliasing will occur and the precision of a movement vector detected by using a shrunk image will deteriorate substantially.

A function exhibited by a low-pass filter used in the process to shrink an image as a function resembling the sinc function has been proven theoretically to be an ideal characteristic of a low-pass filter. The sinc function itself is the function of an infinite-tap FIR (Finite Impulse Response) filter having a cut-off frequency f/2 expressed by sin (xπ)/(xπ). In the case of a low-pass filter having an ideal cut-off frequency of f/(2n) for a contraction factor of 1/n, the cut-off frequency is represented by sin (xπ/n)/(xπ/n), which can also be used as a form of the sinc function though.

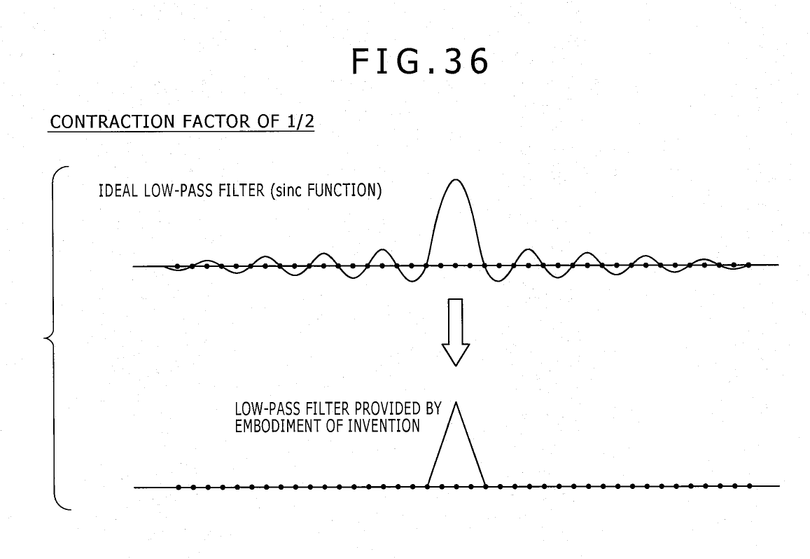

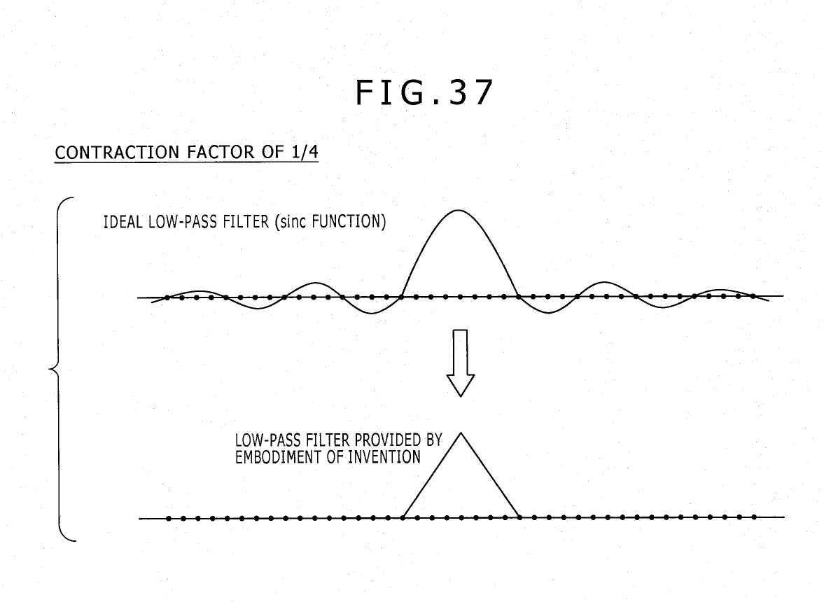

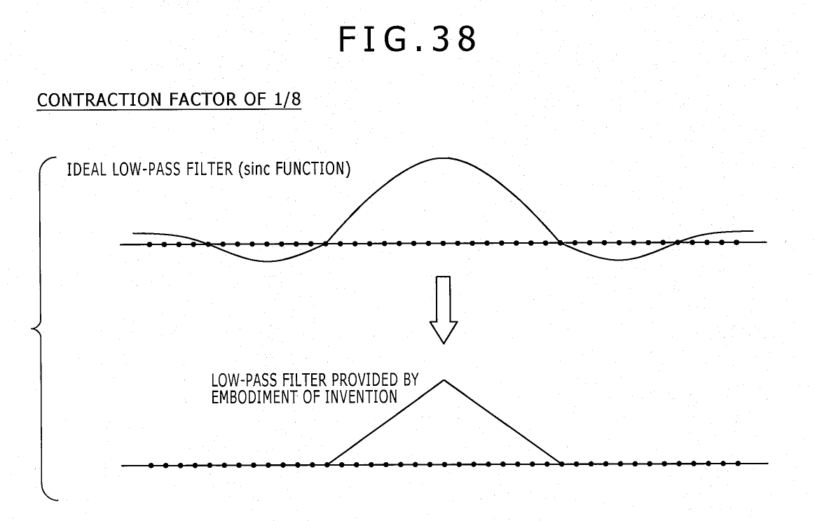

Diagrams on the upper side of FIGS. 36 to 38 show the shapes of the sinc function (or the ideal characteristic of a low-pass filter) for contraction factors of ½, ¼, and ⅛ respectively. It is obvious from FIGS. 36 to 38 that, the larger the contraction factor, the larger the factor at which the function is expanded in the tap-axis direction. In other words, even for a case in which the infinite-tap sinc function is approximated by principal coefficients, we can say that the number of taps of the FIR filter is increased.

In addition, it is known that, in general, the lower the cut-off frequency in the frequency band, the more predominant the number of taps in the performance of the low-pass filter in comparison with the dominance of the filter shape.

Thus, a movement-vector identification method using a shrunk image generated in accordance with the method in related art disclosed in Japanese Patent Laid-open No. 2005-38396 generally shows a contradiction that, in spite of the fact that, the larger the contraction factor of an image, the bigger the effect of reducing the size of the SAD table, we encounter the fact that the cost increases in proportional to the increase in contraction factor.

In general, in implementation of a high-order tap FIR filter, the cost of the processing logic increases in proportion to the square of the number of taps, raising a big problem. However, an even bigger problem is caused by an increased number of line memories used to realize a vertical filter. In digital still cameras manufactured in recent years, in order to reduce the size of the line memory to keep up with the increasing number of pixels, the so-called strap processing is carried out. However, even if the size per memory line is reduced for example, the number of line memories themselves increases, raising the total cost substantially if a physical layout area is translated into the cost.

As described above, the approach based on image contraction according to the method in related art disclosed in Japanese Patent Laid-open No. 2005-38396 is known to have a large barrier encountered particularly in implementation of a vertical low-pass filter. On the other hand, the image processing method according to the present embodiments has solved this problem effectively in a completely different way.

Diagrams on the lower side of FIGS. 36 to 38 each show an image of the low-pass filters according to the image-processing method provided by the embodiment. In accordance with the image-processing method provided by the embodiment of the present invention, the processing to shrink an image is not carried out. However, the process to generate a shrunk SAD table includes the processing of a low-pass filter, the image of which is shown in any of the figures.

As shown in the diagrams on the lower side of FIGS. 36 to 38, the characteristic of this low-pass filter is a simple filter characteristic in which the principal-coefficient portions of the sinc function can be approximated linearly, but the number of taps increases in a manner interlocked with the contraction factor. The simple filter characteristic and the increasing manner of the tap count are suitable for the fact that the lower the cut-off frequency, the more predominant the number of taps in the performance of the low-pass filter. That is to say, the process to find component SAD values (which are each a component SAD value) in accordance with the embodiment is equivalent to implementation of a low-pass filter exhibiting high performance in a manner interlocked with the contraction factor as a simple circuit. As described earlier, the process to find component SAD values is processing carried out in accordance with the embodiments as a process based on the linear weighted distribution technique to find component SAD values.

The simple circuit implementing a low-pass filter offers another merit in comparison with the method in related art disclosed in Japanese Patent Laid-open No. 2005-38396. That is to say, in accordance with the method in related art disclosed in Japanese Patent Laid-open No. 2005-38396, an image is shrunk in a sampling process after the image passes through a low-pass filter. In this shrinking process, much image information is lost. More specifically, in the processing carried out by the low-pass filter, the word length of the luminance value of the image information is rounded considerably before the image information is stored in a memory. Thus, most of low-order bits of the pixel information have no effect on the shrunk image.

In accordance with the image processing technique according to the embodiments, on the other hand, the luminance values of all pixels in the target block are used equally in a process to compute a final component SAD value stored in a shrunk SAD table as an element of the table. That is to say, the final component correlation is a cumulative sum of SAD values each found for one of the pixels in the target block. Thus, by merely increasing the word length of every element of the shrunk SAD table, it is possible to carry out such a SAD value computation process that even the eventually computed final SAD value does not include a rounding-process error at all. Since the size of the shrunk SAD table is small in comparison with the size of the frame memory, the extension of the word length of every element composing the shrunk SAD table does not raise a big problem. As a result, the shrunk SAD table and the processing to determine a movement vector can be implemented with a high degree of precision.

### EMBODIMENTS OF AN IMAGE PROCESSING APPARATUS

By referring to diagrams, the following description explains embodiments each implementing an image-pickup apparatus as an image processing apparatus adopting the image processing method.

### First Embodiment

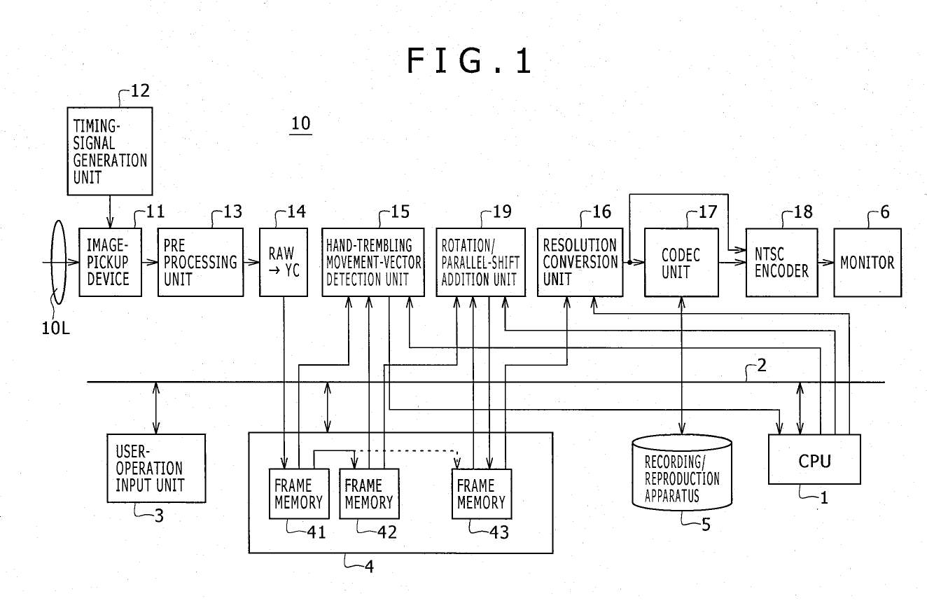

FIG. 1 is a block diagram showing a first embodiment implementing an image-pickup apparatus 10 as an image processing apparatus adopting the image processing method.

The first embodiment shown in FIG. 1 implements a system for compensating an image for effects caused by hand trembling. It is to be noted that the first embodiment is by no means limited to applications to still images, but the first embodiment can also be applied to moving pictures. In the case of a moving picture, however, there is an upper limit of the number of frames to be added to each other in order to generate an image exhibiting a real-time property. By adopting the technique according to the embodiment of the present invention, nevertheless, the first embodiment can also be applied to a system for generating a moving picture demonstrating a good effect of noise reduction by making use of exactly the same configuration units.

In the first embodiment, the input image frame lagging behind an original frame already stored in a frame memory as a target frame is taken as an observed frame whereas a movement vector representing a movement of the observed frame from the original frame is found. Then, in the first embodiment, a still image is compensated for effects caused by hand trembling by superposing a plurality of successive images taken consecutively in a photographing operation, for example, at a typical rate of 3 fps on each other.

As described above, in the first embodiment, a still image is compensated for effects caused by hand trembling by superposing a plurality of successive images taken consecutively in a photographing operation, for example, at a typical rate of 3 fps on each other. Thus, precision close to the precision of the pixel level is demanded. That is to say, the first embodiment finds the horizontal-direction and vertical-direction parallel-shift components of a hand-trembling movement vector representing a movement of the observed frame from the original frame as well as a rotation angle representing the angle of a rotation of the observed frame from the original frame at the same time as described before.

As shown in FIG. 1, the image-pickup apparatus 10 according to the embodiment includes a taken-image signal processing system, a CPU (Central Processing Unit) 1, a user-operation input unit 3, an image memory unit 4, and a recording/reproduction apparatus 5, which are connected to each other by a system bus 2. The taken-image signal processing system includes an image-pickup lens 10L, an image-pickup device 11, a timing-signal generation unit 12, a preprocessing unit 13, a data conversion unit 14, a hand-trembling movement-vector detection unit 15, a resolution conversion unit 16, a codec unit 17, an NTSC encoder 18, and a monitoring display unit 6. It is to be noted that the CPU 1 described in this patent specification includes a ROM (Read Only Memory) for storing various kinds of software to be executed by the CPU 1 as processing programs and a RAM (Random Access Memory) used by the CPU 1 as a work area.

Receiving an operation command entered by the user via the user-operation input unit 3 as a command to start an image-pickup and recording process, the image-pickup apparatus 10 shown in FIG. 1 carries out a process to record taken-image data to be described later. Receiving an operation command entered by the user via the user-operation input unit 3 as a command to start a process to reproduce recorded taken-image data, on the other hand, the image-pickup apparatus 10 shown in FIG. 1 carries out a process to reproduce the taken-image data recorded on a recording medium employed in the recording/reproduction apparatus 5.

As shown in FIG. 1, a light beam entering from an object of photographing by way of a camera optical system employing the image-pickup lens 10L is radiated to the image-pickup device 11 for carrying out an image-pickup process on the light beam. It is to be noted that the camera optical system itself is not shown in the figure. In this embodiment, the image-pickup device 11 is configured as a CCD (Charge Coupled Device) imager. It is to be noted the image-pickup device 11 can also be configured as a CMOS (Complementary Metal Oxide Semiconductor) imager.

In the image-pickup apparatus 10 according to this embodiment, when the user enters an operation command to the image-pickup apparatus 10 via the user-operation input unit 3 as a command to start an image-pickup and recording process, the image-pickup device 11 outputs a raw signal of a bayer array including the 3 primary colors, i.e., the red (R), green (G), and blue (B) colors. The raw signal, which is an analog taken-image signal, is a signal obtained as a result a sampling process according to a timing signal generated by the timing-signal generation unit 12. The image-pickup device 11 supplies the analog taken-image signal to the preprocessing unit 13 for carrying out preprocessing such as a defect compensation process and a γ compensation process. The data conversion unit 14 outputs a result of the preprocessing to the data conversion unit 14.

The data conversion unit 14 converts the analog taken-image signal supplied thereto into a digital taken-image signal (YC data) including a luminance signal component Y and chrominance signal component Cb/Cr, supplying the digital taken-image signal to the image memory unit 4 through the system bus 2.

In the embodiment shown in FIG. 1, the image memory unit 4 includes three frame memories 41, 42, and 43. First of all, the digital taken-image signal received from the data conversion unit 14 is stored in the frame memory 41. Then, after the lapse of time corresponding to one frame, the digital taken-image signal stored in the frame memory 41 is transferred to the frame memory 42 and a new digital taken-image signal received from the data conversion unit 14 is stored in the frame memory 41. Thus, a frame represented by the digital taken-image signal stored in the frame memory 42 is an immediately leading ahead of frame, which precedes a frame represented by the digital taken-image signal stored in the frame memory 41 by a time difference corresponding to one frame.

Then, the hand-trembling movement-vector detection unit 15 makes accesses to the two frame memories 41 and 42 through the system bus 2 in order to read out the digital taken-image signals from the frame memories 41 and 42. The hand-trembling movement-vector detection unit 15 then carries out processing such as a process to create 16 shrunk SAD tables for every observed frame, a process to detect an every-block movement vector for each of the SAD tables, a process to create a SAD total table, a process to generate a recreated SAD total table, a process to detect a global movement vector, which have been described before. In addition, the hand-trembling vector detection unit 15 carries out a process to compute parallel-shift quantities and a rotation angle for each of the observed frames as explained earlier.

In this movement-vector detection process, a frame represented by the digital taken-image signal stored in the frame memory 41 is taken as the observed frame while a frame represented by the digital taken-image signal stored in the frame memory 42 is taken as the original frame, which is also referred to as the target frame. It is to be noted that, in actuality, the frame memories 41 and 42 are a rotating double buffer.

The hand-trembling vector detection unit 15 employed in the first embodiment carries out a process to detect a movement vector by making use of a SAD total table found from shrunk SAD tables at two or more stages by reducing the size of the search range from stage to stage while changing the contraction factor if necessary as described earlier.

In particular, in a process to detect a hand-trembling vector for a still image and a process to compensate the still image for effects caused by hand trembling, there are few real-time restrictions imposed on the number of pixels and the number of pixels can thus be set at a large value. However, a high-precision movement vector needs to be detected. Thus, a process carried out at a plurality of stages set in a hierarchical order to detect a movement vector is extremely effective.

The image memory unit 4 employed in the first embodiment includes a frame memory 43 for storing a result of superposing a plurality of observed frames after being rotated and moved in a parallel shift. As described earlier, the process to superpose observed frames on each other is carried out by taking one of the frames as a reference, which is shown as the image frame 120 in FIG. 3. In the following description, the first observed frame is taken as the reference.

The image data of the first observed frame is also stored in the frame memory 43 as shown by a dashed arrow in FIG. 1. After the second observed frame has been superposed on the first observed frame after being rotated and moved in a parallel shift, the frame memory 43 is also used for storing the image data of a post-addition frame obtained as a result of superposing a plurality of frames after being rotated and moved in a parallel shift.

The image data of each of the second and subsequent observed frames is stored in the frame memory 41 before being usually subjected to a process carried out by the hand-trembling vector detection unit 15 to detect a hand-trembling vector representing a movement relative to the immediately leading ahead of observed frame with its image data stored in the frame memory 42. Thus, in order to compute the amount of hand trembling relative to the first observed frame serving as the reference, the hand-trembling vectors detected so far for every two consecutive observed frames are integrated in a cumulative addition. In addition, the hand-trembling vector detection unit 15 also detects a rotation angle representing a rotation of each of the second and subsequent observed frames from the first observed frame serving as the reference.

The hand-trembling vector detection unit 15 supplies the detected hand-trembling vector representing a movement of each of the second and subsequent observed frames from the first observed frame serving as the reference and the detected rotation angle representing a rotation of each of the second and subsequent observed frames from the first observed frame to the CPU 1.

Then, the CPU 1 controls the rotation/parallel-shift addition unit 19 to read out the image data of each of the second and subsequent observed frames from the frame memory 42 in such a way that its computed hand-trembling components (or parallel-shift quantity components) relative to the first observed frame serving as the reference are eliminated. That is to say, the rotation/parallel-shift addition unit 19 receives the image data from the frame memory 42 with the parallel-shift quantities removed due to a cut-out operation carried out in accordance with the relative hand-trembling components.

In accordance with a control signal output by the CPU 1, the rotation/parallel-shift addition unit 19 rotates each individual one of the second and subsequent observed frames read out from the frame memory 42 in accordance with the angle of rotation of the individual observed frame from the first observed frame serving as the reference, and adds or averages the rotated observed frame to the first observed frame or a post-addition frame read out from the frame memory 43 as a previous result of superposing a plurality of frames. A frame resulting from the addition or the averaging process is then stored back in the frame memory 43 as a new post-addition frame.

Then, in accordance with a control signal output by the CPU 1, the data of the image frame stored in the frame memory 43 is cut out into a frame with a resolution determined in advance and a size also determined in advance and the resulting frame is supplied to the resolution conversion unit 16. In other words, the resolution conversion unit 16 generates data of the frame with the predetermined resolution and the predetermined size in accordance with a control command issued in control executed by the CPU 1.

Image data output by the resolution conversion unit 16 as data free of effects caused by hand trembling is supplied to the NTSC (National Television System Committee) encoder 18 for converting the data into a standard color video signal conforming to the NTSC system. The standard color video signal is then supplied to the monitor display 6 serving as an electronic view finder for showing the image being taken in the photographing operation on a display screen for a monitoring purpose.

While the image being taken in the photographing operation is being displayed on the display screen for a monitoring purpose, the image data output by the resolution conversion unit 16 as data free of effects caused by hand trembling is also output to the codec unit 17 for carrying out a coding process such as recording/modulation processing. The codec unit 17 then supplies image data obtained as a result of the coding process to the recording/reproduction apparatus 5 for recording the image data onto a recording medium. Examples of the recording medium are an optical disc such as a DVD (Digital Versatile Disc) and a hard disc.

When the user enters an operation command to the image-pickup apparatus 10 via the user-operation input unit 3 as a command to start a process to reproduce recorded taken-image data, the data is reproduced from the recording medium of the recording/reproduction apparatus 5 and supplied to the codec unit 17. This time, the codec unit 17 carries out a decoding/reproduction process on the taken-image data. The codec unit 17 then supplies image data obtained as a result of the decoding/reproduction process to the monitoring display unit 6 by way of the NTSC encoder 18 for displaying the reproduced image on the display screen. It is to be noted that the NTSC encoder 18 is also capable of supplying a video signal output thereby to an external signal recipient by way of a video output terminal even though this feature is not shown in FIG. 1.

The hand-trembling movement-vector detection unit 15 can be implemented as hardware or a DSP (Digital Signal Processor). As an alternative, the hand-trembling movement-vector detection unit 15 can also implemented as software executed by the CPU 1. As another alternative, the hand-trembling movement-vector detection unit 15 can also implemented as a combination of hardware or a DSP and software executed by the CPU 1.

It is possible to provide a configuration in which the hand-trembling vector detection unit 15 carries out processing to detect relative every-block movement vectors and a global movement vector between frames. The CPU 1 computes a global movement vector with relatively high precision, parallel-shift quantities, and an angle of rotation or performs processing to compute parallel-shift quantities representing a movement of the current observed frame from the first observed frame serving as a reference and the angle of a rotation from the reference.

It is to be noted that, as will be described later, the embodiment is capable of executing three methods of processing to add frames to each other, i.e., a simple frame addition method, an averaging frame addition method, and a tournament frame addition method. In addition, the user-operation input unit 3 includes a selection-specifying operation section to be operated by the user to specify one of the three methods of processing to add frames to each other as a method to be executed by the rotation/parallel-shift addition unit 19. When the user specifies one of the three methods of processing to add frames to each other, the CPU 1 supplies a selection control signal according to the selection entered by the user through the selection-specifying operation section to the rotation/parallel-shift addition unit 19. Receiving the signal, the rotation/parallel-shift addition unit 19 executes a method selected by the user as of one the three methods of processing to add frames to each other. It is to be noted that the selection-specifying operation section itself is not shown in FIG. 1.

[Operations of the Hand-Trembling Movement-Vector Detection Unit 15]

[First Typical Implementation]

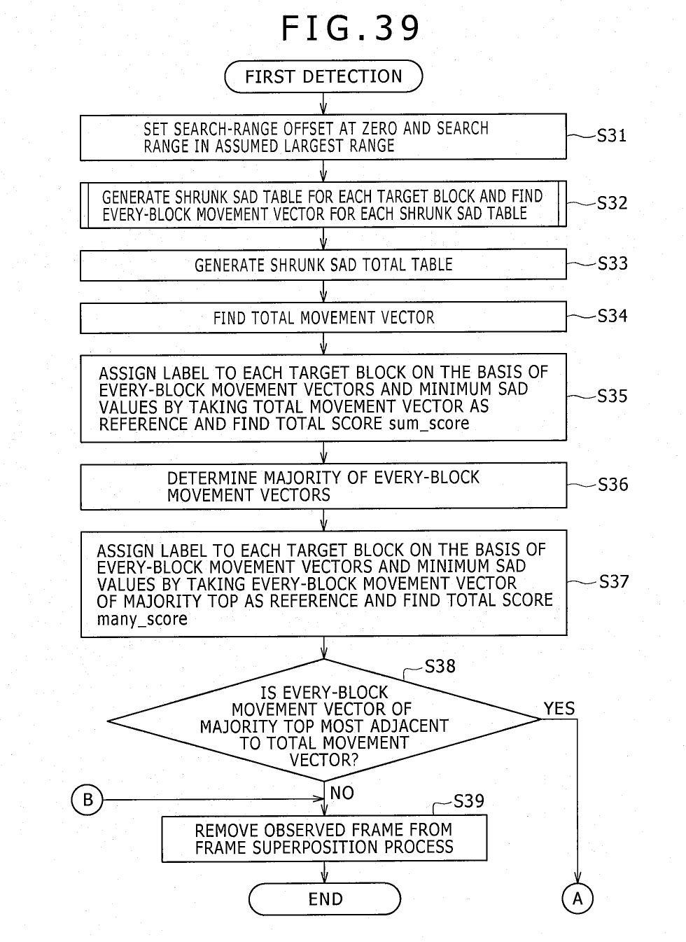

The processing flow of a first typical implementation realizing operations of the hand-trembling movement-vector detection unit 15 is explained below with reference to flowcharts shown in FIGS. 39 to 42. In the first typical implementation, parallel-shift quantities and rotation angle of an observed frame are computed from a global movement vector detected for the observed frame.

It is to be noted that the processing represented by the flowcharts shown in FIGS. 39 to 42 is carried out for an observed frame. Thus, for a plurality of observed frames, the processing represented by the flowcharts shown in FIGS. 39 to 42 is carried out repeatedly. For a plurality of observed frames, however, the process to set a search range is carried out at a step S31 once for the first observed frame. Since the search range can be used in the second and subsequent observed frames, the step S31 can be skipped when carrying out the processing for the second and subsequent observed frames.

First of all, first detection processing is explained. The flowchart shown in FIG. 39 begins with a step S31 at which a search range is set in an observed-frame area assumed to be a largest area in the embodiment for each target block in the same way as the typical processing explained earlier by referring to FIG. 35, and the offset of the search range is set at zero. In the typical processing shown in FIG. 35, 16 search ranges are set for 16 target blocks respectively in such a way that the center of each individual one of the search ranges coincides with the center of a target block associated with the individual search range, to give a search-range offset of zero as shown in FIG. 15A.

Then, at the next step S32, processing is carried out to generate 16 shrunk SAD tables for the 16 target blocks respectively or the 16 search ranges respectively and search each of the shrunk SAD tables for an every-block movement vector. Details of the processing carried out at the step S32 are described later.

After the processing carried out at the step S32 to generate the 16 shrunk SAD tables for the 16 target blocks respectively is completed, the flow of the first detection processing goes on to a step S33 at which a shrunk SAD total table is created from the 16 shrunk SAD tables as a table having the same size and the same number of table elements as each of the shrunk SAD tables. The number of elements in each of the shrunk SAD tables is the same as the number of observed blocks in each of the search ranges. Computed in accordance with Eq. (3) shown in FIG. 4, each individual one of the elements of the shrunk SAD total table is thus a SAD total value representing a sum of 16 SAD values stored in 16 specific elements included in the 16 shrunk SAD tables respectively. The 16 specific elements of the 16 shrunk SAD tables correspond to an observed block associated with the individual element of the shrunk SAD total table.

Then, at the next step S34, a minimum SAD total value is identified from the shrunk SAD total table created in the process carried out at the step S33. Then, a total movement vector is detected by carrying out an interpolation process based on an approximation surface representing the minimum SAD total value and a plurality of neighbor SAD total values each located in a table element in close proximity to the table element for storing the minimum SAD total value.

Then, at the next step S35, a label and a score are given to each target block, each every-block movement vector or each shrunk SAD table. To put it in detail, the conditions shown in FIG. 13 are tested on the basis of the 16 every-block movement vectors, the minimum SAD values of the 16 shrunk SAD tables, and the minimum SAD total value of the shrunk SAD total table. The total movement vector detected in the process carried out at the step S34 is taken as a reference in order to give the TOP, NEXT_TOP NEAR_TOP, and OTHERS labels described before and scores to the 16 target blocks, the 16 every-block movement vectors, or the 16 shrunk SAD tables. Then, a score sum sum_score for the observed frame is found. Subsequently, results of the process to assign a label to each target block and the score sum sum_score for the observed frame are saved in a memory. In this case, a mask flag of every target block to which the NEAR_TOP or OTHERS label has been assigned is set to indicate that the every-block movement vector detected for the target block is a low-reliability vector. Hence, the low-reliability every-block movement vector as well as a target block and a shrunk SAD table, which are associated with such a vector, are not to be used in subsequent processing.

Then, at the next step S36, a largest majority of the 16 every-block movement vectors detected in the process carried out at the step S32 is determined. Also referred to as a majority top, a largest majority of the 16 every-block movement vectors is a largest group of every-block movement vectors having the same or similar magnitude or the same or similar direction. Subsequently, at the next step S37, the conditions shown in FIG. 13 are tested by taking the every-block movement vector of the largest majority as a substitute for the total movement vector. The conditions are tested on the basis of the 16 every-block movement vectors, the minimum SAD values of the 16 shrunk SAD tables, and the minimum SAD value associated with the every-block movement vector of the largest majority by taking the vector as a reference in order to give the TOP, NEXT_TOP NEAR_TOP, and OTHERS labels described before and scores to the 16 target blocks, the 16 every-block movement vectors, or the 16 shrunk SAD tables. Then, a score total many_score for the observed frame is found. Subsequently, results of the process to assign a label to each target block and the score total many_score for the observed frame are saved in the memory.

Then, at the next step S38, the total movement vector detected in the process carried out at the step S34 is compared with the every-block movement vector of the largest majority determined in the process carried out at the step S36. The result is determined as to whether or not an element included in a shrunk SAD table for storing a minimum SAD value associated with the every-block movement vector of the largest majority is most adjacent to or separated away from an element included in a shrunk SAD total table for storing the minimum SAD total value associated with the total movement vector in the vertical, horizontal, or inclined direction by a distance equal to one coordinate unit.

If the determination result at the step S38 indicates that the table element associated with the every-block movement vector of the largest majority is not most adjacent to the table element associated with the total movement vector, the flow of the first detection processing goes on to a step S39. The observed frame is removed from the frame superposition process to compensate the still image for effects caused by hand trembling. Then, the execution of detection processing is ended without carrying out remaining processes. This is because the every-block movement vectors detected for this observed screen are determined to be unreliable vectors.

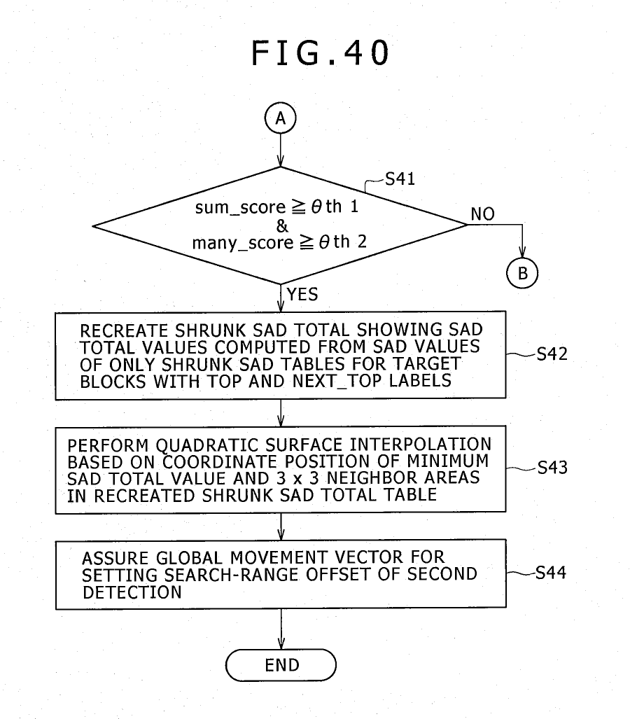

If the determination result at the step S38 indicates that the table element associated with the every-block movement vector of the largest majority is most adjacent to the table element associated with the total movement vector, on the other hand, the flow of the first detection processing goes on to a step S41 of a continuation flowchart shown in FIG. 40. The result of determination is produced as to whether or not the score sum sum_score found in the process carried out at the step S35 is at least equal to a threshold value θth1 determined in advance and the score total many_score found in the process carried out at the step S37 is at least equal to a threshold value θth2 also determined in advance.

If the determination result at the step S41 indicates that the score sum sum_score is smaller than the threshold value θth1 and/or the score total many_score is smaller than the threshold value θth2, the flow of the first detection processing goes back to the step S39. The observed frame is removed from the frame superposition process to compensate the still image for effects caused by hand trembling and, then, the execution of detection processing is ended without carrying out remaining processes.

If the determination result at the step S41 indicates that the score sum sum_score is at least equal to the threshold value θth1 and the score total many_score is at least equal to the threshold value θth2, on the other hand, the flow of the first detection processing goes on to a step S42. A shrunk SAD total table is recreated as a table showing SAD total values computed from SAD values of shrunk SAD tables created for target blocks with TOP and NEXT_TOP labels assigned thereto in the process carried out at the step S35.

Then, at the next step S43, an interpolation process is carried out on the basis of a curved surface approximating the minimum SAD total value and SAD total values at a plurality of neighbor coordinate positions in close proximity to the coordinate position of the minimum SAD total value in the recreated shrunk SAD total table. The interpolation process carried out at this step is the interpolation process explained earlier by referring to FIGS. 23A and 23B as a process based on a curved surface approximating the minimum SAD total value and SAD total values stored in 3×3 table elements forming a rectangular area.

Then, at the next step S44, a detected movement vector obtained as a result of the interpolation process carried out on the basis of the curved surface is saved as a global movement vector to be used for setting an offset of the search range in second detection processing.

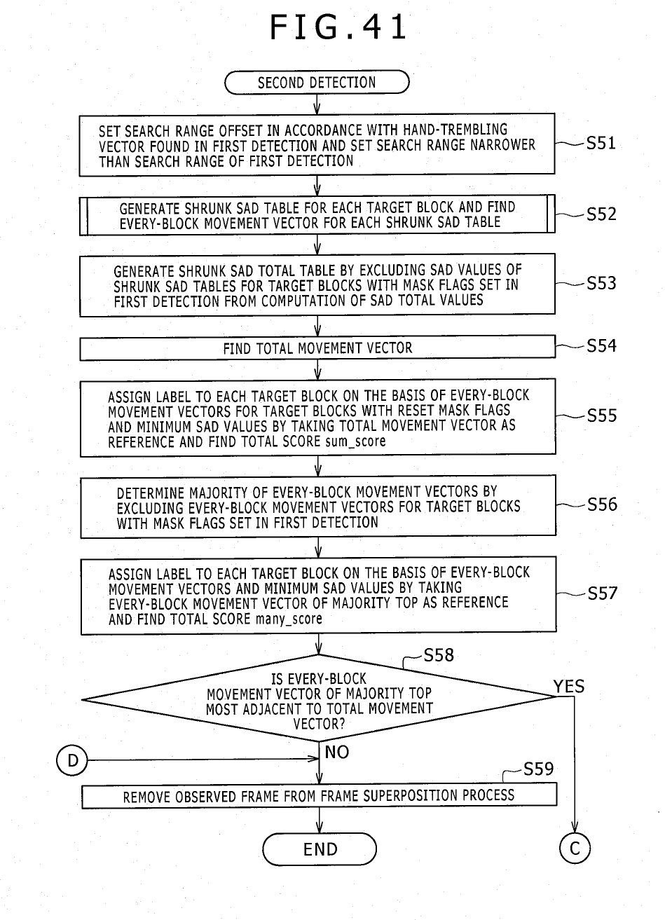

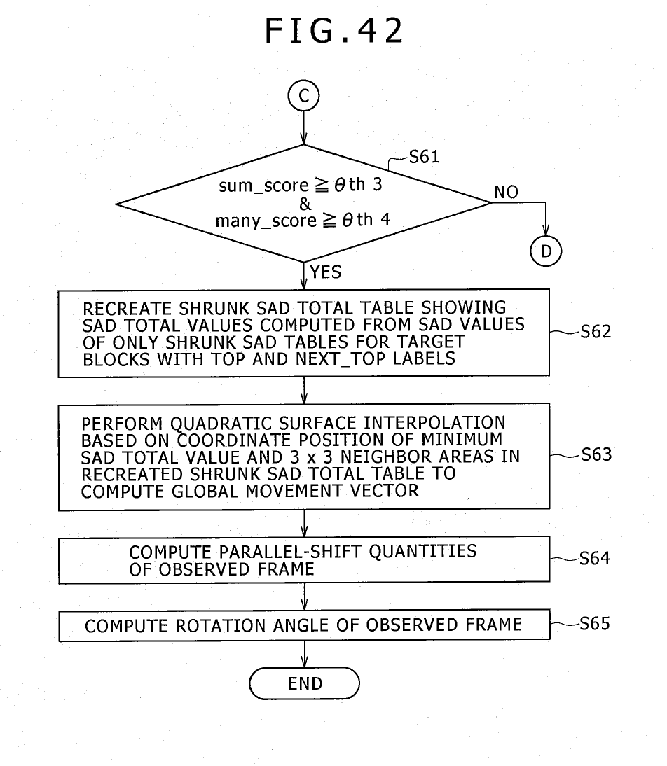

Subsequently, the hand-trembling vector detection unit 15 carries out the second detection processing represented by a flowchart shown in FIGS. 41 and 42 as the continuation of the first detection processing described above.

As shown in FIG. 41, the flowchart begins with a step S51 at which a search range is set in an observed-frame area narrower than the observed-frame area used in the first detection processing, and the offset of the search range is set at value corresponding to the global movement vector saved in the process carried out at the step S39 of the first detection processing explained above. To put in detail, 16 search ranges are set for 16 target blocks respectively in such a way that the center of each individual one of the search ranges is separated away from the center of a target block associated with the individual search range by a search-range offset determined by parallel-shift quantities indicated by the global movement vector as shown in FIG. 15B.

Then, at the next step S52, processing is carried out to generate 16 shrunk SAD tables for the 16 target blocks respectively or the 16 search ranges respectively and search each of the shrunk SAD tables for an every-block movement vector.

After the processing carried out at the step S52 to generate the shrunk SAD tables each associated with one of the target blocks is completed, the flow of the second detection processing goes on to a step S53. A shrunk SAD total table is created from the shrunk SAD tables as a table having the same size and the same number of table elements as each of the shrunk SAD tables. The number of elements in each of the shrunk SAD tables is the same as the number of observed blocks in each of the search ranges. In this case, however, the shrunk SAD tables used for creating the shrunk SAD total table are particular shrunk SAD tables each created for a target block having a TOP or NEXT_TOP label. That is to say, the shrunk SAD tables used for creating the shrunk SAD total table exclude shrunk SAD tables each created for a target block having its mask flag set in the first detection processing. Computed in accordance with Eq. (3) shown in FIG. 4, each individual one of the elements of the shrunk SAD total table is thus a SAD total value representing a sum of SAD values each stored in a specific element of each of the particular shrunk SAD tables. The specific element of each of the particular shrunk SAD tables corresponds to an observed block associated with the individual element of the shrunk SAD total table. It is to be noted that it is possible to provide a configuration that, in the process carried out at the step S52, shrunk SAD tables are created for target blocks each having a TOP or NEXT_TOP label. That is to say, it is possible to provide a configuration that, in the process carried out at the step S52, shrunk SAD tables are created for target blocks except target blocks each having its mask flag set in the first detection processing.

Then, at the next step S54, a minimum SAD total value is identified from the shrunk SAD total table created in the process carried out at the step S53. Subsequently, a total movement vector of the precision of the fraction level is detected by carrying out an interpolation process based on an approximation surface representing the minimum SAD total value and a plurality of neighbor SAD total values each located in a table element in close proximity to the table element for storing the minimum SAD total value.

Then, at the next step S55, a label and a score are given to each of the particular target blocks, each of the particular every-block movement vectors or each of the particular shrunk SAD tables. To put it in detail, the conditions shown in FIG. 13 are tested on the basis of the particular every-block movement vectors and the minimum SAD values of the shrunk SAD tables each created for a particular target block having its mask flag not set in the first detection processing. The total movement vector detected in the process carried out at the step S54 is taken as a reference. Labels and scores are given to the TOP, NEXT_TOP NEAR_TOP, and OTHERS described before. Then, a score sum sum_score for the observed frame is found. Subsequently, results of the process to assign a label to each target block and the score sum sum_score for the observed frame are saved in the memory. In this case, a mask flag of every particular target block to which the NEAR_TOP or OTHERS label has been assigned is further set to indicate that the particular every-block movement vector detected for the particular target block is a low-reliability vector. The low-reliability particular every-block movement vector as well as a target block and a shrunk SAD table, which are associated with such a vector, are not to be used in subsequent processing.

Then, at the next step S56, a largest majority of the particular every-block movement vectors detected in the process carried out at the step S52 is determined. As obvious from the above description, a particular every-block movement vector is an every-block movement vector detected for a target block with its mask flag not set in the first detection processing. Also referred to as a majority top, a largest majority of the particular every-block movement vectors is a largest group of particular every-block movement vectors having the same or similar magnitude or the same or similar direction. Subsequently, at the next step S57, the conditions shown in FIG. 13 are tested by taking the particular every-block movement vector of the largest majority as a substitute for the total movement vector. To put it in detail, the conditions shown in FIG. 13 are tested on the basis of the particular every-block movement vectors, the minimum SAD values of the particular shrunk SAD tables and the minimum SAD value associated with the particular every-block movement vector of the largest majority. The particular every-block movement vector of the largest majority is taken as a reference in order to give the TOP, NEXT_TOP NEAR_TOP, and OTHERS labels described before and scores to the particular target blocks, the particular every-block movement vectors, or the particular shrunk SAD tables. Then, a score total many_score for the observed frame is found. Subsequently, results of the process to assign a label to each target block and the score total many_score for the observed frame are saved in the memory.

Then, at the next step S58, the total movement vector detected in the process carried out at the step S54 is compared with the every-block movement vector of the largest majority determined in the process carried out at the step S56. The result of determination is produced as to whether or not an element included in a shrunk SAD table as the table element associated with the every-block movement vector of the largest majority is most adjacent to or separated away from an element included in a shrunk SAD total table as the table element associated with the total movement vector in the vertical, horizontal, or inclined direction by a distance equal to one coordinate unit.

If the determination result at the step S58 indicates that the table element associated with the every-block movement vector of the largest majority is not most adjacent to the table element associated with the total movement vector, the flow of the second detection processing goes on to a step S59. The observed frame is removed from the frame superposition process to compensate the still image for effects caused by hand trembling. Then, the execution of detection processing is ended without carrying out remaining processes. This is because the every-block movement vectors detected for this observed screen are determined to be unreliable vectors.

If the determination result at the step S58 indicates that the table element associated with the every-block movement vector of the largest majority is most adjacent to the table element associated with the total movement vector, on the other hand, the flow of the second detection processing goes on to a step S61 of a continuation flowchart shown in FIG. 42. The result of determination is produced as to whether or not the score sum sum_score found in the process carried out at the step S55 is at least equal to a threshold value θth3 determined in advance and the score total many_score found in the process carried out at the step S57 is at least equal to a threshold value θth4 also determined in advance.

If the determination result at the step S61 indicates that the score sum sum_score is smaller than the threshold value θth3 and/or the score total many_score is smaller than the threshold value θth4, the flow of the second detection processing goes back to the step S59. The observed frame is removed from the frame superposition process to compensate the still image for effects caused by hand trembling and, then, the execution of detection processing is ended without carrying out remaining processes.

If the determination result at the step S61 indicates that the score sum sum_score is at least equal to the threshold value θth3 and the score total many_score is at least equal to the threshold value θth4, on the other hand, the flow of the second detection processing goes on to a step S62. A shrunk SAD total table is recreated as a table showing SAD total values computed from SAD values of shrunk SAD tables created for target blocks with TOP and NEXT_TOP labels assigned thereto in the process carried out at the step S55.

Then, at the next step S63, an interpolation process is carried out on the basis of a curved surface approximating the minimum SAD total value and SAD total values at a plurality of neighbor coordinate positions in close proximity to the coordinate position of the minimum SAD total value in the recreated shrunk SAD total table. The interpolation process carried out at this step is the interpolation process explained earlier with reference to FIGS. 23A and 23B as a process based on a curved surface approximating the minimum SAD total value and SAD total values stored in 3×3 table elements forming a rectangular area.

Then, at the next step S64, from a detected movement vector, the hand-trembling vector detection unit 15 computes parallel-shift quantities representing a movement of the observed frame of the still image from the immediately leading ahead of frame and cumulatively adds the computed parallel-shift quantities to previously computed parallel-shift quantities in order to find parallel-shift quantities for the observed frame.

Subsequently, at the next step S65, the hand-trembling vector detection unit 15 takes an angle formed by a total movement vector detected at the step S63 and a total movement vector detected and saved for the immediately leading ahead of observed frame in the same way as the total movement vector detected for the current observed frame as an angle of rotation of the current observed frame of the still image from the immediately leading ahead of observed frame. The hand-trembling vector detection unit 15 cumulatively adds the computed angle of rotation to a previously computed angle of rotation in order to find a rotation angle for the observed frame.

Finally, the hand-trembling vector detection unit 15 ends the execution of the processing described above to compute parallel-shift quantities and a rotation angle, which are caused by hand trembling, for an observed frame, supplying the parallel-shift quantities and rotation angle obtained as a result of the computation processing to the CPU 1. The parallel-shift quantities and rotation angle obtained as a result of the computation processing are used in the rotation/parallel-shift addition unit 19 to carry out processing to superpose the current observed frame on the first observed frame.

In the processes carried out at the steps S64 and S65 described above, the hand-trembling vector detection unit 15 computes parallel-shift quantities representing a movement of the current observed frame from the first observed frame and the angle of a rotation of the current observed frame from the first observed frame. It is to be noted, however, that in the processes carried out at the steps S64 and S65, as an alternative, the hand-trembling vector detection unit 15 may cumulatively computes parallel-shift quantities and the angle of a rotation of the current observed frame from the immediately leading ahead of observed frame. The CPU 1 computes parallel-shift quantities and an angle of a rotation of the current observed frame.

The hand-trembling vector detection unit 15 carries out the processing to compute parallel-shift quantities and a rotation angle, which are caused by hand trembling, for an observed frame as described above.

It is to be noted that, as another alternative, the processes of the steps S31 to S34 of the flowchart shown in FIGS. 39 and 40 as well as the processes of the steps S51 to S54 of the flowchart shown in FIGS. 41 and 42 are carried out by the hand-trembling vector detection unit 15 whereas the remaining process are carried out by the CPU 1 by execution of software.

In addition, in the process to detect a global movement vector serving as a hand-trembling vector, the technique described above to save the global technique can also be adopted in conjunction with the technique in related art for predicting a global movement vector from the frequency of changes occurring along the time axis as changes in movement vector in order to further improve the reliability and the precision.

In the process carried out at the step S42 of the typical processing described above, a shrunk SAD total table is recreated as a table showing SAD total values computed from SAD values of shrunk SAD tables created for target blocks with TOP and NEXT_TOP labels assigned in the process carried out at the step S35. By the same token, in the process carried out at the step S62 of the typical processing described above, a shrunk SAD total table is recreated as a table showing SAD total values computed from SAD values of shrunk SAD tables created for target blocks with TOP and NEXT_TOP labels assigned in the process carried out at the step S55. However, it is also possible to provide a configuration in which, a shrunk SAD total table is recreated in the process carried out at the step S42 as a table showing SAD total values computed from SAD values of shrunk SAD tables created for target blocks with TOP and NEXT_TOP labels assigned in the process carried out at the step S37. In the process carried out at the step S62 of the typical processing described above, a shrunk SAD total table is recreated as a table showing SAD total values computed from SAD values of shrunk SAD tables created for target blocks with TOP and NEXT_TOP labels assigned in the process carried out at the step S57. As another alternative, it is also possible to provide a configuration in which, a shrunk SAD total table is recreated in the process carried out at the step S42 as a table showing SAD total values computed from SAD values of shrunk SAD tables created for target blocks with TOP and NEXT_TOP labels assigned in the process carried out at the step S35 or S37. In the process carried out at the step S62 of the typical processing described above, a shrunk SAD total table is recreated as a table showing SAD total values computed from SAD values of shrunk SAD tables created for target blocks with TOP and NEXT_TOP labels assigned in the process carried out at the step S55 or S57.

In addition, in the processing described above, the score sum sum_score and the score total many_score, which are computed for labels assigned to every-block movement vectors, are each used as an indicator for evaluating a global movement vector detected for an observed frame. Instead of making use of the score sum sum_score and the score total many_score, however, the number of every-block movement vectors each having the TOP label and the number of every-block movement vectors each having the NEXT_TOP label are each used as an indicator for evaluating a global movement vector detected for an observed frame and compared with their respective threshold values determined in advance. To be more specific, if the number of every-block movement vectors each having the TOP label and the number of every-block movement vectors each having the NEXT_TOP label are greater than their respective threshold values, the global movement vector detected for an observed frame is determined to be a vector entitled to high evaluation.

[Second Typical Implementation]

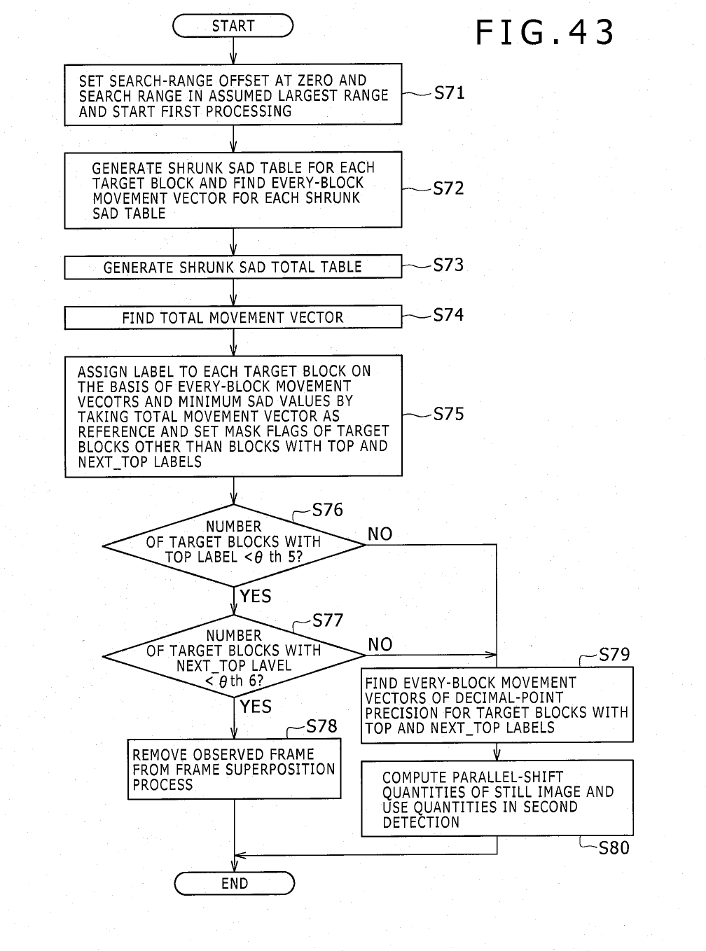

The processing flow of a second typical implementation realizing operations of the hand-trembling movement-vector detection unit 15 is explained below by referring to flowcharts shown in FIGS. 43 to 45. In the second typical implementation, parallel-shift quantities and an angle of rotation are computed for an observed frame by adoption of a technique like the one described earlier by referring to FIGS. 5 to 8E on the basis of every-block movement vectors detected for high-reliability target blocks selected from all target blocks associated with the observed frame.

It is to be noted that the processing represented by the flowcharts shown in FIGS. 43 to 45 is also carried out for an observed frame. Thus, for a plurality of observed frames, the processing represented by the flowcharts shown in FIGS. 43 to 45 has to be carried out repeatedly. For a plurality of observed frames, however, the process to set a search range is carried out at a step S71 once for the first observed frame. Since the search range can be used in the second and subsequent observed frames, the step S71 can be skipped when carrying out the processing for the second and subsequent observed frames.

First of all, the first detection processing is explained. The flowchart shown in FIG. 43 begins with a step S71 at which a search range is set in an observed-frame area assumed to be a largest area in the embodiment for each target block in the same way as the typical processing explained earlier by referring to FIG. 35, and the offset of the search range is set to zero. In the typical processing shown in FIG. 35, 16 search ranges are set for 16 target blocks respectively in such a way that the center of each individual one of the search ranges coincides with the center of a target block associated with the individual search range, to give a search-range offset of zero as shown in FIG. 15A.

Then, at the next step S72, processing is carried out to generate 16 shrunk SAD tables for the 16 target blocks respectively or the 16 search ranges respectively and search each of the shrunk SAD tables for an every-block movement vector. Details of the processing carried out at the step S72 are described later.

After generation of the 16 shrunk SAD tables for the 16 target blocks respectively is completed, the processing goes on to a step S73 at which a shrunk SAD total table is created from the 16 shrunk SAD tables as a table having the same size and the same number of table elements as each of the shrunk SAD tables. The number of elements in each of the shrunk SAD tables is the same as the number of observed blocks in each of the search ranges. Computed in accordance with Eq. (3) shown in FIG. 4, each individual one of the elements of the shrunk SAD total table is thus a SAD total value representing a sum of 16 SAD values stored in 16 specific elements included in the 16 shrunk SAD tables respectively. The 16 specific elements of the 16 shrunk SAD tables correspond to an observed block associated with the individual element of the shrunk SAD total table.

Then, at the next step S74, a minimum SAD total value is detected from the shrunk SAD total table. Subsequently, a total movement vector is detected by carrying out an interpolation process based on an approximation surface representing the minimum SAD total value and a plurality of neighbor SAD total values each located in a table element in close proximity to the table element for storing the minimum SAD total value.

Then, at the next step S75, a label is assigned to each target block, each every-block movement vector or each shrunk SAD table. To put it in detail, the conditions shown in FIG. 13 are tested on the basis of the 16 every-block movement vectors, the minimum SAD values of the 16 shrunk SAD tables and the minimum SAD total value of the shrunk SAD total table by taking the total movement vector detected in the process carried out at the step S74 as a reference in order to assign the TOP, NEXT_TOP NEAR_TOP and OTHERS labels described before to the 16 target blocks, the 16 every-block movement vectors or the 16 shrunk SAD tables. In this case, a mask flag of every target block to which the NEAR_TOP or OTHERS label has been assigned is set to indicate that the every-block movement vector detected for the target block is a low-reliability vector and, hence, the low-reliability every-block movement vector as well as a target block and a shrunk SAD table, which are associated with such a vector, are not to be used in subsequent processing.

Then, the flow of the first detection processing goes on to a step S76 to produce a result of determination as to whether or not the number of target blocks each having the TOP label assigned thereto in the process carried out at the step S75 is smaller than a threshold value θth5 determined in advance. If the result of the determination indicates that the number of target blocks each having the TOP label is smaller than the threshold value θth5, determination is made as to whether or not the number of target blocks each having the NEXT_TOP label assigned thereto is smaller than a threshold value θth6 determined in advance at the step S77.

If the determination result at the step S77 indicates that the number of target blocks each having the NEXT_TOP label is smaller than the threshold value θth6, the observed frame is removed from the frame superposition process to compensate the still image for effects caused by hand trembling at a step S78. Then, the execution of detection processing is ended without carrying out remaining processes.

If the determination result at the step S76 indicates that the number of target blocks each having the TOP label is not smaller than the threshold value θth5 or at the step S77 indicates that the number of target blocks each having the NEXT_TOP label is at least equal to the threshold value θth6, every-block movement vectors of high precision (or precision of the fraction level) are found at a step S79 for shrunk SAD tables each associated with a target block having the TOP or NEXT_TOP label or a reset mask flag by carrying out the interpolation processing explained earlier by referring to FIGS. 20, 23A and 23B, 26A, and 26B, and 30A and 30B as interpolation processing based on curved-surface approximation.

Then, at the next step S80, by carrying out a process explained earlier by referring to FIGS. 5 and 6, the hand-trembling vector detection unit 15 computes parallel-shift quantities representing a movement of the observed frame from the immediately leading ahead of frame by making use of the high-reliability every-block movement vectors detected at the step S79. The computed parallel-shift quantities correspond to the global movement vector detected in the first typical implementation. Thus, the computed parallel-shift quantities are used in a process to set an offset of the search range in the second detection processing. After the step S78 or S80, the execution of the first detection processing is ended.

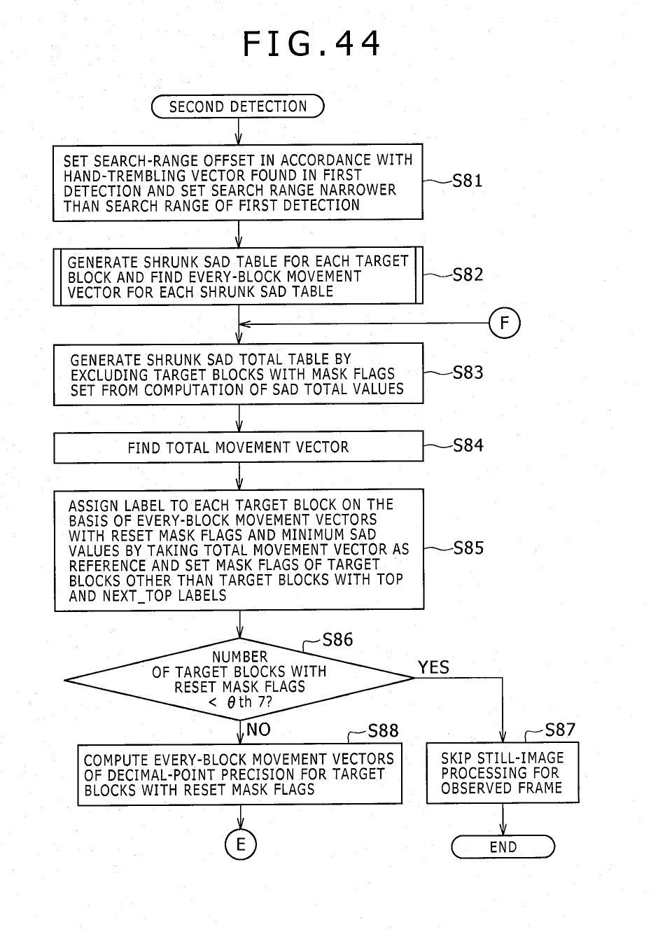

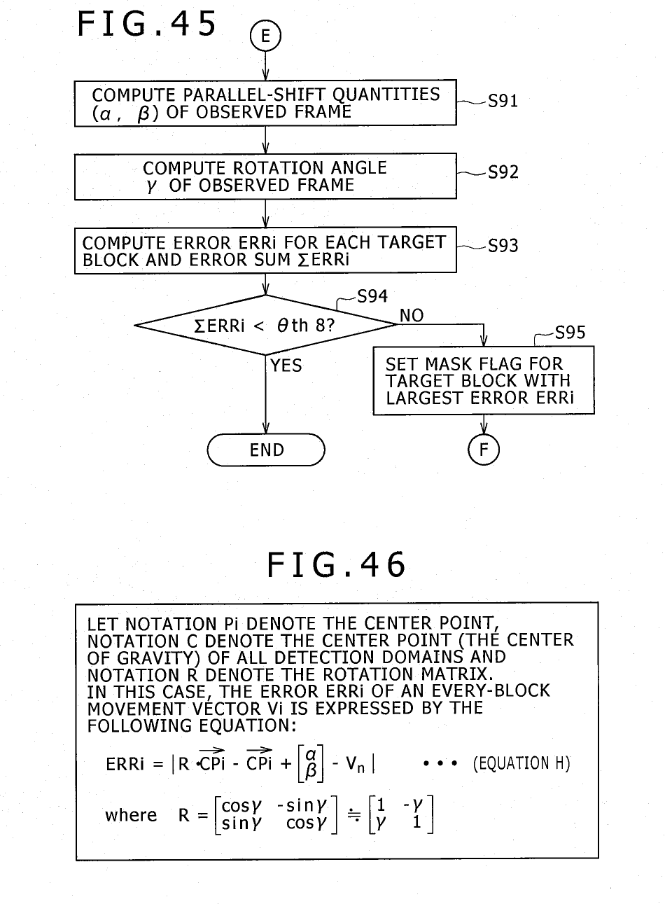

Then, the hand-trembling vector detection unit 15 carries out the second detection processing represented by a flowchart shown in FIGS. 44 and 45 as the continuation of the first detection processing described above.

As shown in FIG. 44, the flowchart begins with a step S81 at which a search range is set in an observed-frame area narrower than the observed-frame area used in the first detection processing, and the offset of the search range is set at value represented by the parallel-shift quantities saved at the step S80 of the first detection processing explained above. To put in detail, 16 search ranges are set for 16 target blocks respectively in such a way that the center of each individual one of the search ranges is separated away from the center of a target block associated with the individual search range by a search-range offset determined by parallel-shift quantities as shown in FIG. 15B.

Then, at the next step S82, processing is carried out to generate 16 shrunk SAD tables for the 16 target blocks respectively or the 16 search ranges respectively and search each of the shrunk SAD tables for an every-block movement vector.

After the processing carried out at the step S82 to generate the shrunk SAD tables for the target blocks respectively is completed, at a step S83, a shrunk SAD total table is created from the shrunk SAD tables for a target block having a TOP or NEXT_TOP label and excluding shrunk SAD tables each created for a target block having its mask flag set in the first detection processing as a table having the same size and the same number of observed blocks in each of the search ranges. Computed in accordance with Eq. (3) shown in FIG. 4, the shrunk SAD total table is thus a SAD total value representing a sum of SAD values each stored in observed blocks in each of the search ranges. It is to be noted that it is possible to provide a configuration that, at the step S82, shrunk SAD tables are created for target blocks each having a TOP or NEXT_TOP label except target blocks each having its mask flag set in the first detection processing.

Then, at the next step S84, a minimum SAD value is identified from the shrunk SAD total table created at the step S83. Subsequently, a total movement vector of the precision of the fraction level is detected by carrying out an interpolation process based on an approximation surface representing the minimum SAD value and a plurality of neighbor SAD values each located in a table element in close proximity to the table element for storing the minimum SAD value.

Then, at the next step S85, the conditions shown in FIG. 13 are tested on the basis of the particular every-block movement vectors detected in the step S84 from the SAD values of the shrunk SAD tables each created for a target block having its mask flag not set in the first detection processing. Then, labeling is assigned as the TOP, NEXT_TOP NEAR_TOP and OTHERS described before to the particular shrunk SAD tables of each target blocks. In this case, a mask flag of every particular target block to which the NEAR_TOP or OTHERS label has been assigned is further set to indicate low-reliability and, hence, not to be used in subsequent processing.

Next, at a step S86, determination is made as to whether or not the number of target blocks each having a reset mask flag is smaller than a threshold value θth7 determined in advance. If the result of the determination indicates that the number of target blocks each having a reset mask flag is smaller than the threshold value θth7, the observed frame is excluded from the processing to compensate a still image for effects caused by hand trembling at a step S87. Then, the processing is ended.

If the determination result produced at the step S86 indicates that the number of target blocks each having a reset mask flag is not smaller than the threshold value θth7, on the other hand, every-block movement vectors of high precision (or precision of the fraction level) are found for shrunk SAD tables each associated with a target block having the TOP or NEXT_TOP label or a reset mask flag by carrying out the interpolation processing explained earlier by referring to FIGS. 20, 23A and 23B, 26A and 26B, and 30A and 30B as interpolation processing based on curved-surface approximation.

Then, at the next step S91 of the continuation flowchart shown in FIG. 45, by carrying out a process explained earlier by referring to FIGS. 5 and 6, the hand-trembling vector detection unit 15 computes parallel-shift quantities (α, β) representing a movement of the observed frame from the immediately leading ahead of frame by making use of the high-reliability every-block movement vectors detected at the step S88.

Subsequently, at the next step S92, by carrying out a process explained earlier by referring to FIGS. 6 to 8E, the hand-trembling vector detection unit 15 computes a rotation angle γ representing a rotation of the observed frame from the immediately leading ahead of frame by making use of the high-reliability every-block movement vectors detected at the step S88.

Then, at the next step S93, on the basis of the parallel-shift quantities (α, β) computed at the step S91 and the rotation angle γ computed at the step S92, an ideal every-block movement vector is computed for every target block and, in addition, an error ERRi between the ideal every-block movement vector and an actual every-block movement vector Vi computed for each target block is found. Then, an error sum ΣERRi representing the sum of the errors ERRi is computed. The error ERRi can be found in accordance with Eq. (H) shown in FIG. 46. The computed error sum ΣERRi is the sum of the errors ERRi for the observed frame.

As explained earlier in the description of Eq. (6), the results of experiments carried out on a plurality of experiment objects verify that the measured angles of rotation are extremely small. Thus, for elements in the rotation matrix R, the following values can be assumed:
cos γ≈1 and sin γ≈γ

That is to say, the rotation matrix R can be expressed as shown in FIG. 46.

Then, the flow of the second detection processing goes on to a step S94 to produce a result of determination as to whether or not the error sum ΣERRi computed at the step S93 is smaller than a threshold value θth8 determined in advance. If the result of the determination indicates that the error sum ΣERRi is not smaller than the threshold value θth8, the flow of the second detection processing goes on to a step S95 to set the mask flag of a target block having the largest error ERRi of the every-block movement vector Vi among those computed at the step S93.

After the process at the step S95 is completed, the flow of the second detection processing goes back to the step S83 of the flowchart shown in FIG. 44. At the step S83, a shrunk SAD total table is created from the shrunk SAD tables as a table having the same size and the same number of observed blocks in each of the search ranges. The shrunk SAD tables used for creating the shrunk SAD total table exclude shrunk SAD tables each created for a target block having its mask flag set in the first detection processing. Computed in accordance with Eq. (3) shown in FIG. 4, a SAD total value represents a sum of SAD values each stored in observed blocks in each of the search ranges. Then, the processes of the step S84 and subsequent steps are repeated.

If the determination result at the step S94 indicates that the error sum ΣERRi computed at the step S93 is smaller than the threshold value θth8, the parallel-shift quantities (α, β) computed at the step S91 and the rotation angle γ computed at the step S92 are confirmed as hand-trembling components. Finally, the execution of the second detection processing is ended.

Then, the hand-trembling vector detection unit 15 supplies the parallel-shift quantities (α, β) and the rotation angle γ, which have been obtained as results of computation, to the CPU 1. Subsequently, the CPU 1 computes parallel-shift quantities representing a movement and an angle of a rotation of the observed frame from the first observed frame on the basis of the parallel-shift quantities (α, β) and the rotation angle γ, which have been received from the hand-trembling vector detection unit 15, and supplies the computed parallel-shift quantities and the computed angle of rotation to the rotation/parallel-shift addition unit 19. Then, the rotation/parallel-shift addition unit 19 carries out a process to superpose the observed frame on the first observed frame on the basis of the parallel-shift quantities and the angle of rotation, which have been received from the CPU 1.

It is to be noted that, also in the second typical implementation, the hand-trembling vector detection unit 15 may compute parallel-shift quantities representing a movement and an angle of rotation of the observed frame from the first observed frame on the basis of the parallel-shift quantities (α, β) and the rotation angle γ.

In addition, in the second typical implementation, the processes of the steps S71 to S74 of the flowchart shown in FIG. 43 as well as the processes of the steps S81 to S84 of the flowchart shown in FIG. 44 are carried out by the hand-trembling vector detection unit 15 whereas the remaining process are carried out by the CPU 1 by execution of software.

On top of that, in the second typical implementation, the total movement vector is used as a global movement vector for evaluating the reliability of each every-block movement vector. However, an every-block movement vector of a largest majority can also be used as a reference.

It is to be noted that the first detection processing represented by the flowchart shown in FIG. 39 as the first detection processing for the first typical implementation can be combined with the second detection processing represented by the flowchart shown in FIGS. 44 and 45 as the second detection processing for the second typical implementation. In this case, a total movement vector found in the first detection processing as a global movement vector is used for determining the offset of the search range in the second detection processing.

That is to say, in the first detection processing, the precision of each every-block movement vector is difficult to be expected much. Thus, instead of adopting the technique explained earlier by referring to FIGS. 5 and 6 as a technique for finding parallel-shift quantities, the offset of the search range in the second detection processing is determined from a global movement vector computed as a result of the block matching method carried out on target blocks each having a TOP or NEXT_TOP label.

In general, if the hand trembling includes a rotation component, as a method for computing accurate parallel-shift components of the hand trembling, the technique explained earlier by referring to FIGS. 5 and 6 is effective. Thus, the technique explained earlier by referring to FIGS. 5 and 6 is adopted as an effective method in the second detection processing or subsequent detection processing in which high-precision every-block movement vectors are obtained.

As described above, after the first detection processing, it is to be noted that, instead of determining the offset of the search range for the second detection processing on the basis of a global detection vector and/or parallel-shift quantities, the offset of a search range associated with a target block for the second detection processing can also be determined independently for each target block by also taking an angle of rotation into consideration after finding the angle of rotation in advance as an angle formed by the global movement vector of the current observed frame and the global movement vector of the previous observed frame or as a rotation angle resulting from adoption of the rotation-angle computation method explained earlier by referring to FIGS. 7A to 8E. In this way, the search range can be further focused on a narrower area so that better precision and a higher processing speed can be expected.

As described above, in both the first detection processing and the second detection processing, all every-block movement vectors each approximating a total movement vector are each taken as a valid every-block movement vector. However, it is also possible to provide a configuration that, in the second detection processing, an every-block movement vector that can be taken as a valid every-block movement vector is an every-block movement vector of any of all the target blocks except target blocks each having its mask flag set in the first detection processing. This is because, in the second detection processing, the precision of each every-block movement vector is high, allowing also the rotation component of the hand trembling to be detected so that, in some cases, the every-block movement vectors are not necessarily similar to vectors to be averaged to produce a total movement vector.

The hand-trembling detection processing described above as processing for a still image provides a big time margin in comparison with the processing for a moving picture even though better precision is demanded. Thus, the hand-trembling detection processing for a still image is extremely effective. In order to further improve the precision, instead of carrying out the detection processing twice, the processing can also be carried out three or more times. In this case, every time the detection processing is carried out, the search range accompanying the newly set offset of the search range is more focused on a narrower area and searched for a high-reliability every-block movement vector. In the last detection processing, parallel-shift quantities and an angle of rotation are found by following a procedure like the one shown in FIGS. 44 and 45.

[Typical Processing Routines of the Steps S32, S52, S72 and S82]

The following description explains the processing carried out at the step S32 of the flowchart shown in FIG. 39, the step S52 of the flowchart shown in FIG. 41, the step S72 of the flowchart shown in FIG. 43 or the step S82 of the flowchart shown in FIG. 44 to generate shrunk SAD tables for the target blocks respectively or the search ranges respectively and search each of the shrunk SAD tables for an every-block movement vector.

<First Typical Processing Routine>

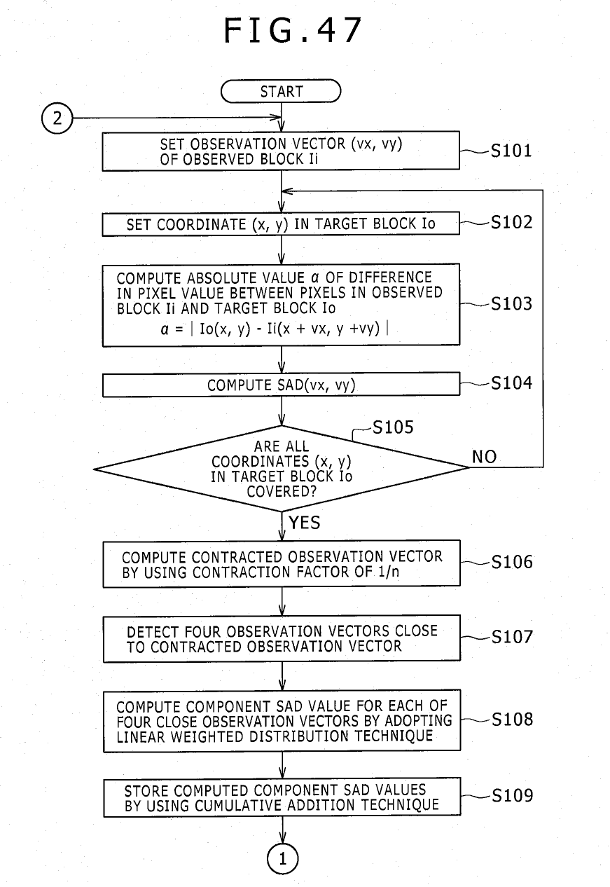

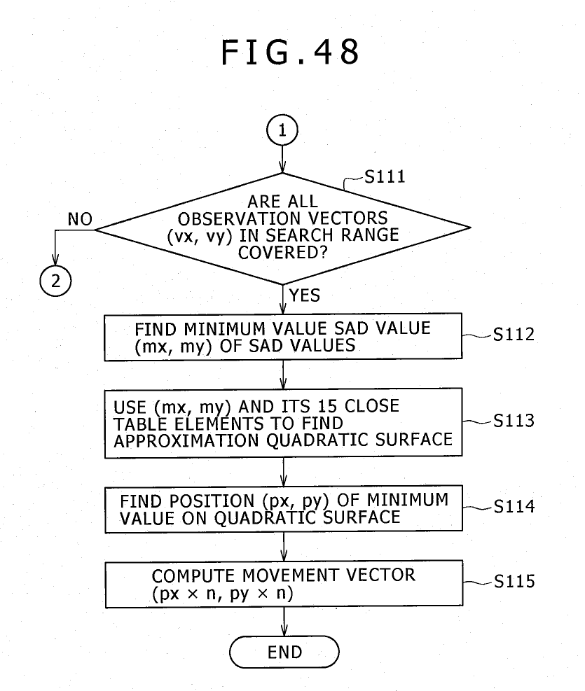

FIGS. 47 and 48 show a flowchart representing the processing carried out at the step S32 in FIG. 39, the step S52 in FIG. 41, the step S72 in FIG. 43 or the step S82 in FIG. 44 to generate shrunk SAD tables for the target blocks respectively or the search ranges respectively and search each of the shrunk SAD tables for an every-block movement vector.

As shown in FIG. 47, the flowchart begins with a step S101 at which an observed block Ii in the SR (search range) 105 like the one shown in FIG. 35 is specified. Let us assume that notation (vx, vy) denote the coordinates of the position of an observed block 106 associated with an observation vector 107, and the position of the target block 103 in the target frame 101 (which is the center of the search range) is taken as a reference position indicated by coordinates (0, 0). In this case, the coordinate vx of an observation vector 107 is the horizontal-direction distance between the reference position and the position of an observed block 106 associated with the observation vector 107 whereas the coordinate vy of an observation vector 107 is the vertical-direction distance between the reference position and the position of an observed block 106 associated with the observation vector 107. Much like the method in related art, the coordinates (vx, vy) are each expressed in terms of pixels each used as the unit of distance.

Here, the center of the search range 105 is taken as the reference position (0, 0). Let us assume that the width of the search range 105 is horizontal dimensions of ±Rx whereas the height of the search range 105 is vertical dimensions of ±Ry. That is to say, the coordinates vx and vy satisfy the following relations:
−Rx≦vx≦+Rx and −Ry≦vy≦+Ry

Then, at the next step S102, a point with coordinates (x, y) is specified as a point in the target block Io denoted by reference numeral 103 in FIG. 78. Let us have notation Io (x, y) denote a pixel value at the specified point (x, y) and notation Ii (x+vx, y+vy) denote a pixel value at a point (x+vx, y+vy) in the observed block Ii at the block position (vx, vy) set in the process carried out at the step S101. In the following description, the point (x+vx, y+vy) in the observed block Ii is said to be a point corresponding the point (x, y) in the target block Io. Then, at the next step S103, the absolute value α of the difference between the pixel value Io (x, y) and the pixel value Ii (x+vx, y+vy) is computed in accordance with Eq. (1).

The above difference absolute value α is to be computed for all points (x, y) in the target block Io and all their corresponding points (x+vx, y+vy) in the observed block Ii, and a SAD value representing the sum of the difference absolute values α computed for the target block Io and the observed block Ii is stored at an address (table element) associated with an observation vector (vx, vy) pointing to the location of the current observed block Ii. In order to compute such a SAD value, at the next step S104, the difference absolute value α found at the step S103 is cumulatively added to a temporary SAD value already stored at the address as a SAD value computed so far. The final SAD value denoted by notation SAD (vx, vy) is obtained as a result of a process to cumulatively sum up all difference absolute values α, which are computed for all points (x, y) in the target block Io and all their corresponding points (x+vx, y+vy) in the observed block Ii as described above. Thus, the final SAD value SAD (vx, vy) associated with the observation vector (x, y) can be expressed by Eq. (2) described earlier as follows:
SAD(vx,vy)===Σα=Σ|Io(x,y)−Ii(x+vx,y+vy)| (2)

Then, the flow of the first typical processing routine goes on to the next step S105 to produce a result of determination as to whether or not the processes of the steps S102 to S104 have been carried out for all pixels (x, y) in the target block Io and all their corresponding pixels (x+vx, y+vy) in the observed block Ii. If the result of the determination indicates that the processes of the steps S102 to S104 have not been carried out yet for all pixels (x, y) in the target block Io and all their corresponding pixels (x+vx, y+vy) in the observed block Ii, the flow of the first processing routine goes back to the step S102 at which another pixel with coordinates (x, y) is specified as another pixel in the target block Io. Then, the processes of the steps S103 and S104 following the step S102 are repeated.

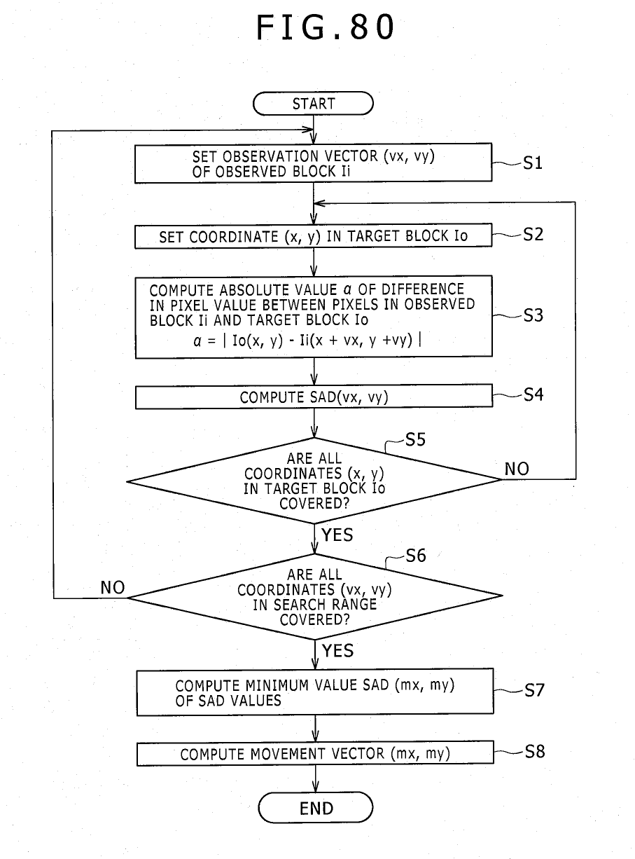

The processes of the steps S101 to S105 are exactly the same as respectively the processes of the steps S1 to S5 of the flowchart shown in FIG. 80.

If, at the step S105, the processes of the steps S102 to S104 have been carried out for all pixels (x, y) in the target block Io and all their corresponding points (x+vx, y+vy) in the observed block Ii, the flow of the processing according to the first typical processing routine goes on to a step S106 at which a contracted observation vector (vx/n, vy/n) is computed by contracting the observation vector (vx, vy). To put it concretely, the contracted observation vector (vx/n, vy/n) is computed by multiplying the observation vector (vx, vy) by a contraction factor of 1/n. In general, the x-direction and y-direction values (vx/n, vy/n) of the contracted observation vector (vx/n, vy/n) each have a fraction part.

Then, at the next step S107, a plurality of neighbor observation vectors located in the neighborhood of the contracted observation vector (vx/n, vy/n) are identified. The neighbor observation vectors are each a contracted observation vector having an integer vx/n value and an integer vy/n value. In this embodiment, the number of neighbor observation vectors is set at four. Then, at the next step S108, the SAD value stored at the temporary location at the step S104 is split into four component SAD values by adoption of a linear weighted distribution technique based on relations between positions pointed to by the neighbor observation vectors and a position pointed to by the contracted observation vector (vx/n, vy/n) as described earlier. Subsequently, at the next step S109, the four component values are distributed among four table elements included in the contracted SAD table as four table elements associated with the four neighbor observation vectors respectively.

After the process of the step S109 is completed, the flow of the processing according to the first typical processing routine goes on to a step S111 of the flowchart shown in FIG. 48 to produce a result of determination as to whether or not the processes of the steps S101 to S109 have been carried out for all observed block locations in the search range 105, that is, for all observation vectors (vx, vy).

If the determination result produced at the step S111 indicates that the processes of the steps S101 to S109 have not been carried out yet for all observed blocks in the search range 105, that is, for all observation vectors (vx, vy), the flow of the processing according to the first typical processing routine goes back to the step S101 at which another observed block Ii pointed to by another observation vector (vx, vy) is set at another block position (vx, vy) in the search range 105. Then, the processes of the step S102 and the subsequent steps are repeated.

If, at the step S111, the processes of the steps S101 to S109 have been carried out for all observed block positions in the search range 105 or for all observation vectors (vx, vy), that is, if all elements of the contracted SAD table have each been filled with a final component SAD value, on the other hand, the flow of the processing according to the first typical processing routine goes on to a step S112 at which the smallest value among all the component final SAD values.

Then, at the next step S113, a quadratic surface is created as a surface approximating the minimum SAD value detected at the table-element address (mx, my) and a plurality of SAD values stored in the shrunk SAD table as table elements in the neighborhood of the table-element address (mx, my). In the case of this embodiment, the number of SAD values stored in the shrunk SAD table as table elements in the neighborhood of the table-element address (mx, my) is set at 15. Then, at the next step S114, a minimum-value vector (px, py) pointing to a position on the X-Y plane at precision of the fraction level is detected as a vector corresponding to the minimum SAD value on the quadratic surface. The position pointed to by the minimum-value vector (px, py) is a position corresponding to the minimum SAD value on the quadratic surface.

Then, at the last step S115, a movement vector (px×n, py×n) with the original magnitude and the original direction is computed by multiplying the minimum-value vector (px, py) by the reciprocal value n of the contraction factor.

The flowchart shown in FIGS. 47 and 48 represents processing carried out in accordance with a block-matching technique according to the first typical processing routine to detect a movement vector for one target block. In general, a target frame includes a plurality of target blocks and, thus, as many search ranges as the target blocks are set in the observed frame as shown in FIG. 35. The typical target frame shown in FIG. 35 includes 16 target blocks and 16 search ranges are thus set in the observed frame. In this case, a movement vector needs to be detected each of the target blocks or each of the search ranges. In addition, for each one of the movement vectors to be detected or each of the target blocks, a search range and a contraction factor of 1/n has to be set anew in order to carry out the processing represented by the flowchart shown in FIGS. 47 and 48.

It is needless to say that, in place of the quadratic-surface method described above, the cubic-curve method can also be adopted as a technique to find the minimum-value vector (px, py) pointing to a position detected on the search range with the precision of the fraction level.

It is possible to provide a configuration in which the processes of the steps S101 to S111 in the flowchart shown in FIGS. 47 and 48 are carried out by the hand-trembling vector detection unit 15 while the processes of the remaining steps are carried out by the CPU 1.

<Second Typical Processing Routine>

In the case of the first typical processing routine described above, a SAD value is found for an observed block (an observation vector) and, by adoption of the linear weighted distribution technique, the SAD value is then split into a plurality of component SAD values for a plurality of neighbor observation vectors each located in close proximity to a shrunk observation vector obtained as a result of contracting the observation vector. That is to say, since a SAD value represents a value of correlation between the target block and an observed block, in the case of the first typical processing routine described, a SAD value is found for an observed block associated with an observation vector. By adoption of the linear weighted distribution technique, the SAD value is then split into a plurality of component SAD values for a plurality of neighbor observation vectors each located in close proximity to a shrunk observation vector obtained as a result of contracting the observation vector.

In the case of a second typical processing routine, on the other hand, a correlation value is computed as a difference in pixel value between a pixel on the target block and a corresponding pixel on an observed block. The computed correlation value is thus not a SAD value. Then, by adoption of the linear weighted distribution technique, the computed correlation value is split into a plurality of component correlation values for a plurality of neighbor observation vectors each located in close proximity to a contracted observation vector obtained as a result of contracting an observation vector pointing to the observed block. The process to compute a correlation value and the process to split the computed correlation value into a plurality of component correlation values are repeated for all pixels in the target block (or all corresponding pixels in the observed blocks) to find a plurality of final component correlation values by adoption of the cumulative addition technique. When the process to compute a correlation value and the process to split the computed correlation value into a plurality of component correlation values are completed for all pixels in the observed block, the state of a resulting shrunk SAD table (or a resulting contracted SAD table) is the same as the shrunk SAD table (or the contracted SAD table) generated by the first typical processing routine.

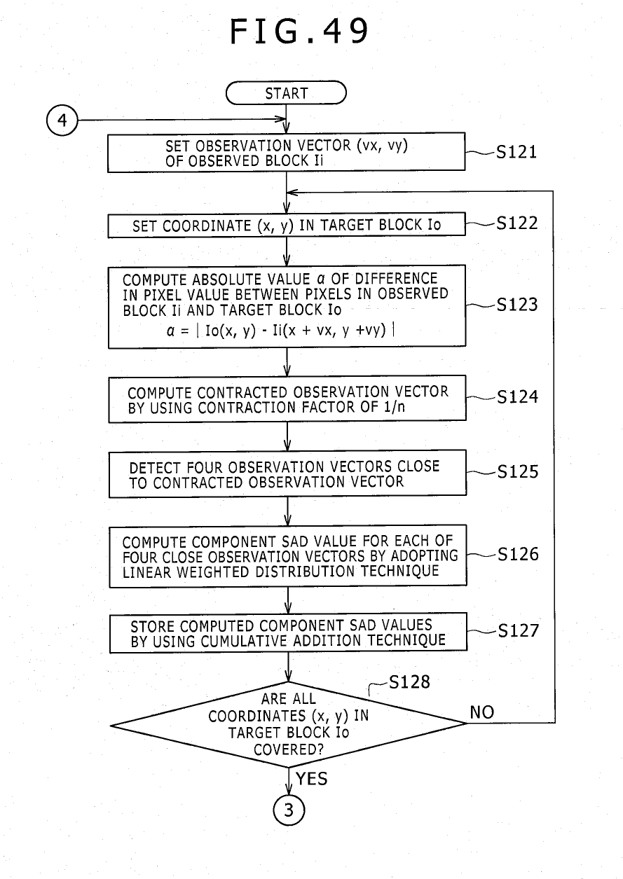

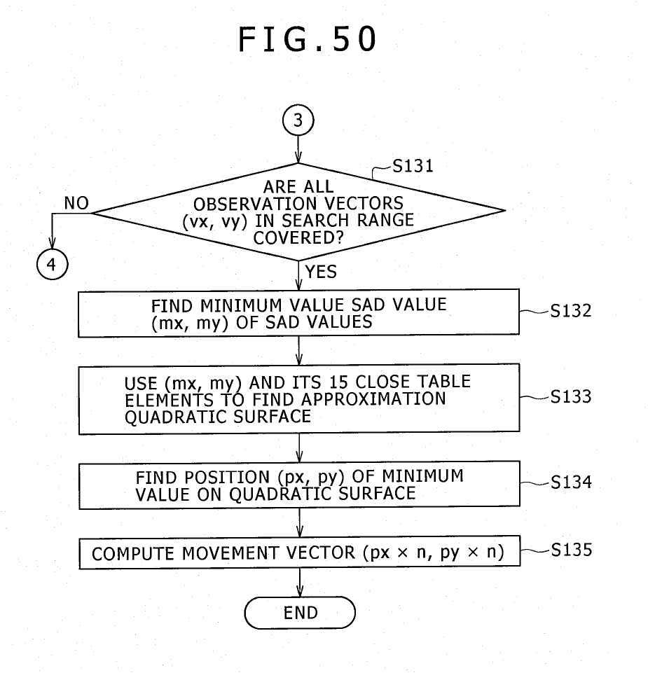

The processing flow of the second typical processing routine realizing operations of the hand-trembling movement-vector detection unit 15 is explained by referring to a flowchart shown in FIGS. 49 and 50 as follows.

Since the processes of steps S121 to S123 of the flowchart shown in FIG. 49 are the same as respectively those of the steps S101 to S103 of the flowchart shown in FIG. 47, the processes of steps S121 to S123 are not explained in detail.

At the next step S123 of the flowchart for the second typical processing routine, the absolute value α of the difference between the pixel value Io (x, y) of a pixel (x, y) on the target block Io and the pixel value Ii (x+vx, y+vy) of the corresponding pixel on the observed block Ii is computed in accordance with Eq. (1). Then, at the next step S124, a contracted observation vector (vx/n, vy/n) is computed by contracting the observation vector (vx, vy) pointing to the observed block Ii at a contraction factor of 1/n.

Subsequently, at the next step S125, a plurality of neighbor observation vectors located at in the neighborhood of the contracted observation vector (vx/n, vy/n) are identified. The neighbor observation vectors are each a contracted observation vector having an integer vx/n value and an integer vy/n value. In this embodiment, the number of neighbor observation vectors is set at four. Then, at the next step S126, the absolute value α found at the step S123 as the absolute value of the difference in pixel value is split into four component differences by adoption of the linear weighted distribution technique based on relations between positions pointed to by the neighbor observation vectors and a position pointed to by the contracted observation vector (vx/n, vy/n) as described earlier.

Subsequently, at the next step S127, the four component differences are distributed among four table elements included in the contracted SAD table as four table elements associated with the four neighbor observation vectors respectively.

After the process of the step S127 is completed, the flow of the processing according to the second typical processing routine goes on to the next step S128 to produce a result of determination as to whether or not the processes of the steps S122 to S127 have been carried out for all points (x, y) in the target block Io and all their corresponding points (x+vx, y+vy) in the observed block Ii. If the processes of the steps S122 to S127 have not been carried out yet for all pixels (x, y) in the target block Io and all their corresponding pixels (x+vx, y+vy) in the observed block Ii, the flow of the processing according to the second typical processing routine goes back to the step S122 at which another pixel with coordinates (x, y) is specified as another pixel in the target block Io. Then, the processes of the steps S123 to S127 following the step S122 are repeated.

If, at the step S128, the final SAD value SAD (vx, vy) for the current observation vector (vx, vy) has been found, the flow of the processing according to the second typical processing routine goes on to a step S131 of the flowchart shown in FIG. 50 to produce a result of determination as to whether or not the processes of the steps S121 to S128 have been carried out for all observed block locations in the search range 105, that is, for all observation vectors (vx, vy).

If, at the step S131, the processes of the steps S121 to S128 have not been carried out yet for all observed blocks, that is, for all observation vectors (vx, vy), the flow of the processing according to the second typical processing routine goes back to the step S121 at which another observed block Ii pointed to by another observation vector (vx, vy) is set at another block position (vx, vy) in the search range 105. Then, the processes of the step S122 and the subsequent steps are repeated.

If, at the step S131, the processes of the steps S121 to S128 have been carried out for all observed block positions in the search range 105 or for all observation vectors (vx, vy), the flow of the processing according to the second typical processing routine goes on to a step S1132 at which the smallest value among all the component final SAD values stored in all the elements of the contracted SAD table or the contracted SAD table is detected at a table-element address (mx, my).

Then, at the next step S133, a quadratic surface is created as a surface approximating the minimum SAD value detected at the table-element address (mx, my) and a plurality of SAD values stored in the shrunk SAD table as table elements in the neighborhood of the table-element address (mx, my). In this embodiment, the number of SAD values stored in the shrunk SAD table as table elements in the neighborhood of the table-element address (mx, my) is set at 15. Then, at the next step S134, a minimum-value vector (px, py) pointing to a position on the X-Y plane at precision of the fraction level is detected as a vector corresponding to the minimum SAD value on the quadratic surface. The position pointed to by the minimum-value vector (px, py) is a position corresponding to the minimum SAD value on the quadratic surface.

Then, at the last step S135, a movement vector (px×n, py×n) with the original magnitude and the original direction is computed by multiplying the minimum-value vector (px, py) by the reciprocal value n of the contraction factor as shown in FIG. 21.

The flowchart shown in FIGS. 49 and 50 represents processing carried out in accordance with a block-matching technique according to the first typical processing routine to detect a movement vector for one target block. In general, a target frame includes a plurality of target blocks and, thus, as many search ranges as the target blocks are set in the observed frame as shown in FIG. 35. The typical target frame shown in FIG. 35 includes 16 target blocks and 16 search ranges are thus set in the observed frame. In this case, a movement vector needs to be detected each of the target blocks or each of the search ranges. In addition, for each one of the movement vectors to be detected or each of the target blocks, a search range and a contraction factor of 1/n is set anew in order to carry out the processing represented by the flowchart shown in FIGS. 49 to 52.

It should be noted that, even in the case of the second typical processing routine, in place of the quadratic-surface method described above, the cubic-curve method based on two cubic curves laid on planes oriented the vertical and horizontal directions respectively can also be adopted as a technique to find the minimum-value vector (px, py) pointing to a position detected on the search range with the precision of the fraction level.

It should also be noted that it is possible to provide a configuration in which the processes of the steps S121 to S131 in the flowchart shown in FIGS. 49 and 50 are carried out by the hand-trembling vector detection unit 15 while the processes of the remaining steps are carried out by the CPU 1.

<Third Typical Processing Routine>

If any of the methods to determine a movement vector in accordance with the embodiment is adopted, the process to determine a movement vector does not end with a failure such as detection of a completely incorrect movement vector even for a one-dimensional contraction factor of 1/64 used for contracting observation vectors as is obvious from the effects exhibited by the method as shown in FIG. 34. Thus, in essence, the size of the SAD table used as a typical SAD table can be reduced at a two-dimensional shrinking factor of 1/4096 successfully.

As a matter of fact, an attempt can be made to further reduce the size a shrunk SAD table (used as a typical SAD table), which has been obtained as a result of a contraction process using the two-dimensional shrinking factor of 1/4096 or the one-dimensional contraction factor of 1/64. That is, first of all, a shrunk SAD table is obtained by carrying out a first process to detect a movement vector at the one-dimensional contraction factor of 1/64. Then, the size of the search range (which corresponds to the SAD table) is further reduced to result in a new search range with its center coinciding with the position pointed to by the detected movement vector before carrying out a second process to detect a movement vector at a one-dimensional contraction factor of typically ⅛. Thus, processes to detect a movement vector are carried out by reducing the one-dimensional contraction factor (that is, increasing the magnitude of 1/n) in order to reduce the resulting vector error to a value within a range of tolerance. By properly setting the one-dimensional contraction factor for the second process to detect a movement vector at a proper value, the movement vector can be detected with a very high degree of precision.

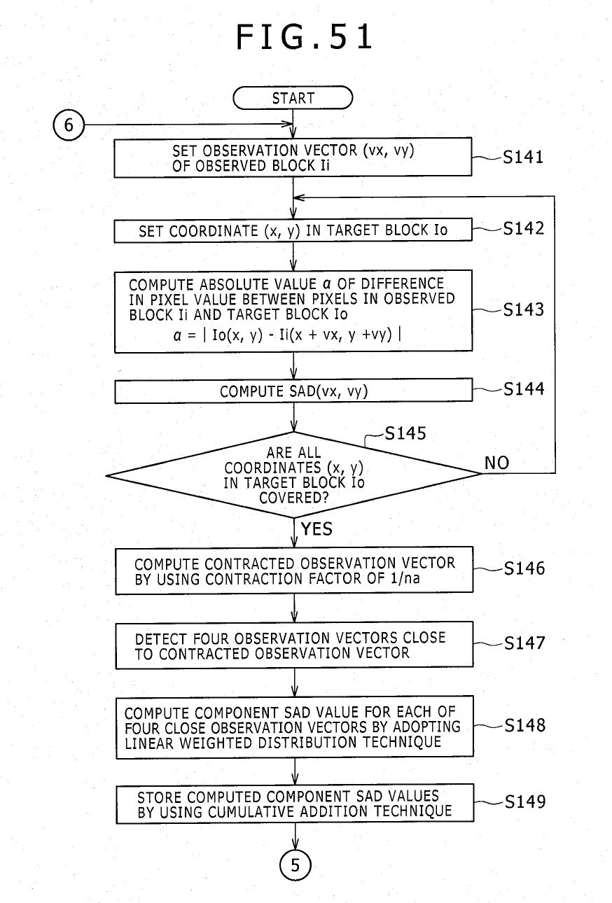

The processing flow of the third typical processing routine implementing operations of the hand-trembling movement-vector detection unit 15 is explained by referring to a flowchart shown in FIGS. 51 to 54 as follows.

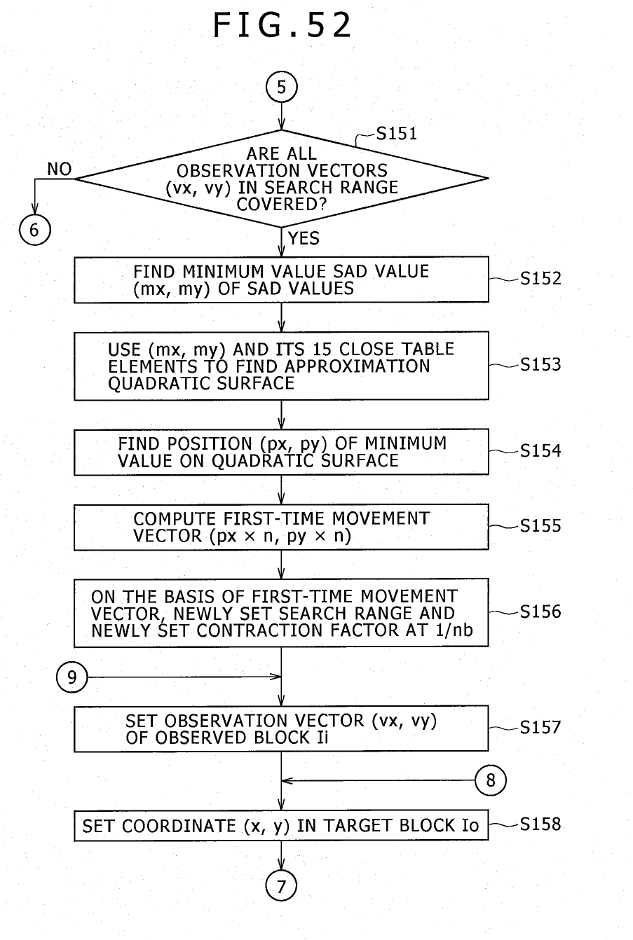

The processing represented by the flowchart shown in FIGS. 51 to 54 as processing according to the third typical processing routine is basically based on the processing to detect a movement vector in accordance with the first typical processing routine. Thus, the processes of steps S141 to S149 of the flowchart shown in FIG. 51 are exactly the same as respectively the processes of the steps S101 to S109 of the flowchart shown in FIG. 47 whereas the processes of steps S151 to S155 of the flowchart shown in FIG. 52 are exactly the same as respectively the processes of the steps S111 to S115 of the flowchart shown in FIG. 48.

In the case of the third typical processing routine, however, the processing to detect a movement vector is not ended at the step S155 of the flowchart shown in FIG. 52. Instead, the movement vector detected at the step S155 is used as a first movement vector. Then, at the next step S156, the size of the search range in the same observed frame is further reduced to result in a new search range by using the position pointed to by the detected movement vector as the center of the new search range with a reduced size and by reducing the one-dimensional contraction factor from 1/na used in the first processing to detect a movement vector to 1/nb used in the second processing where na>nb.

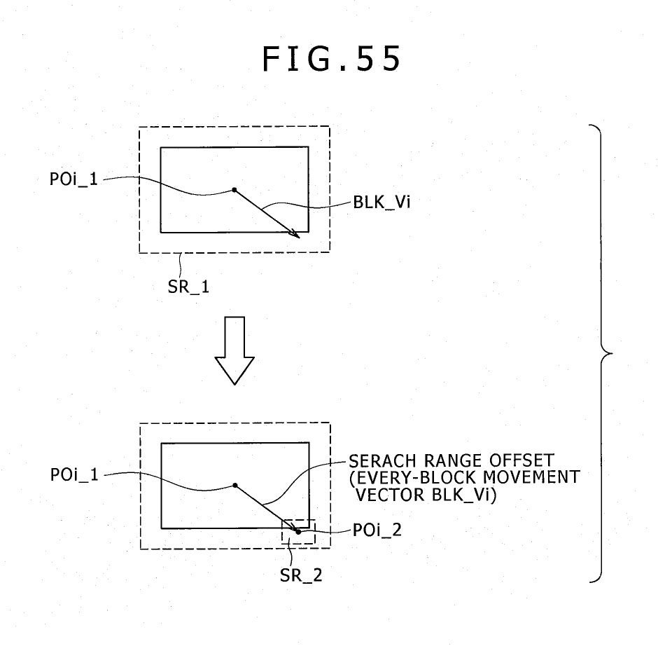

When a movement vector BLK_Vi is computed for a target block TB associated with a search range SR_1 set in the first detection process, as shown in FIG. 55, a second-detection search area SR_2 set in the second detection process is an area having a size smaller than the first-detection search area SR_1 and having its center coinciding with the aforementioned block range having a correlation between the observed frame and the original frame. In this case, as shown in FIG. 55, the center position POi_1 of the first-detection search area SR_1 set for the first detection process and the center position POi_2 of the second-detection search area SR_2 set for the second detection process are separated away from each other by a search-range offset, which is an offset represented by the movement vector BLK_Vi detected in the first detection process.

In this way, by further reducing the one-dimensional contraction factor from 1/na used in the first processing to detect a movement vector to 1/nb used in the second processing where na>nb in this embodiment as described above, it can be expected that a movement vector having fewer errors can be detected in the second detection process.

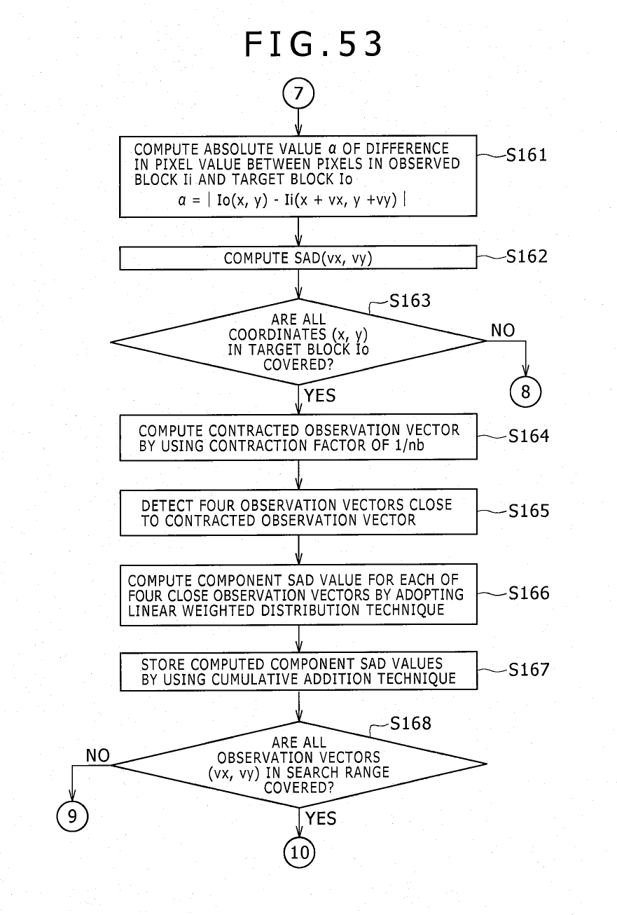

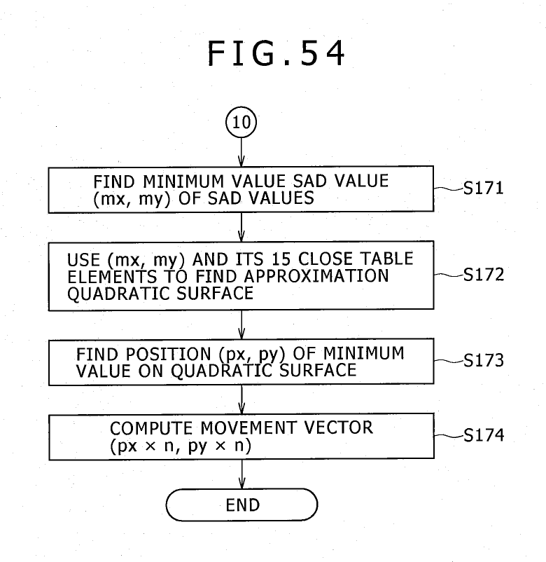

Thus, as described above, at the step S156, a narrower search range and a reduced one-dimensional contraction factor are used to carry out the second processing to detect another movement vector in entirely the same way as the first movement-vector detection processing at steps S157 and S158 shown in FIG. 52, steps S161 to S168 shown in FIG. 53 and steps S171 to S174 shown in FIG. 54. The processes of these steps are entirely the same way as the processes of the steps S101 to S109 shown in FIG. 47 and the processes of the steps S111 to S115 shown in FIG. 48.

By carrying out the second movement-vector detection processing as described above, eventually, a second movement vector is detected at the step S174 as the desired final movement vector.

The method to detect a movement vector in accordance with the third typical processing routine is implemented by executing the method to detect a movement vector in accordance with the first typical processing routine repeatedly twice. It is needless to say, however, that the method to detect a movement vector in accordance with the first typical processing routine can be executed repeatedly more than twice with gradually decreased search ranges and, if necessary, gradually decreased contraction factors.

In addition, in realization of the method to detect a movement vector (px, py) in accordance with the third typical processing routine, the method to detect a movement vector in accordance with the second typical processing routine can be executed in place of the method to detect a movement vector (px, py) in accordance with the first typical processing routine. On top of that, in place of the quadratic-surface method described above, the cubic-curve method based on two cubic curves laid on planes oriented the vertical and horizontal directions respectively can also be adopted as a method to detect a movement vector (px, py) pointing to a position with the precision of the fraction level as is the case the first and second typical processing routines described earlier.

Let us keep in mind that it is possible to provide a configuration in which the processes of the steps S141 to S168 in the flowchart shown in FIGS. 51 to 54 are carried out by the hand-trembling vector detection unit 15 while the processes of the remaining steps are carried out by the CPU 1.

[Addition Processing Carried Out by the Rotation/Parallel-Shift Addition Unit 19]

As described above, parallel shift components (referred to as parallel-shift quantities of an observed frame) as well as an angle of rotation (referred to as a rotation angle of the observed frame), which are caused by hand trembling, are computed for each observed frame. The parallel shift components as well as the angle of rotation are used in the rotation/parallel-shift addition unit 19 for carrying out frame addition (superposition) processing.

As described earlier, the image-pickup apparatus according to this embodiment is provided with three different frame addition methods selectable by the user for a variety of photographing objects, from each of which a drawing is made in accordance with the intention of the user. The user can select any of the frame addition methods by carrying out a selection operation on the user-operation input unit 3 in order to make a drawing in accordance with the intention of the user.

As explained before, this embodiment deals with a still image taken as a photographing object in order to make the description simple. It is to be noted, however, that the embodiment can be applied to a moving picture as well. In the case of a moving picture, nevertheless, there is an upper limit imposed by real-time necessities on the number of observed frames that can be added to each other. If the technique according to this embodiment is applied for every frame, however, the technique can also be applied to a system for generating a moving picture exhibiting a noise reduction effect by making use of exactly the same sections.

The three frame addition (superposition) techniques according to the embodiment are a simple frame addition method, an averaging frame addition method, and a tournament frame addition method, which are mentioned before. The rotation/parallel-shift addition unit 19 employed in the image-pickup apparatus shown in FIG. 1 is configured to allow the simple frame addition method, the averaging frame addition method, and the tournament frame addition method to be implemented. Details of the methods are explained below sequentially one method after another. It is to be noted that, in this embodiment, the number of observed frames that can be added to each other is set at a typical value of eight.

(1) Simple Frame Addition Method

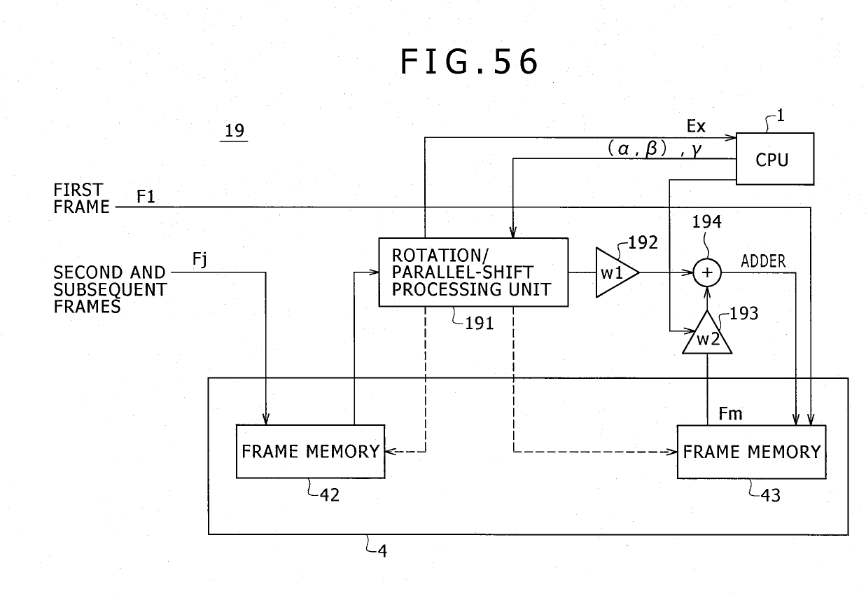

FIG. 56 is a block diagram showing relations between the rotation/parallel-shift addition unit 19, the image memory unit 4, and the CPU 1 for the simple frame addition method. As shown in the figure, the rotation/parallel-shift addition unit 19 employs a rotation/parallel-shift processing unit 191, gain amplifiers 192 and 193, and an adder 194.

As explained earlier, the frame memory 43 employed in the image memory unit 4 is used for storing a post-addition frame Fm, which is a frame obtained as a result of adding the current observed frame to a result of a previous addition process. Initially, when a first observed frame F1 of an input frame sequence is received, the first frame F1 is used as a reference so that the first observed frame F1 is directly stored in the frame memory 43. On the other hand, each of the second and subsequent observed frames Fj (where j=2, 3, 4, . . . , and so on) is stored in the frame memory 42 employed in the image memory unit 4 and, then, supplied to the rotation/parallel-shift addition unit 19. Let us keep in mind that it is necessary to assume the size of the post-addition frame Fm by also considering an expected shift portion caused by the parallel-shift quantities (α, β) and the rotation angle γ. Thus, at least the frame memory 43 employed in the image memory unit 4 is necessary to have a memory size large enough for accommodating also the image data of the expected shift portion caused by the parallel-shift quantities (α, β) and the rotation angle γ in addition to the image data of 1 observed frame.

The rotation/parallel-shift processing unit 191 receives parallel-shift quantities (α, β) representing a movement of the second observed frame F2 from the first observed frame F1 and a rotation angle γ representing a rotation of the second observed frame F2 from the first observed frame F1 from the CPU 1. Then, the rotation/parallel-shift processing unit 191 moves and rotates the second and subsequent observed frame Fj, adding the second observed frame F2 to the first observed frame F1. To put it in detail, the rotation/parallel-shift processing unit 191 reads out the image data of the second and subsequent observed frame Fj from the frame memory 42 so as to eliminate effects of hand trembling on the observed frame, superposing the image data of the observed frame on the image data.

In the operation to read out the image data of any individual one of the subsequent observed frames Fj from the frame memory 42 to be added to the image data of the most recent post-addition frame Fm read out from the frame memory 43, as described above, the rotation/parallel-shift processing unit 191 computes the address of each pixel of the individual subsequent observed frame Fj by making use of cumulative parallel-shift quantities (α, β) and a cumulative rotation angle γ, which are received from the CPU 1. As described above, the first observed frame F1 is the initial post-addition frame Fm whereas the second observed frame F2 is the initial subsequent observed frame Fj. The rotation/parallel-shift processing unit 191 superposes the image data of an observed frame Fj read out from the frame memory 42 on the image data of the post-addition frame Fm stored in the frame memory 43 by adding the luminance value of each pixel on the observed frame Fj to the luminance value of the corresponding pixel on the observed frame Fj.

It is to be noted that, in the operation carried out by the embodiment to read out the image data of any individual one of the subsequent observed frames Fj from the frame memory 42 to be added to the image data of the most recent post-addition frame Fm read out from the frame memory 43, the image data of the post-addition frame Fm is read out sequentially from original addresses for storing pixel data of the post-addition frame Fm in the frame memory 43. However, the rotation/parallel-shift processing unit 191 sequentially computes the address of each pixel of the individual subsequent observed frame Fj in the frame memory 42 on the basis of the corresponding original address for storing data each pixel of the post-addition frame Fm in the frame memory 43. As described above, the first observed frame F1 is the initial post-addition frame Fm whereas the second observed frame F2 is the initial subsequent observed frame Fj.

The gain amplifier 192 is a unit for multiplying the pixel data of the observed frame Fj received from the rotation/parallel-shift processing unit 191, which have moved the observed frame Fj by the cumulative parallel-shift quantities and rotated the observed frame Fj by the angle of rotation, by a gain w1 also referred to as a multiplication coefficient w1 and supplying the result of the multiplication to the adder 194. By the pixel data, a luminance signal component and a chrominance signal component are meant. On the other hand, the gain amplifier 193 is a unit for multiplying the pixel data of the post-addition frame Fm read out from the frame memory 43 by a gain w2 also referred to as a multiplication coefficient w2 and supplying the result of the multiplication to the adder 194. As described above, the first observed frame F1 is the initial post-addition frame Fm whereas the second observed frame F2 is the initial subsequent observed frame Fj.

The adder 194 is a unit for adding the multiplication result received from the gain amplifier 192 to the multiplication result received from the gain amplifier 193 to result in a most recent post-addition frame Fm and storing back the most recent post-addition frame Fm in the frame memory 43 at the same address as the previous post-addition frame Fm in the so-called overwriting operation.

In the case of the embodiment, the gain w1 of the gain amplifier 192 for multiplying the pixel data of the observed frame Fj received from the rotation/parallel-shift processing unit 191 to serve as an active addition operand in the addition of the image data of the two frames to each other is usually set at one (that is, w1=1). As described above, the second observed frame F2 is the initial subsequent observed frame Fj.

On the other hand, the gain w2 of the gain amplifier 193 for multiplying the pixel data of the post-addition frame Fm read out from the frame memory 43 to serve as a passive addition operand in the addition of the image data of the two frames to each other is set at a value depending on whether or not the observed frame Fj includes pixels, the data of which is to be added to pixel data of the post-addition frame Fm. That is, whether or not the observed frame Fj includes an area not to be superposed on the post-addition frame Fm due to a parallel shift and/or rotation of the observed frame Fj. As described above, the second observed frame F2 is the initial subsequent observed frame Fj.

In detail, as a result of moving and rotating the observed frame Fj serving as the active addition operand, there is usually a case in which the area of the moved/rotated subsequent observed image Fj does not include a pixel having data to be added to the data of a corresponding pixel on the post-addition frame Fm serving as the passive addition operand. For a pixel included in the moved/rotated subsequent observed frame Fj as a pixel having data to be added to the data of a corresponding pixel on the post-addition frame Fm serving as the passive addition operand, the gain w2 of the gain amplifier 193 for multiplying the pixel data of the post-addition frame Fm read out from the frame memory 43 to serve as a passive addition operand is set at one (that is, w2=1). For a pixel included in the jth moved/rotated subsequent observed frame Fj as a pixel not corresponding to any pixel on the post-addition frame Fm serving as the passive addition operand, on the other hand, the gain w2 of the gain amplifier 193 for multiplying the pixel data of the post-addition frame Fm read out from the frame memory 43 to serve as a passive addition operand is set at j/(j−1) or (w2=j/(j−1)). Since notation j used in this expression has the same value as the subscript j of notation Fj, the value of the expression j/(j−1) is a value dependent on the observed frame Fj serving as the active addition operand.

By setting the gain w2 at the values described above, a sense of incompatibility can be eliminated from a boundary portion between an area including pixels having data resulting from addition and an area not including such pixels in an image obtained as a result of frame addition according to the embodiment.

In order to control the gain w2 of the gain amplifier 193 as described above, in this embodiment, the rotation/parallel-shift processing unit 191 produces a result of determination. The determination is whether or not the pixel addresses of the observed frame Fj read out from the frame memory 42 to be added to the post-addition frame Fm read out from the frame memory 43 exist in the frame memory 42, that is, whether or not the pixels having data to be added to the data of corresponding pixels on the post-addition frame Fm exist in the observed frame Fj. The unit 191 outputs information EX representing the result of the determination to the CPU 1. Receiving the information EX, the CPU 1 controls the gain w2 of the gain amplifier 193. As described above, the first observed frame F1 is the initial post-addition frame Fm whereas the second observed frame F2 is the initial subsequent observed frame Fj.

Instead of letting the CPU 1 control the gain w2 of the gain amplifier 193, it is also possible to provide a configuration in which the rotation/parallel-shift processing unit 191 supplies the gain w2 to the gain amplifier 193 as a gain depending on whether or not the pixel addresses of the observed frame Fj read out from the frame memory 42 to be added to the post-addition frame Fm read out from the frame memory 43 exist in the frame memory 42. As described above, the first observed frame F1 is the initial post-addition frame Fm whereas the second observed frame F2 is the initial subsequent observed frame Fj.

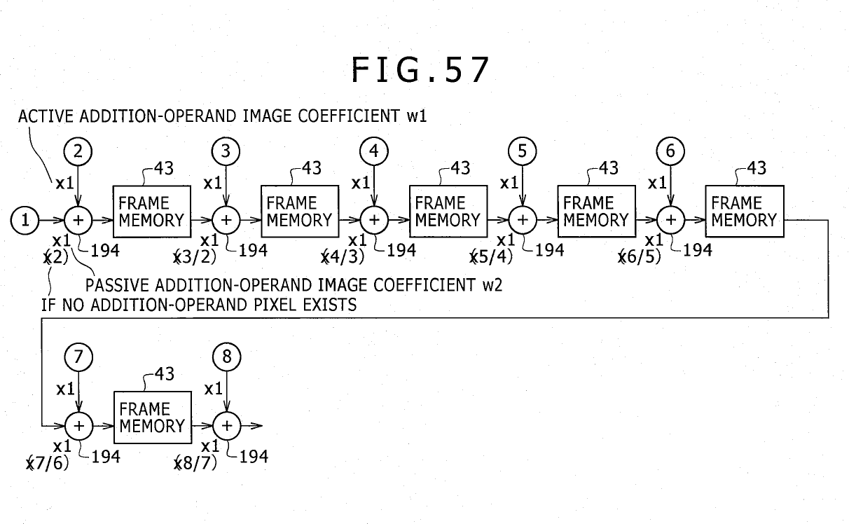

FIG. 57 is a diagram showing the process to add the observed frame Fj to the post-addition frame Fm in accordance with the simple frame addition method. As shown in FIG. 57, the adder 194 and the frame memory 43 are used repeatedly to superpose observed frames on each other. In the typical frame addition process shown in FIG. 57, eight observed frames are superposed on each other. In FIG. 57, an integer j enclosed in a circle represents the jth observed frame Fj. The gain w2 also referred to as the multiplication coefficient w2 can be the value of an expression enclosed in parentheses or a value x1 not enclosed in parentheses. The value of an expression enclosed in parentheses is the multiplication coefficient w2 for a pixel included in the observed frame Fj as a pixel not corresponding to any pixel in the post-addition frame Fm in the process of adding pixel data.

By the way, when the rotation/parallel-shift addition unit 19 reads out the image data of the observed frame Fj to serve as the active addition operand from the frame memory 42 and the post-addition frame Fm to serve as the active addition operand from the frame memory 43 as described above and adds the image data of the observed frame Fj to the image data of the post-addition frame Fm, the rotation/parallel-shift processing unit 191 supplies address control signals each shown as a dashed arrow in FIG. 56 to the frame memory 42 and the frame memory 43 in order to control read addresses. Let us keep in mind that it is needless to say that, in place of the rotation/parallel-shift processing unit 191, the CPU 1 is also capable of executing the address control.

The rotation/parallel-shift processing unit 191 executes the address control of the frame memory 43 as described above in the same way as the raster scanning operation in which the pixel position (X, Y) on the post-addition frame Fm is specified as a read address, starting with the 0th pixel position on the 0th line and changing the x coordinate of the pixel position in an increasing order in the horizontal direction. As all the pixel positions having the same line number have been specified, the rotation/parallel-shift processing unit 191 ends the operation on the line at the last position on the line and the next line number is specified by incrementing the present line number by 1.

On the other hand, the rotation/parallel-shift processing unit 191 also reads out the image data of the observed frame Fj from the frame memory 42 in such a way that the observed frame Fj is moved by a distance according to computed parallel-shift quantities (α, β) and rotated by an angle according to a computed rotation angle γ. To put it in detail, for passive addition operand read out from a pixel position (X, Y) in the frame memory 43, the rotation/parallel-shift processing unit 191 computes the coordinates (x, y) from the coordinates (X, Y) in accordance with Eq. (13) shown in FIG. 10B and reads out data of the active addition operand from a pixel position at the computed coordinates (x, y) in the frame memory 42.

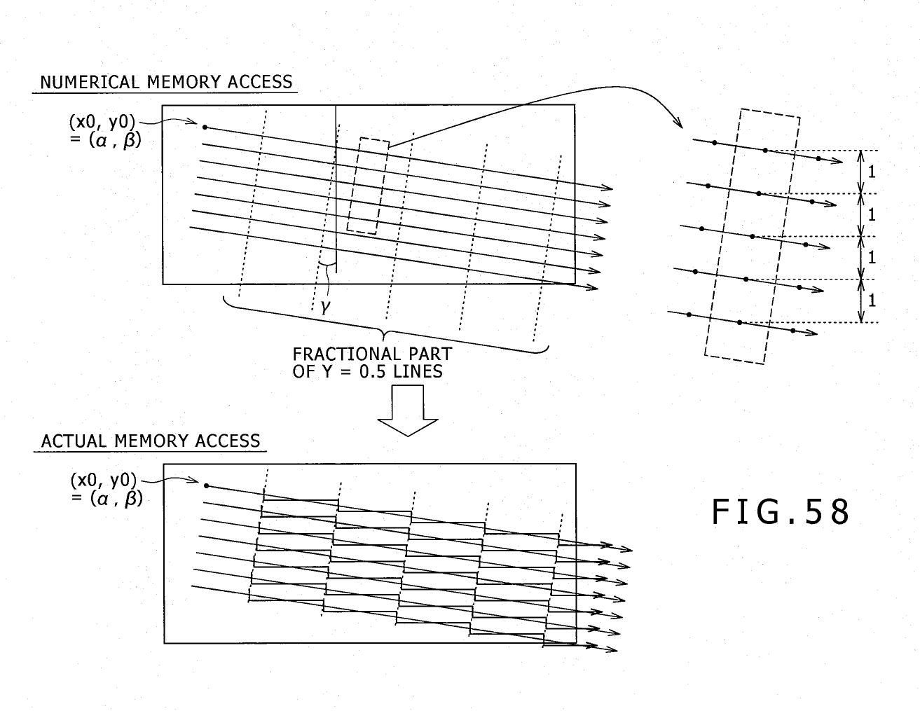

The image of the observed frame Fj to serve as the active addition operand read out from the frame memory 42 at that time in an access to the frame memory 42 is shown in the upper portion of FIG. 58. At that time, points having the same fraction part of the vertical coordinate are lined up along a line inclined by the rotation angle γ from the vertical line of the screen. In FIG. 58, the lines inclined by the rotation angle γ from the vertical line of the screen are each shown as a dashed line. This is because, as shown in the right portion of FIG. 58, as the coordinate value y is incremented by one, the coordinate value Y is also incremented by one in accordance with Eq. (13) shown in FIG. 10B.

This means that, in an access to the frame memory 42 to read out the observed frame Fj from the frame memory 42, the address of a coordinate position (x, y) corresponding to the coordinate position (X, Y) sequentially changed for the reference frame Fm used as the passive operand of the addition needs to be changed in the vertical direction in the course of a change in the horizontal direction in order to provide a step in the vertical direction. As shown in the lower portion of FIG. 58, however, the horizontal coordinate of a position at which a vertical-direction step of the pixel position (x, y) is generated means a gradual shift from line to line.

Thus, if image data is read out from the frame memories 42 and 43 in the so-called burst transfer, the horizontal-direction pixel position with a changing vertical-direction coordinate varies. Thus, the initial address of the burst transfer is difficult to be set at a fixed horizontal-direction pixel position, causing the efficiency of the burst transfer to deteriorate. On the top of that, in accordance with the magnitudes of the computed parallel-shift quantities (α, β) and the computed rotation angle γ, the deterioration degree of the bus-transfer efficiency varies, raising a problem of an increased difference in processing speed between the case of an average and worst deterioration of the burst-transfer efficiency.

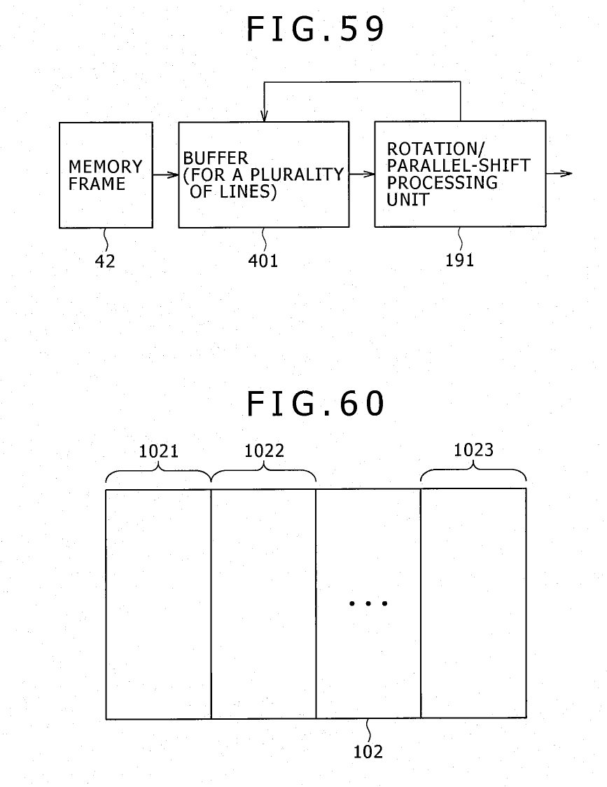

As a method to solve the problem described above, a line memory 401 serving as a buffer memory circuit is provided between the frame memory 42 and the rotation/parallel-shift processing unit 191 as shown in FIG. 59. The line memory 401 has a storage capacity large enough for accommodating image data of a plurality of lines.

In accordance with this method, image data read out from the frame memory 42 without execution of the control of the parallel shift and the control of the rotation is supplied to the line memory 401. Then, the rotation/parallel-shift processing unit 191 computes a pixel position in accordance with Eq. (13) described earlier and reads out data stored at the computed pixel position from the line memory 401.

It is to be noted, however, that if this method is adopted, the cost of the line memory 401 becomes a problem. In order to solve this cost problem, the observed frame 102 is divided into vertical-direction strips 1021, 1022, . . . , and 1023 arranged in the horizontal direction as shown in FIG. 60. Then, the rotation/parallel-shift addition processing needs to be carried out on each of the vertical-direction strips 1021, 1022, . . . , and 1023. In this case, as the line memory 401, a memory needs to be prepared with a storage capacity large enough for accommodating image data of the vertical-direction strips 1021, 1022, . . . , and 1023.

Even by having such a solution, however, it is difficult to deny the fact that the cost of the line memory 401 remains as a problem. Thus, in order to solve this problem, the embodiment lets the low cost take precedence of the picture quality and adopts a technique described below for a case in which the degree of importance of the processing time and the bus bandwidth reduction is high.

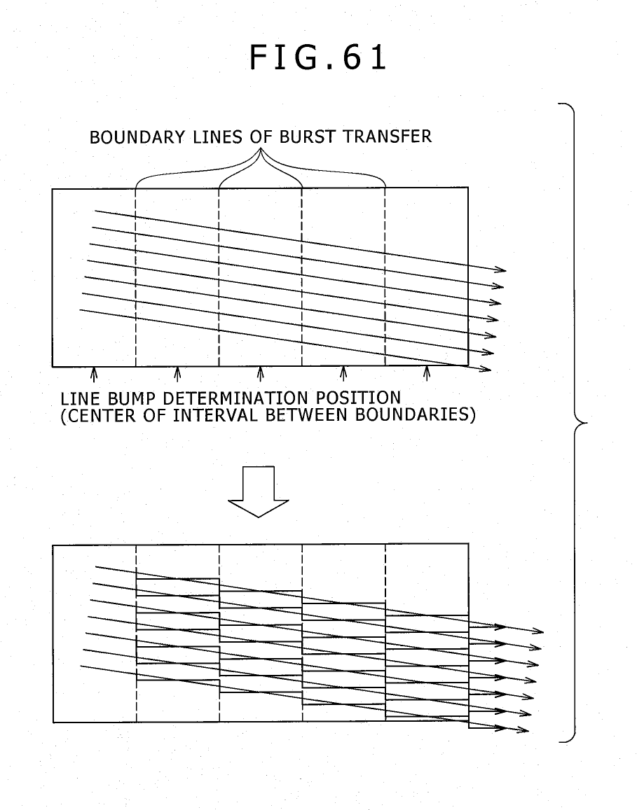

Instead of setting the horizontal-direction pixel position generating a step in the vertical direction in a process to read out data from the frame memory 42 correctly at a position shifted by the rotation angle γ from the vertical direction as shown in FIG. 58, such an address is generated that the boundary address of the burst transfer and the horizontal-direction pixel position generating a step in the vertical direction coincide with each other as shown in FIG. 61.

Thus, as shown in FIG. 61, this embodiment determines a horizontal-direction pixel position generating a step in the vertical direction at the central point of a burst transfer or the middle between adjacent addresses at the boundaries of the burst transfer. For this reason, pre-reading for address computation is usually carried out till the edge of the half of a burst-transfer unit.

If a horizontal-direction pixel position generating a step in the vertical direction is determined on a boundary of a burst transfer, a shift of 1 line is generated at the most. In the case of this embodiment, on the other hand, a horizontal-direction pixel position generating a step in the vertical direction is determined at the central point of a burst transfer in order to give an effect of suppressing the shift to a value not exceeding 0.5 lines.

It is to be noted that, if the phase of a vertical interpolation filter in the resolution conversion unit 16 is smoothly controlled and adjusted to the shift described above, the effect of the shift on the picture quality can be reduced effectively.

By the way, the technique explained by referring to FIG. 61 as a technique adopted by the embodiment is a method aiming at improvement of the burst-transfer efficiency by daringly tolerating errors. Thus, there is raised a conceivable problem of an effect on the picture quality.

In actuality, however, even if the technique according to the embodiment is adopted, most deteriorations of the picture quality are of such a degree that the deteriorations do not raise a problem. This is because, in the case of an ordinary still image taken in a photographing operation, the fineness degree of the pixel precision is difficult to factually be realized and there is also a problem of errors in the detection precision of a movement vector. Thus, if the precision of the operation to read out the image data of an observed frame from the frame memory 42 in a state of being moved by parallel-shift quantities and rotated by an angle of rotation is pursued, the effort is meaningless. On the top of that, by adding a plurality of observed frames to each other repeatedly, an effect caused by a shift in phase level as an effect on a frame obtained as the final result of the addition processes becomes very small.

[Flowchart of the Processing Procedure of the Simple Frame Addition Method]

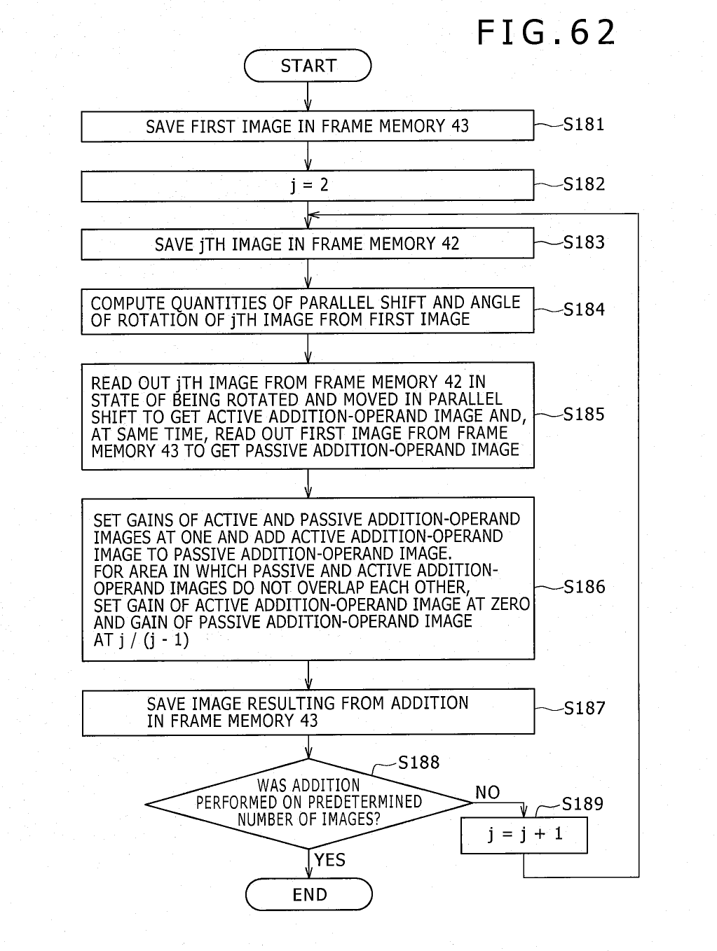

FIG. 62 shows a flowchart referred to in explanation of a processing procedure of the simple frame addition method executed by the rotation/parallel-shift addition unit 19 employed in the image-pickup apparatus according to the embodiment. It is to be noted that the processes of steps in the flowchart shown in FIG. 62 are carried out mainly on the basis of control executed by the CPU 1.

The flowchart shown in the figure begins with a step S181 at which the CPU 1 executes control to save the image data of the first observed frame in the frame memory 43. Then, at the next step S182, the CPU 1 sets a variable j representing the number of observed frames processed so far at two (that is, j=2) indicating the second observed frame.

Subsequently, at the next step S183, the CPU 1 saves the image data of the jth observed frame in the frame memory 42. Then, at the next step S184, the hand-trembling movement-vector detection unit 15 computes a global movement vector representing a movement of the jth observed frame Fj from the first observed frame in accordance with control executed by the CPU 1 as described earlier. In place of a global movement vector, the hand-trembling movement-vector detection unit 15 may also compute the quantities of a parallel shift of the jth observed frame Fj from first observed frame and the angle of a rotation of jth observed frame Fj from first observed frame. Subsequently, the hand-trembling movement-vector detection unit 15 supplies the computed quantities of a parallel shift and the computed angle of rotation to the CPU 1.

Then, at the next step S185, the rotation/parallel-shift addition unit 19 receives the quantities of a parallel shift and the angle of rotation from the CPU 1, reading out the image data of the jth observed frame Fj from the frame memory 42 in state of being rotated by the rotation angle and moved by the parallel-shift quantities to get a so-called active addition-operand frame. At the same time, the rotation/parallel-shift addition unit 19 reads out the image data of the post-addition frame Fm from the frame memory 43 to get a so-called passive addition-operand frame. It is to be noted that the first observed frame is the initial post-addition frame Fm.

Then, at the next step S186, the rotation/parallel-shift addition unit 19 sets both the gains w1 and w2 of the active and passive addition-operand frames respectively at one, adding the pixel data of the active addition-operand frame to the pixel data of the passive addition-operand frame to result in a new post-addition frame Fm. A pixel not corresponding to any pixel on the passive addition-operand frame, that is, for a pixel with pixel data not to be superposed on pixel data of a corresponding pixel may not exist on the passive addition-operand frame. In that case, the gain w1 of the pixel data of the observed frame Fj used as the active addition operand is set at zero or (w1=0) and the gain w2 of the pixel data of the post-addition frame Fm used as the passive addition operand frame at j/(j−1) or (w2=j/(j−1)).

Then, at the next step S187, the rotation/parallel-shift addition unit 19 saves the image data of the new post-addition frame Fm resulting from the addition back in the frame memory 43.

Subsequently, at the next step S188, the CPU 1 produces a result of determination as to whether or not the frame addition process has been performed on a predetermined number of observed frames Fj. If the result of the determination indicates that the frame addition process has not been performed on the predetermined number of observed frames Fj, the flow of the processing procedure goes on to a step S189. The variable j representing the number of processed observed frames Fj is incremented by one (that is, j=j+1). Then, the flow of the processing procedure goes back to the step S183. Subsequently, the execution of the processes of the step S183 and the subsequent steps is repeated.

If the determination result produced in the process carried out at the step S188 indicates that the frame addition process has been performed on the predetermined number of observed frames Fj, on the other hand, the CPU 1 ends the execution of the processing procedure routine shown in FIG. 62.

In accordance with the simple frame addition method described above, the rotation/parallel-shift addition unit 19 sets both the gains w1 and w2 of the active and passive addition-operand frames respectively at one. The pixel data of the active addition-operand frame is added to the pixel data of the passive addition-operand frame to result in a new post-addition frame Fm without discriminating the luminance signal and the chrominance signal from each other. It is excepted for a pixel included in the active addition-operand frame as a pixel not corresponding to any pixel on the passive addition-operand frame, that is, excepted for a pixel included in the active addition-operand frame as a pixel with pixel data not to be superposed on pixel data of a corresponding pixel not existing on the passive addition-operand frame. Thus, the post-addition frame Fm gradually becomes brighter.

For the reason described above, if the simple frame addition method is adopted, it is possible to implement a photographing mode in which the user can display the intermediate post-addition frame Fm or the passive-addition operand serving as a reference frame on a monitor screen while carrying out a continuous photographing operation repeatedly. Then, at a point of time the post-addition frame Fm reaches the intended brightness, the user can stop the continuous photographing operation.

Naturally, a photographing object in an environment with low luminance necessary for a long exposure is continuously photographed while the ISO sensitivity of the camera used in the photographing operation is being suppressed. Thus, the user is capable of verifying a state in which the post-addition image is gradually becoming brighter to match an image taken in a photographing operation with a long exposure. If a histogram can also be displayed on the monitor screen at the same time as an intermediate post-addition image obtained in the course of the photographing operation, a photographing operation can be carried out even more desirably. In addition, of course, it is possible to provide a configuration in which the image-processing apparatus automatically determines the number of observed frames to be added to each other.

(2) Averaging Frame Addition Method

The averaging frame addition method is similar to the simple frame addition method described above except that the gains w1 and w2 of the active addition operand frame and the passive addition operand frame respectively in the averaging frame addition method are different from those of the simple frame addition method. That is to say, in the case of the averaging frame addition method, in a process to add the image data of the second observed frame serving as the active addition operand to the image data of the first observed frame serving as the passive addition operand, the gains w1 and w2 of the active addition operand frame and the passive addition operand frame respectively are both set at ½. In a process to add the image data of the jth observed frame Fj serving as the active addition operand to the image data of the post-addition frame Fm serving as the passive addition operand, on the other hand, the gains w1 and w2 of the active addition operand frame and the passive addition operand frame respectively are set at 1/j or (w1=1/j) and (j−1)/j or (w2=(j−1)/j)) respectively.

That is, while the brightness of the post-addition frame obtained as a result of addition is being fixed independently of the number of additions done so far, the weight applied to the jth active addition operand frame Fj represents a ratio at which the jth active addition operand frame Fj is to be mixed with the post-addition frame. A pixel included in the active addition-operand frame as a pixel not corresponding to any pixel on the passive addition-operand frame, that is, for a pixel included in the active addition-operand frame as a pixel with pixel data not to be superposed on pixel data of a corresponding pixel may not exist on the passive addition-operand frame. In that case, the rotation/parallel-shift addition unit 19 sets the gain w1 of the pixel data of the observed frame Fj used as the active addition operand at zero (that is, w1=0) and the gain w2 of the pixel data of the post-addition frame Fm used as the passive addition operand frame at 1 (that is, w2=1) in order to sustain the brightness of the post addition frame throughout the whole frame.

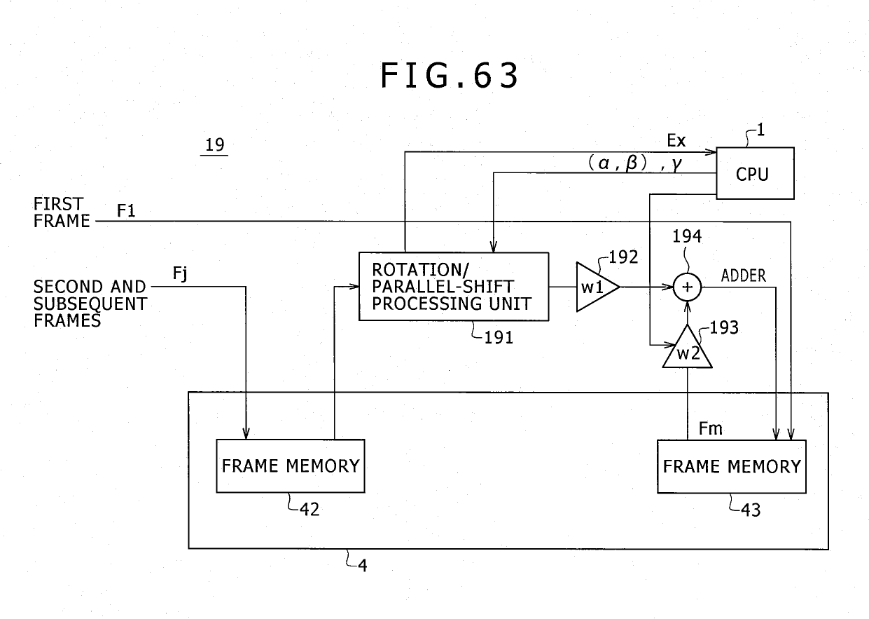

FIG. 63 is a block diagram showing relations between the rotation/parallel-shift addition unit 19 and the image memory unit 4 for the averaging frame addition method. As shown in the figure, the rotation/parallel-shift addition unit 19 employs a rotation/parallel-shift processing unit 191, gain amplifiers 192 and 193 as well as an adder 194 in the same way as the simple frame addition method shown in FIG. 56. In the case of the averaging frame addition method, however, the gain w1 of the gain amplifier 193 and the gain w2 of the adder 194 are each dependent on the number of observed frames added to each other so far. Thus, the averaging frame addition method is different from the simple frame addition method in that, in the case of the averaging frame addition method, the values of the gains w1 and w2 are provided by the CPU 1.

It is to be noted that the control of an operation to read out image data from the frame memory 42 in the averaging frame addition method is executed in exactly the same way as the simple frame addition method described above.

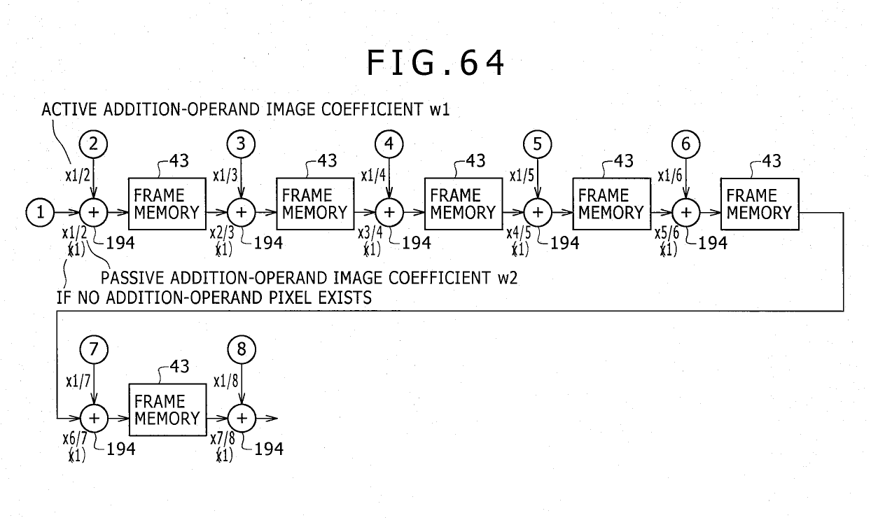

FIG. 64 is a diagram showing the process to add the observed frame Fj to the post-addition frame Fm in accordance with the averaging frame addition method. As shown in FIG. 64, the adder 194 and the frame memory 43 are used repeatedly to superpose observed frames Fj on each other. In the typical frame addition process shown in FIG. 64, eight observed frames Fj are superposed on each other. In FIG. 64, an integer j enclosed in a circle represents the jth observed frame Fj. The gain w2 also referred to as the multiplication coefficient w2 can be the value of an expression not enclosed in parentheses or a value x1 enclosed in parentheses. The value x1 enclosed in parentheses is the multiplication coefficient w2 for a pixel included in the observed frame Fj as a pixel not corresponding to any pixel in the post-addition frame Fm in the process of adding pixel data.

As shown in FIG. 64, the gain w1 of the jth observed frame Fj is set at 1/j or (w1=1/j) whereas the gain w2 of the post-addition frame is set at (j−1)/j or (w2=(j−1)/j)).

The flowchart shown in the figure begins with a step S191 at which the CPU 1 executes control to save the first observed frame in the frame memory 43. Then, at the next step S192, the CPU 1 sets a variable j representing the number of observed frames processed so far at 2 (that is, j=2) indicating the second observed frame.

Subsequently, at the next step S193, the CPU 1 saves the jth observed frame Fj in the frame memory 42. Then, at the next step S194, the hand-trembling movement-vector detection unit 15 computes a global movement vector representing a movement of the jth observed frame Fj from the first observed frame in accordance with control executed by the CPU 1 as described earlier. In place of a global movement vector, the hand-trembling movement-vector detection unit 15 may also compute the quantities of a parallel shift of the jth observed frame Fj from first observed frame and the angle of a rotation of jth observed frame Fj from first observed frame. Subsequently, the hand-trembling movement-vector detection unit 15 supplies the computed quantities of a parallel shift and the computed angle of rotation to the CPU 1.

Then, at the next step S195, the rotation/parallel-shift addition unit 19 receives the quantities of a parallel shift and the angle of rotation from the CPU 1, reading out the jth observed frame Fj from the frame memory 42 in state of being rotated by the rotation angle and moved by the parallel-shift quantities to get a so-called active addition-operand frame. At the same time, the rotation/parallel-shift addition unit 19 reads out the image data of the post-addition frame Fm from the frame memory 43 to get a so-called passive addition-operand frame. It is to be noted that the first observed frame is the initial post-addition frame Fm.

Then, at the next step S196, the rotation/parallel-shift addition unit 19 sets both the gains w1 and w2 of the active and passive addition-operand frames respectively at 1/j or (w1=1/j) and (j−1)/j or (w2=(j−1)/j) respectively, adding the pixel data of the active addition-operand frame to the pixel data of the passive addition-operand frame to result in a new post-addition frame Fm. A pixel included in the active addition-operand frame as a pixel not corresponding to any pixel on the passive addition-operand frame, that is, for a pixel included in the active addition-operand frame as a pixel with pixel data not to be superposed on pixel data of a corresponding pixel may not exist on the passive addition-operand frame. In that case, the rotation/parallel-shift addition unit 19 sets the gain w1 of the pixel data of the observed frame Fj used as the active addition operand at zero (that is, w1=0) and the gain w2 of the pixel data of the post-addition frame Fm used as the passive addition operand frame at 1 (that is, w2=1).

Then, at the next step S197, the rotation/parallel-shift addition unit 19 saves the image data of the new post-addition frame Fm resulting from the addition back in the frame memory 43.

Subsequently, at the next step S198, the CPU 1 produces a result of determination as to whether or not the frame addition process has been performed on a predetermined number of observed frames Fj. If the result of the determination indicates that the frame addition process has not been performed on the predetermined number of observed frames Fj, the flow of the processing procedure goes on to a step S199. The variable j representing the number of processed observed frames is incremented by 1 (that is, j=J+1). Then, the flow of the processing procedure goes back to the step S193. Subsequently, the execution of the processes of the step S193 and the subsequent steps is repeated.

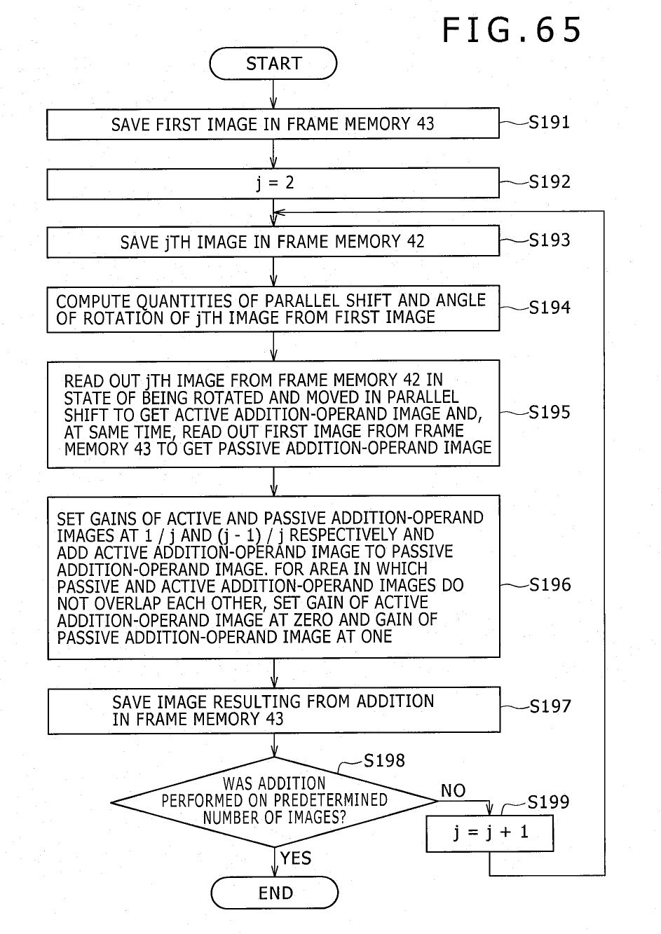

If the determination result produced in the process carried out at the step S198 indicates that the frame addition process has been performed on the predetermined number of observed frames Fj, on the other hand, the CPU 1 ends the execution of the processing procedure routine shown in FIG. 65.

As an application adopting the averaging frame addition method, the image-pickup apparatus according to the embodiment is provided with a gimmick (special effect) function according to which the moving object of photographing disappears. That is to say, in accordance with the averaging frame addition method, it is possible to implement a new photographing mode, which did not exist in the past. In this new photographing mode, the brightness of the image does not change from the brightness of the first observed frame subjected to the frame addition process but, every time a continuous photographing operation is carried out, the moving object of photographing gets blurred little by little and finally disappears. The moving object of photographing is a moving portion of the observed frame. It is to be noted that, every time the frame addition process is carried out, noises can be eliminated from the observed frame by virtue of an addition effect. However, the addition effect of noise elimination from the observed frame is no more than a secondary effect.

(3) Tournament Frame Addition Method

In the case of the simple frame addition method and the averaging frame addition method, the first observed frame is taken as the initial inference frame whereas the second and subsequent observed frames are each used as a frame to be added to the first observed frame and a post-addition frame respectively to result in a most recent post-addition frame. In the case of the tournament frame addition method, on the other hand, every observed frame is handled equally. Thus, the reference frame is by no means limited to the first observed frame. That is to say, any of the observed frames can be taken as the inference frame. In consequence, two observed frames serving as the active and passive addition operands respectively are subjected to a parallel shift and a rotation.

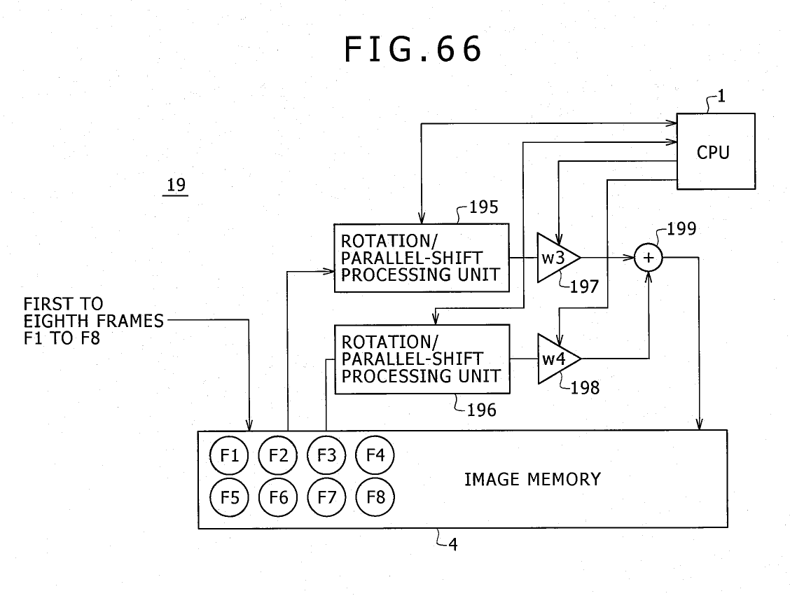

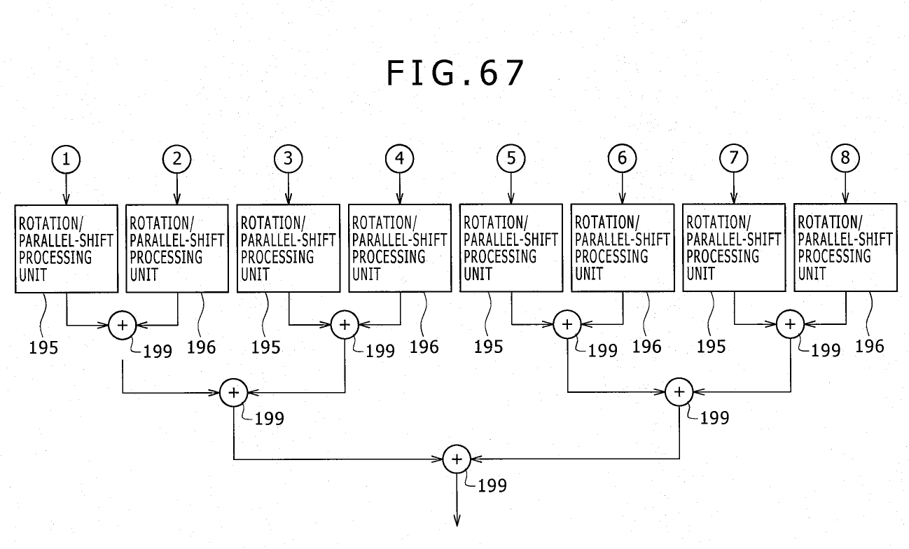

FIG. 66 is a block diagram showing relations between the rotation/parallel-shift addition unit 19, the image memory unit 4 and the CPU 1 for the tournament frame addition method. As shown in the figure, the rotation/parallel-shift addition unit 19 employs two rotation/parallel-shift processing units 195 and 196, gain amplifiers 197 and 198 as well as an adder 199.

The image memory unit 4 employs at least two frame memories 41 and 42 used by the hand-trembling movement-vector detection unit 15 for carrying out a process to detect a hand-trembling movement vector as described earlier. In addition, the image memory unit 4 also employs a frame memory 43 for storing a post-addition frame obtained as a result of adding observed frames to a reference frame also as explained before. In the case of the tournament frame addition method, however, the frame memory 43 is configured to have a size large enough for storing several frames each serving as an addition operand.

That is to say, when the tournament frame addition method is selected, the image-pickup apparatus takes consecutive images each serving as an addition operand in a continuous photographing operation and stores the observed frames of the taken images in the frame memory 43. Then, one of the observed frames is taken as a reference frame before the frame addition process is started.

It is to be noted that, also in the case of the tournament frame addition method, the control to read out image data of frames each serving as a an addition operand in the frame addition process from the image memory unit 4 is executed in exactly the same way as the simple frame addition method described earlier.

In a typical tournament frame addition process explained below, eight observed frames are each used as an object of addition processing. Notations F1 to F8 each enclosed in a circle shown in FIG. 66 each denote one of eight observed frames F1 to F8 taken in a continuous photographing operation and stored in the frame memory 43.

Before a frame addition process is started, the hand-trembling movement-vector detection unit 15 has finished all processing to find information for each of the eight observed frames. The information includes every-block movement vector and a global movement vector.

As described above, however, the hand-trembling movement-vector detection unit 15 is capable of computing a movement vector representing a movement of the present observed frame from the immediately leading ahead of observed frame or the first observed frame serving as a reference frame. Thus, either a cumulative error is tolerated or a movement vector representing a movement of the present observed frame from the most recent post-addition frame is found.

FIG. 67 is a diagram referred to in explaining the outline of the tournament frame addition method. In FIG. 67, numbers 1 to 8 each enclosed in a circle shown in FIG. 66 denote the eight aforementioned observed frames F1 to F8 respectively. First of all, at a first stage of the tournament frame addition method, in the case of these typical observed frames F1 to F8, processes are carried out to add the image data of the first observed frame F1 to the image data of the second observed frame F2, the third observed frame F3 to the fourth observed frame F4, the fifth observed frame F5 to the sixth observed frame F6, and the seventh observed frame F7 to the eighth observed frame F8.

In detail, at the first stage of the tournament frame addition method, the rotation/parallel-shift processing unit 195 rotates the first observed frame F1 by an angle of rotation from a reference frame selected in advance and moves the first observed frame F1 by parallel-shift quantities from the reference frame. The rotation/parallel-shift processing unit 195 rotates the second observed frame F2 by an angle of rotation from the reference frame and moves the second observed frame F2 by parallel-shift quantities from the reference frame. Then, the adder 199 adds weighted image data of a frame output by the rotation/parallel-shift processing unit 195 to weighted image data of a frame output by the rotation/parallel-shift processing unit 196 to result in a frame (F1+F2). These operations are carried out in the same way on the third observed frame F3 and the fourth observed frame F4, the fifth observed frame F5 and the sixth observed frame F6 as well as the seventh observed frame F7 and the eighth observed frame F8 to result in frames (F3+F4), (F5+F6) as well as (F7+F8) respectively.

When the additions of the first stage are completed, a second stage of the tournament frame addition method is started. In the case of the typical observed frames F1 to F8 shown in FIG. 57, the adder 199 adds weighted image data of the frame (F1+F2) to weighted image data of the frame (F3+F4) to result in a frame (F1+F2+F3+F4). By the same token, the adder 199 adds weighted image data of the frame (F5+F6) to weighted image data of the frame (F7+F8) to result in a frame (F5+F6+F7+F8). Since the operands of the additions carried out at the second stage are each a result of processes based on the reference frame, the rotation and parallel-shift operations carried out by the rotation/parallel-shift processing unit 195 and the rotation/parallel-shift processing unit 196 are no longer necessary in the second stage of the tournament frame addition method.

When the additions of the second stage are completed, a third stage of the tournament frame addition method is started. In the case of the typical observed frames F1 to F8 shown in FIG. 67, the adder 199 adds weighted image data of the frame (F1+F2+F3+F4) to weighted image data of the frame (F5+F6+F7+F8) to result in a final frame. By the same token, since the operands of the additions carried out at the third stage are each a result of processes based on the reference frame, the rotation and parallel-shift operations carried out by the rotation/parallel-shift processing unit 195 and the rotation/parallel-shift processing unit 196 are no longer necessary in the third stage of the tournament frame addition method.

The above processes are explained in more detail by referring back to FIG. 66. When the addition process is started, first of all, the CPU 1 determines two observed frames to serve as operands used in an addition process carried out at the first stage. The CPU 1 provides the rotation/parallel-shift processing unit 195 and the rotation/parallel-shift processing unit 196 typically with parallel-shift quantities representing a movement of each of the two observed frames from the reference frame and the angle of a rotation of each of the two observed frames from the reference frame.

Then, the rotation/parallel-shift processing units 195 and 196 each read out image data of the two observed frames respectively from the image memory unit 4 in a state of being rotated by the rotation angle received from the CPU 1 for each of the two observed frames and moved by the parallel-shift quantities received from the CPU 1 for each of the two observed frames in order to cancel the rotation and movement of each of the two observed frames from the reference frame.

The image data of one of the two observed frames, which is output by the rotation/parallel-shift processing unit 195, is supplied to the gain amplifier 197 for multiplying the image data by a gain w3. The image data of the other observed frame output by the rotation/parallel-shift processing unit 196 is supplied to the gain amplifier 198 for multiplying the image data by a gain w4. Then, the gain amplifier 197 and the gain amplifier 198 supply the two pieces of weighted image data to the adder 199 for adding the two pieces of weighted image to each other and storing the addition result in a frame buffer of the image memory unit 4.

At the first stage shown in FIG. 67, the CPU 1, the rotation/parallel-shift processing unit 195, the rotation/parallel-shift processing unit 196, the gain amplifier 197, the gain amplifier 198, and the adder 199 carry out the same processing as the two observed frames mentioned above on other pairs of observed frames and each of the addition results is stored in the frame buffer of the image memory unit 4.

When the additions of the first stage are completed, at the second stage shown in FIG. 67, the CPU 1 determines two addition results of the first stage to serve as operands used in an addition process carried out at the second stage. In this case, however, the CPU 1 provides the rotation/parallel-shift processing unit 195 and the rotation/parallel-shift processing unit 196 with parallel-shift quantities of zero, a rotation angle of zero and a command to read out the two addition results from the frame buffer of the image memory unit 4.

Then, in accordance with the command given by the CPU 1, the rotation/parallel-shift processing units 195 and 196 each read out image data of the two addition results respectively from the frame buffer of the image memory unit 4 in a state of being rotated by the rotation angle of zero and moved by the parallel-shift quantities of zero. The image data of one of the two addition results, which is output by the rotation/parallel-shift processing unit 195, is supplied to the gain amplifier 197 for multiplying the image data by the gain w3. The image data of the other addition result output by the rotation/parallel-shift processing unit 196 is supplied to the gain amplifier 198 for multiplying the image data by the gain w4. Then, the gain amplifier 197 and the gain amplifier 198 supply the two pieces of weighted image data to the adder 199 for adding the two pieces of weighted image to each other and storing a total addition result in the frame buffer of the image memory unit 4. The above processes are carried out in the same way on the other pair of addition results to give another total addition result.

When the additions of the second stage are completed, at the third stage shown in FIG. 67, the CPU 1 determines two total addition results of the second stage to serve as operands used in an addition process carried out at the third stage. Also in this case, the CPU 1 provides the rotation/parallel-shift processing unit 195 and the rotation/parallel-shift processing unit 196 with parallel-shift quantities of zero, a rotation angle of zero and a command to read out the two addition results from the frame buffer of the image memory unit 4.

Then, in accordance with a command given by the CPU 1, the rotation/parallel-shift processing units 195 and 196 each read out image data of the two total addition results at the third stage of the frame addition process shown in FIG. 67. At this point of time, the execution of the tournament frame addition processing is completed.

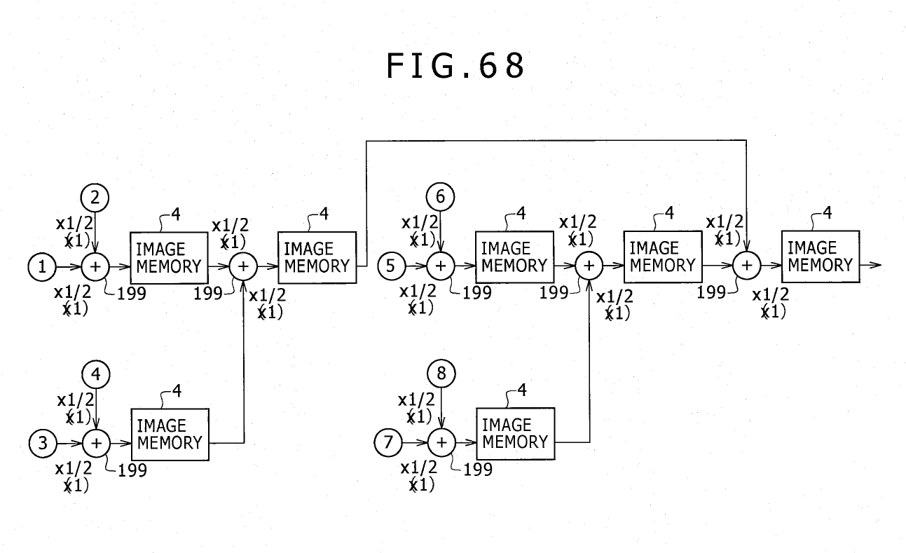

FIG. 68 is a diagram showing the values of the gains (multiplication coefficients) w3 and w4 used by the gain amplifier 197 and the gain amplifier 198 respectively in the addition processing according to the tournament frame addition method for the eight observed frames as well as flows of operands used in the frame addition processing and results of the frame addition processing.

The values of the gains w3 and w4 shown in FIG. 68 are the typical values used in the averaging frame addition method. That is to say, for a pixel included in one of the addition operands as a pixel corresponding to a pixel in the other addition operand, the gains w3 and w4 are each set at ½ (that is, w3=w4=½). For a pixel included in one of the addition operands as a pixel corresponding to no pixel in the other addition operand, on the other hand, one of the gains w3 and w4 is set at zero while the other gain is set at one (that is, either w3=0 and w4=1 or w3=1 and w4=0).

It is to be noted, however, that the values of the gains w3 and w4 shown in FIG. 68 are by no means limited to the typical values used in the averaging frame addition method. For example, the values of the gains w3 and w4 can also be the typical values used in the simple frame addition method.

The tournament frame addition method has a configuration in which, at the second and subsequent stages, every pixel position in the area of the reference frame is examined to determine whether or not the pixel position corresponds to a pixel position obtained as a result of the addition process carried out at the first stage to add the two observed frames each moved and rotated from the reference image. However, this feature is not explained in the above description.

In this feature, if the pixel value of the luminance component Y of the frame resulting from the addition process carried out at the first stage is zero, the pixel value is changed to one. The above operation to change the pixel value of zero to one is accompanied by an operation to set the pixel value of the luminance component Y of a pixel, which is included in the frame resulting from the addition process carried out at the first stage as a pixel not corresponding to any pixels of the two observed frames each moved and rotated from the reference image, at zero.

At the second and subsequent stages, if the pixel values of the luminance components Y of the two addition-operand frames are zero, the pixel value of the luminance component Y of the post-addition frame is also set at zero. After all the eight frames have been subjected to the addition processing, all pixels usually include valid pixels (or pixels of the reference frame). Thus, a zero luminance value of a pixel is replaced with a pixel value of the reference frame.

By taking the zero pixel value of the luminance component Y as the value of an invalid pixel flag as described above, with the format of the image data kept as it is, it is possible to provide a determination flag of a pixel for which a valid pixel does not exist in the frame superposition process.

Of course, for a pixel position for which such a valid pixel does not exist in the frame superposition process, an invalid pixel flag can be provided separately as 1 bit. In addition, any pixel value can also be used as a flag without regard to whether the component is the luminance signal component Y or the chrominance signal component Cb/Cr. If the cost and effects on the picture quality are taken into consideration, however, the technique of making use of the invalid pixel flag according to the embodiment can be considered to be an effective method.

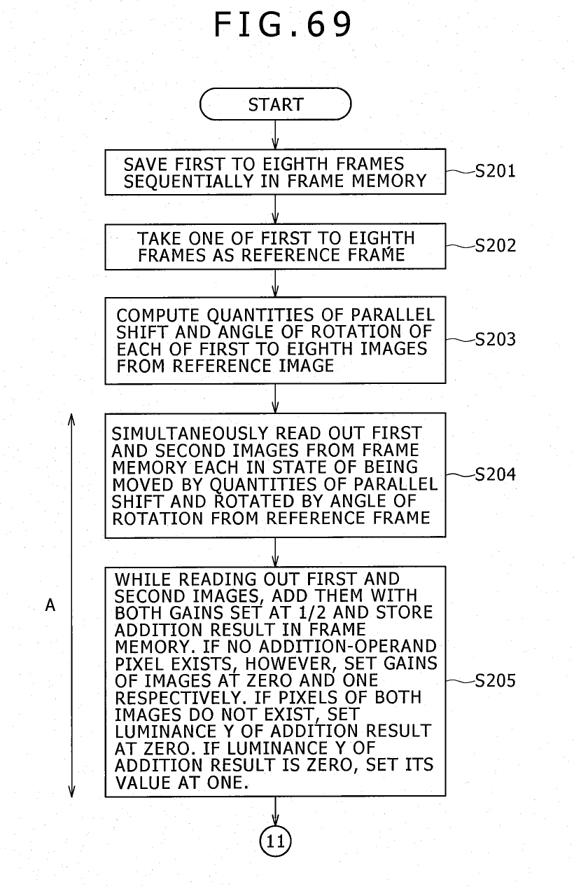

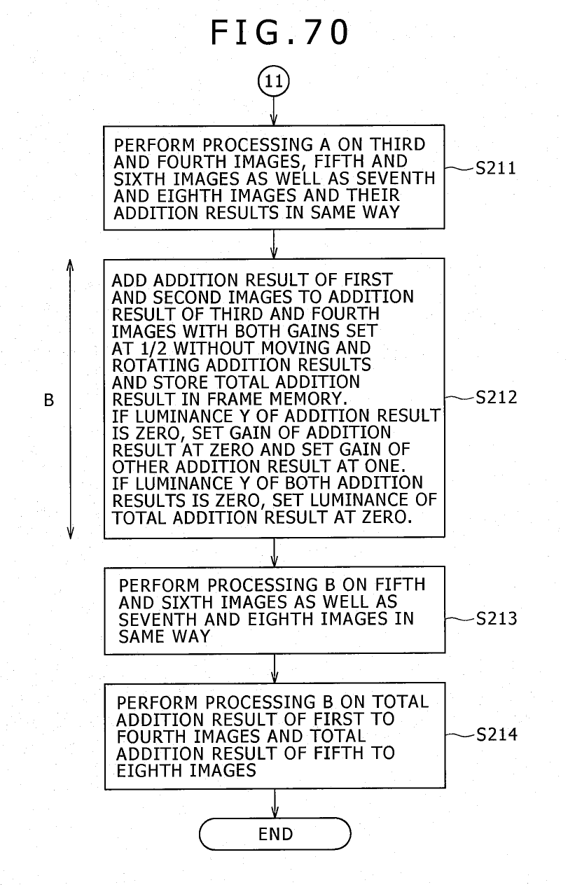

FIGS. 69 and 70 shows a flowchart referred to in explanation of a processing procedure of the tournament frame addition method executed by the rotation/parallel-shift addition unit 19 employed in the image-pickup apparatus according to the embodiment. It is to be noted that the processes of steps in the flowchart shown in FIGS. 69 and 70 are carried out mainly on the basis of control executed by the CPU 1.

As shown in the figures, the flowchart begins with a step S201 at which the CPU 1 saves the image data of the first to eighth observed frames sequentially in the frame memories of the image memory unit 4. Then, at the next step S202, the CPU 1 selects one of the first to eighth observed frames as a reference frame. Subsequently, at the next step S203, the CPU 1 computes quantities of a parallel shift of an observed frame from the reference frame and the angle of a rotation of the observed frame from the reference frame for each of the first to eighth observed images.

Then, at the next step S204, the CPU 1 starts the addition process of the first stage. At the first stage, the CPU 1 provides the rotation/parallel-shift addition unit 19 with quantities representing a parallel shift of each of the first and second observed frames from the reference frame as well as the angle of a rotation of each of the first and second observed frames from the reference frame. Then, the rotation/parallel-shift addition unit 19 simultaneously reads out the image data of each of the first and second observed frames from the frame memory 4 each in state of being moved by the parallel-shift quantities received from the CPU 1 for the observed frame and rotated by the rotation angle received from the CPU 1 for the observed frame. The parallel shift and rotation of each of the first and second observed frames from the reference frame are canceled.

Subsequently, at the next step S205, while reading out the image data of the first and second observed frames from the image memory unit 4 in accordance with control executed by the CPU 1, the rotation/parallel-shift addition unit 19 adds the image data of the first and second observed frames with both the gains w3 and w4 set at ½ and stores the result of the addition in a frame buffer of the image memory unit 4.

In the process carried out at the step S205, pixel positions are set sequentially in the area of the reference frame. A pixel position is a position at which pixel data obtained as a result of addition is to be stored. Then, the image data of the first observed frame is searched for a pixel corresponding to a pixel at every set pixel position in the reference frame. By the same token, the image data of the second observed frame is searched for a pixel corresponding to a pixel at the set pixel position in the reference frame. If pixels are found in both the first and second observed frames during the search process, the gains w3 and w4 are both set at ½. Subsequently, the pixel values of the two pixels found in the search process for the first and second observed frames respectively are added to each other and the result of the addition is stored at the set pixel position of the pixel included in the reference frame as a pixel corresponding to the two pixels. If no pixel is found in either specific one of the first and second observed frames during the search process, the rotation/parallel-shift addition unit 19 sets the gain for the specific observed frame at zero. If a pixel is found in either specific one of the first and second observed frames during the search process but no pixel is found in the other one of the first and second observed frames during the search process, the rotation/parallel-shift addition unit 19 sets the gain for the specific observed frame at 1 but the gain for the other observed frame at zero.

If no pixels are found in both the first and second observed frames during the search process, the rotation/parallel-shift addition unit 19 sets the pixel value of the luminance Y of the addition result at zero. In addition, if the addition result of the pixel data is zero for a case in which pixels are found in both the first and second observed frames during the search process, the rotation/parallel-shift addition unit 19 changes the pixel value to one.

Then, at the next step S211 of the flowchart shown in FIG. 70, the CPU 1 gives a command to the rotation/parallel-shift addition unit 19 to carry out the processes of the steps S204 and S205 on the third and fourth observed frames, the fifth and sixth observed frames as well as the seventh and eighth observed frames in the same way as the steps S204 and S205. In accordance with the command, the rotation/parallel-shift addition unit 19 carries out the processes.

Then, at the next step S212, the CPU 1 gives a command to the rotation/parallel-shift addition unit 19 to start the addition process of the second stage. In accordance with the command received from the CPU 1, the rotation/parallel-shift addition unit 19 adds the image data of the addition result of adding the first and second observed frames to each other to the image data of adding the third and fourth observed frames to each other with both the gains w3 and w4 set at ½ by reading out the data from the image memory unit 4 without moving and rotating the image data.

If the luminance Y of the pixel data of the addition result obtained from the first and second observed frames at the step S212 and/or the luminance Y of the pixel data of the addition result obtained from the third and fourth observed frames at the step S212 is zero, the rotation/parallel-shift addition unit 19 sets the gain for the pixel data with a luminance Y of zero at zero. However, the rotation/parallel-shift addition unit 19 sets the gain for the pixel data with a luminance Y of one at one.

If the luminance Y of the pixel data of both the above addition results to be added in the process carried out at the step S212 is zero, in the process carried out at the step S212, the rotation/parallel-shift addition unit 19 sets the luminance Y of the pixel data of the total addition result at zero.

Then, at the next step S213, the CPU 1 gives a command to the rotation/parallel-shift addition unit 19 to carry out the process of the step S212 on the image data of the addition result obtained from the fifth and sixth observed frames at the step S212 and the image data of the addition result obtained from the seventh and eighth observed frames at the step S212 in the same way as the step S212. In accordance with the command received from the CPU 1, the rotation/parallel-shift addition unit 19 carries out the process to give another total addition result.

Then, at the next step S214, the CPU 1 gives a command to the rotation/parallel-shift addition unit 19 to carry out the process of the step S212 on the total addition result at the step S212 for the first, second, third, and fourth observed frames and the total addition result carried out at the step S212 for the fifth, sixth, seventh, and eighth observed frames in the same way as the step S212. In accordance with the command received from the CPU 1, the rotation/parallel-shift addition unit 19 carries out the process to give a final result.

After the process carried out at the step S214 is completed, the execution of the processing to add the first to eighth observed frames to each other in accordance with the tournament frame addition method provided by the embodiment is ended.

There are two features of the tournament frame addition method according to the embodiment. One of the features is that, at the first stage of the tournament frame addition method, except the reference frame, any two observed frames each serving as an operand of an addition process are each subjected to a movement indicated by parallel-shift quantities and a rotation indicated by a rotation angle before being added to each other to give a result of addition. Then, at the second and subsequent stages of the tournament frame addition method, the addition results obtained at the first stage are added to each other without moving and rotating the addition results. The addition carried out at the first stage corresponds to processing A carried out at the steps S204 and S205 of the flowchart shown in FIG. 69. The additions carried out at the second and subsequent stages correspond to processing B carried out at the step S212 of the flowchart shown in FIG. 70.

The other feature of the tournament frame addition method according to the embodiment is that a mechanism is set to work at the second and subsequent stages as a mechanism for determining whether or not pixel positions are included in the two observed frames processed at the first stage as positions of pixels corresponding to no pixels in the reference frame.

In the typical processing carried out by adoption of the tournament frame addition method according to the embodiment as described above, eight observed frames taken in advance consecutively in a continuous photographing operation are added to each other. It is to be noted, however, that the process to store the eight observed frames is important and the number of observed frames to be added to each other is not significant. If the characteristic of the tournament frame addition method is taken into consideration, however, it is desirable to set the number of such observed frames at the jth power of two where j is an integer.

The tournament frame addition method according to the embodiment offers two merits. One of the merits is that, first of all, all observed frames to be added to each other are taken in advance in a photographing operation and, then, any one of the taken frames can be selected as a reference frame as described earlier. Thus, while the photographing operation is being carried out continuously, hand-trembling vectors can be detected in advance and a frame positioned in the middle of the locus of hand-trembling vectors detected during the continuous photographing operation can be selected as a reference frame so as to be capable of setting the valid area of an image obtained as a result of an addition process as an area with a largest possible size.

The other merit offered by the tournament frame addition method according to the embodiment is that the images of all observed frames to be added to each other can be handled equally. For example, in the case of the averaging frame addition method described before, the addition coefficient is changed in accordance with the number of observed frames processed so far so as to make the weights of frames each obtained as a result of an addition process equal to each other. Nevertheless, a digital rounding-off error is generated. As a result, the weights of frames each obtained as a result of an addition process are difficult to be made completely equal to each other. In the case of the tournament frame addition method according to the embodiment, on the other hand, frames are added to each other by making use of completely equal coefficients. Thus, the effect of the rounding-off error does not include a bias.

In accordance with the tournament frame addition method, however, all observed frames are stored in a memory in advance. Thus, a memory with a large storage capacity is necessary. In addition, the number of successive images that can be taken in a continuous photographing operation is limited by an upper limit. In consequence, the tournament frame addition method raises a problem that the addition processing is difficult to be carried out infinitely as is the case with the simple frame addition method and the averaging frame addition method, which have been descried earlier.

If architecture is adopted to temporarily store observed frames taken in a continuous photographing operation in an external storage unit having a very low cost per bit, however, the problem described above can be solved. An example of the external storage unit having a very low cost per bit is a hard disk.

Methods for avoiding effects of not only hand trembling but also trembling of a moving object of photographing have been drawing much attention from the market of the high-sensitivity photographing in recent years. The high-sensitivity photographing is photographing at a high sensitivity in such a typical short exposure time such as 1/60 seconds that the hand trembling and the trembling of a moving object of photographing hardly occur.

In this case, there is raised a problem as to how far the ISO sensitivity can be kept up with while the S/N is being suppressed. Normally, if the sensitivity is increased, noises of the picture undesirably become striking at the same time. Thus, the manufacturers of digital cameras make efforts to suppress noises by adoption of a variety of techniques in order to advocate the magnitude of the numerical value of the highest ISO sensitivity capable of sustaining the S/N at a fixed level as performance.

One of objectives to solve the main problem also encountered by the embodiment as a problem to compensate a still image for effects of hand trembling is reduction of noises. In a process to add a plurality of observed frames to each other, the portion of a moving object of photographing is detected and no addition is carried out, or the portion of a moving object of photographing is searched. An addition is carried out to make it possible to implement noise reduction with apparent high sensitivity as noise reduction for coping with the moving object of photographing.

If N observed frames are added to each other in handling random noises, statistically, the number of noise components is reduced by a factor equal to the square root of N. That is to say, by adding 16 observed frames for a moving object of photographing to each other in a digital camera exhibiting a real-power value conforming to ISO3200, the ISO sensitivity of the set can be advocated as ISO12800, which is four times ISO3200.

As an addition method demanded in this case, while the processing time can be lengthened to a certain degree even for a process to add a fixed number of observed frames, a picture quality as high as possible is necessary. The tournament frame addition method according to the embodiment is a method meeting this necessity. Conversely, the improvement of the ISO sensitivity in a high-sensitivity photographing operation can be given as an application well suitable for the tournament frame addition method.

As described above, the image-pickup apparatus according to the embodiment is provided with three methods of adding observed frames to each other, i.e., the simple frame addition method, the averaging frame addition method, and the tournament frame addition method. As explained earlier, each individual one of the three methods of adding observed frames to each other has a digital-camera application suitable for the individual method.

By carrying out an operation on the user-operation input unit 3 employed in the image-pickup apparatus according to the embodiment, the user is capable of selecting any one of the three methods of adding observed frames to each other as a method to be adopted in the image-pickup apparatus. Thus, the image-pickup apparatus offers a merit of allowing the user to specify a frame addition method in accordance with a result desired by the user as a result of the process of adding observed frames to each other.

Instead of allowing the user to directly selecting any one of the three methods of adding observed frames to each other, it is possible to provide a configuration in which the image-pickup apparatus is provided with a function capable of selecting an application that is optimum for one of the frame addition methods. Alternatively, when the user specifies an application, the CPU 1 automatically carries out a function to select one of the methods as a frame addition method that is optimum for the specified application.

In addition, the image-pickup apparatus according to the embodiment also offers another merit. with one digital camera, it is possible to implement three new applications, i.e., a photographing operation carried out in the hand-held camera at a long exposure time, a gimmick (special effect) function according to which the moving object of photographing disappears gradually and a photographing operation with a high sensitivity at least equal to the real-power value.

### Second Embodiment Implementing the Image-Processing Apparatus

It is assumed that, in the hand-trembling movement-vector detection unit 15 employed in the image-processing apparatus implemented as the first embodiment of the image-processing apparatus as described above, the image memory unit 4 includes frame memories used for storing two images, i.e., the image of an observed frame and the image of an original frame immediately leading ahead of the observed frame, as shown in FIG. 1. For this reason, a timing to detect a movement vector representing a movement from the original frame is delayed by a time corresponding to one frame.

In the case of a second embodiment, on the other hand, image data currently flowing out from the image-pickup device 11 is taken as the image data of an observed frame. Thus, in such a configuration, the second embodiment is capable of computing SAD values in a real-time manner for the stream data of a raster scan.

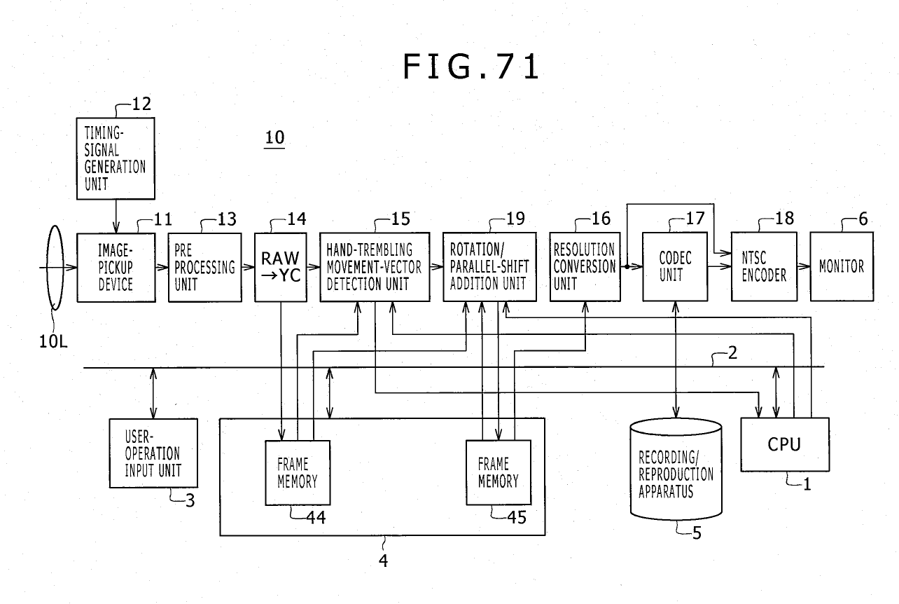

FIG. 71 is a block diagram showing a typical configuration of an image-pickup apparatus 10 according to the second embodiment. As is obvious from FIG. 71, the image-pickup apparatus 10 according to the second embodiment includes a taken-image signal processing system and other components in a configuration completely identical with the first embodiment shown in FIG. 1. In the case of the second embodiment, however, the image memory unit 4 employs two frame memories, i.e. a frame memory 44 and a frame memory 45. The frame memory 44 is a memory used in processing to detect a movement vector whereas the frame memory 45 is a memory used in processing to superpose frame images on each other.

It is to be noted that, in actuality, if the frame memories employed in the image memory unit 4 do not allow data to be written into them and read out from them at the same time, as is generally known, the frame memory 44 is used as two memory banks used by alternately switching the access operation from one bank to the other so as to allow data to be written into one of the banks and other data to be read out from the other bank at the same time.

As will be described later, by taking pixel data received from the data conversion unit 14 as pixel data of an observed frame and image data stored in the frame memory 44 as image data of the original frame, the movement-vector detection unit 15 carries out processes. These processes are to generate shrunk SAD tables, to detect an every-block movement vector for each of the shrunk SAD tables, to generate a SAD total table from the shrunk SAD tables, and to detect a global movement vector (also referred to as a hand-trembling vector) from the SAD total table. In addition, in the case of the second embodiment, besides the global movement vector (also referred to as hand-trembling parallel-shift movement components) and parallel-shift quantities (α, β), the movement-vector detection unit 15 also finds a rotation angle γ representing a rotation of the observed frame from the original frame as described before.

It is to be noted that, in this embodiment, the movement-vector detection unit 15 usually finds a hand-trembling vector indicating a movement of a currently observed frame from the original frame leading ahead of the currently observed frame by one frame. Thus, in order to compute hand trembling relative to a first observed frame serving as a reference frame, the movement represented by the hand-trembling vector is integrated in a cumulative addition process to add the movement to a previously integrated result obtained so far. It is to be noted that the first observed frame serving as a reference frame is the image frame 120 shown in FIG. 3.

Then, in exactly the same way as the first embodiment described above, after a delay corresponding to one frame, while cutting out and rotating an image frame stored in the frame memory 44 at the same time in accordance with parallel-shift quantities and an angle of rotation, which are detected as hand-trembling, the rotation/parallel-shift addition unit 19 adds the image frame to a post-addition frame stored in the frame memory 45 by the addition or average methods. By carrying out this process repeatedly, the final image frame 120 shown in FIG. 3 is stored in the frame memory 45. The final image frame 120 is a still image that is free of hand-trembling effects, has a higher S/N ratio and has better resolution.

Then, the resolution conversion unit 16 cuts out the frame image stored in the frame memory 45 into an image having a resolution and a size, which are specified in a control command issued by the CPU 1, and supplies the image to the codec unit 17 as data of an image taken in a photographing operation to be recorded into a recording medium and to the NTSC encoder 18 as data of a monitored image as described earlier.

In the case of the second embodiment, the original frame is a frame stored in the frame memory 44 and the observed frame is a frame being received from the data conversion unit 14 as a stream. In the case of the first embodiment, the movement-vector detection unit 15 carries out processing to find SAD values for observed blocks from image data of two frames stored in the frame memories 41 and 42. In the case of the second embodiment, on the other hand, the movement-vector detection unit 15 carries out processing to find SAD values for observed blocks by taking stream image data being received from the data conversion unit 14 as the image data of the observed frame and the image data stored in the frame memory 44 as the image data of the original frame as shown in FIG. 71.

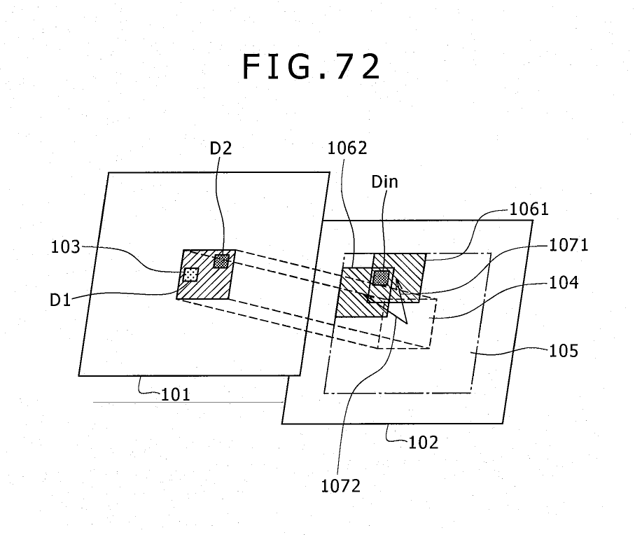

As described above, in the case of the second embodiment, the movement-vector detection unit 15 takes stream image data being received from the data conversion unit 14 as the image data of the observed frame. Thus, for an input pixel Din, there are a plurality of observed blocks 106 each existing on the observed frame 102 at the same time as a block having the input pixel Din as an element. FIG. 72 is an explanatory diagram referred to in description to show the existence of such observed blocks 106 on the observed frame 102.

As is obvious from FIG. 72, the input pixel Din in the search range 105 set on the observed frame 102 is a pixel included on the left side of an observed block 1061 pointed to by an observation vector 1071 as well as a pixel included at the right upper corner of an observed block 1062 pointed to by an observation vector 1072.

Thus, in processing the observed block 1061 during a process to compute a difference in pixel value between pixels, the pixel value of the input pixel Din is compared with a pixel D1 on the target block 103. In processing the observed block 1062 during a process to compute a difference in pixel value between pixels, on the other hand, the pixel value of the input pixel Din is compared with a pixel D2 on the target block 103.

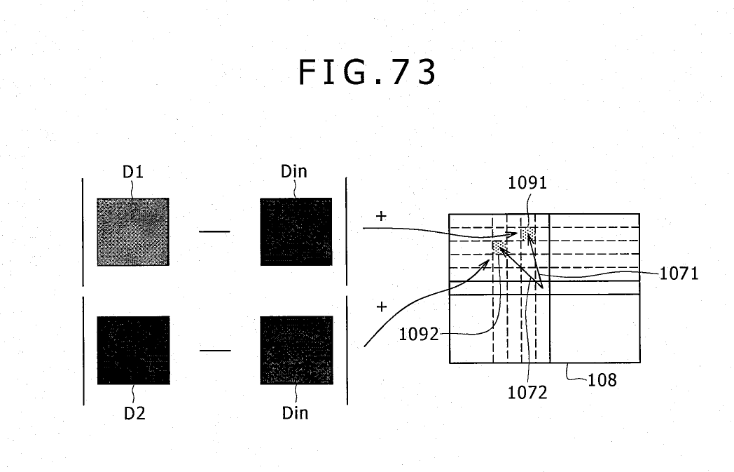

In order to make explanation easy to understand, FIG. 72 and FIG. 73 to be described later each show two observed blocks. In actuality, however, a number of observed blocks each including the input pixel Din exist.

In the process to compute a SAD value in this second embodiment, a difference in pixel value is computed by finding the absolute value of the difference between the luminance value Y of the input pixel Din on the observed block 106 being processed and the luminance value Y of a pixel at a point existing on the target block 103 as a point corresponding to the point of the input pixel Din. Each time the absolute value of such a difference is computed, the absolute value of the difference is cumulatively added to a temporary sum stored previously in a table element, which is included in a SAD table 108 as a table element according to an observation vector 107 associated with the observed block 106, as a sum of the absolute values of such differences. The process to compute the absolute value of a difference in pixel value and the process to store the absolute value in a table element are carried out for every observation vector 107 associated with the reference frame 106 including the input pixel Din.

Let us assume for example that the observed block 1061 is an observed block currently being processed. In this case, a difference in pixel value is computed by finding the absolute value of the difference between the luminance value Y of the input pixel Din on the observed block 1061 and the luminance value Y of a pixel D1 at a point existing on the target block 103 as a point corresponding to the point of the input pixel Din. Then, the computed absolute value of the difference is cumulatively added to a temporary sum stored previously in a correlation-value table element (or a SAD table element) 1091, which is included in a correlation-value table (or a SAD table) 108 shown in FIG. 73 as a table element according to an observation vector 1071 associated with the observed block 1061, as a sum of the absolute values of such differences. The process to compute the absolute value of a difference in pixel value and the process to cumulatively add the computed absolute value to a temporary sum computed and stored previously in the SAD table element 1091 are carried out for every observation vector 107 associated with the reference frame 106 including the input pixel Din.

For example, the observation vector 1072 is associated with the observed block 1062 also including the input pixel Din. In this case, the process to compute the absolute value of a difference in pixel value and the process to cumulatively add the computed absolute value to a temporary sum computed and stored previously in the SAD table element 1092 are carried out for the observation vector 1072. The SAD table element 1092 is included in the correlation-value table (or the SAD table) 108 shown in FIG. 73 as a table element according to an observation vector 1072 associated with the observed block 1062. When the observed block 1062 is processed, a difference in pixel value is computed by finding the absolute value of the difference between the luminance value Y of the input pixel Din on the observed block 1062 and the luminance value Y of a pixel D2 at a point existing on the target block 103 as a point corresponding to the point of the pixel Din. Then, the computed absolute value of the difference is cumulatively added to a temporary sum stored previously in a SAD table element 1092, which is included in the SAD table 108 shown in FIG. 73 as a table element according to the observation vector 1072 associated with the observed block 1062, as a sum of the absolute values of such differences.

The processing carried out on all observed blocks 106 (such as the observed blocks 1061 and 1062) each including the input pixel Din as described above is carried out for all input pixels Din in the search range 105. As the processing is done for all the input pixels Din in the search range 105, each table element 109 of the SAD table 108 contains a final SAD value and the creation of the SAD table 108 is completed.

The explanation with reference to FIG. 73 holds true for a case of applying the technique in related art to a process to compute SAD values in a real-time manner. As described above by referring to FIG. 73, the SAD table elements 1091 and 1092 are each a typical SAD table element 109 included in the SAD table 108 as elements associated with the observation vectors 1071 and 1072 respectively. In the case of this second embodiment, on the other hand, each table element 109 of the correlation-value table (or the SAD table) 108 is not a final SAD value, which is a cumulative sum of the absolute values of differences in pixel value as described above. Instead, much like the first embodiment described before, the SAD table 108 is shrunk into a contracted SAD table. Each table element of the contracted SAD table is a value obtained by executions the steps of:

computing the absolute difference of a difference in pixel value between an input pixel in the search range on a reference frame 106 and the corresponding pixel on the target frame;

contracting an observation vector 107 pointing to an observed block 106 at a contraction factor of 1/n;

splitting the computed absolute difference into a plurality of component absolute differences by adoption of the linear weighted distribution technique; and

cumulatively adding the component absolute differences to temporary sums previously computed and stored in a plurality of table elements associated with a plurality of respective neighbor contracted observation vectors existing in close proximity to a contracted vector obtained as a result of contracting the observation vector 107.

The steps described above are executed for every observation vector 107 pointing to an observed block 106 including the input pixel to obtain the value stored in the table element. The steps executed for all observation vectors 107 pointing to observed blocks 106 sharing an input pixel are repeated for every input pixel. As the execution of the steps is done for every input pixel included in the search range, the contracted SAD table is completed.

After the contracted SAD table is completed, a process to detect an accurate movable vector in accordance with the second embodiment can be carried out by adoption of entirely the same techniques as the first embodiment. As explained earlier, the typical techniques adopted by the first embodiment are the quadratic-surface technique and the technique based on cube curves laid on planes oriented in the vertical and horizontal directions.

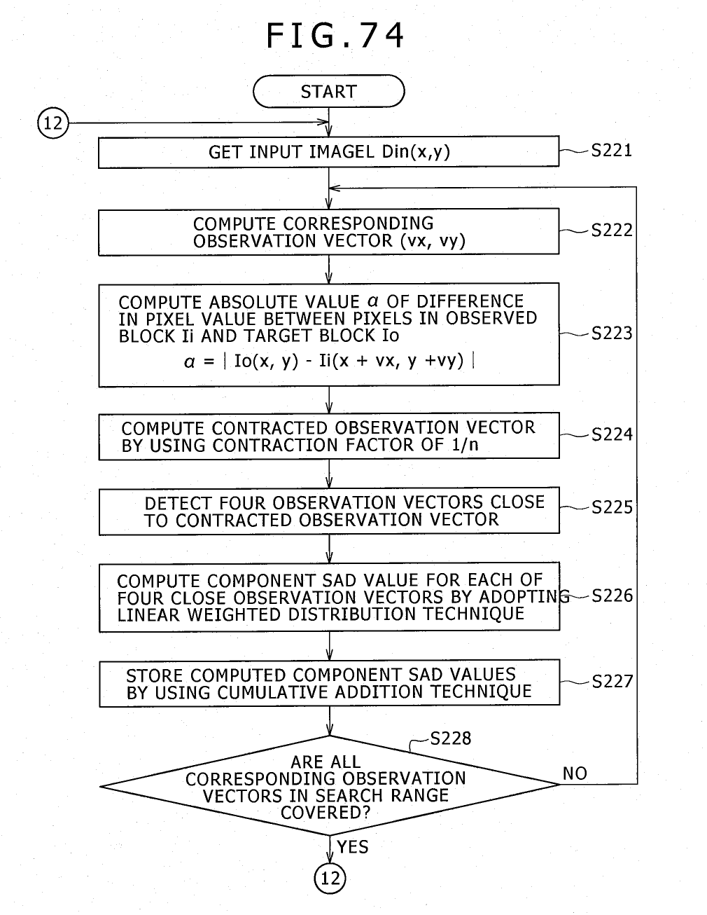

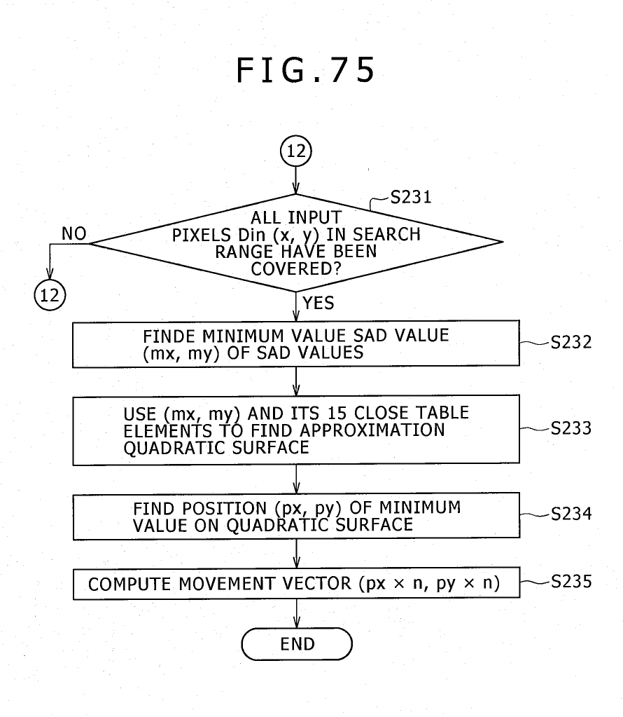

FIGS. 74 and 75 show a flowchart representing processing carried out by the hand-trembling movement-vector detection unit 15 employed in the image-pickup apparatus 10 according to the second embodiment to generate a shrunk SAD table for each target block and detect an every-block movement vector for each shrunk SAD table. The processing is carried out at the step S32 of the flowchart shown in FIG. 39, the step S52 of the flowchart shown in FIG. 41, the step S72 of the flowchart shown in FIG. 43, and the step S82 of the flowchart shown in FIG. 44.

The flowchart begins with a step S221 at which the hand-trembling movement-vector detection unit 15 receives pixel data Din (x, y) of a pixel at any point (x, y) on a frame included in an input image as an observed frame. Then, at the next step S222, an observation vector (vx, vy) pointing to one of a plurality of observed blocks Ti each including the input pixel Din (x, y) at the position (x, y) is specified.

Let us have notation Ii (x, y) denote the pixel value of the pixel at the point (x, y) on the observed block Ii pointed to by the observation vector (vx, vy) and notation (x−vx, y−vy) denotes the pixel value of a pixel at a point (x−vx, y−vy) on the target block Io. In the following description, the point (x−vx, y−vy) in the target block Io is said to be a point corresponding the point (x, y) in the observed block Ii. Then, at the next step S223, the absolute value α of the difference between the pixel value Ii (x, y) and the pixel value Io(x−vx, y−vy) is computed in accordance with Eq. (4) as follows:
α=|Ii(x,y)−Io(x−vx,y−vy)| (4)

Then, at the next step S224, a contracted observation vector (vx/n, vy/n) is computed by contracting the observation vector (vx, vy) pointing to the observed block Ii at a contraction factor of 1/n. In general, the x-direction and y-direction values (vx/n, vy/n) of the resulting contracted observation vector each include a fraction part.

Subsequently, at the next step S225, a plurality of neighbor observation vectors located at in the neighbor of the contracted observation vector (vx/n, vy/n) are identified. As described earlier, the neighbor observation vectors are each a contracted observation vector having an integer vx/n value and an integer vy/n value. In this embodiment, the number of neighbor observation vectors is set at four. Then, at the next step S226, the absolute value α found at the step S223 as the difference in pixel value is split into four component differences by adoption of the linear weighted distribution technique based on relations between positions pointed to by the neighbor observation vectors and a position pointed to by the contracted observation vector (vx/n, vy/n) as described earlier. Subsequently, at the next step S227, the four component differences are distributed among four table elements included in the contracted correlation-value table as four table elements associated with the four neighbor observation vectors, respectively.

After the process of the step S227 is completed, the flow of the processing according to the second embodiment goes on to the next step S228 to produce a result of determination as to whether or not the processes of the steps S222 to S227 have been carried out for all observation vectors (vx, vy) each pointing to an observed block Ii including the input pixel Din (x, y). If the result of the determination indicates that the processes of the steps S222 to S227 have not been carried out yet for all observation vectors (vx, vy) each pointing to an observed block Ii including the input pixel Din (x, y), the flow of the processing goes back to the step S222. Another observation vector (vx, vy) pointing to one of a plurality of observed blocks Ii each including the input pixel Din (x, y) is specified. Then, the processes of the steps S223 to S227 following the step S222 are repeated.

If the determination result produced at the step S228 indicates that the processes of the steps S222 to S227 have been carried out for all observation vectors (vx, vy) each pointing to an observed block Ii including the input pixel Din (x, y), on the other hand, the flow of the processing according to the second embodiment goes on to a step S231 of the continuation flowchart shown in FIG. 75. The step S231 produces a result of determination as to whether or not the processes of the steps S221 to S228 have been carried out for all input pixels Din (x, y) in the search range 105. If the result of the determination indicates that the processes of the steps S221 to S228 have not been carried out yet for all input pixels Din (x, y) in the search range 105, the flow of the processing according to the second embodiment goes back to the step S221 at which pixel data Din (x, y) of another pixel at another point (x, y) on a frame is received. Then, the processes of the subsequent steps are carried out.

If the determination result produced at the step S231 indicates that the processes of the steps S221 to S228 have been carried out for all input pixels Din (x, y) in the search range 105, on the other hand, the flow of the processing according to the second embodiment goes on to a step S232. The smallest value among all the component final SAD values stored in all the elements of the contracted correlation-value table or the contracted SAD table is detected at a table-element address (mx, my).

Then, at the next step S233, a quadratic surface is created as a surface approximating the minimum correlation value detected at the table-element address (mx, my) and a plurality of correlation values stored in the shrunk correlation-value table as table elements in the neighbor of the table-element address (mx, my). As described above, the correlation values are each a SAD value. In the case of this second embodiment, the number of correlation values stored in the shrunk correlation-value table as table elements in the neighbor of the table-element address (mx, my) is set at 15. Then, at the next step S234, a minimum-value vector (px, py) pointing to a position on the X-Y plane at precision of the fraction level is detected as a vector corresponding to the minimum SAD value on the quadratic surface. The position pointed to by the minimum-value vector (px, py) is a position corresponding to the minimum SAD value on the quadratic surface.

Then, at the last step S235, a movement vector (px×n, py×n) with the original magnitude and the original direction is computed by multiplying the minimum-value vector (px, py) by the reciprocal value n of the contraction factor as shown in FIG. 21.

Also, in the case of the second embodiment, in place of the quadratic-surface method described above, the cubic-curve method oriented the vertical and horizontal directions respectively can also be adopted as a method to detect a movement vector (px, py) pointing to a position with the precision of the fraction level described earlier.

Also, in the case of the second embodiment, the processing to detect a movement table by using a contracted SAD table can be carried out repeatedly at two or more stages while narrowing the search range and, if necessary, changing the contraction factor as is the case with a routine explained earlier by referring to the flowchart shown in FIGS. 51 to 54 as the third typical processing routine.

The second embodiment offers merits that the size of the frame memory can be reduced by one frame in comparison with the first embodiment. Hence, the time it takes to store an input image in the frame memory can be shortened. Accordingly, the effect of the memory-size reduction can be demonstrated. However, the short time it takes to store an input image in the frame memory is also regarded as an important feature in recent years.

### Third Embodiment

The second embodiment described above adopts a method to detect a hand-trembling movement vector and a rotational angle by usually comparing an input image with an image leading ahead of the input image by one frame. In actuality, however, the first frame is taken as a base and the subsequent frames are superposed on the base as described earlier by referring to FIG. 3. For this reason, the first image is rather taken deliberately as the base in the process to detect a movement vector in order to reduce errors. A third embodiment is an embodiment taking this point into consideration.

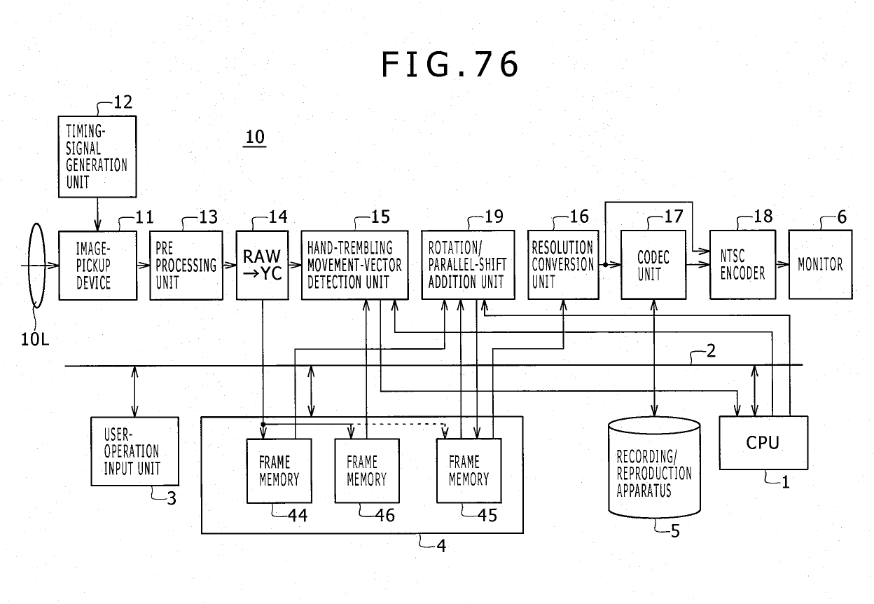

FIG. 76 is a block diagram showing a typical configuration of the image-pickup apparatus according to the third embodiment.

In the case of the third embodiment shown in FIG. 76, the image memory unit 4 includes an additional frame memory 46 besides the frame memories 44 and 45 employed in the second embodiment shown in FIG. 71. Image data output by the data conversion unit 14 is stored in the frame memory 44 first before being transferred to the frame memory 46.

The third embodiment is a system having a configuration in which the frame memory 46 is used for storing a first frame to serve as a target frame, which is also referred to as an original frame or a reference frame, and a movement vector is usually detected as a vector representing a movement of an input image relative to the image of the reference frame. In the configuration, a result of an image addition process is stored in the frame memory 45.

Also in the case of the third embodiment, the image data of the first observed frame is stored first in the frame memory 45 as well as the frame memory 44 as shown by a dashed arrow in FIG. 76.

The image data of each of the second and subsequent observed frames is stored in the frame memory 44 and supplied to the hand-trembling movement-vector detection unit 15. The movement-vector detection unit 15 detects a hand-trembling vector representing a movement of each of the second and subsequent observed frames received from the data conversion unit 14 from the immediately leading ahead of observed frame already transferred from the frame memory 44 to the frame memory 46. Thus, in order to compute the amount of hand trembling relative to the first observed frame serving as the reference, the hand-trembling vectors detected so far for every two consecutive observed frames are integrated in a cumulative addition. By the same token, the movement-vector detection unit 15 also detects a rotation angle representing a rotation of each of the second and subsequent observed frames received from the data conversion unit 14 from the first observed frame serving as the reference already transferred from the frame memory 44 to the frame memory 46.

The hand-trembling movement-vector detection unit 15 supplies the detected hand-trembling vector representing a movement of each of the second and subsequent observed frames from the first observed frame serving as the reference and the detected rotation angle representing a rotation of each of the second and subsequent observed frames from the first observed frame serving as the reference to the CPU 1.

Then, the CPU 1 controls the rotation/parallel-shift addition unit 19 to read out the image data of each of the second and subsequent observed frames from the frame memory 44 in such a way that its computed hand-trembling components relative to the image data of the first observed frame serving as the reference are eliminated. In accordance with a control signal output by the CPU 1, the rotation/parallel-shift addition unit 19 rotates the image data of each individual one of the second and subsequent observed frames read out from the frame memory 44 in accordance with the angle of rotation of the individual observed frame from the first observed frame serving as the reference. The rotation/parallel-shift addition unit 19 adds the rotated observed frame to the first observed frame or a post-addition frame read out from the frame memory 45 as a previous result of superposing a plurality of frames, or carries out an averaging process on the rotated observed frame and the first observed frame or the post-addition frame. A frame resulting from the simple addition or the averaging process is then stored back in the frame memory 45 as a new post-addition frame.

Then, in accordance with a control signal output by the CPU 1, the data of the image frame stored in the frame memory 45 is cut out into a frame with a resolution determined in advance and a size also determined in advance and the resulting frame is supplied to the resolution conversion unit 16. Image data output by the resolution conversion unit 16 as data free of effects caused by hand trembling is supplied to the codec unit 17 and the NTSC (National Television System Committee) encoder 18 for converting the data into a standard color video signal conforming to the NTSC system.

The third embodiment described above implements a system capable of carrying out a simple or averaging addition process an infinite number of times with the first frame of an input image taken as a reference frame. It is to be noted, however, that if the memory is available abundantly or an operation to temporarily save data in the recording/reproduction apparatus 5 is allowed, all images can be held in the memory or the recording/reproduction apparatus 5 in advance and then the process is carried out on the images by adoption of the averaging frame addition method or the tournament frame addition method.

### Fourth Embodiment

By combining the sensorless methods to compensate an image for effects of hand trembling in accordance with the first to third embodiments with the techniques to compensate an image for effects of hand trembling on the basis of the contemporary technology, better results can be obtained.

The beginning of the patent specification explains that a process to compensate an image for effects of hand trembling by using a gyro sensor results in rough compensation whereas a rotary compensation technique is difficult to implement. On the other hand, a sensorless process to compensate an image for effects of hand trembling by adoption of the block-matching method provides a high degree of precision including rotational compensation. If the search range becomes wide, however, the cost of the SAD table rises abruptly or, even if the block-matching method according to the embodiments is adopted, execution of the process to detect a movement vector at a plurality of stages prolongs the time it takes to carry out the whole processing.

In order to solve the problems described above, it is necessary to provide a system for compensating an image for effects of hand trembling at a low cost, with a high degree of precision, and at a high processing speed. The step include compensating the image for optical effects of hand trembling to result in rough compensation, reducing the size of a search range used in detection of a movement vector used for compensating the image for effects of hand trembling at a sensor level, detecting a movement vector in the search range, and compensating the image for effects of hand trembling in a sensorless way.

The sensorless hand-trembling compensation method based on the block-matching techniques according to the first to fourth embodiments described above offers merits including a low cost, a high degree of precision, short processing time as well as good robustness in comparison with the sensorless technologies each proposed so far as a technology for compensating a still image for effects of hand trembling.

All apparatus each made available in the current market as an apparatus for compensating a still image for effects of hand trembling are each a system adopting combined optical compensation techniques including a gyro-sensor method and a lens-shift method. Nevertheless, such a system introduces a big error and an unsatisfactory picture quality. In accordance with the techniques provided by the present embodiment, on the other hand, the sensor and other mechanical components can be eliminated to allow a system to be implemented as an apparatus for compensating a still image for effects of hand trembling at a low cost and with a high degree of precision.

### Other Embodiments

In the case of the embodiments described above, an observation vector is contracted in the vertical and horizontal directions at the same contraction factor. However, an observation vector can also be contracted in the vertical and horizontal directions at different contraction factors.

In addition, in the case of the embodiments described above, a SAD value of an observed block and a target block is computed on the basis of the pixel values of all pixels in the observed block and all corresponding pixels in the target block, being used as a correlation value representing a correlation between the observed block and the target block. However, a SAD value of an observed block and a target block can also be computed on the basis of the pixel values of k pixels in an observed block and the k corresponding pixels in the target block where k is an integer, being used as a correlation value representing a correlation between the observed block and the target block.

It is desirable to provide a system, which is used for detecting a movement vector in a real-time manner, to reduce the processing cost and the time it takes to carry out the processing. In such a system, it is thus often necessary to search the target block for representative points mentioned above and compute a correlation value such as a SAD value on the basis of pixel values at the representative points in the target block and pixel values at corresponding points included in an observed block.

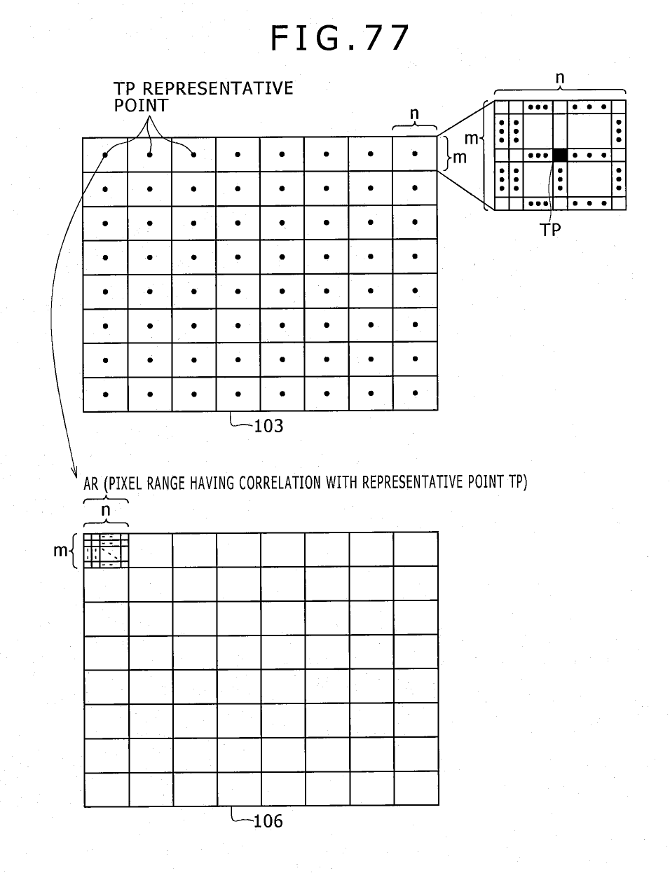

To put it concretely, for example, the target block 103 is spit into a plurality of sub-blocks each including n×m pixels or each including n pixel columns and m pixel rows as shown in FIG. 77 where n and m are each an integer at least equal to one. One of a plurality of pixels in each sub-block is then taken as the representative point (or the target point) TP of the sub-block. Then, a correlation value such as a SAD value is computed on the basis of pixel values at the selected representative points TPs in the target block 103 and pixel values at points included in an observed block 106.

However, pixel values of all pixels in the observed block 106 are still used in the process to compute a correlation value such as a SAD value. In particular, the observed block 106 is split into as many pixel ranges ARs each including n×m pixels as sub-blocks (or target points TPs) in the target block 103, and all the n×m pixels in the pixel range AR are used in the process to compute a correlation value such as a SAD value in conjunction with the pixel value at the target point TP in the sub-block corresponding to the pixel range AR.

In particular, the absolute value of a difference in pixel value between a target point TP in a sub-block on the target block 103 and each of the n×m pixels in the pixel range AR on the observed block 106 is computed and, then, a sub-block sum of such absolute values computed for the n×m pixels is found. Such a sub-block sum is found for every sub-block (or every target point TP) on the target block 103 and, then, a block sum of such sub-block sums found for all sub-blocks (or all target points TPs) on the target block 103 is computed. The computed block sum is the SAD value for the target block 103 and the observed block 106 and is stored in the SAD table 108 as an element 109 of the SAD table 108.

Then, a block sum (or the SAD value) for the target block 103 and an observed block 106 is found on the basis of the target points TPs in the target block 103 as described above for every observed block 106 in the search range 105 provided for the target block 103 and stored in the SAD table 108 as an element 109 of the table 108 in order to fill up the table 108, that is, in order to complete creation of the SAD table 108. In the case of this other embodiment, however, since each of a plurality of observed blocks 106 set in the search range 105 includes n×m pixels, the centers of the observed blocks 106 are shifted from each other by a distance corresponding to n×m pixels or a multiple of the n×m pixels.

In the case of an apparatus where representative points in the target block are used for computing a SAD value serving as a value representing correlation between a target block and an observed block, the memory is accessed for a target point TP on the target block once every pixel range AR including a plurality of pixels in the observed block. Thus, the number of accesses to the memory can be reduced considerably since target points TPs on the target block need to be accessed.

In addition, in the case of an apparatus where representative points in a target block are used, image data of pixels at the target points TPs on the target block need to be stored in the memory. That is to say, it is not necessary to store image data of all pixels on the target block. Thus, the size of the frame memory used for storing the original frame serving as a target frame including target blocks can also be reduced as well.

In addition to the frame memory, a representative-point memory implemented as an SRAM can also be provided locally as a local memory for storing image data of target blocks on an original frame used a target frame. In this way, the bandwidth of accesses to the image memory unit 4 implemented as a DRAM can be reduced.

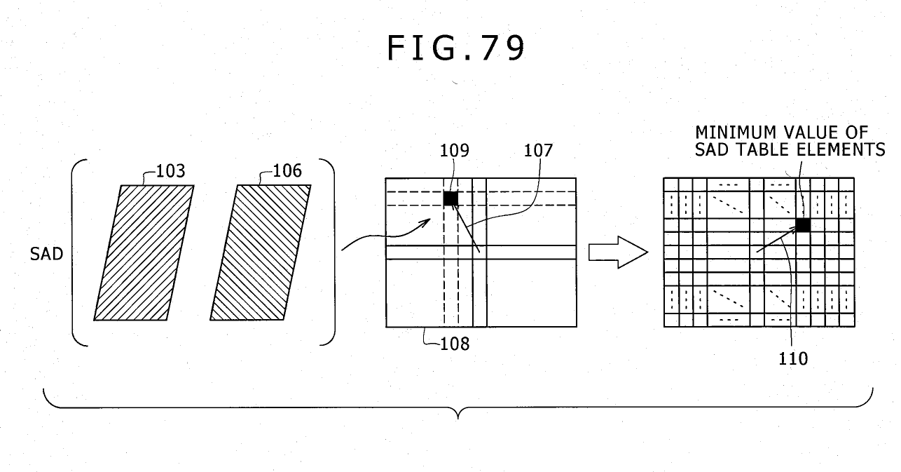

The process adopting the technique to use representative points of a target block is described above for the technique explained earlier by referring to FIGS. 78 to 80. It is needless to say, however, that the explanation of the process adopting technique to make use of representative points can also be applied to the method described before by referring to FIGS. 65 to 68 as a method according to the second embodiment.

The technique of using representative points of the target block is applied to the method according to the second embodiment. The steps include detecting all observed blocks sharing a pixel range AR including a pixel (referred to as an input pixel) of an input observed frame for every input pixel in the entire search range, and determining a plurality of representative points on the target block as points each corresponding to one of pixel ranges AR in each of all the detected observed blocks.

It is to be noted that the position of the input pixel in the pixel range AR varies from AR to AR.

Then, for an input pixel in a pixel range AR, the pixel value of a pixel located at one of the representative points of the target block is read out from the memory for storing the image data of an original frame serving as the target frame and used in conjunction with the pixel value of the input pixel to compute the absolute value of a difference between the pixel value of the pixel located at the representative point and the pixel value of the input pixel. Then, component values of the absolute value are each cumulatively added to a previously computed component value stored in an element included in the SAD table as an element corresponding to an observation vector pointing to an observed block.

In the processing described above, an access to the memory is made in order to read out the pixel values of pixels each located at one of the representative points. Thus, the number of accesses to the memory can be reduced substantially.

The processing based on representative points can also be applied to a case in which a shrunk SAD table is used.

In the embodiments described above, the absolute value of a difference in pixel value and a SAD value are each calculated as a correlation value by processing luminance values Y. In order to detect a movement vector, however, the processed pixel value is not limited to the luminance value Y. That is to say, the chrominance value Cb/Cr can also be taken as the processed pixel value as well. Moreover, raw data before being converted into a luminance value Y and a chrominance value Cb/Cr in the data conversion unit 14 can also be taken as the processed pixel value in the processing to detect a movement vector.

As described before, the hand-trembling movement-vector detection unit 15 is not limited to a configuration in which the processing to detect a movement vector is carried out by hardware. That is to say, the processing to detect a movement vector can also be carried out by execution of software.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An image-processing apparatus comprising:
computation means configured to compute a parallel-shift quantity of a parallel shift between two screens of images received sequentially in screen units and compute a rotation angle as the angle of a rotation made by a specific one of said two screens from the other one of said two screens; and
rotation/parallel-shift addition means configured to move the specific screen in a parallel shift according to said parallel-shift quantity computed by the computation means, rotate the specific screen by the rotation angle computed by the computation means as well as superpose the shifted and rotated specific screen on the other screen or a post-addition screen obtained as a result of superposing screens other than said specific screen on said other screen in order to add said screens other than said specific screen to said other screen;
wherein the rotation/parallel-shift addition means includes
rotation/parallel-shift processing means configured to read out said specific screen stored in a first memory from said first memory by controlling an address to read out said specific screen from said first memory in such a way that said specific screen moves in a parallel shift according to the parallel-shift quantity computed by the computation means and said specific screen rotates by the rotation angle computed by the computation means,
addition means configured to read out said other screen or said post-addition screen from a second memory as well as superpose said specific screen received from said rotation/parallel-shift processing means as a screen completing the parallel-shift and rotation processes on said other screen or said post-addition screen in order to add said specific screen to said other screen or said post-addition screen, and
control means configured to execute control to write back a new post-addition screen produced by the addition means as a result of the superposition process into the second memory.

2. The image-processing apparatus according to claim 1 wherein, in a rotation matrix including trigonometric functions cos γ and sin γ as matrix elements used in the rotation/parallel-shift processing means employed in the image-processing apparatus for computing a rotation quantity according to the rotation angle where notation y denotes the rotation angle, wherein the trigonometric functions cos γ and sin γ are approximated as cos γ=1 and sin γ=γ.

3. The image-processing apparatus according to claim 1 wherein the rotation angle computed by the computation means ranges from −arctan ( 1/64) to +arctan ( 1/64).

4. The image-processing apparatus according to claim 1 wherein image data of said specific screen read out from the first memory is transmitted in a burst transfer and an address position supposed to switch a read line of said specific screen in accordance with the rotation angle is set at an address serving as a boundary of the burst transfer.

5. The image-processing apparatus according to claim 4 wherein the center position of the period of the burst transfer is taken as a determination position for determining the read line of said specific screen.

6. The image-processing apparatus according to claim 1 wherein the computation means comprises:
every-block movement vector computation means configured to compute every-block movement vectors representing a movement made by an observed screen included in images received sequentially in screen units as said specific screen of said two screens from an original screen included in the images as said other screen of said two screens, which leads ahead of said specific screen, by
setting target blocks each having a size determined in advance and including a plurality of target pixels at a plurality of positions in said original screen,
setting a plurality of search ranges at positions corresponding to the positions of the target blocks in said observed screen,
setting a plurality of observed blocks each having the same size as the target blocks and including the same number of observed pixels as the target pixels included in the target block in each of the search ranges, and
executing a block matching method on each of the target blocks and all the observed blocks set in one of the search ranges, which is set at a position corresponding to the position of the individual target block, in order to find the every-block movement vector for said individual target block;
parallel-shift quantity computation means configured to compute a parallel-shift quantity representing a movement made by said observed screen from said original screen on the basis of said every-block movement vectors each computed by said every-block movement vector computation means for one of said target blocks; and
rotation-angle computation means configured to compute a rotation angle, by which said observed screen is rotated from said original screen, on the basis of the every-block movement vectors each computed by the every-block movement vector computation means for one of the target blocks.

7. The image-processing apparatus according to claim 6, wherein the image-processing apparatus further comprises:
global movement vector computation means configured to compute a global movement vector representing a movement made by said entire observed screen from said original screen; and
vector evaluation means configured to utilize the global movement vector in order to evaluate each of the every-block movement vectors computed by the every-block movement vector computation means for the target blocks set in said original screen and said observed screen;
wherein, if the number of aforementioned every-block movement vectors each receiving a high evaluation value from the vector evaluation means is smaller than a threshold value determined in advance, the rotation/parallel-shift addition means excludes said observed screen from said process to superpose said observed screen on said original screen or said post-addition screen.

8. The image-processing apparatus according to claim 6, wherein the image-processing apparatus further comprises:
global movement vector generation means configured to generate a global movement vector representing a movement made by said entire observed screen from said original screen; and
vector evaluation means configured to make use of the global movement vector in order to evaluate each of the every-block movement vectors computed by the every-block movement vector computation means for the target blocks set in said original screen and said observed screen;
wherein the parallel-shift quantity computation means and the rotation angle computation means compute a parallel-shift quantity and a rotation angle respectively from only the every-block movement vectors each receiving a high evaluation value from the vector evaluation means.

9. The image-processing apparatus according to claim 6 wherein the every-block movement vector computation means comprises:
difference absolute-value sum computation means configured to compute a difference absolute-value sum for each of the observed blocks set in one of the search ranges that corresponds to a specific one of the target blocks as a sum of the absolute values of differences in pixel value between target pixels in the specific target block and observed pixels located at positions corresponding to the positions of the target pixels in the individual observed block and find such difference absolute-value sums for each of the target blocks;
difference absolute-value sum table generation means configured to generate a difference absolute-value sum table for each individual one of the target blocks as a table with sum table elements thereof each used for storing a difference absolute-value sum computed by the difference absolute-value sum computation means for one of the observed blocks set in one of the search ranges that corresponds to the individual target block; and
movement-vector computation means configured to compute a plurality of every-block movement vectors each associated with one of the target blocks from the difference absolute-value sum tables each generated by the difference absolute-value sum table generation means for one of the target blocks;
wherein the global movement vector generation means includes
difference absolute-value sum total table generation means configured to generate a difference absolute-value sum total table, each individual one of total table elements of which is used for storing a total of the difference absolute-value sums each stored in a sum table element included in one of the difference absolute-value sum tables as a sum table element corresponding to the individual total table element, and
global movement vector detection means configured to detect the global movement vector from the difference absolute-value sum total table generated by the difference absolute-value sum total table generation means.

10. The image-processing apparatus according to claim 6 wherein the every-block movement vector computation means comprises:
difference absolute-value sum computation means configured to compute a difference absolute-value sum for each individual one of the observed blocks set in one of the search ranges that corresponds to a specific one of the target blocks as a sum of the absolute values of differences in pixel value between target pixels in the specific target block and observed pixels located at positions corresponding to the positions of the target pixels in the individual observed block and find such difference absolute-value sums for each of the target blocks;
contracted observation vector acquisition means configured to take an observation vector for each observed block set in the observed screen as a vector having a magnitude and a direction respectively representing the distance of a shift from the position of a target block on the original screen to the position of the observed block and the direction of the shift as well as configured to acquire a contracted observation vector obtained by contracting the observation vector at a contraction factor determined in advance;
shrunk difference absolute-value sum table generation means configured to generate a shrunk difference absolute-value sum table for each individual one of the search ranges as a table having fewer table elements than observed blocks set in said individual search range by a difference depending on the contraction factor and make use of each of the table elements for storing a fraction of the difference absolute-value sum computed by the difference absolute-value sum computation means for an observed block included in the individual search range as an observed block associated with said observation vector taken by the contracted observation vector acquisition means; and
movement-vector computation means configured to compute an every-block movement vector for each of the shrunk difference absolute-value sum tables each generated by the shrunk difference absolute-value sum table generation means for one of the target blocks that corresponds to the individual search range;
wherein the shrunk difference absolute-value sum table generation means employs
neighbor observation vector detection means configured to find a plurality of neighbor observation vectors each having a vector quantity close to the vector quantity of the contracted observation vector acquired by the contracted observation vector acquisition means,
component difference absolute value sum computation means configured to split the difference absolute-value sum computed by the difference absolute-value sum computation means for each of said observed blocks into the fractions each used as a component difference absolute value sum associated with one of the neighbor observation vectors found by the neighbor observation vector detection means, and
component difference absolute-value sum addition means configured to cumulatively add the component difference absolute value sums each computed by the component difference absolute value sum computation means as a sum associated with one of the neighbor observation vectors for each of the neighbor observation vectors.

11. The image-processing apparatus according to claim 6 wherein the every-block movement vector computation means comprises:
difference computation means configured to compute a difference for each individual one of the observed blocks set in one of the search ranges that corresponds to a specific one of the target blocks as a difference in pixel value between a target pixel in the specific target block and an observed pixel located at a position corresponding to the position of said target pixel in said individual observed block and find such a difference for every target pixel in each of the target blocks;
contracted observation vector acquisition means configured to take an observation vector for each observed block set in the observed screen as a vector having a magnitude and a direction respectively representing the distance of a shift from the position of a target block on said original screen to the position of said observed block and the direction of the shift as well as configured to acquire a contracted observation vector obtained by contracting the observation vector at a contraction factor determined in advance;
shrunk difference absolute-value sum table generation means configured to generate a shrunk difference absolute-value sum table for each individual one of the search ranges as a table having fewer table elements than observed blocks set in the individual search range by a difference depending on the contraction factor, and make use of each of the table elements for cumulatively storing a fraction of the absolute value of said difference computed by the difference computation means for a target pixel in one of the target blocks that corresponds to the individual search range; and
movement-vector computation means configured to compute an every-block movement vector for each of the shrunk difference absolute-value sum tables each generated by the shrunk difference absolute-value sum table generation means for one of the target blocks that corresponds to the individual search range;
wherein the shrunk difference absolute-value sum table generation means employs
neighbor observation vector detection means configured to find a plurality of neighbor observation vectors each having a vector quantity close to the vector quantity of the contracted observation vector acquired by the contracted observation vector acquisition means,
component difference absolute value computation means configured to split the absolute value of the difference computed by the difference computation means for a target pixel into the fractions, each used as a component difference absolute value associated with one of the neighbor observation vectors found by the neighbor observation vector detection means, and
component difference absolute value addition means configured to cumulatively add the component difference absolute values each computed by the component difference absolute value computation means as a component difference absolute value associated with one of the neighbor observation vectors for each of said neighbor observation vectors.

12. The image-processing apparatus according to claim 6, the image-processing apparatus further comprising:
error computation means configured to compute an error between the parallel-shift quantity computed by the parallel-shift quantity computation means and a parallel-shift quantity indicated by the every-block movement vector as well as an error between the rotation angle computed by the rotation angle computation means and a rotation angle indicated by the every-block movement vector;
error determination means for producing a result of determination as to whether or not a sum of the errors each computed by the error computation means for one of the every-block movement vectors is smaller than a threshold value determined in advance; and
control means configured to execute control of driving the rotation/parallel-shift addition means to carry out processing on said observed screen if the error determination means produces a determination result indicating that the sum of said errors each computed by the error computation means for one of the every-block movement vectors is smaller than the threshold value.

13. An image-pickup apparatus comprising:
image taking means for taking an image;
computation means configured to compute a parallel-shift quantity of a parallel shift between two screens of the image received from said image taking means and compute a rotation angle as the angle of a rotation made by a specific one of said two screens from the other one of said two screens;
rotation/parallel-shift addition means configured to move said specific screen in a parallel shift according to the parallel-shift quantity computed by the computation means, rotate said specific screen by the rotation angle computed by the computation means as well as superpose said shifted and rotated specific screen on said other screen or a post-addition screen obtained as a result of superposing screens other than said specific screen on said other screen in order to add said screens other than said specific screen to said other screen; and
image recording means configured to record data of a final post-addition screen obtained as a result of the superposition processing carried out by the rotation/parallel-shift addition means onto a recording medium;
wherein the rotation/parallel-shift addition means includes
rotation/parallel-shift processing means configured to read out said specific screen stored in a first memory from the first memory by controlling an address to read out said specific screen from the first memory in such a way that said specific screen being read out from the first memory moves in a parallel shift according to the parallel-shift quantity computed by the computation means and said specific screen being read out from the first memory rotates by the rotation angle computed by the computation means,
addition means configured to read out said other screen or said post-addition screen from a second memory as well as superpose said specific screen received from the rotation/parallel-shift processing means as a screen completing said parallel-shift and rotation processes on said other screen or said post-addition screen in order to add said specific screen to said other screen or said post-addition screen, and
control means configured to execute control to write back a new post-addition screen produced by the addition means as a result of the superposition process into the second memory.

14. An image-processing method comprising:
computing a parallel-shift quantity of a parallel shift between two screens of images received sequentially in screen units and computing a rotation angle as the angle of a rotation made by a specific one of said two screens from the other one of said two screens; and
moving said specific screen in a parallel shift according to the parallel-shift quantity computed in the computation process, rotating said specific screen by the rotation angle computed in the computation process as well as superposing said shifted and rotated specific screen on said other screen or a post-addition screen obtained as a result of superposing screens other than said specific screen on said other screen in order to add said screens other than said specific screen to said other screen;
wherein the rotation/parallel-shift addition process includes
reading out said specific screen stored in a first memory from the first memory by controlling an address to read out said specific screen from the first memory in such a way that said specific screen being read out from the first memory moves in a parallel shift according to the parallel-shift quantity computed in the computation process and said specific screen being read out from the first memory rotates by the rotation angle computed in the computation process,
reading out said other screen or said post-addition screen from a second memory and superposing said specific screen received from the rotation/parallel-shift processing process as a screen completing the parallel-shift and rotation processes on said other screen or said post-addition screen in order to add said specific screen to said other screen or said post-addition screen, and
executing control to write back a new post-addition screen produced in the addition sub-process as a result of the superposition processing into the second memory.

15. The image processing method according to claim 14 wherein, in a rotation matrix including trigonometric functions cos γ and sin γ as matrix elements used in said rotation/parallel-shift processing process included in the image processing method for computing a rotation quantity according to the rotation angle, where γ denotes the rotation angle, and the trigonometric functions cos γ and sin γ are approximated as cos γ=1 and sin γ=γ.

16. The image processing method according to claim 14 wherein the rotation angle computed in the computation process ranges from −arctan ( 1/64) to +arctan ( 1/64).

17. The image-processing method according to claim 14 wherein image data of said specific screen read out from the first memory is transmitted in a burst transfer and an address position supposed to switch a read line of said specific screen in accordance with the rotation angle is set at an address serving as a boundary of the burst transfer.

18. The image processing method according to claim 17 wherein the center position of the period of the burst transfer is taken as a determination position for determining the read line of said specific screen.

19. An image taking method comprising:
computing a parallel-shift quantity of a parallel shift between two screens of said image received from an image taking means and computing a rotation angle as the angle of a rotation made by a specific one of said two screens from the other one of said two screens;
moving said specific screen in a parallel shift according to the parallel-shift quantity computed in the computation process, rotating said specific screen by the rotation angle computed in the computation process as well as superposing said shifted and rotated specific screen on said other screen or a post-addition screen obtained as a result of superposing screens other than said specific screen on said other screen in order to add said screens other than said specific screen to said other screen; and
recording data of a final post-addition screen obtained as a result of the superposition processing carried out in the rotation/parallel-shift addition process onto a recording medium;
wherein the rotation/parallel-shift addition process includes
reading out said specific screen from a first memory by controlling an address to read out said specific screen from the first memory in such a way that said specific screen being read out from the first memory moves in a parallel shift according to the parallel-shift quantity computed in the computation process and said specific screen being read out from the first memory rotates by said rotation angle computed in the computation process,
reading out said other screen or said post-addition screen from a second memory and superposing said specific screen received from the rotation/parallel-shift processing process as a screen completing said parallel-shift and rotation processes on said other screen or said post-addition screen in order to add said specific screen to said other screen or said post-addition screen, and
executing control to write back a new post-addition screen produced in said addition sub-process as a result of the superposition processing into the second memory.

20. An image-processing apparatus comprising:
a computation section configured to compute a parallel-shift quantity of a parallel shift between two screens of images received sequentially in screen units and compute a rotation angle as the angle of a rotation made by a specific one of said two screens from the other one of said two screens; and
a rotation/parallel-shift addition section configured to move said specific screen in a parallel shift according to the parallel-shift quantity computed by the computation section, rotate said specific screen by the rotation angle as well as superpose said shifted and rotated specific screen on said other screen or a post-addition screen obtained as a result of superposing screens other than said specific screen on said other screen in order to add said screens other than said specific screen to said other screen;
wherein the rotation/parallel-shift addition section includes
a rotation/parallel-shift processing section configured to read out said specific screen stored in a first memory from the first memory by controlling an address to read out said specific screen from the first memory in such a way that said specific screen being read out from the first memory moves in a parallel shift according to the parallel-shift quantity computed by the computation section and said specific screen being read out from the first memory rotates by the rotation angle computed by the computation section,
an addition section configured to read out said other screen or said post-addition screen from a second memory as well as superpose said specific screen received from the rotation/parallel-shift processing section as a screen completing said parallel-shift and rotation processes on said other screen or said post-addition screen in order to add said specific screen to said other screen or said post-addition screen, and
a control section configured to execute control to write back a new post-addition screen produced by the addition section as a result of the superposition process into the second memory.

21. An image-pickup apparatus comprising:
an image taking section for taking an image;
a computation section configured to compute a parallel-shift quantity of a parallel shift between two screens of the image received from the image taking section and compute a rotation angle as the angle of a rotation made by a specific one of said two screens from the other one of said two screens;
a rotation/parallel-shift addition section configured to move said specific screen in a parallel shift according to said parallel-shift quantity computed by the computation section, rotate said specific screen by the rotation angle computed by the computation section as well as superpose said shifted and rotated specific screen on said other screen or a post-addition screen obtained as a result of superposing screens other than said specific screen on said other screen in order to add said screens other than said specific screen to said other screen; and
an image recording section configured to record data of a final post-addition screen obtained as a result of said superposition processing carried out by said rotation/parallel-shift addition section onto a recording medium;
wherein the rotation/parallel-shift addition section includes
a rotation/parallel-shift processing section configured to read out the specific screen stored in a first memory from the first memory by controlling an address to read out said specific screen from the first memory in such a way that said specific screen being read out from the first memory moves in a parallel shift according to said parallel-shift quantity computed by the computation section and said specific screen being read out from the first memory rotates by the rotation angle computed by the computation section,
an addition section configured to read out said other screen or said post-addition screen from a second memory as well as superpose said specific screen received from the rotation/parallel-shift processing section as a screen completing the parallel-shift and rotation processes on said other screen or said post-addition screen in order to add said specific screen to said other screen or said post-addition screen, and
a control section configured to execute control to write back a new post-addition screen produced by the addition section as a result of the superposition process into the second memory.
